(19) United States
(12) Patent Application Publication
(10) Pub. No.: US 2006/0282319 A1
(43) Pub. Date: Dec. 14, 2006

(54) Method and system for substituting media content

(76) Inventor: Frank S. Maggio, St. Petersburg, FL (US)

Correspondence Address: KING & SPALDING LLP, 1180 PEACHTREE STREET, ATLANTA, GA, 30309, US

(21) Appl. No.: 11/397,481

(22) Filed: Apr. 3, 2006

Related U.S. Application Data
(63) Continuation-in-part of application No. 11/348,973, filed on Feb. 7, 2006.
Application No. 11/348,973 is a continuation-in-part of application No. 10/976,149, filed on Oct. 28, 2004.
Application No. 10/976,149 is a continuation-in-part of application No. 10/683,939, filed on Oct. 10, 2003.
Application No. 10/683,939 is a continuation-in-part of application No. 10/439,121, filed on May 15, 2003.
Application No. 10/683,939 is a continuation-in-part of application No. 09/820,482, filed on Mar. 29, 2001, now Pat. No. 6,606,745.
Application No. 10/439,121 is a continuation-in-part of application No. 10/434,622, filed on May 9, 2003.
(60) Provisional application No. 60/381,149, filed on May 16, 2002.
(60) Provisional application No. 60/239,631, filed on Oct. 12, 2000.
(60) Provisional application No. 60/379,799, filed on May 10, 2002.
(60) Provisional application No. 60/417,877, filed on Oct. 11, 2002.
(60) Provisional application No. 60/453,150, filed on Mar. 10, 2003.

(51) Int. Cl. G06Q 30/00

(52) U.S. Cl. 705/14

(57) ABSTRACT

A business entity can replace original advertising content in which the business has little or no economic interest with alternative advertising content in which the business has more economic interest. A media program, such as a television show, can have associated original advertising content that can provide economic benefit to the program's producers, affiliates, or sponsors. The original advertising content can appear during a commercial break or a program intermission. A machine or a human can monitor the program to detect the commercial break or an occurrence of some other advertising event connected with presentation of the original advertising content. In response to detecting the commercial break, presentation of the original advertising content can be manually or automatically interrupted, suspended, or stopped. The alternative advertising content can be presented during the commercial break as a replacement or substitution for the original advertising content, thereby benefiting the business entity.

### CROSS REFERENCE TO RELATED APPLICATIONS

This application claims priority to U.S. Provisional Patent Application Serial No. 60/778,640, filed Mar. 1, 2006, having attorney docket number 58368.105028-P and entitled “Method and System for Providing Broadband Access, HDTV, and Broadband-Enabled Services,” the entire contents of which are hereby included herein by reference.

This application is a continuation-in-part of U.S. patent application Ser. No. 11/348,973 to Maggio, entitled “Method and System for Interacting with On-Demand Video Content,” having attorney docket number 58368.105019, and filed Feb. 7, 2006, which is a continuation-in-part of U.S. patent application Ser. No. 10/976,149, filed Oct. 28, 2004, entitled “Method and System for Interacting with a Writing,” and published as U.S. Patent Application Publication No. 2005/0060232 on Mar. 17, 2005 to Maggio. U.S. patent application Ser. No. 10/976,149 is a continuation-in-part of U.S. patent application Ser. No. 10/683,939, filed Oct. 10, 2003 and entitled “Remote Control System and Method for Interacting with Broadcast Content.” U.S. patent application Ser. No. 10/683,939 is a continuation-in-part of U.S. patent application Ser. No. 10/439,121, filed May 15, 2003 and entitled “Method and System for Verifying Exposure to Message Content Delivered Via Outdoor Media or in a Concentrated Format,” which claims priority to U.S. Provisional Patent Application No. 60/381,149, filed May 16, 2002 and entitled “Mass Media Advertising Distribution and Usage System,” and which is a continuation-in-part of U.S. patent application No. 09/820,482, filed Mar. 29, 2001 and entitled “Method and System for Communicating Advertising and Entertainment Content and Gathering consumer Information,” now U.S. Pat. No. 6,606,745, which claims priority to U.S. Provisional Patent Application No. 60/239,631, filed Oct. 12, 2000 and entitled “System and Method for Using Linked Sponsorships to Increase Mass-Market Appeal of Content.” U.S. patent application No. 10/439,121 is also a continuation-in-part of U.S. patent application Ser. No. 10/434,622, filed May 9, 2003 and entitled “Method and System for Verifying Exposure to Message Content Via a Printed Response,” which claims priority under 35 U.S.C. § 119 to U.S. Provisional Patent Application No. 60/379,799, filed May 10, 2002 and entitled “Methods and Systems of Utilizing Printed Responses and Other Printed Items as Response Devices in the CRAV Immersion Verification and Registration System and Process.” Additionally, U.S. patent application Ser. No. 10/683,939 claims priority to U.S. Provisional Patent Application No. 60/417,877, filed Oct. 11, 2002 and entitled “A System for Dual, Segregated Broadcasting and Data Collection Networks, and Supplemental Remote Control device Design, to Allow Consumer Reaction to CR\overline{A}V Ads and Response to Interactive Content,” and to U.S. Provisional Patent Application No. 60/453,150, filed Mar. 10, 2003 and entitled “An Internet-Enabled Universal Remote Control device Enabled to Respond to Reactive CR\overline{A}V Ad Queries, While Also Enabling Voice-Over Internet Protocol Functions, And Other Optional Functions, Including Instant Messaging And Internet Chatting, Credit Card Reader Functions, And Mathematical Calculations.” The contents of each of the above listed priority documents is hereby fully incorporated herein by reference.

This application is related to commonly owned U.S. patent application Ser. No. 11/348,750 to Maggio, entitled “Method and System for Home Shopping Using Video-on-Demand Services,” having attorney docket number 58368.105026, and filed Feb. 7, 2006, the contents of which are hereby fully incorporated herein by reference.

This application is also a continuation-in-part of U.S. patent application Ser. No. 10/439,121, entitled “Method and System for Verifying Exposure to Message Content Delivered via Outdoor Media or in a Concentrated Format,” filed May 15, 2003, and published on Jan. 22, 2004 in the name of Maggio. U.S. patent application Ser. No. 10/439,121 is a continuation-in-part of U.S. patent application Ser. No. 10/434,622 (Attorney Docket No. 58368.105009; Inventors: Frank S. Maggio and Mark Allen Siler), filed May 9, 2003 and entitled “Method and System for Verifying Exposure to Message Content Via a Printed Response.” U.S. patent application Ser. No. 10/434,622 claims priority under 35 U.S.C. § 119 to U.S. Provisional Patent Application No. 60/379,799, filed May 10, 2002 and entitled “Methods and Systems of Utilizing Printed Responses and Other Printed Items as Response Devices in the CRAV Immersion Verification and Registration System and Process.” U.S. patent application Ser. No. 10/439,121 is also a continuation-in-part of U.S. patent application No. 09/820,482, filed Mar. 29, 2001 and entitled “Method and System for Communicating Advertising and Entertainment Content and Gathering Consumer Information,” now U.S. Pat. No. 6,606,745, which claims priority under 35 U.S.C. § 119 to U.S. Provisional Patent Application No. 60/239,631, filed Oct. 12, 2000 and entitled “System and Method for Using Linked Sponsorships to Increase Mass-Market Appeal of Content.” Additionally, U.S. patent application Ser. No. 10/439,121 claims priority under 35 U.S.C. § 119 to U.S. Provisional Patent Application No. 60/381,149, filed May 16, 2002 and entitled “Mass Media Advertising Distribution and Usage System.” The contents of each of the above listed priority documents is hereby fully incorporated herein by reference.

### TECHNICAL FIELD

The present invention generally relates to substituting media content for presentation on a media device, such as a television, and more specifically to preempting the presentation of a first advertisement that would benefit a first party with presentation of a second advertisement to the benefit of a second party.

### BACKGROUND

In the traditional advertising model, broadcast media (e.g., TV networks, radio stations, newspapers, magazines) develop entertainment content (e.g., a TV show) of interest to consumers. The consumers are persons who may use an Advertiser's commodity or service, and who view, hear, read, or otherwise absorb or become exposed to the entertainment content, as well as advertising content (“ads”). The Advertisers are entities that distribute the ads to induce the consumers to buy, use, or do something. The media deliver the entertainment content and the ads to the consumers (e.g., over the air, by cable transmission, by print media mass distribution, outdoor media, Internet, and private networks). Media may charge the consumers for the entertainment content delivery, but typically media receive most revenue from the Advertisers in exchange for delivering ads with the entertainment content.

Promoters initiate, develop, generate, and/or distribute entertainment content, attracting many of the consumers and, in turn, attracting the Advertisers. The Advertisers sponsor the entertainment content by paying the Promoters to deliver the ads with the entertainment content. Advertising fees generally increase as the number of the consumers exposed to the ads increases. The Promoters use the advertising fees to offset the Promoters' costs to produce and distribute the advertising content and to make a profit. The consumers usually do not pay to see, hear, or otherwise absorb or become exposed to the entertainment content. The consumers also do not receive payment for seeing, hearing, or otherwise absorbing or becoming exposed to the ads. The consumers' traditional reward is the ability to see, hear, and enjoy the entertainment content for little or no charge in exchange for tolerating the ads.

Recent technological advancements (i.e., the Internet) have caused an increase in possible entertainment outlets. With this increase, the consumers are distracted by multiple entertainment forms. As a result, the Advertisers have more difficulty reaching mass numbers of the consumers. In addition, the Promoters have more difficulty guaranteeing that many of the consumers will watch, hear, read, or otherwise absorb or become exposed to the entertainment content and the ads. This phenomenon has led to lower advertising fees and lower profits for the Promoters.

The Advertisers' goal is to provide the consumers with memorable ads that include information on the Advertisers'product or service. However, the consumers typically ignore or avoid the ads. The consumers often “tune out,” change the channel, skip a printed page, or walk away when the ads are presented. In addition, the consumers increasingly turn to less advertising-dependent entertainment forms (e.g., premium channels), or use technology (e.g., video recorders, personal recording devices (“PRDs”), remote controls, etc.) to skip the ads.

Perhaps the most ubiquitous device for avoiding advertising is the handheld remote control that allows a consumer to rapidly navigate among television channels. Remote controls have been recognized as the second most frequently used household appliance in the United States, behind only the refrigerator. Consumers often purchase new remote controls with enhanced features in conjunction with acquiring entertainment appliances such as televisions, stereos, digital versatile disc (“DVD”) players, and video cassette recorders (“VCRs”). The new and enhanced remote control can interact with the acquired appliances as well as the consumer's preexisting or “legacy” appliances. While remote controls with capabilities for tuning one or more electronic appliances are widely available, hand-held devices that can facilitate interaction between readers and printed media are less common. Such hand-held devices are often limited to providing low-level textual interaction, for example reading printed words via optical character recognition (“OCR”).

Advertising, whether delivered via a printed or an electronic medium, can be divided into two classes: mass media advertising and targeted advertising. Mass media advertising (e.g., over a broadcast network such as TV, cable, satellite, radio, newspaper, magazine, mass mail, mass e-mail, streaming Internet, etc.) sends broadly based advertising messages to a wide spectrum of the consumers. Mass media broadcasting of advertisements comprises presenting one or more advertisements through the broadcast network such that anyone receiving the broadcast network receives the same advertising content, regardless of the person's demographics or other criteria. For example, each person tuning into the same TV channel, streaming Internet website, or radio station, or reading the same magazine page, newspaper page, or billboard, will receive the same entertainment and advertisement content. Accordingly, those advertisements comprise mass media broadcast advertisements. On the other hand, targeted advertising focuses on delivering specific, personalized advertising to the consumers that meet a demographic profile specified by the Advertisers. Mass media advertising is usually less expensive per impression than targeted advertising. However, targeted advertising is usually more effective and has become less expensive per impression as technology has progressed. As a result, the effectiveness of mass media advertising has been questioned.

Both mass media advertising and targeted advertising find value in estimating the size and demographics of the audience for each segment of content offered to the consumers. Characterization of the audience facilitates a promoter pricing advertisement delivery at a level that accurately reflects value. With the proliferation of networking technologies, consumers often have an array of media alternatives from which a specific content selection can be made. This array of alternatives causes complexities in conventional methods for estimating audiences. For example, a segment of an audience that could be statistically insignificant from a mass advertising perspective might be a very significant portion of a highly targeted audience.

Often, one or more private content distribution networks offer content choices to a consumer or household of consumers. The access controls of such private networks can limit accurately estimating and characterizing an audience for a specific content segment. For example, an owner of a private network, such as a cable television network, may restrict access to the network, thus hampering audience estimation by an independent party.

In one conventional approach to audience estimation, a content distribution network broadcasts content choices to each broadcast receiver, such as a television, on the network. Each broadcast receiver interfaces with the content distribution network via a device, known as a set top box, through with a consumer can make a channel selection to show content on a specific channel. Recording the channel selections on a representative sample of set top boxes provides data that can be processed to estimate the audience. For such audience estimation, the set top boxes involved in audience estimation send the channel selections upstream on the broadcast network to a central site which aggregates the data from each set top box. One drawback of this arrangement is that sending the channel selection upstream on the broadcast distribution network typically requires a content distribution network that is bidirectional, and many content distribution networks are unidirectional or lack sufficient upstream bandwidth.

Another potential issue with characterizing an audience based on information from a set top box is that the set top box resides on the content distribution network and consequently might not be independent from the business entities involved in content distribution. Since the results of the audience characterization could financially impact those business entities, their motivation to conduct an unbiased estimation of the audience might conflict with their financial motivations.

Audiences can comprise households of people that consume a variety of products, such as food, cleaning supplies, clothing, sporting goods, toys, etc. These consumers often have busy lifestyles that leave little time for tracking or managing a household's stock of products, for example to replenish depletable items. Unexpectedly running out of a needed product, such as a laundry detergent, the consumer may hurry to a convenience store to purchase whatever brand the store carries, often at a premium price. Thus, impromptu purchases and unstructured management of a household's inventory of products can lead to consumers acquiring products of undesirable brands at high prices. For a manufacturer or promoter of a brand that the consumer prefers or should prefer, unmanaged or unplanned product purchases can result in lost sales when the consumer purchases a competitive product.

Television audiences often select and view programming content that a distribution network broadcasts to multiple homes or viewing sites. The broadcast distribution network may transmit signals over a cable system, via satellite, or through the air. Those signals typically carry multiple programs at the same time, with each program having a distinct range of signal frequencies. Thus, at any given time, the distribution network presents each household television with multiple programs that are simultaneously airing. An audience member can view a program of interest by selecting the appropriate channel that tunes the television to receive the signal frequencies that carry the program. When the audience member “tunes in” to a selected channel, the television typically shows the portion of the program that is airing at that time. In other words, television viewers typically watch programs as they broadcast over the network.

Those broadcast programs can provide entertainment or information about a product or service that the audience member may have an interest in acquiring. The audience member may be a consumer that is interested in purchasing a product featured on an infomercial or a home shopping program. In response to viewing a program about the product, the consumer may elect to place an order for the product. The consumer may make a telephone call, access an Internet site, or use an interactive television capability to order the product while the program is airing. The business entity that is offering the product for sale receives and logs the order and reduces its available inventory accordingly. Broadcast home shopping programs, such as the programs produced by HSN, a subsidiary of IAC/InterActiveCorp of St. Petersburg, Fla., often show sales or inventory information about a featured product during a live broadcast. The programs may show a count of received orders or an inventory of items that remain available for purchase. In response to receiving orders, the program may update the count audibly or visually in an area of the displayed picture. Knowing the amount of inventory remaining available can positively influence consumer purchasing decisions. The producer of the program can use a tally of purchasing activity or a count of available inventory as feedback for the program. A spokesperson selling a product in a live broadcast may ad lib. based on available inventory, for example, terminating a sale offer to coincide with exhausting the inventory.

While live broadcast television programs generally provide a vehicle through which a consumer can obtain dynamic information about sales or inventory of a featured product, the audience often has limited flexibility to select viewing times. With conventional broadcast technology, viewers frequently need to schedule viewing activities to coincide with time slots in a broadcast schedule. To provide audiences with enhanced viewing flexibility for entertainment programming, a trend is emerging to provide audience members with videos or programming content on demand. A user with a television linked to a video-on-demand (“VOD”) network can access a library of prerecorded programming on an as-needed basis or at essentially any convenient time. The user can select a prerecorded entertainment program for downloading over the VOD network from a remote server. The program, in the form of video signals, arrives at a set top box for local storage or buffering. The set top box processes and feeds the video signals to an associated television set that shows the selected entertainment program. Thus, VOD-based television systems typically remotely access and play prerecorded video content.

While VOD networks afford users schedule flexibility for viewing entertainment, conventional VOD technology generally provides limited or insufficient capabilities to adequately support home shopping. As discussed above, programs that offer products for sale to consumers should preferentially have a capability to present dynamic information related to sales volume or product inventory, and conventional VOD programs do not support that capability. That is, although conventional VOD technology supports presenting a viewer with prerecorded content in response to a viewer request, that conventional technology lacks a capability to respond to sales events or a capability to integrate programming that offers products for sale with dynamic inventory or sales information. Thus, inventory management issues, such as having sufficient product available to meet sales demands, often preclude selling products over a communication network using prerecorded sales content.

The constraint of airing home shopping segments live often limits the amount of resources that a “shopping network” business can invest in creating and producing home shopping programs. Since conventional home shopping programs are not readily recorded and rebroadcast, each program needs to achieve profitability through a single broadcast. Accordingly, the shopping network usually can not afford to pay celebrities to routinely appear on live broadcasts. Because a conventional home shopping program has limited or no shelf life, a producer's investment in on-air talent essentially expires with the airing of the program. Celebrity appearances may be limited to times that coincide with peak viewing or to periods when high order volume is expected. When the shopping network commissions a prominent celebrity to make a live appearance, the celebrity may receive a level of compensation that erodes the shopping network's profit or that is higher than the shopping network desires. For example, the celebrity may be able to negotiate a heavy share of sales rather than a modest hourly rate that the shopping network would prefer.

Another problem that impedes shopping networks from vending products using on-demand access to prerecorded sales content is the organization of that content. Consumers are accustomed to purchasing by product type or by department, and existing technology for delivering on-demand videos fails to satisfactorily organize shopping content. A conventional shopping network might dedicate certain times or special events to focused marketing of categories of products, such as a jewelry hour or a weekend that features decorating products. However, since on-demand content is somewhat unscheduled, conventional methods for organizing live home shopping programs on a time basis do not readily apply to on-demand shopping programs.

Traditional bricks-and-mortar shopping malls have physical buildings in which a shopper can walk and window shop, for example. Shoppers find traditional shopping malls appealing at least in part because a shopper can conveniently visit specialty stores or store departments that specialize in particular categories or types of products. A mall store might specialize in beauty aids, shoes, golf supplies, sporting goods, flowers, or nutritional supplements, for example. The shopper can conveniently and efficiently visit stores of interest and purchase needed or wanted gifts or other items. Conventional systems for organizing video content or home shopping programs are not well tailored to emulating the shopping experience that traditional shopping malls provide. While purchasing goods through a conventional communication network offers the luxury of shopping from home, the benefits of traditional shopping malls continues to draw shoppers.

Another attraction of the bricks-and-mortar shopping mall is the opportunity for shoppers to interact with physical stores, salespersons, sales presentations, and merchandise. In contrast to that attraction, conventional VOD technology fails to offer a viewer with a desirable level of interaction with on-demand content. Relegated to a role of a passive observer, the viewer's interest in the on-demand content often fades. Using conventional technology, the entity that produced or distributed the on-demand content cannot easily capture the viewer's interest, motivate the viewer to remember a message, or stimulate the viewer to make a purchase or take some other action.

Whether a consumer receives content from a VOD network or a broadcast network, the closed nature of most conventional content distribution systems often limits the consumer's viewing options. A cable company or some other content distributor typically controls tightly the content that reaches a consumer's television or other media receiver. Consequently, an exclusive set of businesses often have a monopoly over the content that the television can readily show. A set top box links a feed from a content distribution network, such as a cable network, to the television. Thus, in a typical arrangement, the set top box helps restrict the viewing options on that television to the programming broadcast over that network. That programming generally comprises entertainment programming with tightly interwoven segments of advertising content. To consume the entertainment content, the consumer is left with few options beyond tolerating the advertising content that the network carries or manually changing the channel after an unwanted advertisement appears.

While the content control of conventional content distribution systems may benefit the content distributor and those exclusive parties that have a financial interest in the advertising content distributed thereon, the consumer typically dislikes and does not benefit from content control. Oftentimes, the consumer would prefer to view commercial content that is not available on the closed distribution network. Further, businesses without ready access to closed content distribution networks would like an opportunity to describe their businesses, products, and services to consumers using televisions connected to those networks. Moreover, the monopoly enjoyed by the content distributor may artificially inflate the cost of presenting advertising content to the consumers, even by those selected parties that have been granted access to the closed content distribution network.

To address those representative deficiencies in the art, a need exists for opening access to otherwise closed content distribution systems. Another need exists for replacing media content that offers little or no benefit to a party with media content likely to benefit that party. Another need exists for preempting the presentation of advertisements with the presentation of other advertisements. Yet another need exists for accessing a feed to a content distribution network and manipulating the signals propagating on that feed in a manner that helps provide devices on the network with content alternatives. A capability fulfilling one or more of these needs would offer a viewer of commercial content a rewarding experience while offering Advertisers and Promoters new options for sales, marketing, and advertising.

### SUMMARY OF THE INVENTION

The present invention supports presenting an alternative advertisement during a media program as a substitute for another advertisement that offers less benefit than the alternative advertisement.

In one aspect of the present invention, a media program can have commercial content that accompanies other content. The other content can comprise entertainment content, sports content, educational content, news content, documentary content, weather-oriented content, talk radio, talk television, on-demand content, etc. The commercial content can be referred to as original commercial content. The original commercial content can comprise part or all of a commercial, an advertisement, an infomercial, a sales presentation, a presentation about a product, service, or other good of commerce, a home shopping program, a series of moving images, a stationary image, a graphic, a logo, a slogan, a musical piece, a voice, or a sound, to name a few examples. The media program could be a television program, a video program, a radio program, an Internet-based program, signage, a webcast, a telecast, a tradeshow presentation, a program that appears on a private network or an intranet, or billboard material (not an exhaustive list).

A monitor can detect an advertising event, such as a presence or an appearance of the original commercial content in association with the media program. Detecting the presence of the original commercial content can comprise a human or a machine monitoring signals that carry the media program. The human or machine can observe a showing or presentation of the media program, for example. The monitor can be a human representative of the business entity that seeks to present the alternative advertising content as a substitute or replacement for the original advertising content. The monitor can comprise a computer-based system, circuitry, or a sensor that monitors signals or images associated with the media program. The monitor can be situated or disposed near a media device, such as a television, radio, or computer, that presents the media program to a consumer, viewer, or some other user. Alternatively, the monitor can reside at a remote location with respect to the media device or on a network or other communication link, for example.

In response to detecting the advertising event or the presence of the original commercial content in the media program, the alternative commercial content can be presented to a viewer of the media program. The presentation of the alternative commercial content can replace the original commercial content. The alternative commercial content can be substituted for the original commercial content that the producer or the distributor of the media program intended for presentation during the media program, for example. Replacing the original commercial content can comprise preemption of the original commercial content. Making the substitution can comprise changing the media device's channel during an intermission or commercial break, for example. Prior to the commercial break, the media device can be set to a channel that carries the media program. During the commercial break, the media device can be set to a channel that carries the alternative commercial content.

Other aspects, systems, methods, features, advantages, and objects of the present invention will become apparent to one with skill in the art upon examination of the following drawings and detailed description. It is intended that all such aspects, systems, methods, features, advantages, and objects are included within this description, are within the scope of the present invention, and are protected by the accompanying claims.

### BRIEF DESCRIPTION OF THE DRAWINGS

FIG. 1 is a block diagram illustrating the components of a system according to an exemplary embodiment of the present invention.

FIG. 2 is a flow diagram illustrating an overview of an exemplary CR\overline{A}V Ad process according to an exemplary embodiment of the present invention.

FIG. 3 is a flow diagram illustrating an exemplary process describing how the Promoters sell the CR\overline{A}V Ads to the Advertisers according to an exemplary embodiment of the present invention.

FIG. 4 is a flow diagram illustrating an exemplary process describing how the Promoters and the Advertisers use the broadcast network to promote future CR\overline{A}V Ads according to an exemplary embodiment of the present invention.

FIG. 5 is a flow diagram illustrating an exemplary process describing how the privacy option applies according to an exemplary embodiment of the present invention.

FIG. 6 is a flow diagram illustrating an exemplary process describing how the Promoters use the broadcast network, the device, the information gathering system, and the data storage center to communicate the CR\overline{A}V Ads to the consumers and to interact with the consumers according to an exemplary embodiment of the present invention.

FIG. 7 is a flow diagram illustrating an exemplary process describing how the Promoter communicates the alert, the vignette, and the query using the broadcast network according to an exemplary embodiment of the present invention.

FIG. 8 is a flow diagram illustrating an exemplary process describing how the consumers answer the CR\overline{A}V Ads according to an exemplary embodiment of the present invention.

FIGS. 9A and 9B, together comprising FIG. 9, are picture diagrams illustrating an exemplary nationwide network for gathering CR\overline{A}V Ad responses according to an exemplary embodiment of the present invention.

FIG. 10 is a picture diagram illustrating how the information gathering system sends the registration and the response information to the data storage center according to an exemplary embodiment of the present invention.

FIG. 11 is a flow diagram illustrating an exemplary process describing how the Promoters select winners and distribute prizes.

FIG. 12 is a flow diagram illustrating an exemplary process describing an overview of a CR\overline{A}V Ad process according to an exemplary embodiment of the present invention.

FIG. 13 is a flow diagram illustrating an exemplary process describing how the ad slots are sold according to an exemplary embodiment of the present invention.

FIG. 14 is a chart illustrating how the ad price is determined according to an exemplary embodiment of the present invention.

FIG. 15 is a flow diagram illustrating an exemplary CR\overline{A}V Ad process for ABS and ACME to promote future CR\overline{A}V Ads according to an exemplary embodiment of the present invention.

FIG. 16 is a chart illustrating a CR\overline{A}V record according to an exemplary embodiment of the present invention.

FIG. 17 is a flow chart illustrating how ABS broadcasts the CR\overline{A}V Ads according to an exemplary embodiment of the present invention.

FIG. 18 illustrates the CR\overline{A}V Ad the consumers see according to an exemplary embodiment of the present invention.

FIG. 19 is a flow diagram illustrating how the CR\overline{A}V Ads are answered by the consumers in an exemplary embodiment.

FIG. 20 is a flow diagram illustrating how the data storage center selects winners and distributes prizes according to an exemplary embodiment of the present invention.

FIG. 21 illustrates a CR\overline{A}V Ad broadcast over a convergence of mass media formats according to an exemplary embodiment of the present invention.

FIG. 22 is a block diagram depicting a system for remotely interacting with broadcast content according to an exemplary embodiment of the present invention.

FIG. 23 is block diagram depicting an interactive remote control according to an exemplary embodiment of the present invention.

FIG. 24 is a flowchart depicting a method for remotely interacting with broadcast content according to an exemplary embodiment of the present invention.

FIG. 25 is a flowchart depicting a method for tuning a broadcast receiver to the desired station channel according to an exemplary embodiment of the present invention.

FIG. 26 is a flowchart illustrating a method for presenting a query on the interactive remote control according to an exemplary embodiment of the present invention.

FIG. 27 is a flowchart depicting a method for communicating a response to the query via the interactive remote control according to an exemplary embodiment of the present invention.

FIG. 28 is a flowchart depicting a method for remotely controlling presentation of broadcast content according to an exemplary embodiment of the present invention.

FIG. 29 is a flowchart depicting a method for tuning a broadcast receiver to the station channel on which the receiver will present broadcast content according to an exemplary embodiment of the present invention.

FIG. 30 is a block diagram depicting an interactive remote control according to an alternative exemplary embodiment of the present invention.

FIG. 31 illustrates the form factor of an interactive remote control according to an exemplary embodiment of the present invention.

FIG. 32 is a flow chart depicting a method for real-time capturing of audience share information for broadcast content according to an exemplary embodiment of the present invention.

FIG. 33 is a flow chart depicting a method for determining whether a particular recipient received broadcast content according to an exemplary embodiment of the present invention.

FIG. 34 is a functional block diagram illustrating residences coupled to a broadcast network and to the Internet according to an exemplary embodiment of the present invention.

FIG. 35 is a functional block diagram illustrating a residence with a user of an interactive remote control interacting with a broadcast receiver coupled to a broadcast network and a with data network according to an exemplary embodiment of the present invention.

FIG. 36 is a functional block diagram illustrating an interactive remote control with a biometric sensor according to an exemplary embodiment of the present invention.

FIG. 37 is a functional block diagram illustrating an access control module of an interactive remote control according to an exemplary embodiment of the present invention.

FIG. 38 is a functional block diagram illustrating a transmitter module of an interactive remote control according to an exemplary embodiment of the present invention.

FIG. 39 is a functional block diagram illustrating a data station coupled to an interactive remote control and to the Internet according to an exemplary embodiment of the present invention.

FIG. 40 is a functional block diagram illustrating an interactive remote control with a speaker and a microphone according to an exemplary embodiment of the present invention.

FIG. 41 is a functional block diagram illustrating a processor of an interactive remote control according to an exemplary embodiment of the present invention.

FIG. 42 is a flow chart illustrating a process for controlling access to features of an interactive remote control according to an exemplary embodiment of the present invention.

FIG. 43 is a flow chart illustrating a process for identifying an authorized user of an interactive remote control according to an exemplary embodiment of the present invention.

FIG. 44 is a flow chart illustrating a process for characterizing an unknown user of an interactive remote control according to an exemplary embodiment of the present invention.

FIG. 45 is a functional block diagram illustrating a user in a residence interacting with an interactive remote control that tracks viewership of content by monitoring the channel selections entered by the user into the interactive remote control according to an exemplary embodiment of the present invention.

FIGS. 46A and 46B are flow charts illustrating a process for identifying content presented on a broadcast receiver by monitoring the tuning commands input by a user into an interactive remote control according to an exemplary embodiment of the present invention.

FIG. 47 is a functional block diagram illustrating an interactive remote control with a barcode scanner according to an exemplary embodiment of the present invention.

FIG. 48 illustrates an interactive remote control scanning a paper and displaying a question regarding printed content of the paper according to an exemplary embodiment of the present invention.

FIG. 49 is a flow chart illustrating a process for interacting with printed content using an interactive remote control according to an exemplary embodiment of the present invention.

FIGS. 50A and 50B are a flow chart illustrating a process for scanning products with an interactive remote control according to an exemplary embodiment of the present invention.

FIG. 51 is an illustration showing an exemplary hierarchical categorization of on-demand videos offering products for sale according to an embodiment of the present invention.

FIG. 52 is an illustration of a television monitor playing an exemplary on-demand video that presents prerecorded shopping content and dynamic data related to sales and inventory according to an embodiment of the present invention.

FIG. 53 is functional block diagram of an exemplary system for providing on-demand shopping videos that present prerecorded content integrated with dynamic content according to an embodiment of the present invention.

FIGS. 54A and 54B, collectively FIG. 54, are a flow diagram illustrating an exemplary process for providing on-demand shopping videos to consumers according to an embodiment of the present invention.

FIG. 55 is a flow diagram illustrating an exemplary process in which a system that provides on-demand shopping videos responds to a low-inventory condition according to an embodiment of the present invention.

FIG. 56 is a flow diagram illustrating an exemplary process for providing on-demand shopping videos that present prerecorded content integrated with dynamic inventory data according to an embodiment of the present invention.

FIG. 57 is an illustration of an exemplary handheld remote control device that presents a consumer with questions about a shopping video according to an embodiment of the present invention.

FIG. 58 is a flow diagram illustrating an exemplary process in which a consumer interacts with on-demand video content according to an embodiment of the present invention.

FIG. 59 is a flow diagram illustrating an exemplary process for offering a consumer a categorized list of on-demand shopping videos according to an embodiment of the present invention.

FIG. 60 illustrates a representative OMR printed response according to an exemplary embodiment of the present invention.

FIG. 61 illustrates a representative OCR printed response according to an exemplary embodiment of the present invention.

FIG. 62 illustrates a representative manual data entry printed response according to an exemplary embodiment of the present invention.

FIG. 63 illustrates a representative multiple-entry printed response according to an exemplary embodiment of the present invention.

FIG. 64 is a flow chart depicting a method for providing an advertisement that combines CR\overline{A}V ad elements with the interactive portion of a reply according to an exemplary embodiment of the present invention.

FIG. 65 illustrates a print media advertisement according to an exemplary embodiment of the present invention.

FIG. 66 illustrates a print media advertisement pod according to an exemplary embodiment of the present invention.

FIG. 67 illustrates a CR\overline{A}V ad broadcast over a convergence of mass media formats according to an exemplary embodiment of the present invention.

FIG. 68 illustrates the ratio of ad minutes to content minutes in a conventional programming hour-long broadcast.

FIG. 69 illustrates the ratio of ad minutes to hosted program minutes in a CR\overline{A}V game show hour-long broadcast according to an exemplary embodiment of the present invention.

FIG. 70 illustrates a representative CR\overline{A}V game show two minute segment according to an exemplary embodiment of the present invention.

FIG. 71 illustrates the substitution of conventional advertising segments with CR\overline{A}V ad segments broadcast on a continuous CR\overline{A}V network according to an exemplary embodiment of the present invention.

FIG. 72 is a flowchart depicting a method for substituting a CR\overline{A}V advertisement for a conventional advertisement according to an exemplary embodiment of the present invention.

FIG. 73 illustrates a functional block diagram depicting a system for providing media content that comprises substitute commercial content according to an exemplary embodiment of the present invention.

FIGS. 74A and 74B, collectively FIG. 74, illustrate a functional block diagram depicting a system for replacing original commercial content with alternative commercial content according to an exemplary embodiment of the present invention.

FIG. 75 illustrates a timing diagram for replacing original commercial content with alternative commercial content according to an exemplary embodiment of the present invention.

FIGS. 76A, 76B, and 76C, collectively FIG. 76, illustrate a flowchart depicting a method for replacing original commercial content with alternative commercial content according to an exemplary embodiment of the present invention.

Many aspects of the invention can be better understood with reference to the above drawings. The components in the drawings are not necessarily to scale, emphasis instead being placed upon clearly illustrating the principles of exemplary embodiments of the present invention. Moreover, in the drawings, reference numerals designate corresponding, but not necessarily identical, parts throughout the different views.

### DETAILED DESCRIPTION OF THE EXEMPLARY EMBODIMENTS

The present invention supports deploying advertisements that benefit a first party to preempt presentation of other advertisements that benefit a second party rather that the first party.

In one exemplary embodiment of the present invention, a viewer can interact with the contents of on-demand videos, such as video content downloaded from a remote archive for viewing on a television system or a video display. Engaging a viewer to interact with video content or downloaded content can stimulate the viewer to respond favorably to advertising, promotional content, commercials, or sales offers associated with that content.

In one exemplary embodiment of the present invention, a hand-held device can scan a machine-readable mark from a writing that a user is viewing and transmit data associated with the mark to a computer at a remote site. The machine readable mark can identify the writing or the content of the writing and can comprise a barcode, for example. The remote computer can generate a question about the content of the writing and send the question back to the hand-held device. The question can concern advertising content of the writing, a product associated with the writing, related on-demand video content, or another aspect of the writing's content. The hand-held device can display the question to the user. The user can respond to the question by entering an answer to the question into the hand-held device. The hand-held device can send the user's answer to the remote computer for processing or evaluation. The remote computer can return an evaluation of the user's answer to the hand-held device, which can display the evaluation results to the user. If processing at the remote computer determines that the answer is acceptable, the user can receive a reward. The user's reward can be a product discount, a coupon, a free product, or entry in a contest, for example. The scanned writing can be associated with interactive on-demand video content.

In another exemplary embodiment of the present invention, the hand-held device or another household device can identify products that a consumer or a household consumes. A scanner, barcode reader, or radio frequency identification system can identify a product by scanning the product, the product's package, or a writing associated with the product. A computer-based processing center can compile a list of products that the consumer has consumed. The list can comprise a shopping list. The computer-based processing center can have a financial motivation to promote one or more specific brands of products in preference to other products that may be competitive. When the consumer consumes a product of one brand, the computer-based processing center can promote another brand by offering the consumer an enticement to switch brands. Such an enticement can comprise, for example, a financial incentive, a coupon, a discount, a free product, or an entry into a contest for a prize. The shopping list can include a reference to the enticement. A discount or coupon can be electronically attached to the shopping list in association with an entry corresponding to a consumed product. That is, the shopping list can comprise appended promotional sales terms. The computer-based processing center can communicate the shopping list to a store or other sales outlet that can provide the consumer with the products specified on the shopping list. The purchase price of the products can take into account applicable discounts, coupons, or other purchase enticements. The products can be associated with interactive on-demand video content. The consumer can use the hand-held device to view and/or respond to questions about on- demand video content.

In another exemplary embodiment of the present invention, the hand-held device can remotely control a household appliance that receives signals broadcast over a broadcast network. The household appliance can comprise a radio or television and can receive signals via a cable, satellite, radio, or television network, for example. The user of the hand-held device can swap between using the device for channel selection of the appliance and interacting with a writing. The hand-held device can further be used to interact with on-demand video content. The user might enter an answer to a question about an on-demand video into the hand-held device or view the question on a display of the hand-held device.

In yet another exemplary embodiment of the present invention, the user of the hand-held device can interact with content presented on a broadcast receiver, which can comprise a television or other household appliance coupled to a communication infrastructure. Interacting with content can include responding to advertisements shown on the broadcast receiver. A user can place an order for a product advertised on television, for example. The hand-held device can present a question to the user about a televised commercial or advertisement. The user can receive a reward for correctly answering such a question. Querying users about televised advertisements can promote audience attentiveness, facilitate product purchases, and enhance brand awareness. The broadcast receiver can be coupled to a set top box that receives on-demand content to facilitate interacting with remotely accessed or downloaded prerecorded content or dynamic content.

One exemplary embodiment of the present invention supports offering television viewers on-demand video content that features a product for sale and that provides dynamic information related to product availability or sales events occurring while those videos are playing. Integrating, combining, associating, or aggregating dynamic inventory or product supply information with downloaded video content can support home shopping in a VOD environment. Asking the viewers questions about the downloaded content, for example one or more of dynamic information, product availability, sales events, prerecorded content, and downloaded video content, can provide an interactive home shopping experience.

In still another exemplary embodiment the present invention, a video distribution network, such as a VOD network, can offer consumers, users, or potential viewers downloadable or remotely accessible video selections, each presenting one or more products for sale. A consumer with an interest in one of the products can select a video featuring that product for showing or playing at a viewing site, such as the consumer's home or residence. In connection with making the selection, the consumer or a device that the consumer controls can send or transmit a prompt, request, message, or demand that triggers remote access to the selected video. A signal representation of the selected video can transmit over the network or download from a server or another storage facility, for example. A television system or a set top box associated with a television set can receive and play the transmitted video. The network can transmit multiple copies or instances of the video to respective consumers, so that consumers at different sites view the same prerecorded video content during an overlapping timeframe. A consumer at one site can place an order for a product while another consumer at another site contemplates purchasing the product as he or she views the video featuring that product. As consumers at various sites place orders for a featured product in response to viewing a downloaded video, the stock, supply, availability, or inventory of that product can change. While the video plays or shows at multiple sites, the respective television systems of those sites can receive dynamic, up-to-date, real time, or current information regarding inventory levels. That information can reflect or account for orders received from multiple sites on a video distribution network. Each respective television system can present inventory information, or a derivative thereof, to its consumer viewer. For example, each television might notify its viewer of a limited-supply condition or offer an alternative video about a substitute product when stock level dwindles. As another example, each television might show an inventory count in a field of the video or on an area of a television screen. As yet another example, some aspect of the video content might vary in response to a changing inventory condition or to another stimulus. As yet another example, the television system or an associated media device might present the viewer with a query or question about some aspect the video or the video's content.

Yet another exemplary embodiment of the present invention can provide a cost-effective, entertaining, rewarding, and effective way to present entertainment content and ads to a mass audience. For example, an embodiment of the present invention could transform advertising from something consumers avoid to a drawing card that attracts the consumers. The consumers can be presented with an opportunity to remember ads and to win valuable prizes. This may increase viewership, consumer entertainment, and advertising immersion.

An exemplary embodiment of the present invention can communicate Consumer Rewarded Advertising Vehicle Immersive Ad Bundles (“CR\overline{A}V Ads”). The CR\overline{A}V Ads may be an ad including an Advertising Vignette (“Vignette”) and a Verification Query (“Query”). An optional Immersion Alert (“Alert”) may also be added. In addition, an optional Correct Answer (“Answer”) may be added. The CR\overline{A}V Ads may be any duration. The CR\overline{A}V Ads may be visual and/or audible. The CR\overline{A}V Ads may be spoken, printed, displayed, heard, or communicated by any possible means, or any combination of possible means. The CR\overline{A}V Ad, or a series of CR\overline{A}V Ads, may also be the basis for an entire show, particularly of the game show genre.

Another option, called a “Sneak Peek” Vignette, may be used to promote the CR\overline{A}V Ads. The Sneak Peek Vignette may be identical to the CR\overline{A}V Ad Vignette. The Sneak Peek Vignette may also contain other information that helps the consumers answer the Query.

Another exemplary embodiment of the present invention can comprise a Broadcast Network, the Consumers, a Response Device, an Information Gathering System, and a Data Storage Center. The Consumers, Advertisers, Promoters, or other entities, can use such an embodiment of the present invention. The consumers can be persons who may use the Advertiser's commodity or service, who view, hear, read, or otherwise absorb the entertainment content and the ads. The Advertisers can be entities that distribute the ads to induce the consumers to buy, use, or do something. The Promoters can initiate, develop, generate, and/or distribute entertainment content attracting many of the consumers, and will in turn attract the Advertisers. While certain embodiments of the present invention have been or will be discussed in the context of the consumers, the Promoters, and the Advertisers, those experienced in the art will recognize that other entities can be used or involved.

Each of those disclosed exemplary embodiments can comprise one or more functions, features, processes, or steps for providing commercial content that preempts or replaces other commercial content.

The Broadcast Network can be a means of connecting the consumers with the entertainment content and the ads. According to one exemplary embodiment of the present invention, the Broadcast Network can comprise TV, cable, radio, printed media (magazines, newspapers) outdoor media (billboards, signs, buses) mass mail, mass e-mail, streaming Internet, private networks, or any other mass media broadcast. The Device can be a means of communicating the consumer information to the Information Gathering System. The Information Gathering System can be a means of forwarding the information to the Data Storage Center. The Data Storage Center can be a means for storing and using the consumer information. The consumer information can include registration and response information. The registration information can include personal information, such as name, address, phone number, household income, maximum education, etc. The response information can include answers to the Query questions.

The Promoters can sell the CR\overline{A}V Ads to the Advertisers. The Promoters or the Advertisers can use the Broadcast Network to promote future CR\overline{A}V Ads. The Promoters can use the Broadcast Network, the Device, the Information Gathering System, and the Data Storage Center to communicate the CR\overline{A}V Ads to the consumers and to interact with the consumers. The Promoters or the Advertisers can use the Device, the Information Gathering System, and the Data Storage Center to gather the consumers'responses to the CR\overline{A}V Ads. The Promoters can edit and/or distribute the registration and response information to the Advertiser or other interested third parties. The Promoters can select the winners and distribute the prizes.

A privacy option can be included to implement privacy protection for the consumers that respond to the CR\overline{A}V Ads, who have provided personal and confidential data while registering. This option helps ensure security, data protection, and isolation levels.

In one exemplary embodiment of the present invention, CR\overline{A}V ads also can be distributed in a concentrated format, either through a game show format of continuous ads, or via a dedicated network which distributes continuous or contiguous CR\overline{A}V Ads.

One exemplary embodiment of the present invention supports interaction between on-demand video content and a user, consumer, or viewer that remotely accessed the content. Interaction between on-demand video content can heighten a consumer's attentiveness to the content, benefiting the user and/or an entity associated with providing that content. In such an embodiment, the user can request access to video content, such as on-demand video content, from a remote site. For example, the user might initiate downloading the video content from the remote site by submitting or entering a request or prompt into a television system, a set top box, a hand-held remote control, a video device, a media device, a computing device, etc. The request can transmit or propagate on a network, a communication link, and/or a signal medium to the remote site. For holding at least some portion of the video content, the remote site might comprise a storage facility, a server, a system of collocated servers, a system of servers dispersed over a geographic area, a machine-readable medium, a digital or analog video archive, a video library, or a mass storage (not an exhaustive list). In response to receiving the user's request, the remote site can make the video content available to the user, for example downloading at least some of the video content from the remote site to a video receiver via signal transmission. Making the video content available to the user can alternatively comprise granting some form of remote or controlled access to the video content without downloading. The video receiver can comprise a television system, a video monitor, a set top box, a radio, a media device, a computing device, a hand-held unit, or an appliance that is operable to display moving images, to name a few possibilities. The video receiver can present, play, show, or display the remotely accessed video content to the user. The remotely accessed video content can comprise one or more of prerecorded content, sales content, an advertisement, promotional material, a commercial, an offer for sale, dynamic data, inventory information, a sales presentation, product information, educational content, a home shopping program segment, entertainment, etc. The user can receive a question or query about some aspect or portion of the remotely accessed video content and can submit a response or an answer to the question or query. Processing the submitted response can determine whether the response is correct, accurate, or meets another criterion. If the submitted response meets the criterion, then the user can receive a reward or become eligible to receive a reward. To name a few examples, the reward might comprise a cash award, entry into a sweepstakes, a discount coupon, a prize, a product, a free service, a vacation, points that accumulate towards a financially significant prize, or some other tangible or intangible item having at least some economic value.

An interactive remote query-response device according an exemplary embodiment of the present invention can allow a recipient to interact with broadcast or on-demand content without moving from the viewing or listening area in which the broadcast content is presented. For example, the recipient can view broadcast or on-demand content and can respond to a query about the content via the interactive remote query-response device coupled to the Internet. Accordingly, the recipient does not have to leave the viewing area to respond to the query from a personal computer, and the consumer does not have to carry a separate personal computer such as a laptop computer or personal digital assistant. The interactive remote query-response device also can automatically or manually control a receiver to receive a selected or predetermined segment of on-demand content.

Promoters can increase an ad's appeal via interaction with on-demand content, while substantially and cost-effectively enhancing an Advertiser's promotion and retention of its products and services. When compared to traditional mass media advertising, an exemplary embodiment delivers ads that cause the consumers to fully immerse themselves in the ad. An exemplary embodiment can deliver ads in print, by radio, by TV, as a game show, or by any other method that communicates with the consumers.

Immersion is a heightened attention level that causes the consumers to remember the ads. Immersion is the highest, most effective, and valuable attention level. Immersion helps the Advertisers achieve a maximized share of the consumers'mind for their product. Products are remembered easier and faster than competing products.

Immersion is enhanced by several methods. First, immersion is enhanced when the ad triggers an immediate emotional response within the brain, such as a warning or alert signal. This signal causes the consumers to pay more attention to the ads, and increases the likelihood the consumers will remember the ads. When the consumers interact with the ads, as opposed to passively viewing or hearing the ads, the consumers are more likely to remember the ads. A memorization request also increases immersion by testing the consumers'ability to recall the ads. In addition, extended exposure, which is obtained by a longer effective ad length, increases the likelihood of immersion. Effective length begins from the first moment one recognizes the brand advertised. Another advertising technique that increases immersion is using alternate, multiple media vehicles for distributing advertising (i.e., using print or Internet-based advertising simultaneously, or following, TV advertising). Rewards also help to create immersion because the consumers like challenges and rewards, and likable ads are more readily and easily recalled.

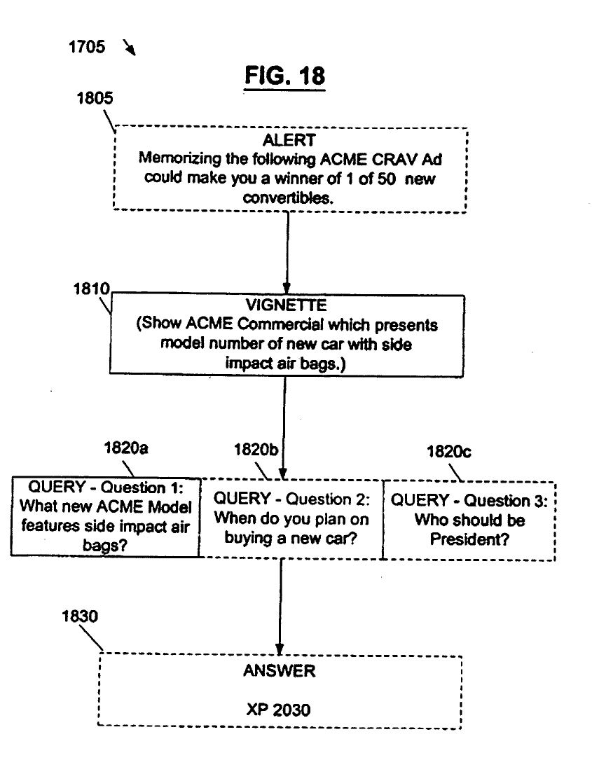

CR\overline{A}V Ad Description Consumer Rewarded Advertising Vehicle Immersive Ad Bundles (“CR\overline{A}V Ads”) provide a process for Promoters to increase viewership and immersion, as described in U.S. Pat. No. 6,606,745, which is hereby fully incorporated herein by reference. A CR\overline{A}V Ad example will be discussed while referring to FIG. 18 later in this document. However, for purpose of defining the CR\overline{A}V Ad, it is useful to refer to FIG. 18 at this time.

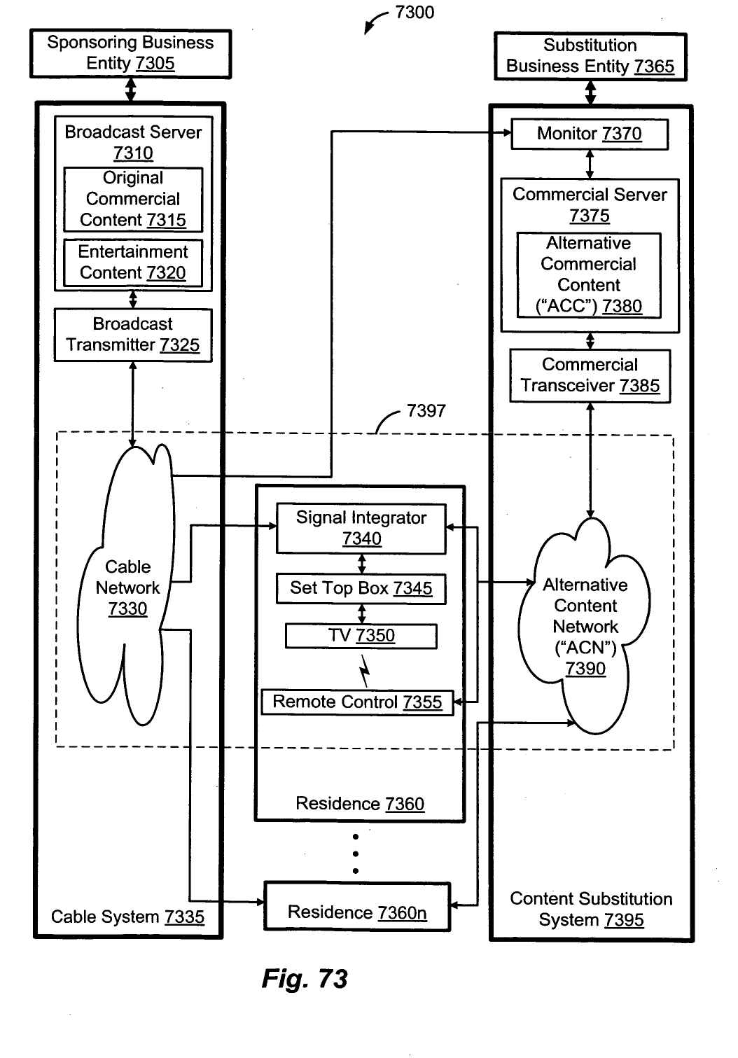

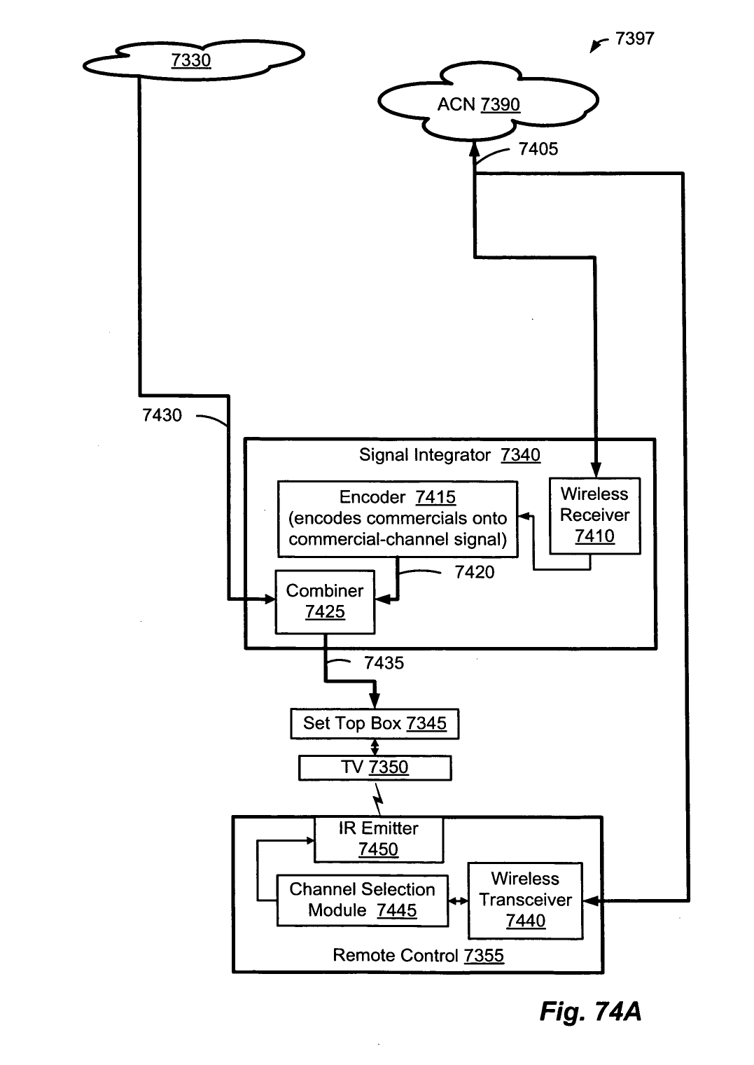

Turning now to FIG. 18, an exemplary CR\overline{A}V Ad is displayed. In one exemplary embodiment of the present invention, a method and/or a system for substituting media content, as discussed in further detail with reference to FIGS. 73-76, comprises an element, step, technology, or other item that FIG. 18 illustrates.

The CR\overline{A}V Ad is an ad including at least an advertising vignette (“vignette”) 1810 and a verification query (“query”) 1820. An immersion alert (“alert”) 1805 also can be included. In addition, an optional correct answer (“answer”) 1830 may be added. Those parts create a CR\overline{A}V Ad that may be any duration. The CR\overline{A}V Ad may be visual and/or audible. The CR\overline{A}V Ad may be spoken, printed, displayed, heard, or communicated by any other possible means, or any combination of possible means. A CR\overline{A}V Ad, or a series of CR\overline{A}V Ads, may also be the basis for an entire show.

Some or all of the components of the query 1820 may be “detached” from the vignette 1810 (i.e., the vignette 1810 may be in print and the query 1820 may be posted on-line or by phone). In addition, the response time for the query 1820 may be limited to cause the consumers to memorize the vignette 1810 for expedited recall (from memory) when asked the query 1820. Similarly, the alert 1805 and/or the answer 1830 may be detached from the vignette 1810 and/or the query 1820. Accordingly, the vignette, query, alert, and offer of a reward can be communicated via the same communications media or different communications media. The communications media can comprise a broadcast network 105 or a response device 111.

The alert 1805, which is optional (as indicated by the dashed lines), is a warning to the consumers that the upcoming vignette 1810 should be memorized so the consumers may become eligible to win a reward. The alert 1805 could be any cue or operational procedure that leads the consumers to believe that immersion may lead to a reward. The alert 1805 may be as simple as a logo (such as a CR\overline{A}V logo), a sound, or some other discrete notice. The alert 1805 may also include much more extensive data. The alert 1805 may include the product's brand name and information on the identity of the available rewards. By providing branding during the alert 1805, the Advertisers effectively begin the CR\overline{A}V Ad's exposure time. The alert 1805 is an urgency signal and a memorization request. Those advertising techniques increase the likelihood of the consumer remembering the ad. The alert 1805 may be any duration.

Following the alert 1805, a vignette 1810 is broadcast. The vignette 1810 may be a conventional commercial for a product or service or any other information designed for presentation to a consuming audience. This may include key product or service benefits, pricing information, image building information, etc. The vignette 1810 may be any duration.

Following the vignette 1810 broadcast, the query 1820 is broadcast. The query 1820 includes one or more questions. One question may be linked to the vignette 1810. This question is designed to require the consumers to remember certain information. The other questions may ask for public opinion, trivia, or other information, and those questions may be asked on-line or off-line. The query 1820 questions may be displayed on a separate screen following the vignette 1810, asked by a crawl-line below the entertainment content, or shown in an alternative way, such as off-line. The query 1820 may serve to increase the effective length of the CR\overline{A}V Ad, even though the traditional ad (i.e., video or audio clip) extends for a conventional duration, because the consumers must continue concentrating on the product as advertised during the immersion verification and query-response process. During the query 1820, the Promoters or the Advertisers may provide potential multiple choice answers or require the consumers to provide the answer without the aid of multiple choice answers. The query 1820 includes one or more questions and may include reward information, registration or login instructions, multiple choice answers, a “time remaining” counter, and brand information. The CR\overline{A}V Ad may end following the query 1820.

The answer 1830 may be added and is optional, as shown by the dashed lines in the answer 1830. The answer 1830 extends the CR\overline{A}V Ad's effective length. The answer 1830 includes the answer or answers to the query's 1820 one or more questions, where applicable. The answer 1830 also may include logo or other information. The answer 1830 may be broadcast via a TV medium, or distributed by an alternate communications medium (e.g., radio, print, Phone 145, Internet 130).

Another option, called the “sneak peek” vignette, may be incorporated. The sneak peek may be identical to the CR\overline{A}V Ad vignette 1810. The sneak peek may also contain other information to help the consumers answer the query 1820. The sneak peek is not shown during the actual CR\overline{A}V Ad, but is shown prior to the CR\overline{A}V Ad. The sneak peek may be featured several minutes, hours, days, weeks, etc. before the CR\overline{A}V Ad. The sneak peek vignette may be indicated by a logo, sound, or another method. Alternatively, the consumers may be informed only that the sneak peek will occur at some point during a particular show. The consumers are told one or more ads are CR\overline{A}V Ad sneak peek vignettes. The consumers will then pay greater attention to the particular commercial, or all the possible commercials so they may get additional information to help them answer the CR\overline{A}V Ad query 1820. For example, a sneak peek could read: “1 of the following 6 ads will be featured in a CR\overline{A}V Ad next Sunday. Please pay attention to ALL of them, because we will not tell you at this time which ad is the CR\overline{A}V Ad.” This same process could apply to the vignettes, in addition to the Sneak Peaks. Thus, for example, during the communication of numerous ads, an alert in the form of a logo could appear on the corner of the ads, which are in the form of vignettes. After communicating the vignettes, one or more Queries with immersion verification questions for one or more of the vignettes would be shown (i.e., at the bottom of the screen while the entertainment content continues). When the user calls, the user could be required to answer one or more of the shown immersion verification questions.

CR\overline{A}V Ad System

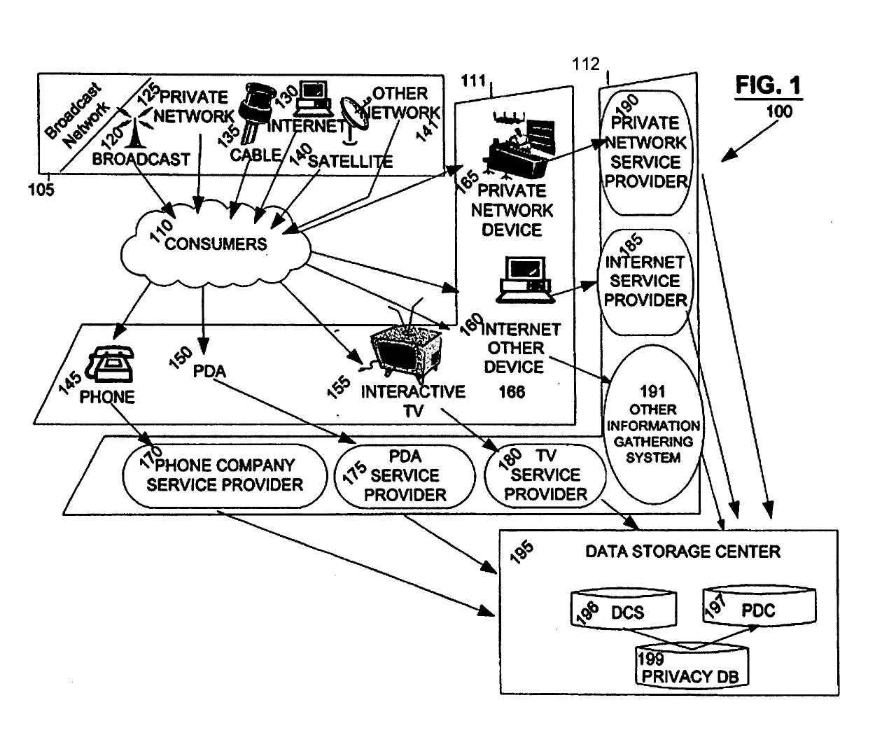

FIG. 1 is a block diagram illustrating components of a system in accordance with an exemplary embodiment of the present invention. In one exemplary embodiment of the present invention, a method and/or a system for substituting media content, as discussed in further detail with reference to FIGS. 73-76, comprises an element, step, technology, or other item that FIG. 1 illustrates.

Turning to FIG. 1, the CR\overline{A}V Ad system 100 includes a broadcast network 105, the consumers 110, an answering device (“device”) 111, an information gathering system 112, and a data storage center 195. The consumers 110, the Advertisers, the Promoters, or other entities, use the present invention. The consumers 110 are the recipients of the ads and are persons who may use the Advertiser's commodity or service, who view, hear, read, or otherwise absorb the entertainment content and the ads. The Advertisers are entities that distribute the ads to induce the consumers to buy, use, or do something. The Promoters initiate, develop, generate, and/or distribute entertainment content attracting many of the consumers, and in turn attracting the Advertisers. While the invention is described in the context of the consumers, the Advertiser, and the Promoters, those experienced in the art will recognize that other entities can be used.

The broadcast network 105 is a means of connecting the consumers 110 with the entertainment content and the ads. The broadcast network can comprise TV, cable, radio, printed media (magazines, newspapers) outdoor media (billboards, signs, buses) mass mail, mass e-mail, streaming Internet, private networks, or any other mass media broadcast.

The device 111 is a means of communicating the registration and the response information to the information gathering system 112. The device 111 also can be a means of communicating with the consumers 110 by broadcasting an immersion verification question and other questions, and subsequently forwarding related registration and response information to the information gathering system 112. The information gathering system 112 is a means of forwarding the registration and the response information to the data storage center 195. The data storage center 195 is a means for storing the registration and response information.

The broadcast network 105 may include a Broadcast TV Network 120, a Private Network 125, a Cable Network 135, an Internet Network 130, a Satellite Network 140, or any Other Network 141 (e.g., newspaper). Those experienced in the art will recognize numerous communications networks and systems (including presently available systems and future systems) may be substituted or interchanged with the broadcast network 105. For example, the broadcast network 105 also can comprise any of radio, outdoor media (billboards, signs, buses), print media (newspapers, magazines), direct mail, or other broadcast network.

The response device 111 can comprise a Phone 145, a Personal Digital Assistant (“PDA”) 150, an Interactive TV 155, an Internet Computer 130, a Hospitality Industry Private Network (i.e., a Sports Bar and Pub device) 165, or any other device 166. In an exemplary embodiment, the other response device 166 can comprise a printed response device, which can be completed by a consumer and delivered subsequently to the data storage center 195. For example, the printed response device can comprise a handwritten or typewritten response.

The devices 111 can include computer-related devices such as cellular phone networks, two-way pagers, and two-way contained network devices such as proprietary NTN systems found in numerous restaurants and pubs throughout the United States. Different instructions and methods may be used to register or answer. Those experienced in the art will recognize numerous devices (including presently available devices and future devices) may be substituted or interchanged as the device 111. In addition, those experienced in the art will recognize that one device 111 can be used to register, and another device 111 used to respond to the CR\overline{A}V Ad.

The information gathering system 112 may include numerous service providers (“SPs”), including a Phone Company SP 170, a PDA SP 175, a TV SP 180, an Internet SP 185, a Private Network SP 190, and any other information gathering system 191. For example, the other information gathering system 191 can comprise a private delivery network, such as the U.S. Postal Service, a facsimile machine, or other system. Those experienced in the art will recognize numerous distribution systems (including presently available systems and future systems) may be substituted or interchanged as the information gathering system 112.

The information gathering system 112 connects to a data storage center 195, which stores data gathered by the information gathering system 112. The data storage center 195 may include a Personal Data Center (“PDC”) Database 197 and a Data Compiling and Storage (“DCS”) Center Database 196. The data storage center 195 includes registration information and response information, random winner selection, and long-term storage of data collected for future data mining ventures. The PDC 197 stores the consumers'personal information, which may include the name, address, social security number (which is typically obtained only from prize winners for tax reporting purposes), personal ID number, phone number, etc. The DCS 196 may store demographic data collected during registration, a CR\overline{A}V ID, and CR\overline{A}V Ad query 1820 answers.

The data storage center 195 may also include a Privacy Database 199. The Privacy Database 199 is used when the Promoters decide to implement privacy protection for the consumers 110 that respond to the CR\overline{A}V Ads, who have provided personal and confidential data while registering. The Privacy Database 199 requires records from the PDC 197 and the DCS 196 to match before consumers'identities are matched with demographic and historical records. This matching helps ensure security, data protection, and isolation levels.

CR\overline{A}V Ad Process Overview

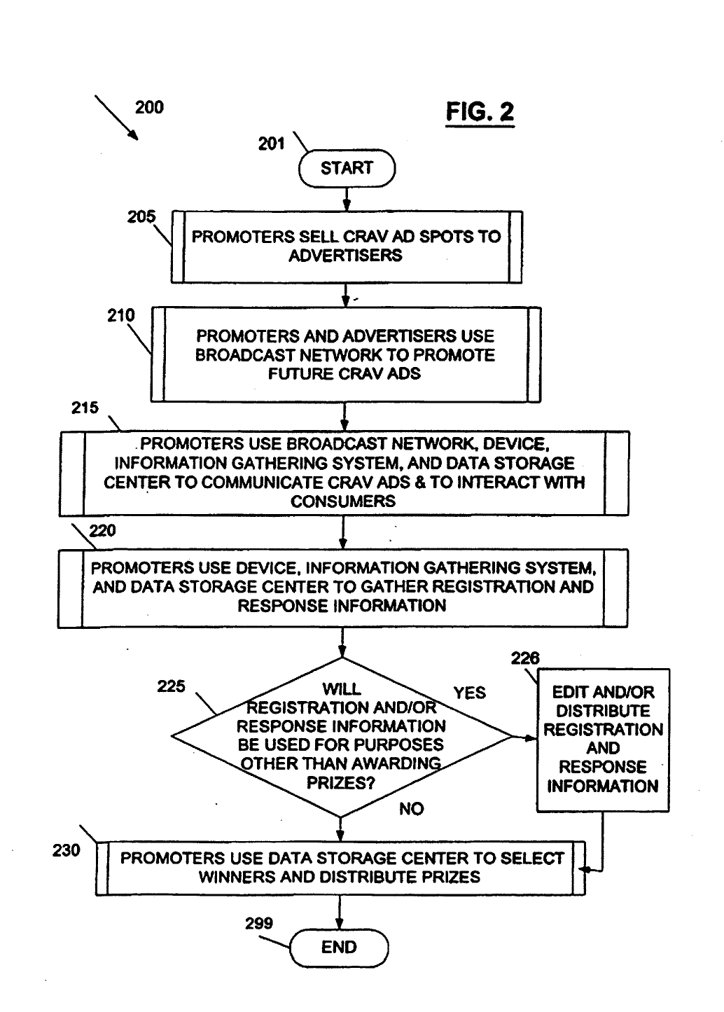

FIG. 2 is a flow diagram illustrating an overview of an exemplary CR\overline{A}V Ad process. In one exemplary embodiment of the present invention, a method and/or a system for substituting media content, as discussed in further detail with reference to FIGS. 73-76, comprises an element, step, technology, or other item that FIG. 2 illustrates.

Turning now to FIG. 2, an exemplary CR\overline{A}V Ad process 200 is initiated at the “START” step 201. In step 205, the Promoters sell the CR\overline{A}V Ads to the Advertisers. In step 210, the Promoters and the Advertisers use the broadcast network 105 to promote future CR\overline{A}V Ads. In step 215, the Promoters use the broadcast network 105, the device 111, the information gathering system 112, and the data storage center 195 to communicate the CR\overline{A}V Ads to the consumers 110 and to interact with the consumers 110. In step 220, the Promoters use the device 111, the information gathering system 112, and the data storage center 195 to gather the consumers'registration information and response information. In step 225, it is determined whether or not the registration and/or the response information will be used for purposes other than awarding prizes. If the answer to step 225 is “YES” and the registration and/or the response information will be used, the process moves to step 226, where the Promoters edit and/or distribute the registration and the response information to the Advertisers and other interested entities. If the answer to step 225 is “NO” and the registration and the response information will not be used, the process moves directly to step 230. In step 230, the Promoters use the data storage center to select the winners and distribute the prizes. The process then proceeds to the “END” step 299 and terminates.

CR\overline{A}AV Ads are Sold

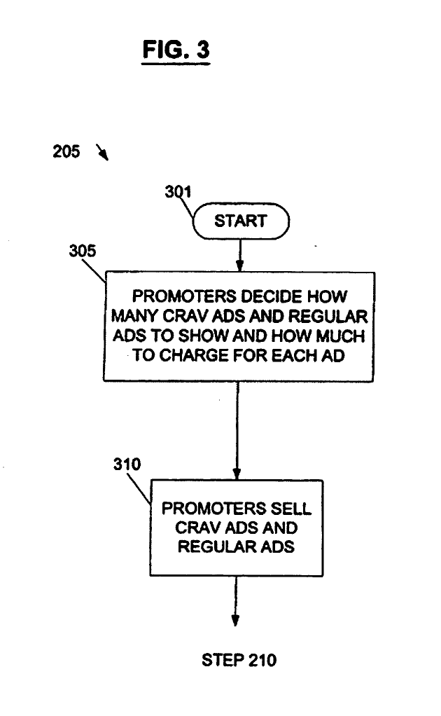

FIG. 3 is a flow diagram illustrating an exemplary process describing how the Promoters sell the CR\overline{A}V Ads to the Advertisers, as set forth in step 205 of FIG. 2. In one exemplary embodiment of the present invention, a method and/or a system for substituting media content, as discussed in further detail with reference to FIGS. 73-76, comprises an element, step, technology, or other item that FIG. 3 illustrates.

Turning now to FIG. 3, an exemplary CR\overline{A}V Ad process 205 is initiated at the “START” step 301. In step 305, the Promoters decide how many of the CR\overline{A}V Ads and the regular ads to communicate and how much to charge for each ad. In step 310, the Promoters sell the CR\overline{A}V ads and the regular ads. The process then moves to step 210 of FIG. 2.

The CR\overline{A}V Ads may be priced in numerous ways. For example, the price may be dependent on the program's audience size (i.e., ratings), or may be priced based on an auction or bidding process, where the CR\overline{A}V Ads are rewarded to the highest bidder. To establish pricing, the Promoters may analyze the existing program profitability based on standard production, promotion, and broadcast costs. This may be offset by standard advertising fees for standard advertising. The Promoters° CR\overline{A}V Ad price may include the value of a larger audience size and a higher quality of immersion among consumers 110. This legitimizes a higher cost-per-minute advertising fee, with the additional fee revenues helping to offset CR\overline{A}V Ad reward costs, CR\overline{A}V Ad licensing and promotion costs, and query 1820 response management process costs.

When determining CR\overline{A}V Ad prices, the following may also be considered: the promotion costs, the simultaneous broadcast venues used, the number and type of immersion rewards, the number of questions in the query 1820 (i.e., immersion verification question, polling question, trivia-based questions of varied difficulties to reduce the number of fully correct responses), on-air versus off-air immersion verification responses, registration requirements, query 1820 response gathering methodology, and winner selection and prize awarding responsibility. The Promoters must also determine if the consumers 110 will be required to answer one or more special Advertiser-designed questions during the immersion verification process. This market data may be very valuable to the Advertisers, and may further substantiate the fee being charged by the Promoters. The Promoters may also elect to add one or more special public opinion questions to the query 1820. This data may be related to the Promoters'other programs, may determine the consumers'110 interest levels to certain programming types, or may address any other marketing related issues. Those public opinion questions may also be conducted as a service to public opinion agencies, which may pay the Promoters for providing the public opinion response results.

CR\overline{A}V Ad is Presented to Consumers

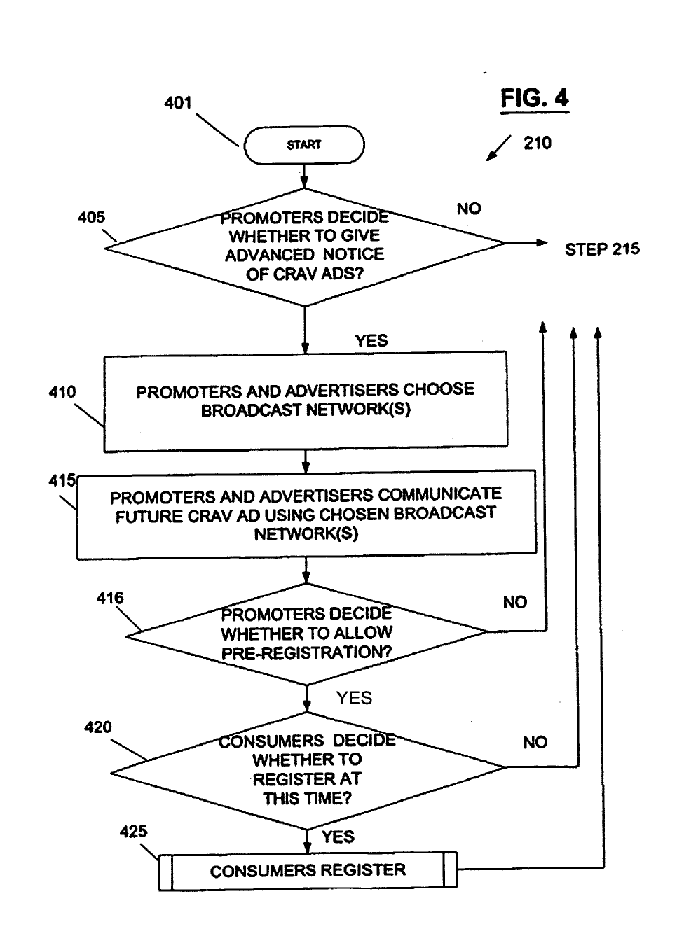

FIG. 4 is a flow diagram illustrating an exemplary process describing how the Promoters and the Advertisers use the broadcast network 105 to promote future CR\overline{A}V Ads, as set forth in step 210 of FIG. 2. The public can be notified about the broadcast of the CR\overline{A}V Ad to maximize the program's audience size. Prior to the communication including the CR\overline{A}V Ad, the Promoters provide advance warning to the consumers 110 who may receive programs where the CR\overline{A}V Ads will be communicated. This advanced warning may include educational, general public information informing the consumers 110 about the CR\overline{A}V Ads, and how successful immersion may result in the consumers 110 receiving substantial rewards. Those advance warnings also may include specific prize information, reveal the name and/or logo, and invite registration by the consumers 110 prior to the broadcast. The Promoters and the Advertisers may provide this advanced notice.

In one exemplary embodiment of the present invention, a method and/or a system for substituting media content, as discussed in further detail with reference to FIGS. 73-76, comprises an element, step, technology, or other item that FIG. 4 illustrates.

Turning now to FIG. 4, an exemplary CR\overline{A}V Ad process 210 is initiated at the “START” step 401. In step 405, the Promoters determine whether or not to give advanced notice of the future CR\overline{A}V Ad broadcast. If the answer is “NO,” then the process moves to step 215 of FIG. 2. If the answer is “YES,” the process moves to step 410, where the Promoters and the Advertisers choose the broadcast network 105 for the advanced notice. The broadcast network 105 that can be used for the advanced notice includes the Broadcast TV Network 120, the Private Network 125, the Cable Network 135, the Internet 130, the Satellite Network 140, or any Other System 141. In step 415, the Promoters and the Advertisers communicate the availability of future CR\overline{A}V Ads to the consumers 110 using the chosen broadcast network(s) 105. In step 416, the Promoter decides whether to allow the consumers 110 to pre-register. If the answer is “NO,” then the process moves to step 215 of FIG. 2. If the answer is “YES,” the process moves to step 420.

In step 420, the consumers 110 decide whether or not to register to respond to the CR\overline{A}V Ads using the device 111. If the answer to step 420 is “NO,” the process moves to step 215 of FIG. 2. In one alternative exemplary embodiment, the CR\overline{A}V Ad system is simple, and registration is not required. However, in alternative exemplary embodiments, registration is required during the process. Registration allows the Promoters and the Advertisers to collect detailed information about the consumers 110. If the answer to step 420 is “YES,” the consumers 110 register, as set forth in step 425. The process then moves to step 215 of FIG. 2.

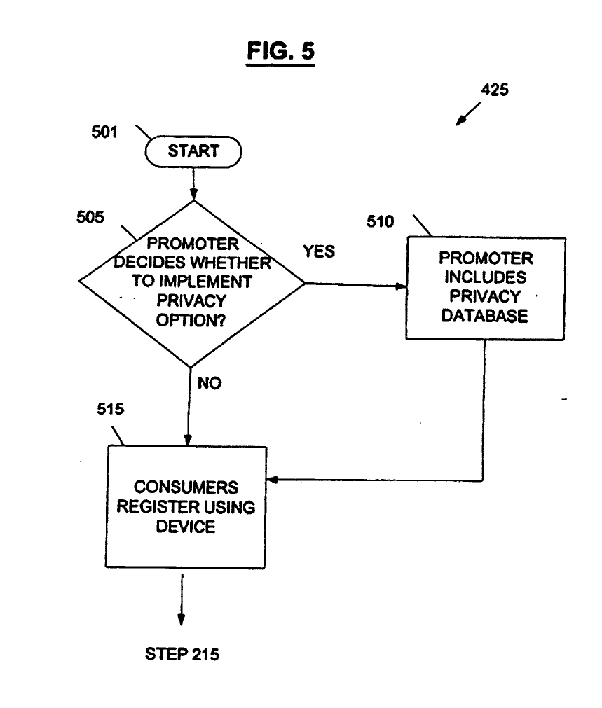

FIG. 5 is a flow diagram illustrating an exemplary process describing how the privacy option applies to the registration process, as set forth in step 425 of FIG. 4. In one exemplary embodiment of the present invention, a method and/or a system for substituting media content, as discussed in further detail with reference to FIGS. 73-76, comprises an element, step, technology, or other item that FIG. 5 illustrates.

Turning now to FIG. 5, an exemplary CR\overline{A}V Ad process 425 is initiated at the “START” step 501. In step 505, the Promoters decide whether to implement the privacy option. The privacy option segregates confidential personal data from demographic data. If the privacy option is used, the data storage center 195 includes the Privacy Database 199, as set forth in step 510. The process then moves to step 515. If the privacy option is not implemented, the process moves directly from step 505 to step 515. In step 515, the consumers 110 register using the device 111, and the process moves to step 215 of FIG. 2.

The privacy option is important because it allows the consumers 110 to be less concerned that their personal registration information will be matched with their demographic and response information by outside parties.

Registration

Because the query 1820 may be short in duration, the consumers 110 may not be able to fully register and respond to the CR\overline{A}V Ad within the allocated CR\overline{A}V Ad time. Therefore, the consumers 110 will usually want to register before the CR\overline{A}V Ad is broadcast. Several registration options are available.

Registration information may include a variety of data. In one exemplary embodiment, the Promoters do not want to use demographic information and simply seek to identify the consumers 110 for tracking and prize awarding purposes. The consumers 110 are thus asked to provide simple information where they may be reached and identified if selected as a winner. This information may include a phone number, a social security number (or portion thereof), a birthday, a name, and an address. After providing the registration information, the consumers 110 are provided with a unique “CR\overline{A}V ID”. This number may be a randomly generated unique number, or an easily remembered number or a series of numbers (such as a birthday and phone number combination), which may also provide ID information within the number.

In another exemplary embodiment for registration, the Promoters may wish to obtain ID information, product-related information, or public opinion-related information. The demographic profile of each consumer 110 may include age, sex, race, weight, height, zip code, physical home or e-mail address, occupation, individual annual earning, educational background, political affiliation, religious affiliation, family size, number of TVs and computers, Advertiser-related or public opinion survey questions, and prior CR\overline{A}V Ad answers (historical response information). A detailed registration may be required for each CR\overline{A}V Ad. However, gathering this information for each CR\overline{A}V Ad makes the registration process time-consuming, costly, and redundant, and may deter the consumers 110 from submitting a response. Thus, a one-time registration process is also available. In this mode, only changed/updated demographic or ID information (such as a change in marital status, phone number, etc.) is added for each CR\overline{A}V Ad response after the original registration. Under this scenario, the original registration information is stored in the PDC 197. As new responses or update information are transmitted to the data storage center 195, the data storage center 195 is updated.

In another alternative embodiment for registration, when only one registration is used (as described above), the Advertisers may have the consumers 110 with existing CRAV IDs enter additional demographic information to be qualified for the rewards. In this case, new “response” information is added for each additional CR\overline{A}V Ad response after the original registration. Under this scenario, the original registration information would be stored in the DCS 196, and as new responses are transmitted to the data storage center 195, the registration information can be added to the data storage center 195. The CR\overline{A}V ID would be required before allowing additions to CR\overline{A}V Ad records.

Broadcast CR\overline{A}V Ad and Interaction with Consumers

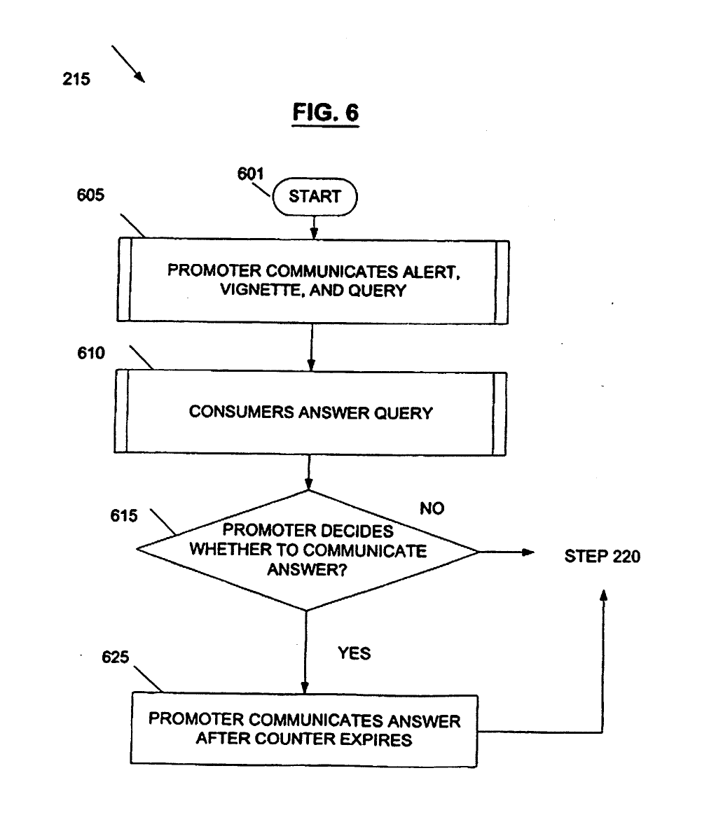

FIG. 6 is a flow diagram illustrating an exemplary process describing how the Promoters use the broadcast network 105, the device 111, the information gathering system 112, and the data storage center 195 to communicate the CR\overline{A}V Ads to the consumers 110 and to interact with the consumers 110, as set forth in step 215 of FIG. 2.

In one exemplary embodiment of the present invention, a method and/or a system for substituting media content, as discussed in further detail with reference to FIGS. 73-76, comprises an element, step, technology, or other item that FIG. 6 illustrates.

Turning now to FIG. 6, an exemplary CR\overline{A}V Ad process 215 is initiated at the “START” step 601. In step 605, the Promoter communicates the alert 1805, the vignette 1810, and the query 1820 using the broadcast network 105. The alert 1805 is a warning to the consumers that the upcoming vignette 1810 should be memorized so the consumers may become eligible to win a reward. The vignette 1810 may be a conventional commercial for a product or service or any other information designed for presentation to a consuming audience. The query 1820 includes one or more questions. In step 610, the consumers 110 answer the query 1820. In step 615, the option to communicate the answer 1830 is provided, based on whether or not the Promoters wish to use this option. The answer 1830 includes the answer to at least one of the query's 1820 question or questions. If the answer to step 615 is “NO”, and the answer 1830 is not communicated, the process moves to step 220 of FIG. 2. If the answer to step 615 is “YES”, the Promoter communicates the answer 1830 after the counter time has expired using the broadcast network 105, as set forth in step 620. The process then moves to step 220 of FIG. 2.

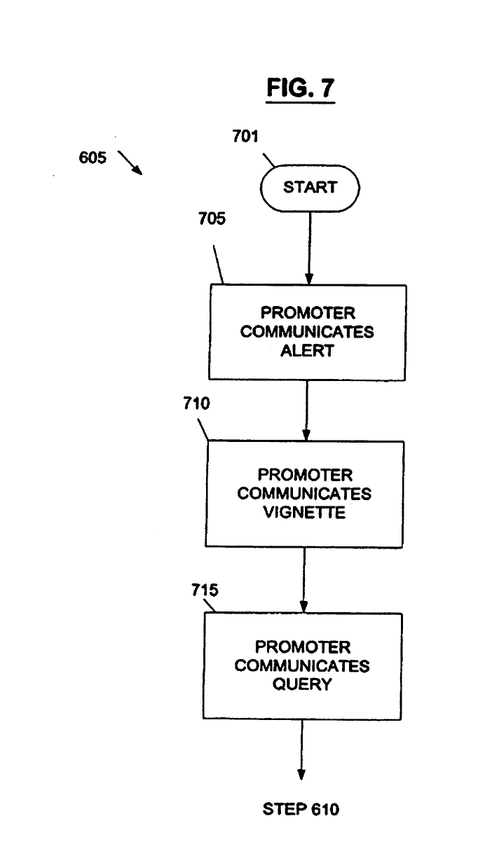

FIG. 7 is a flow diagram illustrating an exemplary process describing how the Promoter communicates the alert 1805, the vignette 1810, and the query 1820 using the broadcast network 105, as set forth in step 605 of FIG. 6.

In one exemplary embodiment of the present invention, a method and/or a system for substituting media content, as discussed in further detail with reference to FIGS. 73-76, comprises an element, step, technology, or other item that FIG. 7 illustrates.

Turning now to FIG. 7, an exemplary CR\overline{A}V Ad process 605 is initiated at the “START” step 701. In step 705, the Promoter communicates the alert 1805 using the broadcast network 105. The alert 1805 may include a prize description and an Advertiser and/or Promoter logo. The alert 1805 may also include any other information the Promoters, or some other entity, wishes to display. In step 710, the Promoter communicates the vignette 1810 using the broadcast network 105. The vignette 1810 may include an Ad and the Advertiser and/or Promoter logo. The vignette 1810 may also include any other information the Promoters, or some other entity, wishes to display. In step 715, the Promoter communicates the query 1820 using the broadcast network 105. Alternatively, the Promoter can communicate the query 1820 using one or more of the response devices 111. The query 1820 may include questions, possible answers, login response information, a time remaining counter, and the Advertiser and/or Promoter logo. The CR\overline{A}V Ad query 1820 may also include any other information the Promoter wishes to include. The process then moves to step 610 of FIG. 6.

CR\overline{A}V Ad is Answered

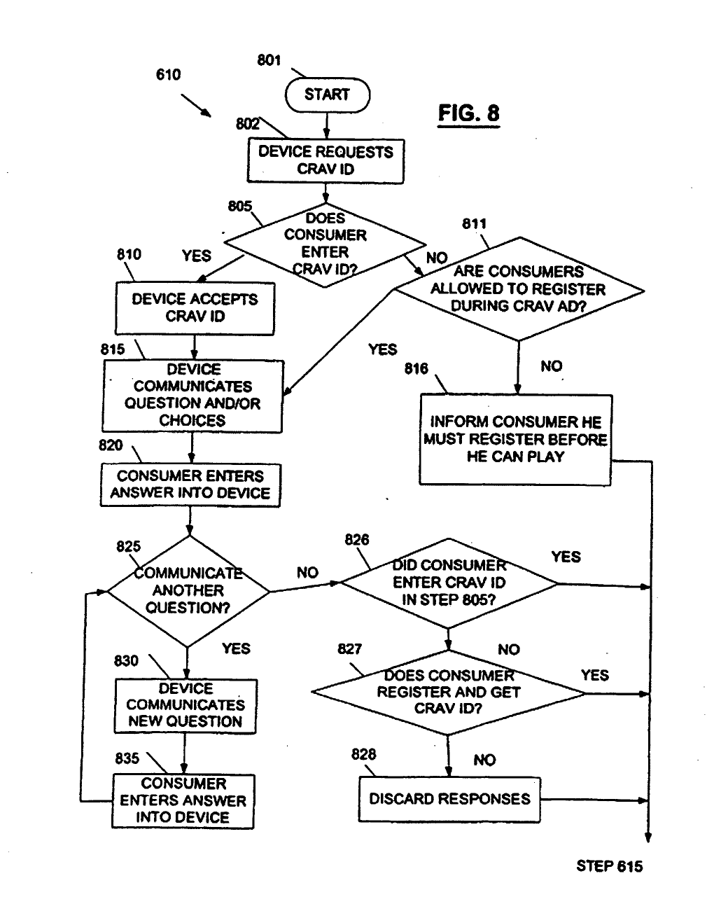

FIG. 8 is a flow diagram illustrating an exemplary process describing how the consumers 110 answer the CR\overline{A}V Ads, as set forth in step 610 of FIG. 6. In one exemplary embodiment of the present invention, a method and/or a system for substituting media content, as discussed in further detail with reference to FIGS. 73-76, comprises an element, step, technology, or other item that FIG. 8 illustrates.

Turning now to FIG. 8, an exemplary CR\overline{A}V Ad process 610 is initiated at the “START” step 801. In step 802, the device 111 prompts the consumers 110 to enter their CR\overline{A}V ID. In step 805, it is determined whether or not consumers 110 have entered a CR\overline{A}V ID. If the answer to step 805 is “NO” and the consumers 110 do not enter a CR\overline{A}V ID, registration may be allowed, as set forth in step 811. If registration is allowed, the process moves to step 815. If registration is not allowed, the consumers 110 are informed that they must register before they can submit a response to the CR\overline{A}V Ad, as set forth in step 816. The process then moves to step 615 of FIG. 6.

If the answer to step 805 is “YES”, and the consumers 110 have entered a CR\overline{A}V ID using the device 111, the device 111 accepts the CR\overline{A}V ID as set forth in step 810. The CR\overline{A}V ID may be a number assigned by the Promoter or the Advertiser. It may be stored in memory to eliminate the need for manual entry. Examples of how to store the CR\overline{A}V ID into memory include using a cookie over the Internet, or entering a stored number into a phone (speed dial memory function). In step 815, the broadcast network 105 or device 111 communicates the first question of the CR\overline{A}V Ad query 1820 and the answer choices. The question can be an immersion verification question, a polling question, a trivia question, or any other type of question. The answer choices may be a set of predetermined response options a, b, c, d, etc., or the consumers 110 may be required to enter the answer itself. The options for answering may include the broadcast of unique numbers or letters that may differ between broadcasters, which allow subsequent decoding by the data storage center 195 to determine the broadcast medium or location used by the consumers 110 to view the CR\overline{A}V Ad. In step 820, the consumers 110 enter their answer into the device 111. In step 825, the Promoters may communicate another question as part of the same query 1820 using the broadcast network 105 or device 111. This question may be another immersion verification question, or a question used to get information about the consumers 110. This information may include demographic information or other information. If the Promoter chooses “YES” to decision step 825, the process moves to step 830, and the device 111 communicates the new question. In step 835, the consumer enters the answer into the device 111. The process then moves back to step 825 and is repeated. If the answer to step 825 is “NO”, and no other questions will be asked, the process moves to step 826. In step 826, it is determined whether or not the consumer 110 entered a CR\overline{A}V ID in step 805. If the answer to step 826 is “YES”, the process moves to step 615 of FIG. 6. If the answer to step 826 is “NO”, the process moves to step 827, where consumers 110 have the option to register. If the answer to step 827 is “YES”, and the consumers 110 register, the process moves to step 615 of FIG. 6. If the answer is “NO”, and the consumers 110 don't register, or don't completely register, the process moves to step 828 and the responses are discarded. The process then moves to step 615 of FIG. 6.

CR\overline{A}V Ad Answers are Gathered

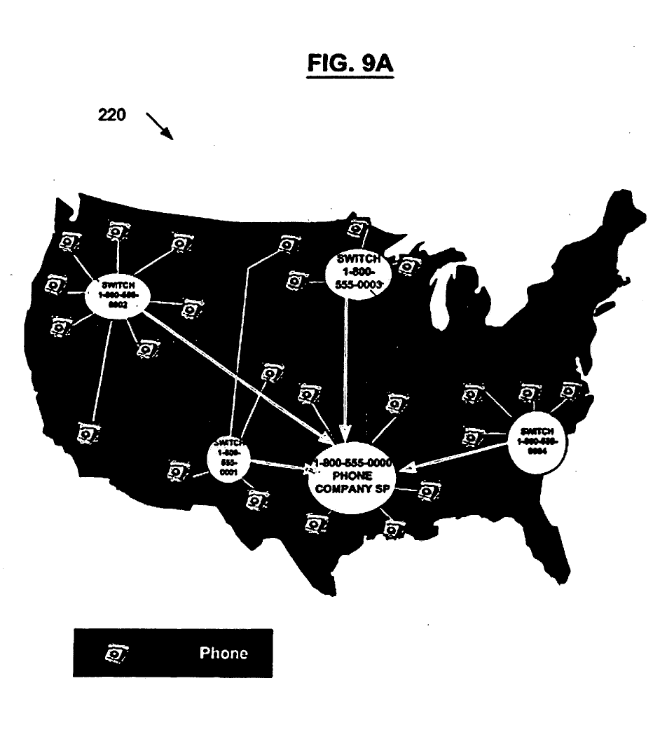

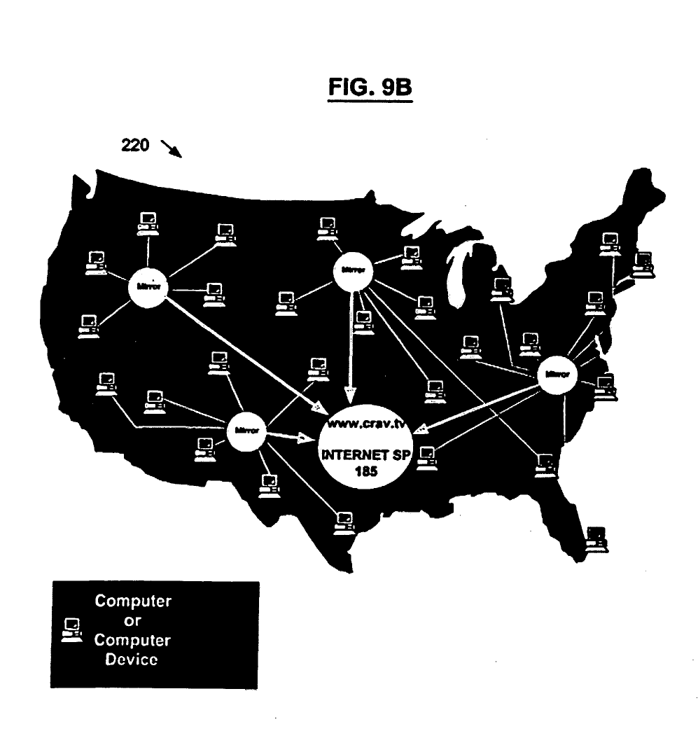

FIGS. 9A and 9B, together comprising FIG. 9, are picture diagrams illustrating an exemplary nationwide network for gathering the registration and response information, as set forth in step 220 of FIG. 2. The query 1820 gathering network is designed to accommodate two variables in any data collection activity. First, expected traffic and geographic/time zone requirements must be met. Second, the registration and the response information must be sent to the data storage center 195. FIG. 9A illustrates the United States map, and shows how conventional Phones 145 forward the registration and the response information to the Phone Company SP 170. FIG. 9B illustrates the United States map, and shows how the Internet computer 130 forwards the registration and the response information to the Internet SP 185. Although the Figures illustrate the United States, one experienced in the art will recognize that the collection system may be implemented in any country, or in multiple countries.

In one exemplary embodiment of the present invention, a method and/or a system for substituting media content, as discussed in further detail with reference to FIGS. 73-76, comprises an element, step, technology, or other item that FIG. 9 illustrates.

Turning now to FIG. 9A, a network is illustrated showing how consumer responses are forwarded by the Phone 145 to the Phone Company SP 170. Those experienced in the art will recognize the multiple ways to meet expected traffic and geographic/time zone requirements. Similar to traffic terminology, the traveling information is called “traffic”, the length between two points is “distance”, and impeded traffic is “congestion.” In an exemplary embodiment, a single Web site and a single phone number would be sufficient to handle query 1820 responses. However, in most cases, multiple lines are necessary to handle the numerous response traffic.

For telecommunication lines, design elements may assist in reducing distance and avoiding congestion. For example, multiple phone numbers (connected to one or multiple information gathering systems 112) may be located in geographically centered locations. In addition, one published phone number, which incorporates a switch directing incoming calls to one or multiple information gathering systems 112, may be located in geographically centered locations, directed based on the incoming call's origin point. FIG. 9A illustrates the option of the Phones 145 forwarding the registration and the response information to the Phone Company SP 170.

For responses provided over a network such as the Internet Network 130, the following design elements may assist to reduce distance and avoid congestion: mirrored Web sites with unique Web site addresses (each serving as a information gathering system 112) located in geographically centered locations; one published Web site address, which is redirected to one or more mirrored Web sites ideally located in geographically centered locations near the user's SP 112; and unique Web sites hosted by individual Internet SPs 185 or approved information gathering systems 112. FIG. 9B illustrates the option of the Internet computer 160 forwarding the registration and the response information to the Internet SP 185.

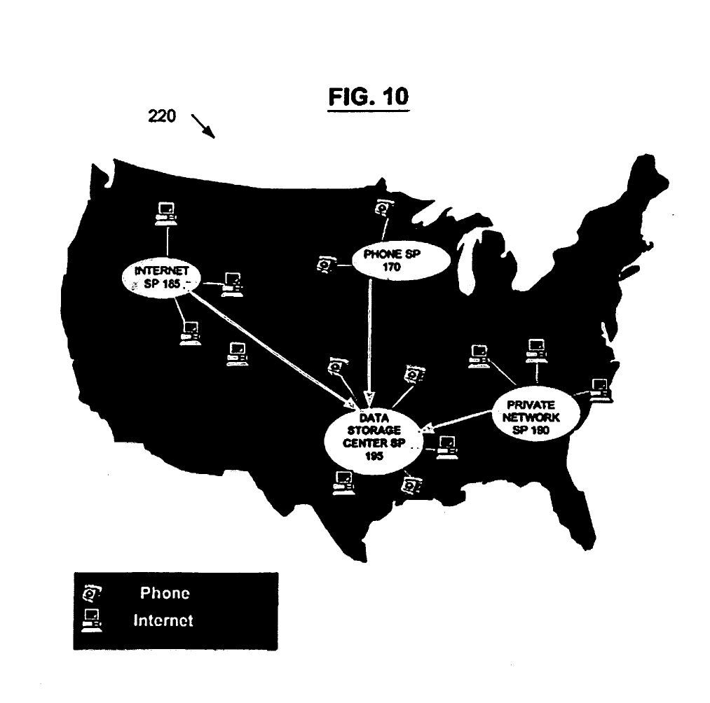

FIG. 10 shows how the information gathering system 112 sends the registration and the response information to the data storage center 195. The registration and the response information are sent to the information gathering systems 112 that may be hosted by a SP network. A CR\overline{A}V Web site may also be set up to be the information gathering system 112. This CR\overline{A}V Web site may be housed at the same location as the data storage center 195. Once the CR\overline{A}V Ad has concluded, the information gathering system 112 forwards the registration and the response information to the data storage center 195 on a time scheduled synchronized basis. Once the consumers'110 data is received and verified by the data storage center 195, the response information may be programmed for automatic erasure by the information gathering system 112. FIG. 10 illustrates three information gathering systems 112 for forwarding registration and response information: an Internet SP 185, a Phone Company SP 170, and a private network SP 190.

In one exemplary embodiment of the present invention, a method and/or a system for substituting media content, as discussed in further detail with reference to FIGS. 73-76, comprises an element, step, technology, or other item that FIG. 10 illustrates.

CR\overline{A}V Ad Winners Selected and Prizes Distributed

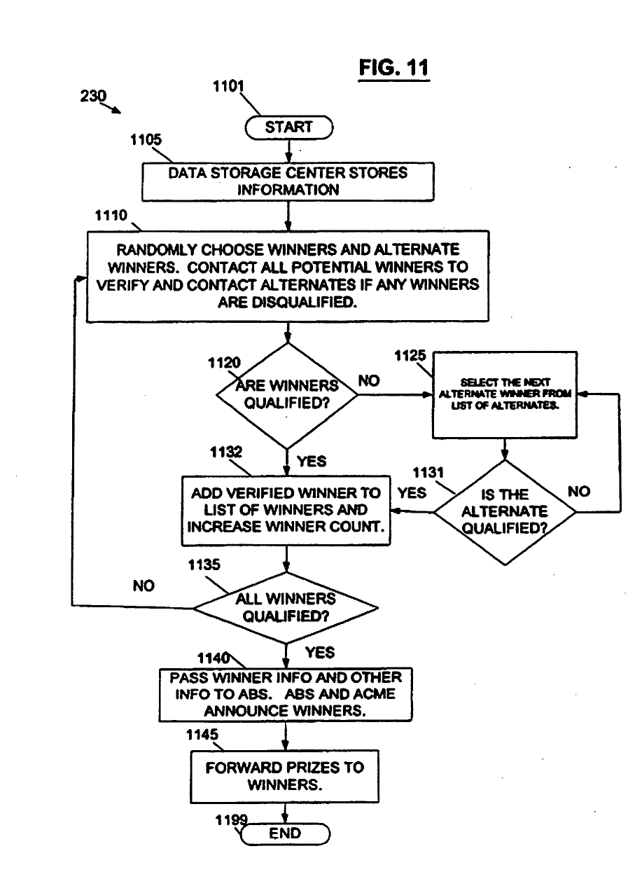

FIG. 11 is a flow diagram illustrating an exemplary process describing how the Promoters select winners and distribute prizes, as set forth in step 230 of FIG. 2.

In one exemplary embodiment of the present invention, a method and/or a system for substituting media content, as discussed in further detail with reference to FIGS. 73-76, comprises an element, step, technology, or other item that FIG. 11 illustrates.

Turning now to FIG. 11, an exemplary CR\overline{A}V Ad process 230 is initiated at the “START” step 1101. In step 1105, the data storage center 195 stores the registration information in the PDC 197 and the response information in the DCS 196. In step 1110, the Promoters or a third party service provider randomly choose winners and alternate winners from the DCS 196 database. The DCS 196 database includes a list of the consumers 110 who have correctly answered all required questions. The Promoters, the Advertisers, or a third party service provider, also contact the potential winners. (This third party service provider may also offer fulfillment services including information on consumer answers and coupons.) Based upon the process selected by the Promoters or the Advertisers, the potential winner identities and the truthfulness of the potential winners'registration and response information may be verified. If this option is used, the Promoters verify the identity by authenticating the consumers'registration and response information. The Promoters may require potential winners to verify demographic or confidential data prior to awarding the prize. The Promoters may repeat the one or more questions in the query 1820. The Promoters may elect to disqualify potential winners who fail to provide responses that match their query 1820 responses.

In step 1120, it is determined if the winners are qualified for the prizes. If the answer to step 1120 is “NO”, the process moves to step 1125, and the next alternate winner is selected from the list of alternate winners. In step 1131, it is determined if the alternate winner is qualified. If the answer to step 1131 is “NO”, the process moves back to step 1125 and is repeated. If the answer to step 1131 is “YES”, the process then moves to step 1132.

If the answer to step 1120 is “YES”, the process moves to step 1132, and the verified winner is added to the list of winners and the winner count is increased. In step 1135, it is determined if all winners are qualified. If the answer to step 1135 is “NO”, the process moves to step 1110 and is repeated. If the answer to step 1135 is “YES”, the process moves to step 1140. In step 1140, the winner information and other opted information (i.e., demographically pertinent data and query 1820 response results) may be forwarded to Advertisers and/or other interested entities, particularly if consumers 110 have approved the forwarding of said information. The Promoters, the Advertisers, or a third party service provider also announce the winners. In step 1145, the Promoters, the Advertisers, or third party service provider forwards the prizes to the winners. The process then ends in step 1199.

Other Applications for CR\overline{A}V Ads

While the above description is ideally suited for visual mass media technology such as the TV and the Internet 130, it may also be utilized in alternate mass media channels, using audio-only technology like radio, or visual-only broadcast mediums, such as a magazine or newspaper ad. The CR\overline{A}V Ads may be answered with complicated, highly-developed computer devices 111, or simply by using the Phone 145. Those practiced in the art will recognize the above invention may be implemented with any broadcast medium and response medium. In addition, the invention is not limited to providing ads within entertainment content, but can be extended to providing other types of information. Finally, while the invention has been discussed in the context of the consumers 110, the Promoters, and the Advertisers, those experienced in the art will recognize that other entities can be used. For example, a third party service provider can be responsible for: gathering the registration and response information, screening the registration and response information to validate it, mining the registration and response information to extract pertinent data, randomly selecting the winners and alternate winners, and providing prize fulfillment and delivery verification services.

### EXAMPLE

To better illustrate the CRAV Ad process, a representative example is provided. The Promoter is ABS Broadcasting Company (“ABS”) and the Advertiser is ACME Motors (“ACME”). The consumers 110 are a four person family in Largo, Fla. Mr. Daly is 60 years old and Mrs. Daly is 58. Two sons live at home. Mike is 25, Mark is 23.

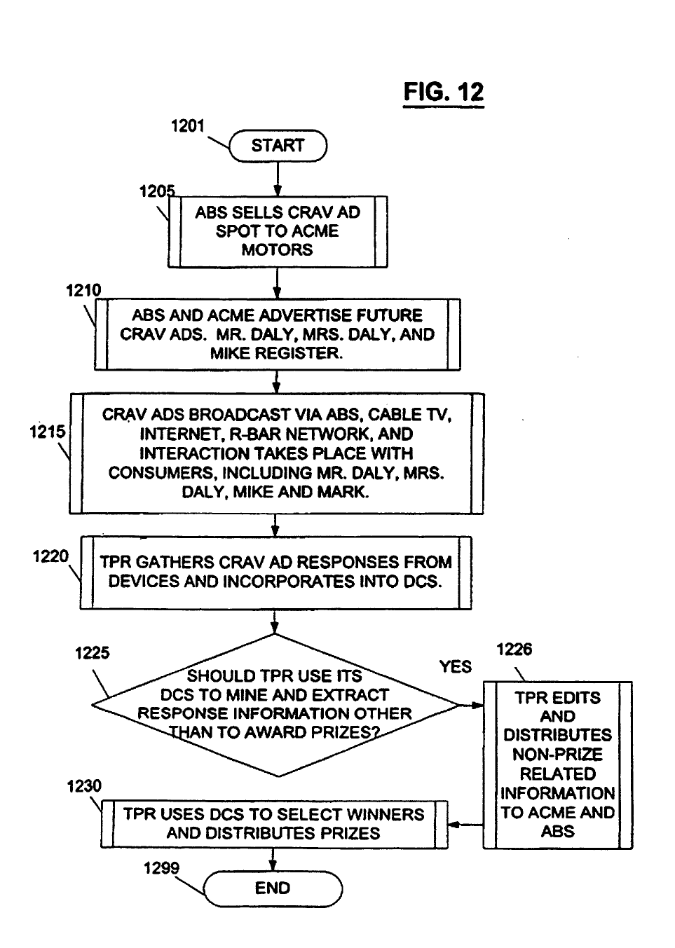

FIG. 12 is a flow diagram illustrating a CR\overline{A}V Ad example. An exemplary process is initiated in step 1201. In step 1205, ABS sells two two-minute CR\overline{A}V Ad slots to ACME Motors (“ACME”). In step 1210, ABS and ACME advertise the future broadcast of CR\overline{A}V Ads, and as a result, the Dalys register. In step 1215, the CR\overline{A}V Ads are broadcast. In step 1220, the CR\overline{A}V AD responses are gathered. In step 1225, the DCS is utilized to use the gathered information for purposes other than awarding prizes. In step 1226, the DCS mines, extracts, edits and forwards the non-prize winner related information. In step 1230, the DCS is utilized to select the winners and distributes the prizes.

In one exemplary embodiment of the present invention, a method and/or a system for substituting media content, as discussed in further detail with reference to FIGS. 73-76, comprises an element, step, technology, or other item that FIG. 12 illustrates.

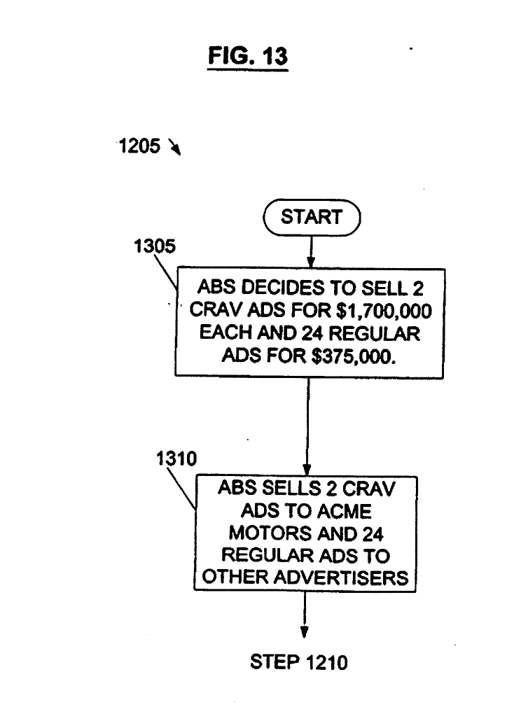

FIG. 13 is a flow diagram illustrating how the Ad slots are sold, as set forth in step 1205 of FIG. 12. In one exemplary embodiment of the present invention, a method and/or a system for substituting media content, as discussed in further detail with reference to FIGS. 73-76, comprises an element, step, technology, or other item that FIG. 13 illustrates.

Turning now to FIG. 13, ABS decides to sell the two CR\overline{A}V Ads for $1,700,000 each and the twenty-four regular ads for $375,000 each, as set forth in step 1305. ABS sells the two CR\overline{A}V Ads to ACME and the twenty-four regular ads to other Advertisers, as set forth in step 1310. The process then moves to step 1210 of FIG. 12.

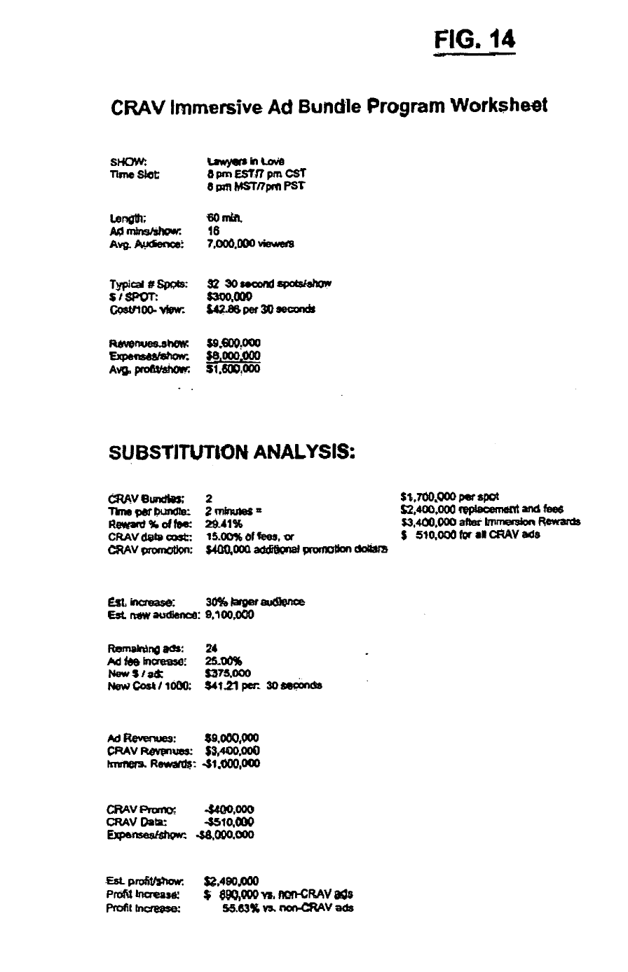

To determine the ad price, ABS follows the chart set forth in FIG. 14. In one exemplary embodiment of the present invention, a method and/or a system for substituting media content, as discussed in further detail with reference to FIGS. 73-76, comprises an element, step, technology, or other item that FIG. 14 illustrates.

ABS determines the average profit for a show “Lawyers in Love”. “Lawyers in Love” is shown at 8 PM EST/8 PM MST (broadcast over delayed time slots) and has a length of 60 minutes. The show's average viewing audience is 7 million consumers 110. ABS has allocated 16 advertising minutes (32 30-second spots) for the show. ABS charges $300,000 per 30- second spot to Advertisers, earning $9.6 million revenue per show. The show expenses are $8,000,000. Thus, the average profit is show revenue ($9.6 million) - show expenses ($8 million)=net profit ($1.6 million). The average cost to the Advertiser per 1000 consumers 110 is $42.86, without taking the CR\overline{A}V Ads into account.

ABS then determines the substitution analysis. The two CR\overline{A}V Ads priced at $1,700,000 replace (8) 30-second ad slots, for which ABS had formerly garnered $2.4 million in revenue. ABS also wishes to allocate $1 million for prizes, bringing the CR\overline{A}V Ad price to $3.4 million. The CRAV data gathering cost is $510,000. ABS pays this fee to TPR, a third party information warehousing and collection organization equipped with CR\overline{A}V related registration and information gathering system 112. TPR will also select winners and alternates, authenticate winner responses, provide a list to ABS and ACME, and will handle the prize distribution process. ABS spends $400,000 promoting the future CR\overline{A}V Ads.

ABS estimates the CR\overline{A}V Ad contest will increase the audience by 30%. ABS therefore increases the traditional ad price by 25%. The new ad price is $375,000 for each 30-second slot. The Advertisers are therefore paying $375,000 per 30-second regular ad (as opposed to $300,000), but are in exchange potentially achieving higher immersion levels, and their regular ads are being broadcast to a larger audience at a lower cost per impression. The new cost per 1000 consumers 110 is lower: $42.21.

This $75,000 increase per slot, over 24 slots, adds $1.8 million in additional revenues to ABS. This is offset by the $400,000 additional cost to promote the upcoming CRAV Ads, plus $510,000 for CRAV information collection, compilation and winner selection/verification. Thus, ABS realizes $890,000 in additional net profit. This increases the show's profitability by over 55%.

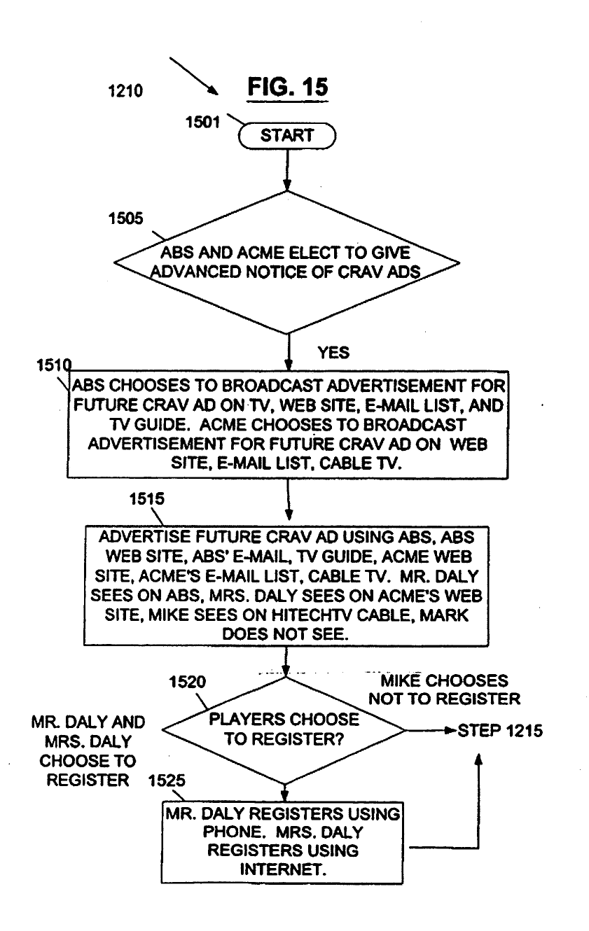

FIG. 15 is a flow diagram illustrating an exemplary CR\overline{A}V Ad process for ABS and ACME to promote future CR\overline{A}V Ads, as set forth in step 1210 of FIG. 12. In one exemplary embodiment of the present invention, a method and/or a system for substituting media content, as discussed in further detail with reference to FIGS. 73-76, comprises an element, step, technology, or other item that FIG. 15 illustrates.

In step 1501, the process 1210 is initiated at the “START” button 1501. In step 1505, ABS and ACME elect to promote and give advanced notice of the CR\overline{A}V Ads. In step 1510, ABS chooses to promote the CR\overline{A}V Ads on TV, the Internet 130, e-mail, and TV guide, and ACME chooses to promote the CR\overline{A}V Ads on the Internet 130, e-mail, and cable TV. As set forth in step 1515, during the weeks before the broadcast, ABS promotes the upcoming “CRAV/ACME New Car Giveaway” promotion on its own ABS network. ABS also purchases TV guide magazine ads, posts information on the ABS Web site, and sends out information to its e-mail lists. Also promoting the CR\overline{A}V Ads are ACME's own banners on its Web site and e-mail notification to its 3.5 million subscribers. ACME also advertises on the HiTechTV cable channel network. Mr. Daly sees the CRAV Ads promoted on ABS. Mrs. Daly sees the CR\overline{A}V Ads promoted on ACME's Web site while surfing the Internet 130. Mike sees the CR\overline{A}V Ads promoted on HiTechTV cable. Mark does not see the CR\overline{A}V Ads promoted. The CR\overline{A}V Ad promotion states: “Watch 'Lawyers in Love'on Sunday at 8:00 EST and you may win 1 of 50 new ACME convertibles. Register at www.CRAV.tv or by calling 1-800-CR\overline{A}VNOW.” All broadcast promotions for the future ACME CR\overline{A}V Ads include this registration information. Registration is conducted by TPR.

Following step 1520, Mr. Daly and Mrs. Daly choose to register. Mike chooses not to register at this time. Mark does not know he may register, and therefore does not register. As set forth in step 1525, Mr. Daly registers using the Phone 145, and Mrs. Daly registers using the Internet computer 160. The process then moves forward to step 1215.

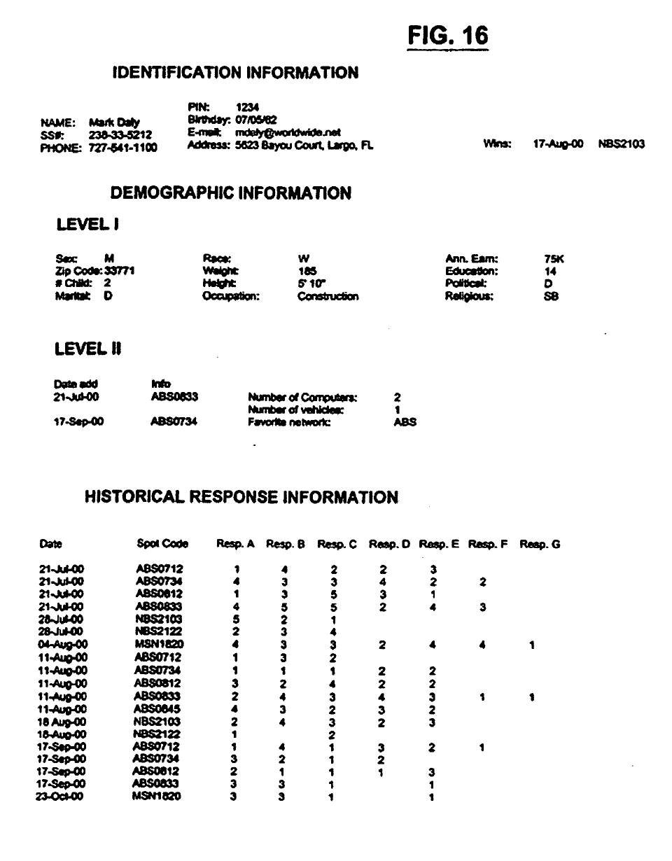

The registration process involves having Mr. Daly and Mrs. Daly enter registration information. FIG. 16 shows a sample CR\overline{A}V record, which may include a name, Social Security number, phone number, PIN, birthday, e-mail, address, and any wins.

In one exemplary embodiment of the present invention, a method and/or a system for substituting media content, as discussed in further detail with reference to FIGS. 73-76, comprises an element, step, technology, or other item that FIG. 16 illustrates.

The Promoters may also ask the consumers 110 to enter demographic information, which may include sex, zip code, number of children, marital status, race, weight, height, occupation, annual earnings, education, political affiliation, and religious affiliation. This information may be supplemented and updated with information including: the number of TVs and computers owned, the number of vehicles owned, and the favorite TV network. The historical response information provides information on the responses the consumers 110 have given to prior CR\overline{A}V Ads.

While the consumers 110 may enter demographic information during the registration process, the query 1820 also provides an opportunity to gather demographic information. This information may be added to the CR\overline{A}V demographic information, or may be added to the historical response data. In this case, a Level II demographic record may be incorporated into the record, for easier search and compilation in the future. Level II demographic information is collected after the initial registration point and thus may contain information for some, but not all, consumers 110. As a result, Level II demographic information may limit the total survey population, as opposed to the primary Level I demographic information, which is provided by all registrants at initial registration.

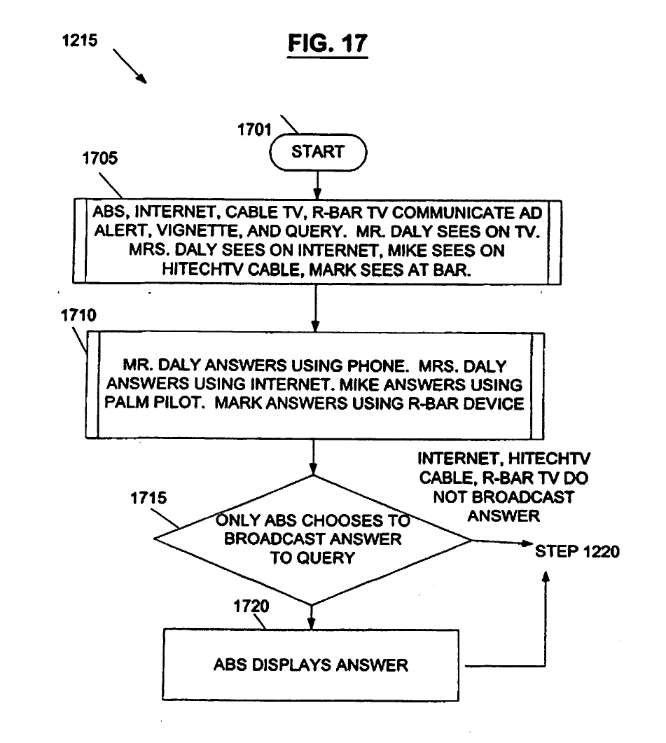

FIG. 17 is a flow chart illustrating an exemplary embodiment of step 1215, where ABS broadcasts the alert 1805, the vignette 1810, and the query 1820. In one exemplary embodiment of the present invention, a method and/or a system for substituting media content, as discussed in further detail with reference to FIGS. 73-76, comprises an element, step, technology, or other item that FIG. 17 illustrates.

Turning now to FIG. 17, the process 1215 is initiated at the “START” step 1701. In step 1705, ACME elects to utilize the MultiSimulcast concept, by offering simultaneous ACME CR\overline{A}V Ad broadcasts over multiple devices. ACME chooses to show the ACME CR\overline{A}V Ad on ABS, ACME's Web site, HiTechTV Cable, and the R-BAR Network simultaneously at 8:33 PM EST on Sunday. Therefore, identical ACME CR\overline{A}V Ads are MultiSimulcast on those mediums at 8:33 PM EST. Mr. Daly sees the ACME CR\overline{A}V Ad while watching “Lawyers in Love” on ABS 120. Mrs. Daly sees the ACME CR\overline{A}V Ad while logged on to the Internet 130. (Mrs. Daly already provided her CR\overline{A}V ID when she logged on.) Mike is watching HiTechTV Cable 135 in his room, and sees the ACME CR\overline{A}V Ad. Mark sees the ACME CR\overline{A}V Ad at a local bar, using the R-Bar Network 125. In step 1710, the consumers 110 answer. Mr. Daly answers using the Phone 145. Mrs. Daly answers using the Internet computer 160. Mike answers using his Palm Pilot PDA 150, although Mike has not yet registered. Mark answers using the R-Bar device 165. The answer 1830 to the query 1820 is shown only on ABS, as set forth in step 1715-1720. The answer 1830 is not shown on the Internet 130, the HiTechTV Cable 135, and the R-Bar Network 125.

FIG. 18 illustrates the CR\overline{A}V Ad the consumers 110 see, as set forth in FIG. 17. In step 1805, the alert 1805 is pictured. The alert 1805 states: “Memorizing the following ACME CAR COMPANY CR\overline{A}V Ad may make you a winner of 1 of 50 new ACME convertibles.” This alert 1805 is shown for 10 seconds. In step 1810, the vignette 1810 is broadcast. The vignette 1810 is a 60-second entertaining and informative ad suitable for broadcast in non-CR\overline{A}V Ads as well. In step 1820, the query 1820 is broadcast. The query 1820 includes three questions: an immersion verification question 1820a broadcast over broadcast network 105, including ABS, ACME's web site, HiTechTV, and R-BAR private broadcast network; and an Advertiser question 1820b, and polling question 1820c, both of which are distributed via devices 111, including a telephone network, ACME's Web Site, R-Bar private Network, and Palm Pilot PDA Network. The immersion verification question 1820a asks “What new ACME model features side impact air bags?” The multiple choice responses are displayed or vocalized: 1) SD2020, 2) XP2030, 3) XX2040, 4) XYZ123. The second question, the Advertiser question 1820b, is communicated. This is a question designed by the Advertiser, posed to the consumers 110 while responding through the various devices 111. This question asks “When do you plan on buying a new car?” The multiple choice responses are displayed or vocalized: 1) 2 years or over, 2) within 2 years, 3) within 1 year, 4) within 6 months. In step 1820c, the third question, the polling question 1820c, is displayed or vocalized. This question is designed for a contracted pollster, posed to the consumers 110 while responding through the various devices 111. This question asks “Assuming the following choices, for whom do you plan to vote for U.S. President in 2008?” The multiple choice responses are displayed or vocalized: 1) Hillary Clinton, 2) Colin Powell 3) Jeb Bush 4) Frank Maggio. In step 1830, the correct answer to question 1 is displayed or vocalized: XP2030.

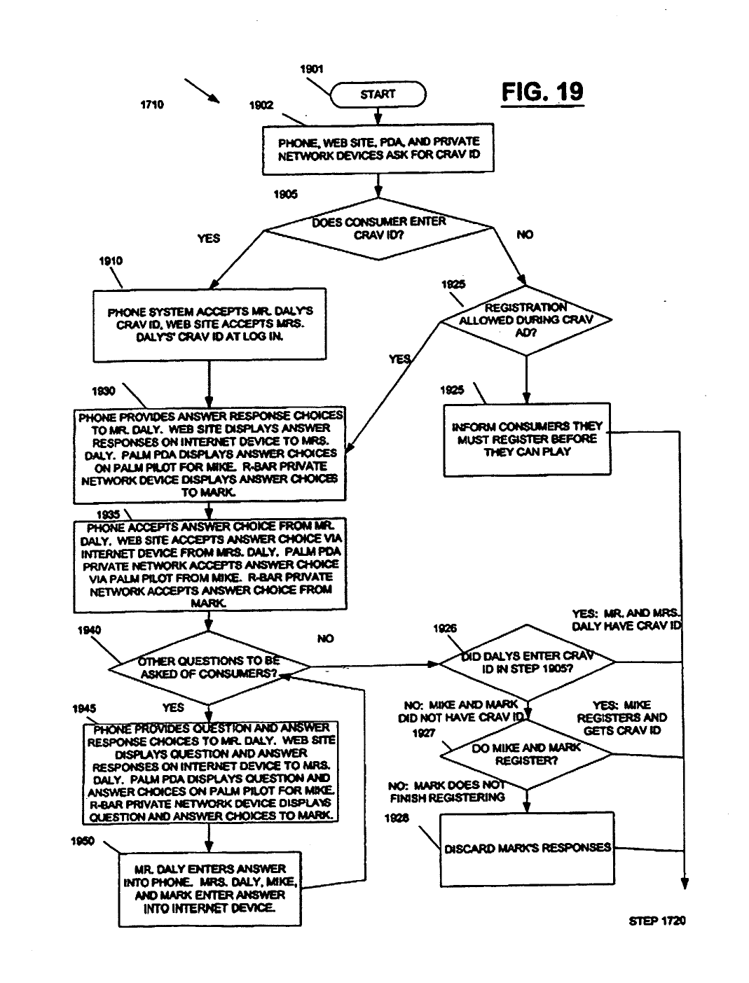

FIG. 19 is a flow diagram illustrating how the CR\overline{A}V Ads are answered by the Dalys, as set forth in step 1710 of FIG. 17. In one exemplary embodiment of the present invention, a method and/or a system for substituting media content, as discussed in further detail with reference to FIGS. 73-76, comprises an element, step, technology, or other item that FIG. 19 illustrates.

For Mr. Daly, the process is as follows. Mr. Daly answers using the Phone 145, by dialing a phone number he was given when he registered. The phone number connects to an answering service, which asks Mr. Daly for his CR\overline{A}V ID, as set forth in step 1902. Mr. Daly has already registered, so he enters his CR\overline{A}V ID and it is accepted in step 1910. In step 1930, the Phone 145 plays Mr. Daly the first question 1820a with answer choices. In step 1935, he answers “SD2020” by pressing 1 on his touch-tone Phone 145, as prompted. (This is not the correct response.) Another question is asked, so the process moves from step 1940 to step 1945. In step 1945, Mr. Daly is asked the second question 1820b with answer choices. In step 1950, Mr. Daly answers “2 years and over” by pressing 1 on his Phone 145. A third question 1820c is asked, so the process moves from step 1940 to step 1945. In step 1945, Mr. Daly is asked the third question. In step 1950, Mr. Daly answers he will vote for “Frank Maggio” for President by pressing 4 on his Phone 145. (This is evidence of his political acumen.)

For Mrs. Daly, the process is as follows: Mrs. Daly answers using the Internet Computer 160. As Mrs. Daly already provided her CR\overline{A}V ID automatically when she logged on (steps 1902-1910), she only needs to answer the questions. In step 1930, the Internet 130 shows the immersion verification question 1820a. In step 1935, Mrs. Daly selects “XP2030”. In step 1945, the Internet Network 130 shows the Advertiser question 1820b with answer choices. In step 1950, Mrs. Daly selects “within 2 years”. Because there is another question, the process moves from step 1940 to step 1945 again. In step 1945 the polling question 1820c with answer choices is shown. In step 1950, Mrs. Daly selects “Frank Maggio” representing her choice for President. (Intelligence runs in the Daly household.)

For Mike, the process is as follows: Mike uses his Palm Pilot 150 to access the Web site shown on HiTechTV Cable 135. Mike has not registered, but registration is allowed, so the process moves from step 1905, to step 1925, where registration is allowed, and then to step 1930. In step 1930, the immersion verification question 1820a with answer choices is displayed. In step 1935, Mike answers 3 (“XX2040”). There is another question so the process moves from step 1940 to 1945. In step 1945, the Advertiser question 1820b with answer choices is displayed. In step 1950, Mike answers 3 (“within one year”). The same process is followed for the polling question 1820c, and Mike answers it. There are no additional questions, so the process moves from step 1940 to step 1926. In step 1926, because Mike does not have a CR\overline{A}V ID, the process moves to step 1927 and Mike registers and gets a CR\overline{A}V ID, which is automatically entered. The process then moves to step 1720.

For Mark, the process is as follows: Mark uses the bar's private network, which broadcasts the CR\overline{A}V Ads and presents the query 1820 to the consumers 110 located within the bar who are connected to the private network and who have enrolled to play. Mark is asked for his CR\overline{A}V ID in step 1902. Mark has not pre-registered, so Mark types “NONE”, and the process moves to step 1905, and then to 1925. In step 1925, registration is allowed during the CR\overline{A}V Ad, so the process moves to step 1930. In step 1930, the immersion verification question 1820a with answer choices is displayed. In step 1935, Mark answers 3 (“XX2040”). Another question is asked, so the process moves from step 1940 to 1945. In step 1945, the Advertiser question 1820b with answer choices is displayed. In step 1950, Mark answers 3 (“within 1 year”). Another question is asked, so the process moves from step 1940 to 1945. In step 1945, the polling question 1820c with answer choices is displayed. In step 1950, Mark answers 1 (“Hillary Clinton”). No other questions are asked, so the process moves from step 1940 to step 1926. In step 1926, the device recognizes that Mark does not have a CR\overline{A}V ID. The process moves to step 1927, and Mark is asked if he wishes to follow the registration process (to obtain a CR\overline{A}V ID) or lose his query 1820 response information. Mark starts to complete the registration information, but is distracted and logs off. Because he does not complete the registration, he is not assigned a CR\overline{A}V ID, and his responses are discarded, as set forth in step 1928.

In step 1220 of FIG. 12, the CR\overline{A}V Ad answers are gathered. This is done by the Phone Company SP 170, the Internet SP 185, the PDA SP 175, and the R-Bar Private Network SP 190 forwarding the response and applicable registration information to TPR's DCS 195.

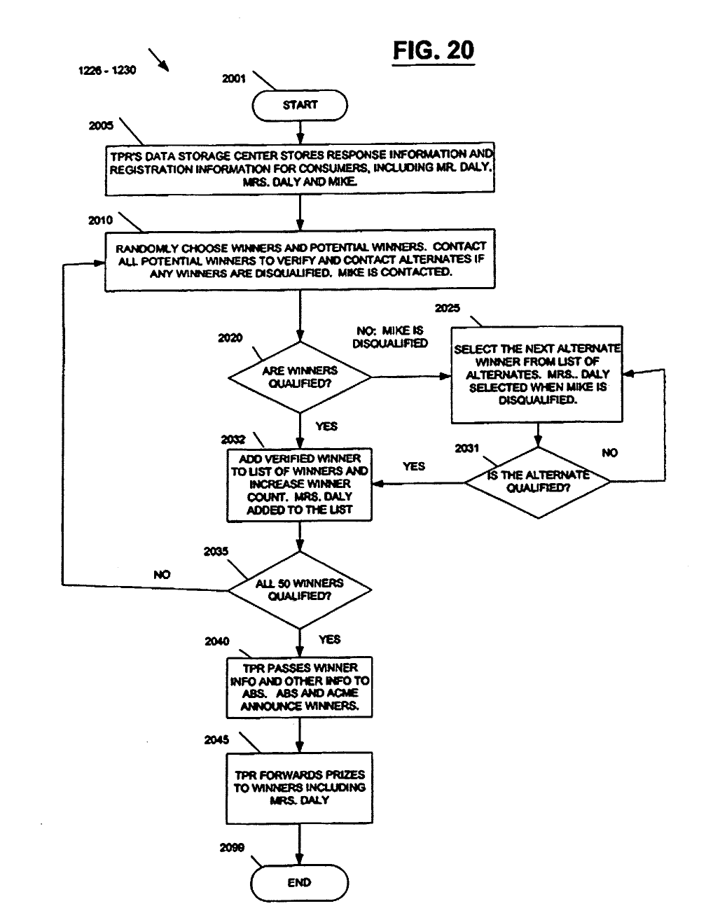

FIG. 20 is a flow diagram illustrating how TPR uses the data storage center 195 to select winners and distribute the prizes, as set forth in step 1226 and 1227 of FIG. 12. In one exemplary embodiment of the present invention, a method and/or a system for substituting media content, as discussed in further detail with reference to FIGS. 73-76, comprises an element, step, technology, or other item that FIG. 20 illustrates.

In step 2001, the process is initiated at the “START” button. In step 2005, TPR's data storage center 195 stores the registration information (for those who registered during game play) and the DCS 196 stores the response information for all the registered consumers 110, including Mr. Daly, Mrs. Daly, and Mike. In step 2010, the potential and alternates winners are randomly chosen and extracted from all the correct answers for question 1820a stored within the DCS 196. Mike is chosen as a one of 50 winners and Mrs. Daly is chosen as the first of 50 alternate winners. TPR begins the verification process by contacting all 50 winners. Each winner is qualified in step 2020, and as each winner is verified their name is added to the list of verified winners in step 2035, and the winner counter is increased. Ultimately, TPR contacts Mike in step 2010 to verify his CR\overline{A}V ID, registration information, and response information in step 2020. Mike's registration information was falsified (he said he was 60 when registering, but in reality he is 25), so he is disqualified, because truthful answers are required as a condition of winning according to ABS Promotion rules. All of Mike's data is also purged from the data storage center 195 to avoid potentially false or misleading information. This is done to maintain data base integrity. According to step 2020, because Mike's information is not correct, the first alternate winner at the top of the list is chosen, as set forth in step 2025. Mrs. Daly is the first alternate winner, so her information is verified in step 2025. Because Mrs. Daly's immersion verification question was correct, and her demographic data is proven to be accurate and verified in step 2031, so she is selected as a verified winner and added to the list in step 2032.

In step 2035, once all 50 winners have been selected and verified, the process moves to step 2040, where TPR forwards to ABS the information as to the identities of all winners, including Mrs. Daly. In step 2040, ABS and ACME also jointly announce the name of all winners, including Mrs. Daly. Included in the information passed to ABS from TPR in step 2040 is a report including demographic information for all consumer responses for the ACME and pollster designed questions, which ABS may elect to pass along to ACME or to survey organizations that have contracted ABS to acquire polling statistics. This report is derived and data mined from the registration and response data. This information includes statistics indicating that of the 5.532 million female consumers 110, 534,461 live in households with average incomes in excess of $75,000 per year. This information also indicates that, of those, 6.5% live in the state of Florida and are over 50 years old, and 3.443% expect to purchase a car within the next six months, 5.2% live in the metropolitan NYC area, and 0.8429% expect to purchase a new car within the next six months. The statistics also indicate that across all age groups, and all occupations, Frank Maggio will be elected President in 2008 by a 59.8% share of the popular vote.

In step 2045, TPR forwards a convertible to Mrs. Daly and the other winners. The process ends in step 2099.

Other Applications

While the above description is ideally suited for visual mass media broadcast technology such as the Broadcast TV 120, Cable TV 135, Satellite TV 140, Private Networks 125, Other Networks 141, and streaming Internet 130, it may also be utilized in alternate mass media channels, using audio-only technology like radio, or visual-only broadcast mediums, such as a magazine or newspaper ad. The CR\overline{A}V Ads may be answered with complicated, highly developed computer devices 111, or simply by using the Phone 145. Those practiced in the art will recognize the above invention may be implemented with any broadcast medium and response medium.

The CR\overline{A}V system and process can be utilized across any mass media broadcast network 105. For example, the mass media broadcast network 105 can comprise TV, cable, satellite, radio, outdoor media (billboards, signs, buses), print media (newspapers, magazines), direct mail, the Internet, or other broadcast network, as well as private networks. Private networks can comprise networks having connected Personal Recording devices such as a TiVo®. Additionally, a convergence of multiple mass media broadcast networks 105, when utilized together, can broaden the reach and effectiveness of CR\overline{A}V ads.

Radio

Radio programs are distributed over the airwaves, and/or over the Internet. As with the television industry, ad revenues garnered by radio stations are utilized to offset the costs of content (music, news, sports, etc.) and its production, as well as overhead costs such as staff and marketing. As with television, ads and ad pods are embedded between content segments. Consumers tend to avoid radio ads by switching channels, listening to alternate forms of entertainment (such as CDs, DVDs, television, etc.), or by turning off the radio.

Within radio program segments, single CR\overline{A}V ads or CR\overline{A}V ad pods can be broadcast. Some or all ads within the program may be CR\overline{A}V ads. CR\overline{A}V ads can contain “alert” tones or specific alert wording to entice immersion. The alert can be provided at the beginning of a program or program segment, or at the beginning or end of an ad or ad pod. After the ads (audio “vignettes”) are broadcast, listeners can be provided with log-in instructions. The instructions can suggest immersion verification via telephone or cellular phone. Additionally, the instructions can suggest immersion verification through any of the response devices 11. Accordingly, consumers can register and/or provide query responses to immersion verification or other queries through the response devices 111.

The Queries can be broadcast on air, before or after the CR\overline{A}V ad. Alternatively, the Queries can be provided during the query-response interaction process utilizing devices 111 over networks provided by Service Providers 112.

Promoters may desire to provide multiple queries to make cheating more difficult. For example, cheating can include one consumer learning the content and providing the query and answer to subsequent players. Promoters may also desire to limit the amount of time allowed for interaction. In addition to Immersion Verification queries, other queries can be included. For example, the other queries can comprise sponsor-designed questions, polling questions, demographic questions, etc., similarly to television use of CR\overline{A}V ads.

Aspects of the television industry's use of CR\overline{A}V ads discussed above mirror the radio industry. Those aspects comprise the advance promotion and registration of CR\overline{A}V players, the assignment of CR\overline{A}V ID numbers, research, and the substantial prizing and prize fulfillment aspects. Those practiced in the art will recognize the similarities between the radio broadcast and television broadcast industries, as well as the similarities in the methods, analysis, and sales techniques utilized by Promoters to determine the sales price and costs of CR\overline{A}V ads.

Print Media: Books/Magazines/Newspapers

Books, magazines, and newspapers are distributed to subscribers through vending or printed work sales outlets. Additionally, on-line versions of those printed materials may be distributed via the Internet. Over-air broadcast mass media (such as television and radio) have costs affiliated with time. In other words, radio and television costs of content are measured in units of time, and ad units are sold as units of time. On the other hand, print mass media content costs are affiliated with space, such as ad size on printed pages. The more printed pages, the higher the cost of a printed work.

Ad revenues garnered by print media are utilized to offset the costs of paper, printing costs, distribution, development of written and photographic content and its production, and staff and marketing overhead. Ads of different sizes can be embedded between content segments or sections of the print media. Consumers tend to avoid print ads by ignoring the ad, reading around the ad, turning the page, or discontinuing reading the written work.

Within and between printed content segments, CR\overline{A}V ads of different sizes can be printed or distributed. The ads can comprise an alert mark or logo to entice immersion. Additionally, specific printed instructions can be provided within the ad to entice immersion. Internet distribution of magazines (e-magazines or e-zines) or newspapers also can comprise audio or visual alerts. An alert logo can be provided on a printed ad to invite immersion in the content of that individual ad. Alternatively, an alert logo can be provided on multiple ads to invite immersion in the content for a section of ads or for one of the ads in the section. The multiple ads can comprise the printed version of an ad pod.

After the consumers review the print media ads, they can register and/or provide a query response through the various response devices 111. In exemplary embodiments, the Immersion verification query can be printed on the ad, hidden elsewhere within the printed publication, or provided only during the query interaction/response process through the response devices 111. Providing the query during the interaction/response process can enhance immersion by requiring memorization of the ad to assist in expeditious answering of the query.

As discussed above, Promoters may desire to provide multiple queries to make cheating more difficult. Promoters can attempt to allow a consumer to interact with an ad only once, further increasing the likelihood of serious desire to play properly and increasing the likelihood and effectiveness of immersion. To prevent subsequent reviewing of the ad, Promoters can limit the amount of time allowed for interaction, or can allow interaction and immersion verification within a limited, announced timeframe. Accordingly, the consumers can rely on memory to correctly and timely answer the query. In addition to immersion verification queries, other queries can be included. For example, other queries can comprise sponsor-designed questions, polling questions, demographic questions, etc.

Most aspects of the television industry's use of CR\overline{A}V ads discussed above mirror the mass media print industry. For example, similarities include advance promotion and registration of CR\overline{A}V players, the assignment of CR\overline{A}V ID numbers, research, and the substantial prizing and prize fulfillment aspects. Those practiced in the art will recognize the similarities between the radio and television broadcast industries, when compared to the print industry, as well as the methods, analysis, and sales techniques utilized by Promoters to determine the sales price and costs for CR\overline{A}V ads.

Printed Response Devices

In one exemplary embodiment, the Other Response Device 166 can comprise a printed response device, which can be delivered subsequently to the data storage center 195. Printed response devices can provide a cost-effective means of interacting and can rely upon an information gathering system 191, such as the U.S. Postal service network or Private Delivery services (ranging from couriers to overnight mail service center networks), to deliver the printed responses to the data storage center 195. Additionally, printed responses can be forwarded to the data storage center 195 via a facsimile machine, or can be scanned and forwarded via e-mail or other computer media.

In an exemplary embodiment, consumers (recipients) can interact with CR\overline{A}V ads through printed responses, which can be forwarded subsequently to a data storage center 195 for compilation utilizing manual methodologies. Other compilation methodologies may be employed such as Optical Character Recognition (OCR) or Optical Mark Recognition (OMR), which will facilitate a quicker and more efficient compilation of data contained on the printed responses when compared to manual data entry.

In one embodiment of a CR\overline{A}V printed response, other elements of a CR\overline{A}V ad can be included on the printed response device itself, in effect converting the printed response to a self-contained, printed CR\overline{A}V ad, complete with the “Alert,” printed “Vignette,” and Immersion Verification Query (or an area upon the printed response to enter the response, after broadcast of the Immersion Verification Query via another medium, such as Television or Internet).

Production and Distribution of CR\overline{A}V Printed Responses

The means by which the consumer may obtain a printed response may include, but are not limited to, newspaper (local or national) printed responses printed as content on the pages or as a separate insert; magazine (local or national) printed responses printed as content on the pages or as a separate insert; e-mail delivery to registered CR\overline{A}V players that have elected this service; Internet download from the CR\overline{A}V promoter, Advertiser, or affiliated site, in .pdf, .txt, .doc, or other format; direct mail (either upon request or as part of a direct mail promotion); physical distribution points, such as grocery stores, gas stations, or other affiliated establishments; and facsimile delivery to registered CR\overline{A}V players who have elected this service, or to those who have requested a facsimile printed response.

OCR and OMR Technology

OCR (Optical Character Recognition) involves electronic reading of text from paper and translating the images into a form that the computer can manipulate. An OCR system enables feeding a document directly into an electronic computer file. The text can be written in any method acceptable to the OCR system. For example, the text can be written with a dark pencil or ink and in a legible manner. Any difficulties the computer develops when identifying a character may involve manual intervention. While this method does require more manual intervention than OMR, discussed below, it is significantly quicker than pure manual entry for all data to be captured.

OMR (Optical Mark Reading) is a process to detect the presence of intended, marked responses. An OMR form comprises response areas (“bubbles”), which a consumer marks to indicate a response. A mark, such as a darkened bubble, registers significantly less light than the surrounding paper. In order to be detected, a mark should be positioned correctly on the paper (within the bubble) and significantly darker than the surrounding paper. While being the most accurate and quickest method of capturing data, OMR forms are larger than OCR forms due to the included bubbles.

Outdoor Media

Outdoor media can comprise billboards, fixed signs on or inside buildings, and mobile signs on taxis, buses, plane banners, or blimps. Outdoor mass media advertising can rely on capturing the attention of passing consumers for short time periods. To create outdoor media, Promoters utilize printed materials such as billboard “wraps” or printed card inserts for taxis, paint applied directly to boards or buildings, and electronic billboards. Electronic billboards can display advertising messages and entertainment content, such as news headlines, sports headlines, etc. However, most outdoor media comprise advertising messages and do not comprise substantial amounts of traditional content.

Ad revenues generated by outdoor media Promoters are utilized to offset the costs of development of written and photographic content and its production, paper, printing costs, paint, distribution, installation, material costs, overhead, rental fees, or other fees charged by billboard property owners, taxi cab, or advertising facility owners. Consumers tend to avoid outdoor media ads by ignoring them, or by looking away.

A CR\overline{A}V version of an outdoor mass media ad can comprise a recognized visual “alert” mark or logo on an outdoor media ad to entice immersion. Alternatively, the outdoor media ad can comprise an audible tone to entice immersion. The audible tone can be provided over radio waves or can emanate from the outdoor media item itself. The outdoor media CR\overline{A}V ad also can provide log-in instructions, allowing interaction through the various response devices 111 for consumers to register and/or to provide query responses. The Immersion verification query can be printed on the outdoor media ad. Alternatively, the Immersion verification query can be provided during the query interaction/response process through the response devices 111.

As discussed above, Promoters may desire to provide multiple queries to make cheating more difficult. Promoters can attempt to allow a consumer to interact with an ad only once, further increasing the likelihood of serious desire to properly play and increasing the likelihood and effectiveness of immersion. To prevent subsequent reviewing of the ad, Promoters can limit the amount of time allowed for interaction, or can allow interaction and immersion verification within a limited announced timeframe. Accordingly, the consumer can rely on memory to correctly and timely answer the query. In addition to immersion verification queries, other queries can be included. For example, other queries can comprise sponsor-designed questions, polling questions, demographic questions, etc.

Aspects of the television industry's use of CR\overline{A}V ads discussed above mirror the outdoor media industry. For example, those aspects comprise the advance promotion and registration of CR\overline{A}V players (a billboard Promoter could advise passerby's of “WATCH THIS SPACE FOR FUTURE CR\overline{A}V ADS”), the assignment of CR\overline{A}V ID numbers for registered players, research aspects of registration and query responses, and the substantial prizing and prize fulfillment aspects. Those practiced in the art will recognize the similarities between the radio and television broadcast industries, when compared to the outdoor media, as well as the methods, analysis, and sales techniques utilized by Promoters to determine the sales price and costs for CRAV outdoor ads.

Direct Mail

Direct mail relies on capturing the attention of consumers while opening their mail. Many Direct Mail Promoters utilize printed materials (envelopes, printed advertising fliers, brochures, coupons, etc.) and incur substantial costs in distributing their advertising. Most direct mail media, like outdoor media, do not comprise substantial amounts of traditional content and are typically dominated by advertising messages. However, in some respects, direct mail Promoters face many of the cost structures of the print media industries because costs are determined by space rather than broadcast time.

Direct mail Promoters can mail one advertising insert, or multiple ad inserts, to a mass mailing list, taking advantage of economies of scale such as bulk mail rates. In the event of multiple mailed pieces within one envelope (the direct mail version of an ad “pod”), costs of distribution are shared by multiple Advertisers, lowering the costs per insert. Ad revenues garnered by direct mail media Promoters are utilized to offset the costs of paper, printing costs, distribution and postage, handling, overhead, and development of written and photographic content and its production. Consumers tend to avoid direct mail media ads by discarding them while sorting incoming mail, often before even opening the envelopes.

A CR\overline{A}V version of a direct mail ad can comprise a recognized visual alert mark or logo on the envelope or on the insert itself. An alert logo can be added to a single printed insert to invite immersion in that individual CR\overline{A}V ad. Alternatively, an alert can apply and invite immersion for all inserts in the event of multiple inserts (a direct mail ad pod.) The CR\overline{A}V envelope or CR\overline{A}V ad can provide printed log-in instructions, allowing interaction facilitated through the various response devices 111. Accordingly, consumers can register and/or provide query responses through the response devices 111. The Immersion verification query also can be printed on the envelope or insert. Alternatively, the query can be provided during the query response/interaction process.

As discussed above, Promoters may desire to provide multiple queries to make cheating more difficult. Promoters can attempt to allow a consumer to interact with an ad only once, further increasing the likelihood of serious desire to play properly and increasing the likelihood and effectiveness of immersion. To prevent subsequent reviewing of the ad, Promoters can limit the amount of time allowed for interaction, or can allow interaction and immersion verification within a limited announced timeframe. Accordingly, the consumer can rely on memory to correctly and timely answer the query. In addition to immersion verification queries, other queries can be included. For example, other queries can comprise sponsor-designed questions, polling questions, demographic questions, etc.

Aspects of the television industry's use of CR\overline{A}V ads discussed above mirror the direct mail media industry. Those aspects comprise the advance promotion and registration of CR\overline{A}V players (initial mailings can advise recipients of future mailings bearing the CR\overline{A}V logo or pre-registration), the assignment of CR\overline{A}V ID numbers for registered players, research aspects of registration and query responses, and the substantial prizing and prize fulfillment aspects. Those practiced in the art will recognize the similarities between the radio and television broadcast industries, when compared to the direct mail media industry, as well as the methods, analysis, and sales techniques utilized by Promoters to determine the sales price and costs for direct mail CR\overline{A}V ads.

Internet

Mass distribution of CR\overline{A}V ads over the Internet can take multiple forms, each of which can share aspects of other mass media types. In addition, the Internet can save Promoters certain costs affiliated with less modern forms of mass media. For example, Internet Promoters can create “broadcast e-mail ads.” In such ads, a Promoter can mass broadcast e-mails to a list of e-mail addresses, simulating a direct mail campaign without bearing the costs of materials and postage.

Internet Promoters also can “stream” video versions of televised or radio content and embedded ads, or merely the ads themselves, to consumers. In “requested streamed Internet ads,” the Promoters can stream the content to consumers upon request. Alternatively, in “simulcast broadcast ads,” the Promoters can stream simulcast versions of televised or radio content and embedded ads, which are mass broadcast over a web site. In the example of streaming audio or video feeds, Promoters bear bandwidth costs, which must be considered when calculating the cost to the Advertiser for sending streaming ads, or streaming CR\overline{A}V ads, to consumers.

Some distributors of printed materials offer “Internet mirrored display ads.” For example, newspaper distributors can offer on-line versions of their printed works on a website. Internet consumers of the printed work can review content and ads in the newspaper on the website. Those Internet mirrored display ads are similar to the printed media ads discussed above.

Internet Promoters also use “mass media banner ads” as a means of Internet advertising. A Promoter can create a CR\overline{A}V mass media banner ad by consistently posting the ad on a mass media website in a non-targeted fashion without linking the Advertiser directly to the consumer. The CR\overline{A}V banner ad can comprise an alert and can provide substantial rewards to some of the consumers who register and verify immersion in the ad's content. Those CR\overline{A}V ads are different from the types of targeted Internet ads displayed only to consumers that meet specified criteria.

Consumers tend to avoid Internet ads by closing browser windows containing ads, or avoiding web sites that comprise ads altogether. However, Iternet CR\overline{A}V ads can overcome the consumers'tendencies by drawing the consumers'attention to the ads. Each of the Internet ads discussed above can comprise a CR\overline{A}V ad by implementing the alert and Immersion Verification processes for the ad itself. Multiple CR\overline{A}V ads within a requested stream, simulcast broadcast, mirrored display, or mass media banner broadcast can comprise a “pod” of ads, whereby an Immersion verification query can be posed about one or more of the ads in the pod. The CR\overline{A}V ads can comprise alert logos or tones, or specific alert wording to entice immersion.

After the ads are broadcast by stream, display, or banner with video and/or audio vignettes, consumers can be provided with log-in instructions, typically suggesting log-in for immersion verification via the Internet, but also available through the other response devices 111. Accordingly, consumers can register and/or provide query responses to immersion verification queries using the response devices 111. Queries also can be broadcast following the vignette or before or after the CR\overline{A}V ad. Alternatively, the Queries can be provided during the query-response/interaction process utilizing the response devices 111 over networks provided by Service Providers 112.

As discussed above, Promoters may desire to provide multiple queries to make cheating more difficult. Promoters can attempt to allow a consumer to interact with an ad only once, further increasing the likelihood of serious desire to play properly and increasing the likelihood and effectiveness of immersion. To prevent subsequent reviewing of the ad, Promoters can limit the amount of time allowed for interaction, or can allow interaction and immersion verification within a limited, announced timeframe. Accordingly, the consumer can rely on memory to correctly and timely answer the query. In addition to immersion verification queries, other queries can be included. For example, other queries can comprise sponsor-designed questions, polling questions, demographic questions, etc.

Aspects of the television industry's use of CR\overline{A}V ads discussed above mirror CR\overline{A}V ads over the Internet. Those aspects comprise the advance promotion and registration of CR\overline{A}V players, the assignment of CR\overline{A}V ID numbers, research, and the substantial prizing and prize fulfillment aspects. Those practiced in the art will recognize the similarities between the Internet and television broadcast industries, as well as the methods, analysis, and sales techniques utilized by Promoters to determine the sales price and costs for CR\overline{A}V ads.

Private Networks

Private networks can exist across all mass media industries. For example, private networks comprise a mailing list (distribution of materials over the U.S. Postal Service delivery network), magazine subscription list, e-mail address distribution list, taped music distributed to subscribers (like Muzak), a connected network of broadcast content linked to interactive devices within bars and restaurants (such as NTN), consumers connected through a cable system to Video on Demand servers, and owners on a Personal Video Recorder network.

For mass media broadcasting of CR\overline{A}V ads over a private network, the private network requires the ability to cost effectively distribute (i.e., broadcast) ads across the entire network. That broadcasting differs from targeted media, which include distributing interactive ads to a segment of consumers connected to the private network based on targeted profiles, such as demographics.

In general, ads distributed over a private network are subject to the same consumer avoidance techniques indicative of the industry (i.e., print ads can be avoided by turning the page). Similarly, the implementation of CR\overline{A}V ads across a private network will enhance immersion, just as it would across the public network version of the same CR\overline{A}V ads.

Convergence

To enhance the effectiveness of CR\overline{A}V ads, the CR\overline{A}V ads can be broadcast across a convergence of multiple media forms (“cross-media” broadcasting). For example, a Promoter can distribute CR\overline{A}V ads comprising the same message about a new automobile across the radio, television, Internet, and print mediums. The ads can be presented simultaneously or at different times on the multiple media forms. While the ads can have different appearances based upon restrictions of each media, the immersion verification query can be the same across all media.

FIG. 21 illustrates a CR\overline{A}V ad broadcast over a convergence 2100 of mass media formats according to an exemplary embodiment of the present invention. In one exemplary embodiment of the present invention, a method and/or a system for substituting media content, as discussed in further detail with reference to FIGS. 73-76, comprises an element, step, technology, or other item 'that FIG. 21 illustrates.

As shown, a Promoter can broadcast to consumers 110 a CR\overline{A}V ad or ad pod over two or more of the broadcast networks 105. The CR\overline{A}V ad or ad pod can be broadcast simultaneously or independently over the multiple broadcast networks 105. The consumers 110 can react to the CRAV ad or ad pod by responding to an immersion verification query about a selected content portion of a CR\overline{A}V ad or pod. The consumers 110 can respond to the query through one or more of the response devices 111. The query can be provided over one or more of the multiple broadcast networks 105. Alternatively, the query can be provided over the response devices 111. The response devices 111 communicate the consumers'query responses to the data storage center 195 through the respective Service Provides 112. A reward can be granted to a consumer that responds correctly to the query.

In an exemplary embodiment, a Promoter or Advertiser can bundle CR\overline{A}V ads across all media, and the interaction process also can be triggered by each media individually or through instructions provided in one of the media (for example, television). In an exemplary embodiment, one media can provide “clues” to assist CR\overline{A}V players in correctly answering CR\overline{A}V ads in another media. For example, a local newspaper might publish an ad with a CR\overline{A}V logo. The ad can explain that a televised CR\overline{A}V ad sponsored by the same Advertiser will be broadcast within a CR\overline{A}V ad pod during a certain timeframe that evening, over a specified television network. In an exemplary embodiment, immersion verification can be available only after the televised CR\overline{A}V ad airs. The query can be broadcast on air, provided in the original ad, or provided during the response/interaction process. Accordingly, the CR\overline{A}V logo on the print ad can provide the future televised CR\overline{A}V ad viewer with a clue as to which ad in the indicated CR\overline{A}V pod is the ad for which the immersion query applies. This convergence methodology can be implemented over the radio, or in unison with radio, print, television, well-timed direct mail, private networks, or other broadcast media. Additionally, such a “detached” CR\overline{A}V ad can be distributed in various parts over various mass media formats.

Another exemplary form of convergence is the utilization of the bandwidth provided over a high definition signal. This bandwidth can be divided into multiple signals, which can include data, Internet, radio, and televised content. Multiple-channel use of this bandwidth can provide delivery of normal or high definition televised or radio CR\overline{A}V ads, while also providing Internet content that might include Immersion Verification Queries. Similarly, the Internet signal might include CR\overline{A}V ads (stream, display, or banner with video and/or audio vignettes). As indicated above, those Internet CR\overline{A}V ads can utilize the same Immersion Verification Queries as other cross-media CR\overline{A}V ads in the marketplace. Additionally, the multiple media formats can provide clues to viewers of televised CR\overline{A}V ads as to which ad or ads in a scheduled televised pod will be subject to immersion verification.

Another exemplary form of convergence comprises “back channel” technology, which provides a data feed from television set top boxes or private video recorders (“PVRs”). The set top boxes and PVRs receive broadcast content signal over a satellite or cable network and display the signal on a monitor. The monitor can comprise a TV. Consumers can access the back channel of the set top boxes or PVRs to send data from the set top boxes or PVRs to a third party. This back channel signal can be delivered by a second signal source. The second signal source can comprise broadband or dial-up Internet access, telephone, cable, or satellite. The back channel signal also can provide two-way communication. Accordingly, immersion verification, registration, and response/interaction can be performed utilizing the back channel capabilities of the set top boxes or PVRs.

For set top boxes and PVRs, CR\overline{A}V ads (or elements of CR\overline{A}V ads) can be delivered to the consumer via a convergence of mass media formats. For example, the alert and vignette can be delivered via television broadcast, while the immersion verification query and interaction elements can be delivered via Internet.

In an exemplary embodiment, while watching a CR\overline{A}V ad, the consumer can press a button on the set top box, PVR, or the remote control, which opens a second CR\overline{A}V ad. The second CR\overline{A}V ad can comprise a display ad or even full motion video and can provide some or all of the elements of the on-air CR\overline{A}V ad. That exemplary embodiment can expose the consumer to a second branded CR\overline{A}V advertisement.

Those skilled in the art will recognize that the present invention applies to any mass media broadcast network and that new types of delivery technologies can serve as new mass media platforms for the delivery of content and ads, including CR\overline{A}V ads. Those future media will form part of the CR\overline{A}V ad delivery and interaction system and will be able to participate in the cross-media convergence methodologies discussed above.

Interactive Remote Query-Response Device

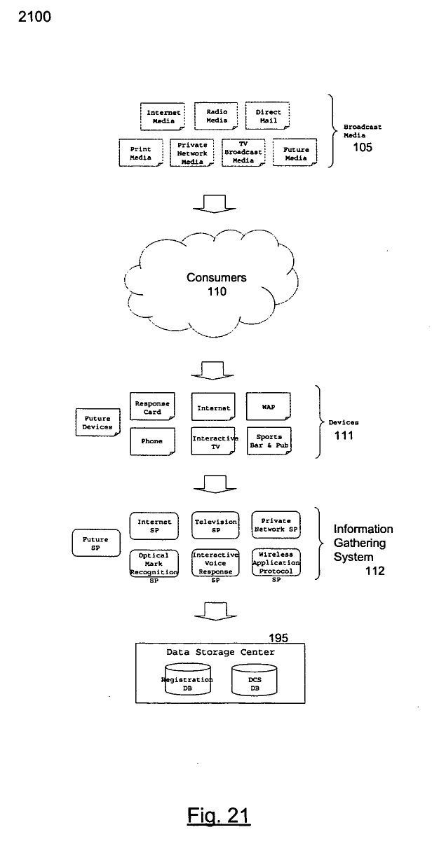

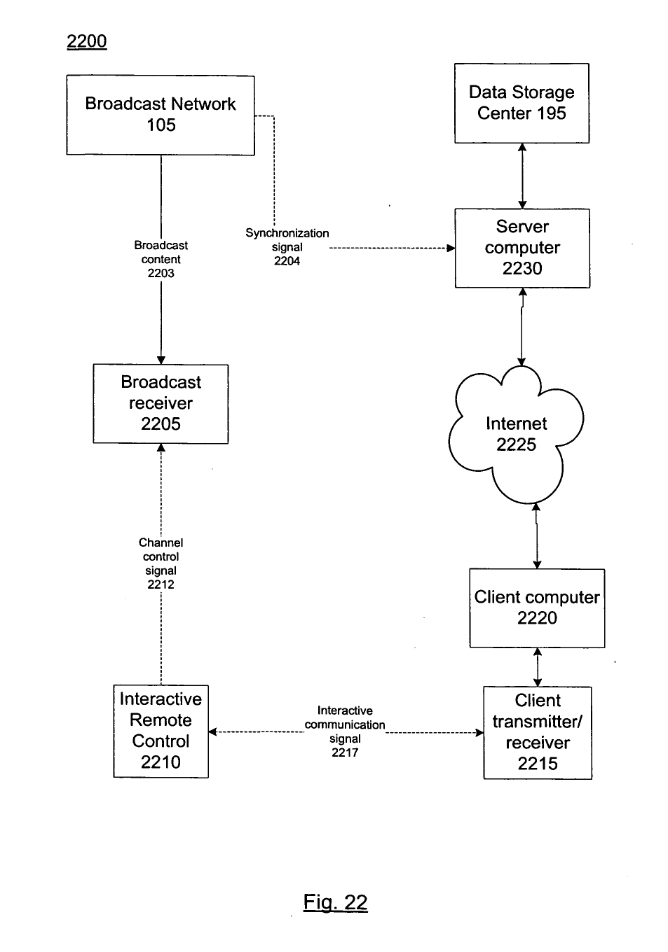

FIG. 22 is a block diagram depicting a system 2200 for remotely interacting with broadcast content according to an exemplary embodiment of the present invention. In one exemplary embodiment of the present invention, a method and/or a system for substituting media content, as discussed in further detail with reference to FIGS. 73-76, comprises an element, step, technology, or other item that FIG. 22 illustrates.

As shown in FIG. 22, the broadcast network 105 broadcasts content 2203 to a broadcast receiver 2205. In an exemplary embodiment, the broadcast network 105 comprises a broadcast television network 120, and the broadcast receiver 2205 comprises a television of a recipient (consumer 110). In an alternative exemplary embodiment, the broadcast network 105 comprises a cable network 135, and the broadcast receiver 2205 comprises either a television receiving the cable input directly or a cable tuner set-top box that receives the cable input and presents the broadcast content 2203 on a television. In another alternative exemplary embodiment, the broadcast network 105 comprises a satellite network 140, and the broadcast receiver 2205 comprises a satellite receiver that receives the broadcast content 2203 and presents the broadcast content 2203 on a television. In other exemplary embodiments, the broadcast network 105 can comprise a broadcast radio network, and the broadcast receiver 2205 can comprise a radio receiver; or the broadcast network 105 can comprise a server communicating streaming audio or video, and the broadcast receiver 2205 can comprise a personal computer connected to the server via a distributed computer network, such as the Internet. Other broadcast networks and receivers are within the scope of the present invention.

A server computer 2230 communicates a query to a client computer 2220 via a distributed computer network. The query comprises a question about a selected portion of the broadcast content 2203. As shown in FIG. 22, the network can comprise the Internet 2225. In exemplary embodiments, the client computer 2220 can comprise a personal computer, a laptop computer, or a personal digital assistant (PDA). In other exemplary embodiments, the client computer 2220 can comprise a cable or satellite set-top box, a video cassette recorder, or a personal video recorder (PVR). In those embodiments, the client computer 2220 also can comprise the broadcast receiver 2205.

The client computer 2220 communicates the query to a client transmitter/receiver 2215. The client transmitter/receiver 2215 transmits an interactive communication signal 2217 to an interactive remote control 2210, which comprises the interactive remote query-response device. The interactive communication signal 2217 can comprise the query received from the server computer 2230. Additionally, the interactive communication signal 2217 can comprise a synchronization signal 2204 (discussed below) or other information.

In an exemplary embodiment, the client transmitter/receiver 2215 can be an integral component of the client computer 2220. In an alternative exemplary embodiment, the client transmitter/receiver 2215 can comprise a separate component coupled to the client computer 2220. The client transmitter/receiver 2215 can comprise a single component performing both transmitting and receiving functions. Alternatively, the client transmitter/receiver 2215 can comprise separate components that perform the respective transmitting and receiving functions. For example, for a PC-based implementation, the client computer 2220 can be coupled to the client transmitter/receiver 2215 via the client computer's 2220 USB, serial, or other ports, via a card installed in a card slot, or via an Ethernet coupled to the client computer 2220. Throughout this specification, reference to a “client transmitter/receiver” 2215 refers to any of those exemplary embodiments discussed above.

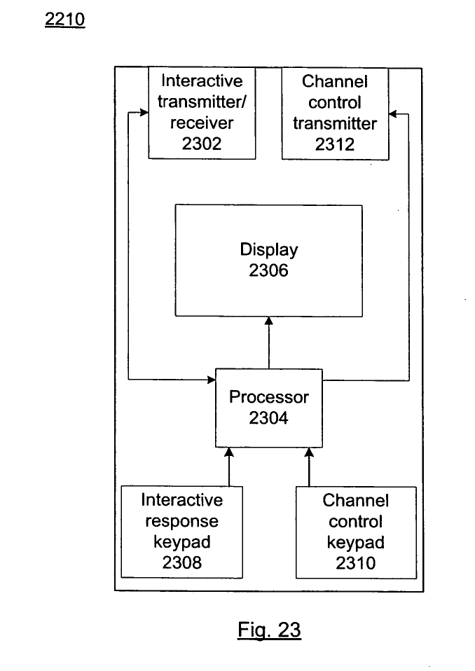

The interactive remote control 2210 receives the interactive communication signal 2217 and presents the query to a recipient operating the interactive remote control 2210. The interactive remote control 2210 will be described with reference to FIGS. 22 and 23. FIG. 23 is block diagram depicting the interactive remote control 2210 according to an exemplary embodiment of the present invention.

In one exemplary embodiment of the present invention, a method and/or a system for substituting media content, as discussed in further detail with reference to FIGS. 73-76, comprises an element, step, technology, or other item that FIG. 23 illustrates.

Using the interactive remote control 2210, a recipient of the broadcast content 2203 can tune the broadcast receiver 2205 to the station channel upon which the broadcast content 2203 will be presented. In an exemplary embodiment, the recipient can input the station channel to a processor 2304 of the remote control 2210 via an input device, such as a channel control keypad 2310. The processor 2304 generates a channel control signal 2212 comprising instructions to tune the broadcast receiver 2205 to the station channel. Then, a channel control transmitter 2312 transmits the channel control signal 2212 to the broadcast receiver 2205, thereby tuning the broadcast receiver 2205 to the station channel.

The channel control keypad 2310 can allow the interactive remote control 2210 to perform remote control functions for a television or other multi-media devices. The multi-media devices can comprise cable boxes, digital satellite set-top boxes, PVR controls, and audio receiver and amplifier controls. The interactive remote control 2210 can comprise a “Universal Remote,” with numerous device control codes stored within a memory (not shown) during the manufacturing process. Additionally, the interactive remote control 2210 can learn the remote control functions, utilizing conventional technology used in “learning remotes.” The interactive remote control 2210 also can download remote control codes from the Internet for storage in the memory, thereby allowing the recipients to easily update the codes as new hardware is added to the home.

An interactive transmitter/receiver 2302 receives the interactive communication signal 2217 transmitted from the client transmitter/receiver 2215 and communicates the interactive communication signal 2217 to the processor 2304. The processor 2304 parses the query from the interactive communication signal 2217 and presents the query on a display 2306. In exemplary embodiments, the display 2306 comprises an LED or LCD display, with or without backlighting. Alternatively, the display 2306 can comprise a full color visual active matrix display of the design and specifications of those utilized with PDAs and laptop computers. The size and power requirements of the display affect the power requirements, battery specifications, and expected battery life of the interactive remote control 2210.

The client transmitter/receiver 2215 can interact with multiple interactive remote controls 2210 within a single location by referencing a unique media access control (“MAC”) address for the respective interactive remote control 2210. In that exemplary embodiment, the client computer 2220 can recognize the MAC address to determine which interactive remote control 2210, and indirectly which recipient, is interacting. Additionally, the client transmitter/receiver 2215 can transmit generic interactive communication signals 2212 that can be received by any interactive remote control 2210 within range.

Transmissions between the client transmitter/receiver 2215 and the interactive transmitter/receiver 2302 can comprise signals using the same or different format as that used by the channel control transmitter 2312. For example, radio frequency (RF), infrared (IR), ultra wide band (UWB), or other methods can be used to transmit the interactive communication signal 2217 and the channel control signal 2212.

The recipient operating the interactive remote control 2210 can respond to the query directly through the interactive remote control 2210. The recipient can input a response to the processor 2304 via an input device, such as an interactive response keypad 2308. In an exemplary embodiment, the interactive response keypad 2308 comprises a complete alpha/numeric keyboard-type keypad. In an alternative exemplary embodiment, the interactive response keypad 2308 comprises multiple choice response buttons. In that embodiment, the recipient can input a response to a multiple choice question by selecting the corresponding multiple choice button. Thus, the interactive response keypad 2308 can comprise simple keys for multiple choice responses and can be extended to include a full “QWERTY” keyboard with numerals, symbols, and fully functional arrow keys and special function keys customized for the interactive response process. In another exemplary embodiment, the interactive response keypad 2308 can comprise “soft buttons” corresponding to adjacent information presented on the display 2306. Those soft buttons can provide one-touch entry by the recipient of pre-programmed or on-screen interactive responses (such as multiple choice letters or selections), or to store pre programmed macros relative to the interaction (i.e., identification numbers that allow multiple users to log into and utilize the interactive remote control 2210). In other exemplary embodiments, the input device for inputting the response to the query can comprise a touch screen, a pressure sensitive screen operated by a stylus, a joystick, or other suitable device for inputting the query response into the interactive remote control 2210.

In an exemplary embodiment, the interactive response keypad 2308 and the channel control keypad 2310 can comprise separate components of the interactive remote control 2210. In an alternative exemplary embodiment, the interactive response keypad 2308 and the channel control keypad 2310 can comprise a single component of the interactive remote control 2210. In that case, the interactive remote control 2210 can comprise a selector button (not shown) to switch between an interactive response function and a channel control function.

The interactive transmitter/receiver 2302 transmits the response input by the recipient to the client transmitter/receiver 2215 via an interactive communication signal 2217. In an exemplary embodiment, the interactive transmitter/receiver 2302 comprises a single component performing both transmitting and receiving functions. In an alternative exemplary embodiment, the interactive transmitter/receiver 2302 comprises separate components that perform the respective transmitting and receiving functions. Throughout this specification, reference to an “interactive transmitter/receiver” 2302 refers to either of those exemplary embodiments.

The client transmitter/receiver 2215 communicates the recipient's response received from the interactive transmitter/receiver 2302 to the client computer 2220. The client computer 2220 communicates the recipient's response to the server computer 2230 via the Internet 2225. The server computer 2230 communicates the recipient's response to the data storage center 195.

The data storage center 195 determines whether the recipient's response comprises a correct reply to the query. Then, the data storage center 195 awards a prize to a recipient that submits a response comprising a correct reply to the query. Each response comprising a correct reply to the query can indicate that the recipient providing the response was exposed to at least the selected portion of the broadcast content 2203 addressed in the query. In an alternative exemplary embodiment, the server computer 2230 can comprise the data storage center 195 and can perform the functions of the data storage center 195.

Presentation of the query on the interactive remote control 2210 can be synchronized with presentation of the broadcast content 2203 on the broadcast receiver 2205. The broadcast network 105 can communicate a synchronization signal 2204 to the server computer 2230. The synchronization signal 2204 can comprise information indicating the broadcasting time at which the broadcast network 105 will broadcast the broadcast content 2203. The synchronization signal 2204 also can comprise the station channel upon which the broadcast content 2203 will be presented.

In an exemplary embodiment, the server computer 2230 can communicate the query to the client computer 2220 based on the broadcasting time in the synchronization signal 2204. Accordingly, the server computer 2230 can control the time at which the interactive remote control 2210 presents the query by controlling the time at which the server computer 2230 communicates the query to the client computer 2220.

In an alternative exemplary embodiment, the server computer 2230 can communicate the synchronization signal to the client computer 2220 via the Internet 2225. Then, the client computer 2220 can transmit the query to the interactive remote control 2210 via the client transmitter/receiver 2215 based on the broadcast time in the synchronization signal 2204. For example, the client computer 2220 can communicate the query at the broadcast time indicated in the synchronization signal 2204. In that case, the interactive remote control 2210 will display the query in synchronization with presentation of the broadcast content 2203 on the broadcast receiver 2205. Alternatively, the broadcasting time information in the synchronization signal 2204 can include a delay to allow presentation of the query on the interactive remote control 2210 at a desired time after presentation of the broadcast content 2203 on the broadcast receiver 2205. Accordingly, the client computer 2220 can control the time at which the interactive remote control 2210 presents the query by controlling the time at which the client transmitter/receiver 2215 transmits the query to the interactive remote control 2210, based on the information in the synchronization signal 2204.

In another alternative exemplary embodiment, the client computer 2220 can transmit the synchronization signal 2204 to the interactive remote control 2210 via the client transmitter/receiver 2215. In that case, the processor 2304 can present the query on the display 2306 based on the broadcasting time information in the synchronization signal 2204. Accordingly, the processor 2304 can control the time at which the interactive remote control 2210 presents the query by controlling the time at which the query is presented on the display 2306.

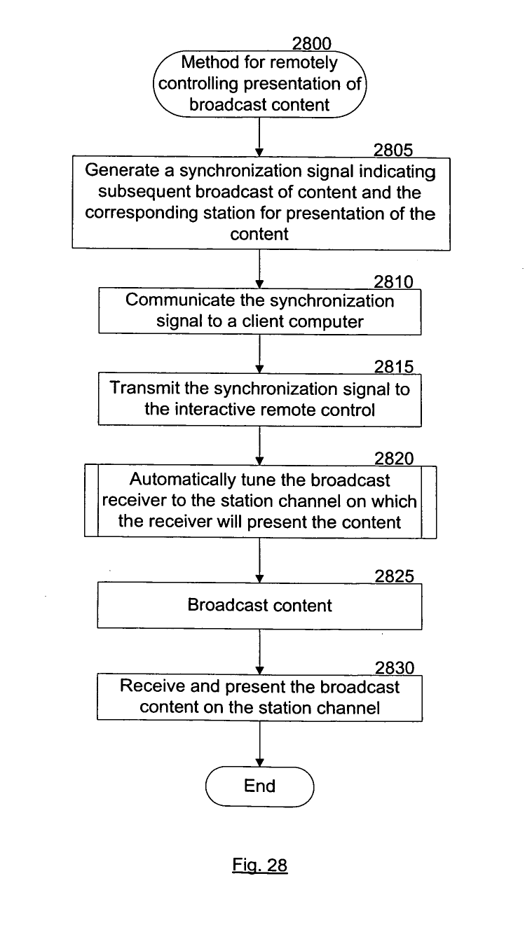

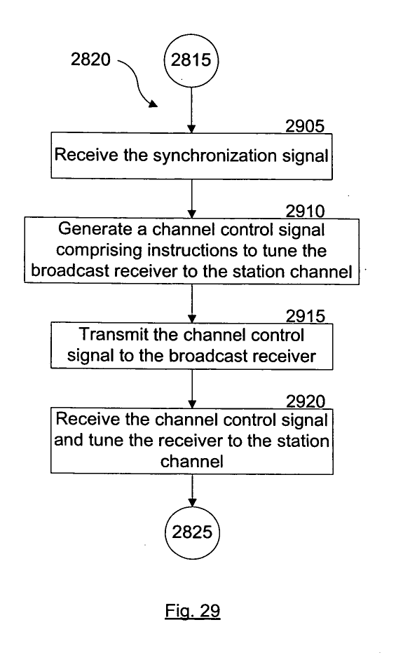

In an exemplary embodiment, the server computer 2230 (or the web site presented by the server computer 2230) also can notify the recipient via the display 2306 of the interactive remote control 2210 of desirable content available on other television channels. The desirable content can comprise CR\overline{A}V ads being presented on different networks at different times. Alternatively, the desirable content can comprise any pre-selected content, such as breaking news, selected sports teams, selected entertainers, selected TV shows, or other content for which the recipient requested notification of its broadcast. Accordingly, the recipient can change channels to the view the desirable content, in response to the notification received from the server computer 2230. As discussed with reference to FIG. 28, the interactive remote control 2210 can automatically tune the broadcast receiver 2205 to the station channel on which the desirable content will be presented, in response to the notification received from the server computer 2230. Thus, the recipient can pre-select content for which the recipient desires notification of its broadcast. When the server computer 2230 detects broadcasting or subsequent broadcasting of the pre-selected content, the server computer 2230 can generate and communicate a synchronization signal 2204 comprising an identification of the content, the broadcast time, and the broadcast station channel. The display 2306 presents the information from the synchronization signal. Then, the recipient can tune the broadcast receiver 2205 to the desired station channel to view the pre-selected content. Alternatively, the interactive remote control 2210 can automatically tune the broadcast receiver 2205 to the desired station channel for presentation of the pre-selected content. The recipient can configure the interactive remote control for either manual or automatic operation.

The client transmitter/receiver 2215 can interact with multiple interactive remote controls 2210 within a single location by referencing a unique MAC address of the respective interactive remote control 2210. In that exemplary embodiment, the client computer 2220 can recognize the MAC address to determine which interactive remote control 2210, and indirectly which recipient, is interacting.

A MAC address comprises a hardware address that uniquely identifies each node on a network. When a recipient registers with CR\overline{A}V, the recipient provides his demographics (age, sex, address, salary, education, etc.) to obtain a registration number. Then, the user associates the MAC address of his interactive remote control 2210 with his registration number. Multiple recipients can use the same interactive remote control 2210 based on their individual registration numbers and the MAC address. For example, a family of four can each have different registration numbers. Each time one of the family members logs into the server computer 2230 via the interactive remote control 2210, the server computer 2230 can identify the particular individual based on the registration number. Accordingly, the server computer 2230 can communicate queries about the broadcast content 2203 based on the demographics of the family member that is currently using the interactive remote control 2210.

In an alternative exemplary embodiment, the server computer 2210 can communicate generic queries that are not based on the demographics of the individual recipients. Accordingly, non-registered (and registered) recipients can receive the queries and respond. Additionally, the broadcast content 2203 can comprise the query, and the recipient can respond to that query via the interactive remote control 2210.

The exemplary embodiment illustrated in FIG. 22 depicts a single recipient interacting with the broadcast content 2203 using the interactive remote control 2210. However, multiple recipients can simultaneously receive and interact with the broadcast content 2203 presented on multiple broadcast receivers 2205 by connecting multiple client computers 2220 to the server computer 2230 and by coupling multiple interactive remote controls 2210 to the multiple client computers 2220.

The exemplary embodiment illustrated in FIG. 22 depicts a “two-part” interactive television process, where the broadcast network 105, utilizing existing broadcast technology and infrastructure, broadcasts the interactive content (and queries) to the recipients (consumers 110), and the recipients respond via the Internet-connected information gathering system. The recipients, utilizing the interactive remote control 2210 connected to the Internet, send query responses to the web site on the sever computer 2230 and receive/interact with any other queries sent to the recipient via the Internet 2225. The Internet web site on the server computer 2230 can collect, process, or data harvest the responses, or can send that information to the data storage center 195 (as in the CR\overline{A}V interactive ad process). Additionally, a third party “synchronization service” can synchronize the posting of queries and follow-up queries to the broadcast content 2203, ensuring that timely and accurate information is sent and collected through the interactive remote control 2210. In some instances, the synchronization service can be automated by the Promoter, television network, cable network, satellite network, or server computer, or the broadcaster can provide those services on their own, manually or in an automated manner.

For an exemplary embodiment, the interactive remote control 2210 provides interactive television services as its primary function. The interactive remote control 2210 optionally allows the recipient to remotely control a television or home theater system to control the power, volume levels and channels being viewed on the broadcast receiver 2205. The interactive remote control 2210 can utilize two integrated communication transmitters—one to interact with the client computer 2220 (i.e., utilizing RF), and one to transmit channel control signals 2212 (i.e., utilizing IR). The same or different keys or buttons on the interactive remote control 2210 can be utilized to enter interaction input (query responses) as well as television controls. Such an interactive remote control 2210, serving only to provide interactive television services along with television remote control functions, can be constructed and sold at prices that will attract mass consumer purchases.

In an exemplary embodiment, the client computer 2220 can comprise a cable set-top box or satellite receiver, which performs the separate, dual functions of the client computer 2220 and the broadcast receiver 2205. The cable set-top box or satellite receiver can comprise a back channel that communicates information over a telephone or Internet connection to the server computer 2230. That back channel is different from the channel or medium used to broadcast the content from the broadcast network 105 to the broadcast receiver 2205 component of the cable set-top box or satellite receiver.

Other components (not shown) of the interactive remote control 2210 comprise an internal rechargeable (or replaceable) battery system sufficient for untethered operation from a hard-wired power source. The interactive remote control 2210 also can comprise charging contact points for connecting to a charging cradle, or an alternate DC power plug, to allow periodic charging of the device. Alternatively, the interactive remote control 2210 can comprise a removable battery compartment, which can utilize disposable or rechargeable batteries. The interactive remote control 2210 can comprise sufficient memory and processing power to conduct calculations, interactive events, and remote control functions. The interactive remote control 2210 can allow for future expansion through one or more card slots (for the addition of PMCIA cards or flash memory cards, etc.), as well as the ability to add new keyboard skins to allow special interactive applications that may be introduced in the future.

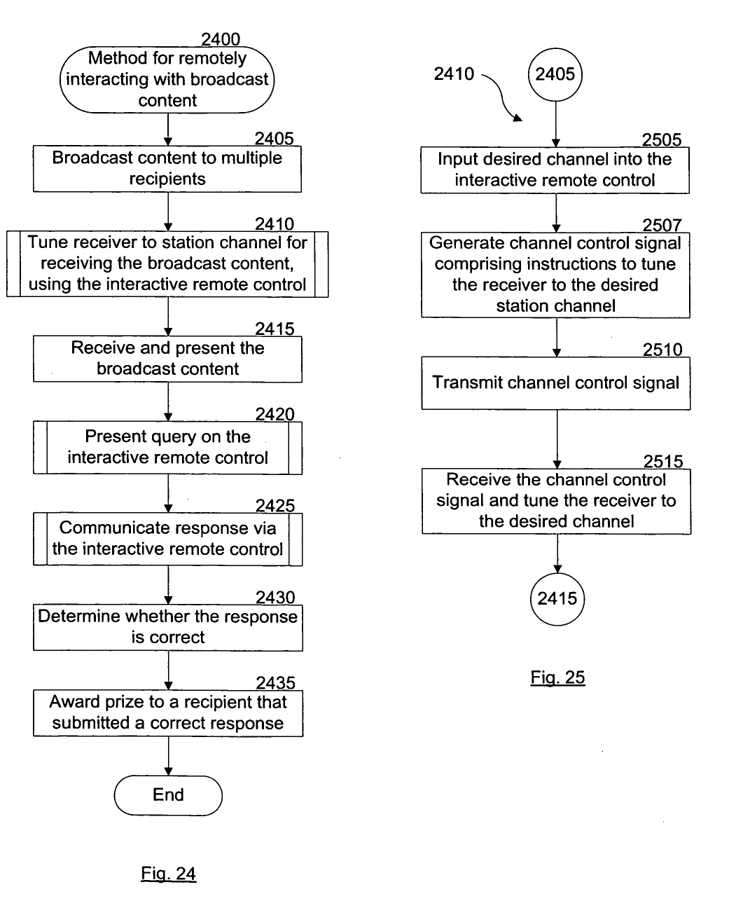

FIG. 24 is a flowchart depicting a method 2400 for remotely interacting with broadcast content 2203 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 24 illustrates.

The method 2400 will be described with reference to FIGS. 22, 23, and 24. In step 2405, the broadcast network 105 broadcasts content 2203 to multiple recipients. In step 2410, the interactive remote control 2210 tunes the broadcast receiver 2205 to the desired station channel for receiving the broadcast content 2203. Step 2410 will be discussed in more detail with reference to FIG. 25. Additionally, an alternative exemplary method for tuning the receiver to the desired channel will be described with reference to FIG. 28.

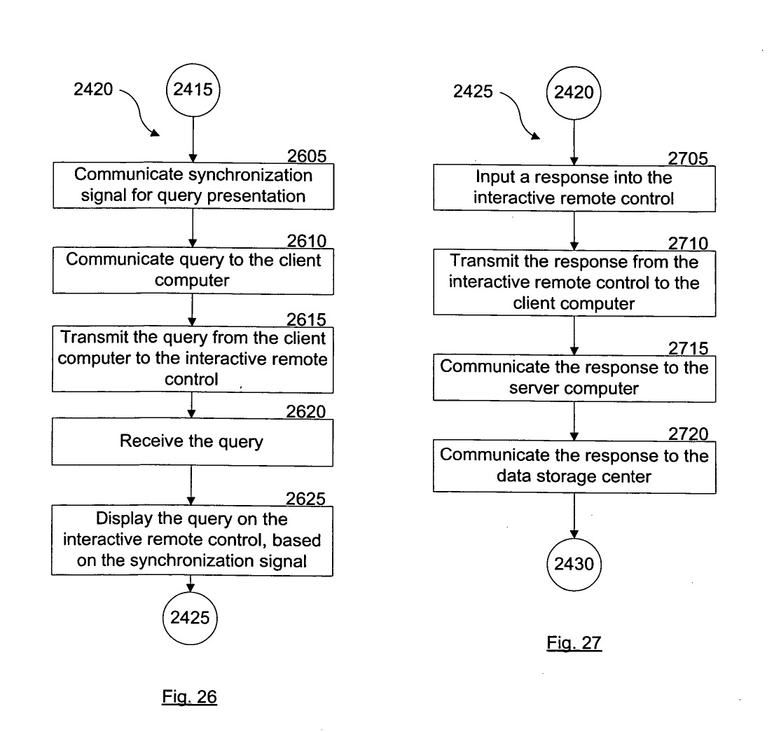

In step 2415 the broadcast receiver 2205 receives and presents the broadcast content 2203. In step 2420, the query is presented on the interactive remote control 2210. Step 2420 will be discussed in more detail with reference to FIG. 26. Alternatively, the query can be presented on the broadcast receiver 2205 as part of the broadcast content 2203.

In step 2425, the recipient communicates a response to the query via the interactive remote control 2210. Step 2425 will be discussed in more detail below with reference to FIG. 27. In step 2430, the data storage center 195 determines whether the recipient's response comprises a correct reply to the query. Then, in step 2435, the data storage center 195 awards a prize to a recipient that submitted a response comprising a correct reply to the query. Each response comprising a correct reply to the query indicates that the respective responding recipient was exposed to the selected portion of the content about which the query asked a question.

The method 2400 can proceed in an online manner whereby a dynamic, real time exchange of information occurs between the user and the data storage center 195 with the interactive remote control 2210 functioning as the user interface. A user's entry into the interactive remote control 2210 can transmit to the data storage center 195 for processing and essentially immediate composition of a return message. The return message can transmit to the interactive remote control 2210 for display within one second or within ten seconds from the time of the user's entry, for example.

FIG. 25 is a flowchart depicting a method 2410 for tuning the broadcast receiver 2205 to the desired station channel according to an exemplary embodiment of the present invention, as referred to in step 2410 of FIG. 4.

In one exemplary embodiment of the present invention, a method and/or a system for substituting media content, as discussed in further detail with reference to FIGS. 73-76, comprises an element, step, technology, or other item that FIG. 25 illustrates.

The method 2410 will be described with reference to FIGS. 22, 23, and 25. In step 2505, the recipient inputs the desired station channel into the interactive remote control 2210 via the channel control keypad 2310.

In step 2507, the processor 2304 generates a channel control signal 2212 comprising instructions to tune the broadcast receiver 2205 to the station channel input by the recipient via the channel control keypad 2310. Then, in step 2510, the channel control transmitter 2312 transmits the channel control signal 2212 to the broadcast receiver 2205. In step 2515, the broadcast receiver 2205 receives the channel control signal 2212 and tunes to the desired station channel based on the instructions in the channel control signal 2212. The method then proceeds to step 2415 (FIG. 24).

FIG. 26 is a flowchart illustrating a method 2420 for presenting the query on the interactive remote control 2210 according to an exemplary embodiment of the present invention, as referred to in step 2420 of FIG. 4. In one exemplary embodiment of the present invention, a method and/or a system for substituting media content, as discussed in further detail with reference to FIGS. 73-76, comprises an element, step, technology, or other item that FIG. 26 illustrates.

The method 2420 will be described with reference to FIGS. 22, 23, and 26. In step 2605, the broadcast network 105 communicates the synchronization signal 2204 for presentation of the query about a selected portion of the broadcast content 2203. In an alternative exemplary embodiment, the server computer 2230 can generate and communicate the synchronization signal 2204. The synchronization signal 2204 can comprise information indicating a broadcasting time at which the broadcast content 2203 will be presented on the broadcast receiver 2205, as well as the station channel upon which the broadcast receiver 2205 will present the broadcast content 2203. The synchronization signal also can comprise the query about a selected portion of the broadcast content 2203. Alternatively, the server computer 2230 can add the query to the synchronization signal 2204.

In step 2610, the server computer 2230 communicates the synchronization signal 2204 to the client computer 2220 via the Internet 2225. In step 2615, the client computer 2220 transmits the synchronization signal 2204 through the client transmitter/receiver 2215 to the interactive remote control 2210 via an interactive communication signal 2217.

In step 2620, the interactive remote control 2210 receives the interactive communication signal 2217 comprising the synchronization signal 2204 via the interactive transmitter/receiver 2302. Then, in step 2625, the processor 2304 parses the query from the interactive communication signal 2217 and displays the query on the display 2306 based on the broadcasting time in the synchronization signal 2204.

In an exemplary embodiment, the interactive remote control 2210 displays the query based on the broadcasting time as a result of actions from the server computer 2230. In that case, the server computer 2230 communicates the query to the client computer 2220 based on the broadcasting time information in the synchronization signal 2204. Accordingly the query is communicated to the interactive remote control 2210 at the appropriate broadcasting time for synchronization with presentation of the broadcast content 2203 on the broadcast receiver 2205.

In an alternative exemplary embodiment, the interactive remote control 2210 displays the query based on the broadcasting time as a result of actions from the client computer 2220. In that case, the client computer 2220 transmits the query to the interactive remote control 2210 based on the broadcast time information in the synchronization signal 2204. Accordingly, the client computer 2220 transmits the query to the interactive remote control 2210 at the appropriate time for synchronization with presentation of the broadcast content 2203 on the broadcast receiver 2205.

In another alternative exemplary embodiment, the interactive remote control 2210 displays the query based on the broadcasting time as a result of actions from the processor 2304 of the interactive remote control 2210. In that case, the interactive remote control 2210 receives the synchronization signal 2204 and the query via the interactive communication signal 2217. Then, the processor 2304 determines the appropriate time to present the query on the display 2306 based on the broadcast time information from the synchronization signal 2204. Accordingly, the processor 2304 presents the query on the display 2306 at the appropriate time for synchronization with presentation of the broadcast content 2203 on the broadcast receiver 2205.

Presenting the query “in synchronization with” presentation of the broadcast content 2203 comprises presenting the query based on the broadcasting time of the broadcast content 2203. In that regard, the query can be presented simultaneously with presentation of the broadcast content 2203, at a predetermined time prior to presentation of the broadcast content 2203, or at a predetermined time after presentation of the broadcast content 2203.

Referring back to step 2625 in FIG. 26, the method proceeds from step 2625 to step 2425 (FIG. 24).

FIG. 27 is a flowchart depicting a method 2425 for communicating a response to the query via the interactive remote control 2210 according to an exemplary embodiment of the present invention, as referred to in step 2425 of FIG. 4.

In one exemplary embodiment of the present invention, a method and/or a system for substituting media content, as discussed in further detail with reference to FIGS. 73-76, comprises an element, step, technology, or other item that FIG. 27 illustrates.

The method 2425 will be described with reference to FIGS. 22, 23, and 27. In step 2705, the recipient inputs a response into the processor 2304 of the interactive remote control 2210 via the interactive response keypad 2308. Then, in step 2710, the interactive transmitter/receiver 2302 of the interactive remote control 2210 transmits the recipient's response from the interactive remote control 2210 to the client transmitter/receiver 2215 of the client computer 2220. In step 2715, the client computer 2220 communicates the recipient's response to the server computer 2230 via the Internet 2225. In step 2720, the server computer 2230 communicates the recipient's response to the data storage center 195. The method then proceeds to step 2430 (FIG. 4).

An on-line, real-time connection to the Internet program that allows the recipient to utilize an interactive remote control 2210 is an optimal utilization of the process and device. However, the client computer 2220 also can download its interactive content on a time-delayed basis, and utilizing time-stamped sensitive, encrypted software, can simulate real-time distribution of interactive information to the interactive remote control 2210. That software can be designed so that the recipient cannot access the interactive data unless it is unencrypted on a time-sensitive basis, synchronizing the distribution of the interactive content (queries) with the related interactive broadcast content 2203. The client computer 2220 can store the responses, optionally attaching accurate time stamped information (which also may be encrypted to prevent tampering by the recipient or others), to verify timely responses. Thereafter, the client computer 2220 can forward the responses to the server computer 2230 (information gathering system 112) when a periodic connection to the Internet 2225 is established. In one exemplary embodiment, the broadcast content 2203 can provide the recipient with a password that, when entered on the interactive remote control 2210 or client computer 2220, unlocks or unencrypts the information stored in the interactive remote control 2210 or client computer 2220. Accordingly, a real-time Internet connection is not required during interaction, which also creates less demand on the Internet, as well as telephone land lines used by dial-up Internet service recipients.

While interactive television broadcast of CR\overline{A}V ads is one application for the use of this system and process, as well as for the use of the interactive remote control 2210, those skilled in the art will recognize that any type of broadcast content, such as radio broadcasting, could benefit from the use of this method of providing interactive content, and the interactive remote control 2210 can be used to interact with sound-only, broadcast content as well.

FIG. 28 is a flowchart depicting a method 2800 for remotely controlling presentation of broadcast content according to an exemplary embodiment of the present invention. In one exemplary embodiment of the present invention, a method and/or a system for substituting media content, as discussed in further detail with reference to FIGS. 73-76, comprises an element, step, technology, or other item that FIG. 28 illustrates.

The method 2800 will be described with reference to FIGS. 22, 23, and 28. In step 2805, a synchronization signal 2204 is generated. The synchronization signal 2204 indicates a subsequent (or current) broadcast time of the broadcast content 2203 and the corresponding station channel for presentation of the broadcast content 2203. As shown in FIG. 22, the broadcast network 105 can generate the synchronization signal 2204. In an alternative exemplary embodiment, the data storage center 195 or the server computer 2230 can generate the synchronization signal 2204.

In step 2810, the server computer 2230 communicates the synchronization signal to the client computer 2220 via the Internet 2225 based on the broadcasting time in the synchronization signal. In step 2815, the client computer 2220 transmits the synchronization signal 2204 to the interactive remote control 2210 via the client transmitter/receiver 2215. Then, in step 2820, the interactive remote control 2210 automatically tunes the broadcast receiver 2205 to the station channel in which the receiver will present the broadcast content 2203. Step 2820 will be discussed in more detail below with reference to FIG. 29.

In step 2825, the broadcast network 105 broadcasts the content 2203 to multiple recipients (consumers 110). In step 2830, the broadcast receiver 2205 receives and presents the broadcast content 2203 on the station channel. As illustrated in FIG. 28, the method 2800 can automatically tune the broadcast receiver 2205 to the desired station channel at the appropriate time for receiving the broadcast content 2203.

As discussed above, the server computer 2230 communicates the synchronization signal at the appropriate time based on the broadcasting time in the synchronization signal. In an alternative exemplary embodiment, the client computer 2220 can transmit the synchronization signal at the appropriate time based on the broadcasting time in the synchronization signal. In another alternative exemplary embodiment, the processor 2304 can generate the channel control signal 2212 at the appropriate time based on the broadcasting time in the synchronization signal.

FIG. 29 is a flowchart depicting a method 2820 for tuning the broadcast receiver 2205 to the station channel on which the receiver will present the broadcast content 2203 according to an exemplary embodiment of the present invention, as referred to in step 2820 of FIG. 28.

In one exemplary embodiment of the present invention, a method and/or a system for substituting media content, as discussed in further detail with reference to FIGS. 73-76, comprises an element, step, technology, or other item that FIG. 29 illustrates.

The method 2820 will be described with reference to FIGS. 22, 23, and 29. In step 2905, the interactive transmitter/receiver 2302 of the interactive remote control 2210 receives the synchronization signal 2204 from the client transmitter/receiver 2215. In step 2910, the processor 2304 generates a channel control signal 2212 comprising instructions to tune the broadcast receiver 2205 to the station channel provided in the synchronization signal 2204.

Then, in step 2915, the channel control transmitter 2312 transmits the channel control signal 2212 to the broadcast receiver 2205. In step 2920, the broadcast receiver 2205 receives the channel control signal 2212 and tunes the receiver to the station channel, as instructed in the channel control signal 2212. The method then proceeds to step 2825 (FIG. 29).

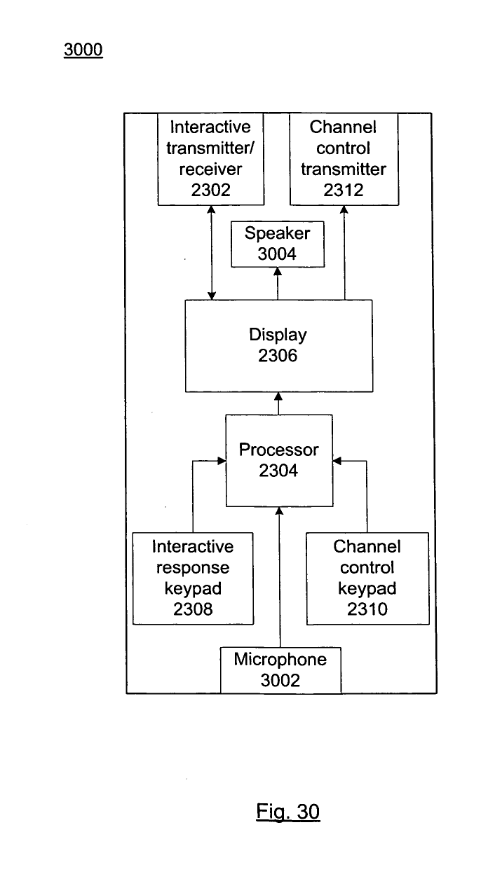

FIG. 30 is a block diagram depicting an interactive remote control 3000 according to an alternative exemplary embodiment of the present invention. In one exemplary embodiment of the present invention, a method and/or a system for substituting media content, as discussed in further detail with reference to FIGS. 73-76, comprises an element, step, technology, or other item that FIG. 30 illustrates.

As shown in FIG. 30, the interactive remote control 3000 comprises the components illustrated in FIG. 23 for the interactive remote control 2210. Additionally, the interactive remote control 3000 comprises a microphone 3002 and a speaker 3004 to allow two-way voice communication. The microphone 3002 receives voice from the recipient and communicates the recipient voice to the interactive transmitter/receiver 2302. The interactive transmitter/receiver 2302 transmits the recipient voice to the client transmitter/receiver 2215 for input into the client computer 2220. Additionally, the speaker 3004 can communicate sender voice received via the interactive transmitter/receiver 2303 from the client transmitter/receiver 2215 of the client computer 2220. Accordingly, the interactive remote control 2210 can provide two-way voice communications, thereby comprising a voice over Internet protocol (“VOIP”) telephone.

In an exemplary embodiment (not shown), the microphone 3002 and speaker 3004 can be provided by a headset, or separate earpiece and microphone, that plugs into the processor 2304.

In an exemplary embodiment, the recipient voice can be transmitted between the interactive remote control 2210 and the client transmitter/receiver 2215 in analog form for input into the client computer 2220. Then, the client computer 2220 can process the analog recipient voice using conventional VOIP software to communicate the recipient voice as a VOIP telephone call. Additionally, the client computer 2220 can receive VOIP sender voice via the Internet 2225 and can convert the sender voice to analog form. Then, the client computer 2220 can communicate the analog sender voice via the client transmitter/receiver 2215 to the interactive remote control 2210.

In an alternative exemplary embodiment, the interactive remote control 3000 can comprise an analog-to-digital converter (not shown). The analog-to-digital converter can convert the analog recipient voice to a digital signal before transmitting the digital recipient voice signal to the client transmitter/receiver 2215. Additionally, the interactive remote control 3000 can receive digital sender voice signals and can convert the digital sender voice signals to analog signals for communication via the speaker 3004. The interactive remote control 3000 also can comprise software that performs the VOIP conversion process. In that case, the interactive remote control 3000 can convert the digital recipient voice to a VOIP signal and can transmit that VOIP signal to the client transmitter/receiver 2215. Additionally, the interactive remote control 3000 can receive VOIP sender voice signals from the client transmitter/receiver 2215, convert those VOIP sender voice signals to analog signals, and communicate the analog signals via the speaker 3004.

To further enhance the desirability of the interactive remote control 2210, certain on-board functionality and hardware can be added to increase the number of tasks the device can accomplish. For example, utilizing the display and multifunction keypad and enabling the device to perform simple or complicated calculations using onboard memory and processors, can allow performance of mathematical calculations prompted by a televised, educational program or game show, which response can subsequently be transmitted from the control 2210 through the wireless connection to the computer, and subsequently to the hosting web site. The control 2210 can be linked or registered to an individual or logged-in user, such that the mathematical response can be matched with the user, who can be a student or contestant.

Additionally, or alternatively, the control 2210 can be manufactured and equipped with a card scanner (not shown), which can enable the user to “swipe” an ID or credit card through the scanner, allowing the user to either “log-in” to the control 2210, or to conduct an Internet-connected transaction. The ID card can enable multiple individuals to quickly log-in and log-out of a single control 2210, in the event of a time-sensitive CR\overline{A}V ad, such that more than one person can answer the requisite queries, logout, and then a new user can swipe an ID card, log-in, respond, and logout. In the event a user wishes to purchase something seen on a CR\overline{A}V ad, or program, or when prompted by an on-screen prompt or invitation to purchase, the use of an actual credit card, as opposed to simply typing the credit card number, provides a more secure and convenient transaction for both users and vendors.

Furthermore, the indirect Internet connection to the control 2210 can allow users to communicate over the Internet with others connected to the Internet, and with other similar device owners. Simple typed messages sent from the control 2210, using the keyboard, or multi-purpose keys that enable both device controls and communication, can enable chatting between others connected to the hosting website, or simply to the Internet. Typed information can be sent from one control 2210, through the Internet, and to the intended recipient(s), and can be viewed on the display 2306.

As discussed with reference to FIG. 30, should the control 2210 be equipped with an earpiece and microphone (which can be discretely incorporated into the control 2210), the control 2210 also can utilize new or emerging VOIP technology, which will send voice packets or streams received from one control 2210, to the client computer 2220 connected to the Internet, over the Internet, to computers also connected to the Internet, and ultimately to other users using Internet-enabled devices that allow them to accept, hear, and communicate with voice or data that is transmitted and intended for their receipt. Conventional software and hardware can enable users of the voice-enabled control 2210 to connect with traditional telephones. However, a more secure and less error-prone environment exists for VOIP between devices connected through a dedicated network, enabled for VOIP. In such an environment, such as two individuals using two controls 2210, connected through an Internet-based network designed to allow those controls 2210 (and users) to communicate, clear voice communications can be enabled, with limited or no packet loss, and at little or no cost to the users.

Indeed, with current voice recognition software, two users on opposite sides of the globe can find each other and communicate over the Internet, simply by one owner (User 1) enabling the control 2210 to communicate by “switching” to phone mode by saying “Phone” into the microphone, by then saying “Find Joe Smith” into the microphone, such that the individual named Joe Smith (who had been identified at an earlier time by User 1, such that only the specific Joe Smith can be connected) can be alerted on his control 2210 (via audible tone or ring, information displayed on the display 2306, vibration, or some combination of those or other alert methods), and Joe Smith can then talk to User 1. Long-distance charges do not apply in such a scenario, further enticing recipients to purchase controls 2210 enabled to interact with CR\overline{A}V ads and queries.

In exemplary embodiments, the interactive remote control 2210 can be enabled to control multiple audio and video devices, receive and respond to CR\overline{A}V ads or other content, “chat” or “Instant Message” with other Internet and control 2210 users, perform and optionally transmit via the Internet calculations made from the control 2210, purchase items over the Internet by swiping a credit card, and send and receive VOIP communications to other control 2210 users, Internet-connected users, or traditional land-based or wireless telephone users. The same series of connections (and hosting website) that enables interaction with CR\overline{A}V ads also can enable all other Internet-based functions conducted by the control 2210.

The interactive response keypad 2308 can be “switched” or enabled, if necessary, to allow secondary functions, such as alphanumeric “typed” functions (which can be illustrated on the display, and then “transmitted” to another user, to allow chat or instant messaging functions) or calculator functions (the process or results of which also can be transmitted to another user, or to a hosted web site that collects those calculated responses, such as an educational or gaming website). The control 2210 can be designed in a compact form factor that most closely resembles a remote control or telephone, allowing one-handed control.

In another exemplary embodiment, the interactive remote control can omit the channel control transmitter. In that case, the interactive remote control can comprise a query-response device that can display a query about a selected portion of broadcast content and can allow a recipient to input and transmit a response to the query.

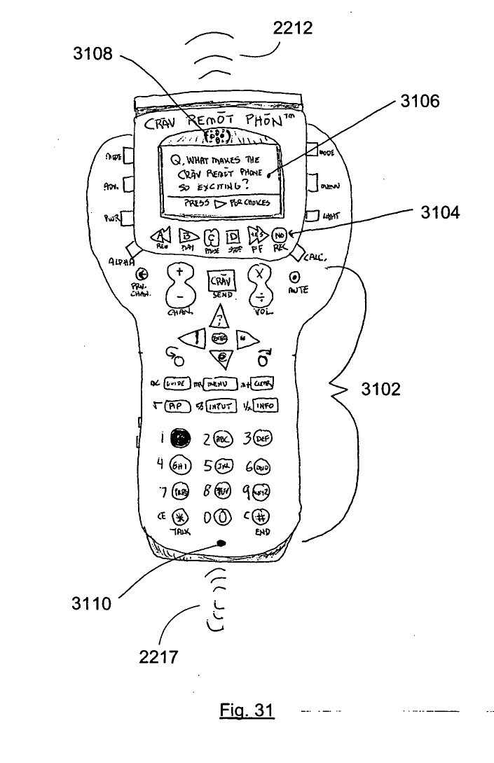

FIG. 31 illustrates the form factor of an interactive remote control 3100 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 31 illustrates.

The interactive remote control 3100 will be described with reference to FIGS. 22, 23, and 31. As illustrated, the exemplary interactive remote control 3100 can comprise a compact form factor of a conventional audio/visual remote control or telephone handset. That compact form factor can allow one-handed control by a user.

The interactive remote control 3100 comprises a primary keypad 3102 that allows a user to perform traditional remote control functions to remotely control audio-visual components. A secondary keypad area 3104 allows the user to perform ancillary remote control functions to remotely control other component functions. For example, the secondary keypad area 3104 can allow the user to control video cassette recorders, digital video disk players, personal video recorders (PVRs), or other components. Additionally, the secondary keypad area 3104 can allow the user to perform CR\overline{A}V response functions. The CR\overline{A}V response functions can comprise selecting multiple choice answers and transmitting those answers to the client computer 2220.

The interactive remote control 3100 also comprises a display 3106. The display 3106 can comprise an LED or LCD display screen, a passive or active matrix type color display, or any other suitable display. The display can present queries received by the interactive remote control 3100, responses input by the user, or other text messages.

The interactive remote control 3100 can comprise a channel control transmitter 2312 (not shown) to transmit channel control signals 2212 (or other audio-visual control signals) and an interactive transmitter/receiver 2302 (not shown) to transmit and receive interactive communication signals 2217.

In an exemplary embodiment, the push buttons in the primary keypad area 3102 can be “switched” or enabled to allow secondary functions. The secondary functions can comprise alphanumeric “typed” functions, calculator functions, or other functions. The alphanumeric typed functions can input text to the display 3106, which then can be transmitted to the remote computer 2220. The transmitted text can comprise a query response, instant messages, or other messages. The calculator functions can allow interaction with educational or gaming content that require the user to calculate responses to queries. In another exemplary embodiment, the secondary functions can comprise telephone dialing.

For telephone functions, the interactive remote control 3100 comprises an earpiece/speaker 3108 and microphone 3110. The speaker 3108 and microphone 3110 can be discreetly located on the front or rear of the device to allow two-way voice communications.

The interactive remote control 3100 also can comprise a card swipe and reader device (not shown) on one side to read magnetic strip information from a card to obtain login information or to conduct consumer transactions.

The exemplary interactive remote control 3100 illustrates a consolidated device enabled to control multiple audio and video devices, receive and respond to CR\overline{A}V ads or other content, “chat” with other Internet and interactive remote control 3100 users, perform and transmit calculations, purchase items over the Internet by swiping a credit card, and send and receive VOIP communications to and from other interactive remote control 3100 users, Internet-connected users, or traditional land-based or wireless telephone users.

As illustrated in FIG. 31, the interactive remote control 3100 can comprise the balance, weight, design, and dimensions of a conventional multi-function (“universal”) remote control for controlling audio/visual components, thereby allowing one-handed use by the operator. The appearance of the interactive remote control 3100 can comprise the appearance of a conventional remote control. Accordingly, consumers can recognize the interactive remote control 3100 as a multi-function remote control that can replace conventional remote controls for various audio/visual components, plus the additional advantage of enabling remote interaction with advertising or other broadcast content.

Consumers desire such one-handed control of their remote control device. Consumers desire a single remote control that performs multiple functions, rather than multiple remote controls that each perform a single function. The exemplary interactive remote control 3100 can provide such one-handed, multi-function control, plus the ability to interact with broadcast content. For marketing purposes, the appearance of a conventional remote control can cause consumers to recognize that the interactive remote control comprises a multi-function remote control. Upon further inspection, consumers can recognize the additional features of interaction with broadcast content and remote telephone functionality. Furthermore, if one family member is hesitant about purchasing a remote control to interact with broadcast advertisements or other content, the multi-function remote control appearance and functionality can persuade that family member to purchase the interactive remote control 3100, because the interactive remote control 3100 can replace multiple remotes owned by the family and can provide the additional interactive functionality.

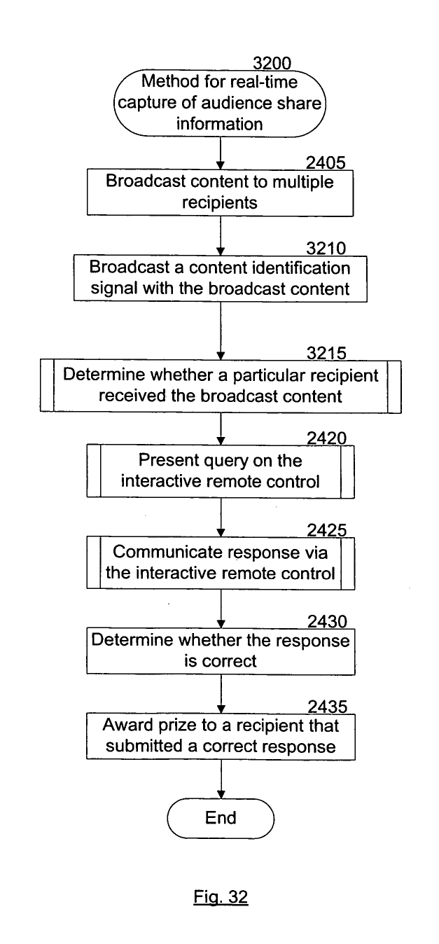

FIG. 32 is a flow chart depicting a method 3200 for real-time capturing of audience share information for broadcast content 2203 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 32 illustrates.

The method 3200 will be described with reference to FIGS. 22, 23, and 32. As illustrated in FIG. 32, the method 3200 can comprise steps described previously with reference to the method 2400 of FIG. 24.

Referring to FIG. 32, in step 2405, the broadcast network 105 broadcasts content 2203 to multiple recipients. In step 3210, the broadcast network 105 broadcasts a content identification signal with the broadcast content 2203. In an exemplary embodiment, the broadcast network 105 can embed the content identification signal in the broadcast content 2203. In alternative exemplary embodiments, the broadcast network can receive content already comprising the content identification signal and can subsequently broadcast the received content. The content identification signal can comprise information to identify the broadcast network, a channel specific to the broadcast network upon which the content is broadcast, or the specific advertising or other content being broadcast. Thus, the content identification signal can comprise one or more content information signals.

In an exemplary embodiment, the content identification signal can comprise an inaudible, high frequency signal comprising information that identifies information about the broadcast content. For example, the information can comprise the broadcast network, channel, date, time, type of content, sponsor, or other content information. Any suitable signal for conveying the content information can be used.

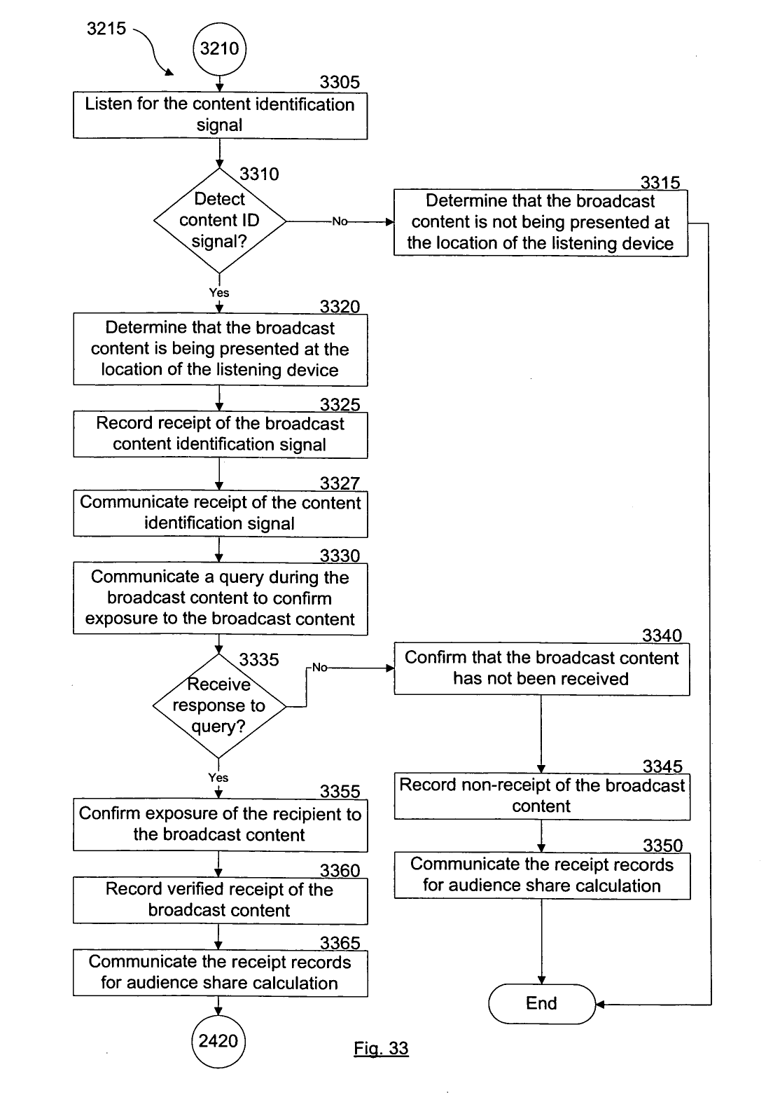

In step 3215, the method 3200 determines whether a particular recipient received the broadcast content 2203. Step 3215 will be discussed in more detail below with reference to FIG. 33.

After determining that particular recipients received the broadcast content 2203, the method 3200 follows the method 2400 to verify exposure (immersion) of the particular recipients to the broadcast content 2203. Accordingly, the method 3200 performs steps 2420-2435, discussed previously with reference to FIG. 24.

FIG. 33 is a flow chart depicting a method 3215 for determining whether a particular recipient received broadcast content 2203 according to an exemplary embodiment of the present invention, as referred to in step 3215 of FIG. 32.

In one exemplary embodiment of the present invention, a method and/or a system for substituting media content, as discussed in further detail with reference to FIGS. 73-76, comprises an element, step, technology, or other item that FIG. 33 illustrates.

The method 3215 will be described with reference to FIGS. 22, 23, and 33. In step 3305, the interactive remote control 3000 listens for the broadcast content identification signal. In an exemplary embodiment, the interactive remote control 3000 can listen for the content identification signal by monitoring sounds collected via the microphone 3002. In that embodiment, the processor 2304 can interpret sounds collected via the microphone 3002 to determine if the sounds comprise a content identification signal.

In step 3310, the interactive remote control 3000 determines whether it has detected a content identification signal. If the broadcast receiver 2205 is not turned on or is not tuned to the proper channel, then the broadcast receiver 2205 will not present the broadcast content 2203 or the content identification signal. In that case, the interactive remote control 3000 does not detect the content identification signal via its microphone 3002. Accordingly, the method branches to step 3315. In step 3315, the processor 2304 determines that the broadcast content is not being presented at its location.

If the broadcast receiver 2205 is turned on and tuned to the proper channel, then the broadcast receiver 2205 will present the broadcast content 2203 and the content identification signal. In that case, the interactive remote control 3000 can detect the content identification signal via its microphone 3002. Accordingly, the method 3215 branches from step 3310 to step 3320. In step 3320, the processor 2304 determines that the broadcast content is being presented at its location based upon receipt of the content identification signal.

In step 3325, the processor 2304 records receipt of the broadcast content identification signal. In an exemplary embodiment, the processor 2304 can record the date and time of receipt, as well as the identifying information for the broadcast content. In step 3327, the processor 2304 communicates the recorded receipt of the content identification signal to the data storage center 195 by transmitting the recorded receipt to the client transmitter/receiver 2215 via the interactive transmitter/receiver 2302. Accordingly, the data storage center 195 can determine the number of broadcast receivers 2205 that are presenting the broadcast content 2203.

If desired, the method 3215 can confirm that a recipient actually is being exposed to the broadcast content. For example, if the recipient is not in the room with the broadcast receiver, then the recipient is not being exposed to the broadcast content 2203 being presented by the broadcast receiver 2205, even though the interactive remote control 3000 located in the room is receiving the content identification signal. Accordingly, in step 3330, the server computer 2230 can communicate a confirmation query to the client computer 2220 for transmission to the interactive remote control 3000 via the client transmitter/receiver 2215. Receipt at the data storage center 195 of the content identification signal can trigger sending the confirmation query to the interactive remote control 3000 on a dynamic basis with little or no perceptible delay.

The interactive remote control 3000 can receive the transmitted confirmation query and can present the confirmation query on the display 2306. In an exemplary embodiment, the confirmation query can comprise, “Are you watching?” In other exemplary embodiments, the interactive remote control can vibrate or emit a sound to gain the recipient's attention to the confirmation query.

In one exemplary embodiment of the present invention, the steps of the method 3215 can execute in an essentially real time, online, or dynamic manner. The steps 3305, 3310, 3315, 3320, 3325, 3327, and 3330 can occur within a timeframe that maintains viewer engagement and immersion. The timeframe can be less than fifteen seconds, for example. In one exemplary embodiment of the present invention, less than two seconds elapses between the step 3305 and the step 3330.

In step 3335, the method 3215 determines whether a response to the query has been received. If the recipient is not present to receive the broadcast content 2203, then the server computer 2230 will not receive a response to the confirmation query. Accordingly, the method branches to step 3340 in which the server computer 2230 confirms that the recipient did not receive the broadcast content because the server computer 2230 did not receive a response to the confirmation query. Then, in step 3345, the server computer records that the recipient did not actually receive the broadcast content, even though the interactive remote control 3000 did detect the content identification signal. In step 3350, the server computer 2230 communicates the record of non-receipt to the data storage center 195 for audience share calculation.

If the recipient is present to receive the broadcast content 2203, then the recipient responds to the confirmation query by entering a response in the interactive remote control 3000 and by transmitting the response from the interactive remote control 3000 to the client transmitter/receiver 2215 for subsequent communication to the server computer 2230. In that case, the method 3215 branches from step 3335 to step 3355 in which the server computer 2230 verifies exposure of the recipient to the broadcast content based on receipt of the response to the confirmation query.

In an exemplary embodiment, the confirmation query can comprise additional queries communicated with, or separately from, the original confirmation query. For example, the additional confirmation query can ask the recipient to enter his demographic information or to enter demographic information for other recipients receiving the broadcast content with him. Accordingly, follow-up queries can be tailored to the demographics of particular recipients not previously registered in data storage center 195.

In step 3360, the server computer 2230 records that the recipient received the broadcast content. Then, in step 3365, the server computer 2230 communicates the recorded receipt to the data storage center 195 for audience share calculation. The method then proceeds to step 2420 (FIG. 32).

As discussed above, the method 3200 can record viewer habits of individual viewers via the interactive remote control. Additionally, if recipients log into the server computer using the interactive remote control, then the server computer can determine the demographics of individual viewers that receive the broadcast content. The method 3200 can provide real-time monitoring of viewer habits by detecting presentation of the broadcast content and forwarding that information to the data storage center for audience share calculation.

If a query regarding a specific portion of the broadcast content comprises a simple answer, such as a multiple choice answer, then a person may get the answer correct by guessing. However, the method 3200 can confirm that the recipient actually is viewing the content. Accordingly, if the recipient did not respond in step 3335 to indicate that he is receiving the content, then the method 3200 can prevent that recipient from receiving the query presented in step 2420. Accordingly, the method 3200 can confirm the immersion verification process.

In an exemplary embodiment, individual recipients can configure their respective interactive remote controls to allow capturing the audience share information or to disable that feature. In another exemplary embodiment, capturing the audience share information can be configured for full-time operation.

In an exemplary embodiment, the interactive remote control used with the method 3200 comprises each component illustrated in FIG. 30. In other exemplary embodiments, the interactive remote control can comprise more or less components than those illustrated in FIG. 30. For example, in one exemplary embodiment, the interactive remote control can comprise a query-response device that receives queries and transmits input responses to the queries, and also transmits a record of receiving the content identification signal. In another exemplary embodiment, the interactive remote control can comprise a device that transmits a record of receiving the content identification signal. Accordingly, the method 3200 can be implemented with different interactive remote controls that perform different levels of functionality.

Example of Interactive Remote Control

Exemplary embodiments of the present invention enable the following exemplary scenarios:

Mr. and Mrs. Jones, and their daughter Pam, own 3 interactive remote control devices. Their home has an always-on broadband connection to an ISP that is CR\overline{A}V enabled, and the interactive remote control devices are linked to the Internet through a client transmitter/receiver attached to a personal client computer in the study of their home.

Mr. & Mrs. Jones are watching a pre-recorded program on the family room television. The program is stored on the hard drive of a PVR device. The hard drive has stored every televised program that has aired in the last 14 days, and Mr. Jones has selected the program because he and Mrs. Jones enjoy the show. During recorded commercial breaks, either Mr. or Mrs. Jones skip over the content in thirty second increments from their individual interactive remote control devices. Mr. Jones'interactive remote control device is blue, and Mrs. Jones'is red. The Jones have an agreement that they will skip all commercials after viewing the first two seconds. If one party wants to watch the commercial, that party will hit the “rewind thirty second” button, signifying their interest in the ad. This rarely occurs.

The Jones have enabled a feature that allows the CR\overline{A}V website to notify them when a live CR\overline{A}V ad (pre-selected content) with prizes in excess of $25,000 is about to air on any cable channel. At 8:42 PM, the blue and red interactive remote control devices vibrate, and immediately after, both devices transmit a signal to the television that overrides the PVR, and places the digital cable set-top box to channel 434. Within 3 seconds, a CR\overline{A}V alert is broadcast and appears on-screen, announcing that ten fourteen day vacations for two to New Zealand will be awarded to registered CR\overline{A}V players who correctly answer the CR\overline{A}V query that follows one of the following four ads.

The Jones watch all four ads carefully. Then, on the broadcast channel and on the interactive remote control displays, a query ad appears. The broadcast query is about the soft drink ads that aired; the query on Mr. Jones'display is about the automobile ad that aired; and the query on Mrs. Jones'display is also the soft drink ad query. Ten seconds later, three multiple choice answers appear on the television screen, as well as on both interactive remote control displays. The selections are different on Mr. Jones'display, than on the broadcast channel and on Mrs. Jones's display. Mrs. Jones feels that before answering, she wishes to view the soft drink commercial again, so she “rewinds” the programming, which is stored on the PVR device, and watches the soft drink ad a second time. Mr. Jones selects choice “B” by pressing the “B” button on his interactive remote control, and then presses the “CR\overline{A}V” button, which transmits his selection to the CR\overline{A}V website, while also resetting his device to allow traditional remote control functions. Mrs. Jones watches the soft drink commercial again, locates the information that matches one of the multiple choice answers, and presses'“C” on her interactive remote control, followed by the “CR\overline{A}V” button, which transmits her selection to the CR\overline{A}V website.

The CR\overline{A}V website recognizes both the selections, and also receives with the selections unique identifier information that allows the data storage center to match each response with the query and the user identification information.

Following the responses by the Jones's, the PVR pre-recorded programming returns to the screen. However, Mrs. Jones'interactive remote control display shows a second query, which asks if she would like to receive two free cases of the new soft drink advertised on the commercial. She would only have to pay $2 for shipping and handling. She elects to accept the offer, so she presses the “YES” button, and then swipes her credit card on the card reader. The display asks for a PIN number, which she enters. Finally, the display explains that her order was received, that $2 was charged to her account under the charge name “Free Case Promo,” and that she will receive the cases and a $3 off coupon good on her next purchase of that soft drink within 10 business days.

Meanwhile, upstairs, Pam is doing her homework, which is broadcast on channel 885. She is studying various subjects. History questions are posed on screen, and multiple choice answers are displayed on her interactive remote control display. She selects and transmits her answers. The home personal computer recognizes the signal being sent from her interactive remote control device (which is camouflage colored), and transmits her choices through the CR\overline{A}V-enabled website, to a database that collects her choices and grades her responses. Pam is periodically asked mathematical questions, and her interactive remote control is enabled to perform calculations. She transmits the results of her calculations. When she gets an answer correct, her display notifies her as such. When she gets an answer wrong, the device beeps and invites her to try again. After two wrong attempts, the display will display the correct answer and also teaches the correct method of calculating the correct answer. The correct answer and explanation are transmitted from the hosting web site, through the CR\overline{A}V ISP provider, to Pam's interactive remote control device.

After she finishes her homework, Pam says “Phone” into the microphone, and then says “Find Susan.” The interactive remote control transmits the commands to the ISP, which recognizes the voice commands, opens up network connections to allow VOIP functionality, and then matches Pam's “Find Susan” command with a user registered by Pam, “Susan Rogers,” who owns an interactive remote control as well. The system recognizes that Susan Rogers is connected to the network as well. Susan's interactive remote control sounds a ring tone. Susan picks up her interactive remote control device and sees on the display that Pam Jones is trying to reach her. Susan says “Hello” into the microphone. The device recognizes that the “Hello” command in Susan's voice is to enable voice communications, and the two parties are connected and conduct a five minute VOIP conversation.

Lastly, several miles away, Grandma Jones is at her home, using her interactive remote control device (which her son purchased over the Internet, using his interactive remote control device and card scanner). Suddenly, Grandma feels a sharp pain in her chest. She immediately presses a special “Emergency” sequence of buttons on her interactive remote control. This sequence of buttons alerts her personal computer to send an emergency message to the CR\overline{A}V-enabled web site, which alerts an individual who is monitoring the web site to contact EMS providers in the area of Grandma Jones. Three minutes later, armed with Grandma Jones's medical history, EMS arrives at her home, and they begin administering medical attention. As she is placed on the stretcher and taken to the hospital, she clutches her interactive remote control to her chest.

Simultaneous to the EMS alert, Mr. Jones is also notified on his interactive remote control that his mother has activated her interactive remote control emergency functions. Moments later, his display reveals that she was taken to the local emergency room. Mr. Jones speaks into his interactive remote control device “Intercom,” and then says, “Pam, come here.” Upstairs, Pam's interactive remote control device's speaker sounds out “Pam, come here.” Pam rushes downstairs, to hear that Grandma is being rushed to the hospital. The entire family runs to the car and arrives at the emergency room fifteen minutes later.

An hour later, the Jones'are ushered to a private room where Grandma is resting comfortably, interactive remote control still held close to her body. Grandma recognizes her son and family, and with a tear in her eye thanks her son for the thoughtful gift of an interactive remote control, which saved her life.

Meanwhile, at home in his absence, Mr. Jones'interactive remote control device sounds a special tone. Then, his display flashes a message that will remain on the screen until he arrives home several hours later. The Jones'are going to New Zealand.

Interactive Remote Control with Identification Capabilities

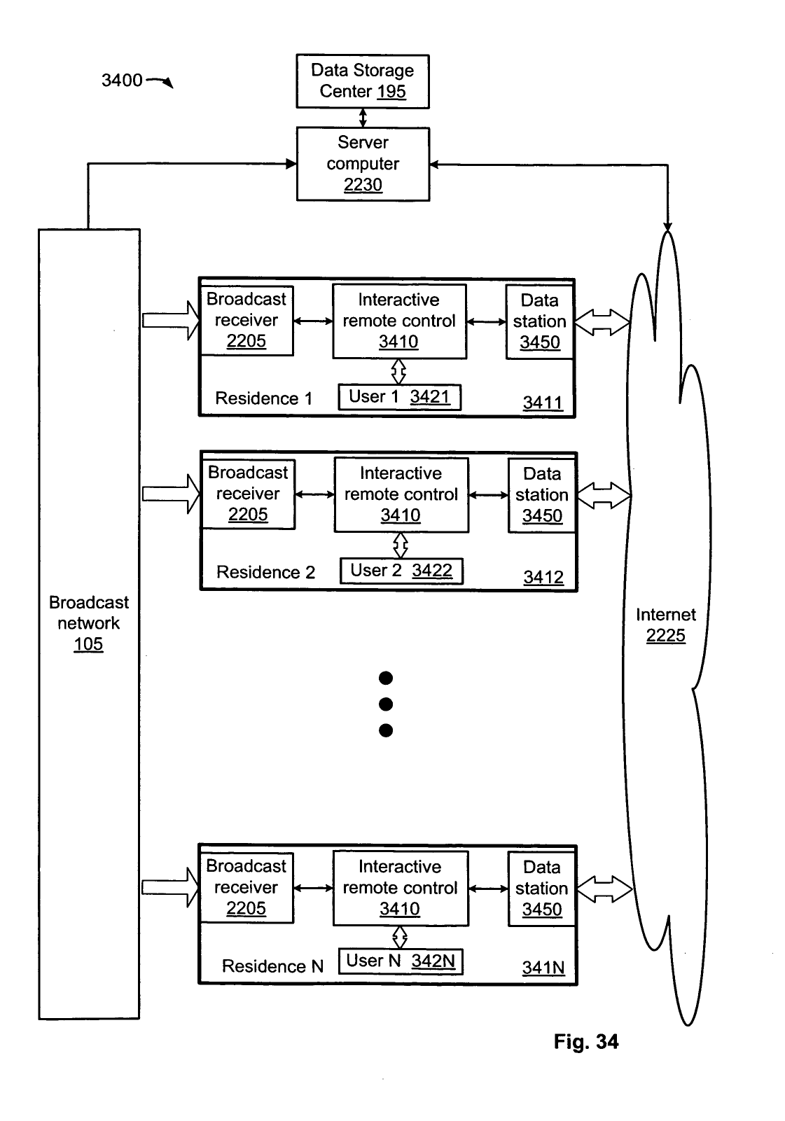

FIG. 34 is a functional block diagram illustrating a system 3400 for coupling a location to two networks according to an exemplary embodiment of the present invention. In one exemplary embodiment of the present invention, a method and/or a system for substituting media content, as discussed in further detail with reference to FIGS. 73-76, comprises an element, step, technology, or other item that FIG. 34 illustrates.

As illustrated in FIG. 34, the system 3400 comprises residences 3411, 3412, 341N coupled to two networks 105, 2225. In exemplary embodiments, the residences 3411, 3412, 341N can comprise a person's residence, a hotel, a restaurant, a bar, or other suitable location. Users at the residences 3411, 3412, 341N interact with a respective broadcast receiver 2205 coupled to the broadcast network 105 and with a data station 3450 coupled to the data network 2225. The data network 2225 is illustrated as the Internet 2225. A broadcast network 105, such as a cable television network, broadcasts content choices to each residence 3411, 3412, 341N in the system 3400. The residences 3411, 3412, 341N can be coupled to the broadcast network 105 through a hardwire connection, a wireless connection, or other suitable means. A hardwire connection can comprise coaxial cable, a fiber optic link, other suitable connection. A wireless connection can comprise satellite or other suitable connection. In one exemplary embodiment of the present invention, the broadcast network 105 includes multiple television stations broadcasting television programming over the airwaves, wherein each station employs a separate antenna for distributing content specific to that station. In other words, in one embodiment of the present invention, the residences 3411, 3412, 341N can receive television or radio programming from local stations via antenna-based broadcasts.

In addition to receiving broad content in an electronic format via the broadcast receivers 2205, each residence 3411, 3412, 341N can receive printed broadcast content such as newspapers, magazines, books, mailers, leaflets, and product packaging. Printed materials can arrive at a residence 3411, 3412, 341N through the mail or via product distribution outlets such as stores, for example. In one exemplary embodiment of the present invention, the broadcast network 105 illustrated in FIG. 34 distributes printed material. For example, the broadcast network 105 can comprise a postal service or other mail service, and the broadcast receivers 2205 can be mail boxes.

The residences 3411, 3412, 341N can be geographically dispersed or concentrated in a locale, such as a town, neighborhood, or community. In one exemplary embodiment of the present invention, the residences 3411, 3412, 341N are geographically dispersed but share a common demographic characteristic, such as a socioeconomic standard. The present invention is not limited to a specific number of residences 3411, 3412, 341N, but rather can include an arbitrary number of residences 3411, 3412, 341N. The system 3400 can include a single residence, several residences, several hundred residences, or many thousand residences 3411, 3412, 341N.

The broadcast network 105 presents content choices to each broadcast receiver 2205 in each residence 3411, 3412, 341N. Each user 3421, 3422, 342N in each residence 3411, 3412, 341N can tune the respective broadcast receiver 2205 using an interactive remote control 3410 to receive a content selection from the content choices that are available via the broadcast network 105. While tuning typically involves adjusting a broadcast receiver 2205 so that it is receptive to a specific frequency range of signals, those skilled in the art appreciate that tuning a broadcast receiver 2205 can involve other techniques for causing the reception and/or presentation of a specific content choice. For example, in one exemplary embodiment of the present invention, the broadcast network 105 distributes content choices on a time-slice basis, sometimes referred to as time division multiplexing. In this case, tuning the broadcast receiver 2205 can involve setting the broadcast receiver 2205 so that it receives the time slices that carry a specific content choice, such as a television program.

Each user 3421, 3422, 342N has an interactive remote control 3410 that communicates channel selection commands to a respective broadcast receiver 2205. The communicated channel selection tunes the corresponding broadcast receiver 2205 to a channel associated with a segment of content, such as entertainment or advertising S content. The interactive remote control can also have a capability to interact with printed materials such as product packaging and written advertisements.

Each interactive remote control 3410 links to the Internet 2225 via the data station 3450, which is typically on the residential premises but may be offsite or remote from a residence 3411, 3412, 341N. In other words, each interactive remote control 3410 is linked with two communication networks 105, 2225, one that broadcasts content for presentation on a broadcast receiver 2205 and one that communicates data and that can provide interactive services such as survey participation, audience characterization, viewership analysis, product ordering, CR\overline{A}V activities, and other forms of user interaction with broadcasts and/or the communication system 3400.

Although FIG. 34 illustrates the data communication network 2225 as the Intemet 2225, this network 2225 also can be another wide area network (“WAN”), which may or may not include the Intemet 2225. Exemplary WANs in accordance with various embodiments of the present invention include cellular telephone networks, wire-line telephone networks, satellite networks, distributed computing networks, private networks, bidirectional data networks, regional networks, and metropolitan area networks.

In addition to linking each interactive remote control 3410 to the Internet 2225, each data station 3450 provides a level of data processing that can reduce the communication burden on the link between the interactive remote control 3410 and one or more remote sites 2230 on the Internet 2225 that are involved in data processing. In other words, the data station 3450 can perform data processing functions as required to minimize the bandwidth requirements of the various communication links and devices in the system 3400.

As described above in reference to FIG. 22, a server computer 2230 and a data storage center 195 includes a function that synchronizes the system 3400 to correlate the transmission of data over the Internet 2225 to and from the interactive remote control 3410 with the distribution of content over the broadcast network 105.

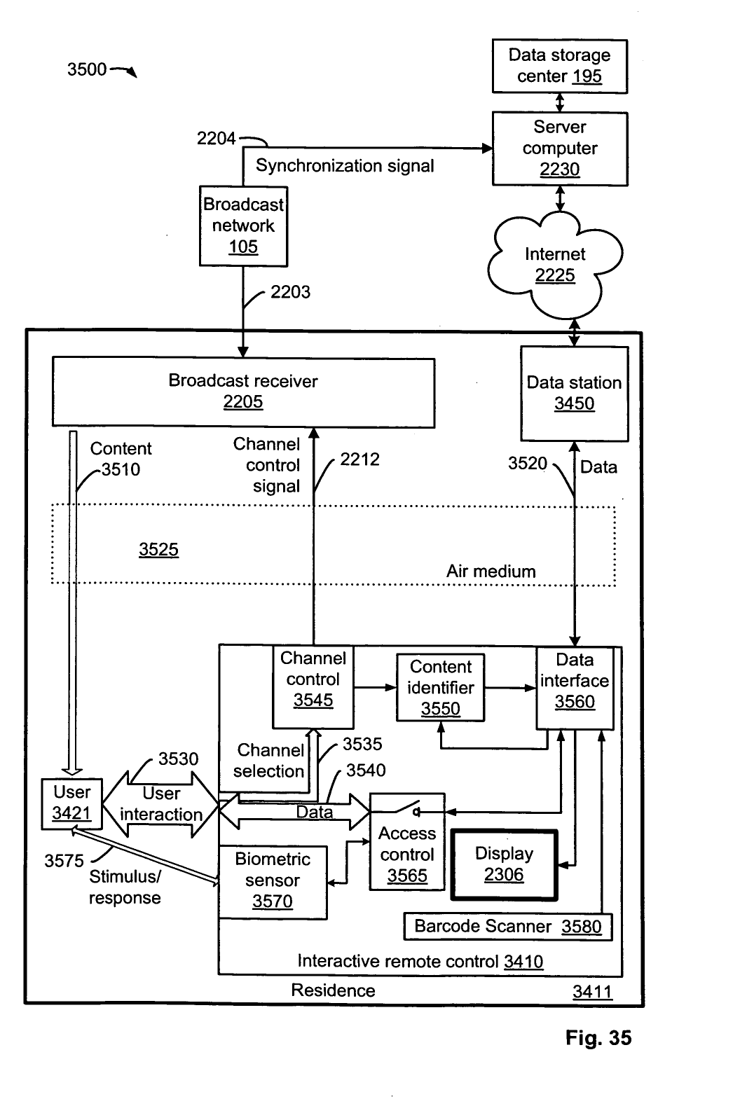

FIG. 35 is a functional block diagram illustrating a system 3500 for interacting with the broadcast receiver 2205 and the data network 2225 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 35 illustrates.

As shown in FIG. 35, the system 3500 comprises a user 3421 located in a residence 3411. In exemplary embodiments, the residence 3411 can comprise a residence, hotel, restaurant, bar, or other suitable location. In one exemplary embodiment of the present invention, the residence 3411 can be one of the residences 3411, 3412, 341N of the system 3400 of FIG. 34. The user 3421 operates the interactive remote control 3410 to interact with the broadcast receiver 2205 coupled to the broadcast network 105 and with data network 2225 via the data station 3450.

The user's interactions 3530 with the interactive remote control 3410 include inputs of channel selections 3535 and data 3540. In an exemplary embodiment, the channel selections 3535 can comprise channel tuning input. In another exemplary embodiment, the data 3450 can comprise personal, financial, or other sensitive data. The user 3421 can input a channel selection 3535 into the interactive remote control 3410 via a keypad entry, spoken command, or other entry technique known in the art. The user can input data 3540 into the interactive remote control 3410 in a similar manner, via keypad, voice command, or other data entry technique known in the art. The keys or buttons on a keypad can have associated switches, either mechanical switches or solid-state electronic switches without moving parts, such as a semiconductor transistor, wherein pressing a key causes the switch to change states. In an exemplary embodiment, the interactive remote control 3410 can comprise a single input device to accept channel selections and data entries from the user. In an alternative exemplary embodiment, the interactive remote control 3410 can comprise multiple input devices dedicated to either channel selection of data entry.

Channel selection input 3535 flows to a channel control module 3545 that transmits the channel control signal 2212 over an air medium 3525 to the broadcast receiver 2205. The broadcast receiver 2205 responds to the received channel control signal 2212 by tuning to a channel corresponding to the channel control signal 2212 to receive the content 2203 broadcast from the broadcast network 105 and to present the broadcast content 2203 to the user 3421 as content 3510 for viewing, listening, recording, or other purpose.

Channel control module 3545 also forwards the user's channel selection input 3535 to a channel identifier module 3550. The channel identifier module 3550 determines the content segment 2203 that corresponds to the user's channel selection 3535. In other words, the user 3421 enters a channel selection 3535 into the interactive remote control 3410, and the channel identifier module 3550 identifies the content 3510 presented on the selected channel of the broadcast receiver 2205. The broadcast content 2203 received by the broadcast receiver 2205 results in the content 3510 presented by the broadcast receiver 2205 to the user 3421.

In an exemplary embodiment, the channel identifier module 3550 correlates the channel selection 2212 to content 3510 based on correlation data received on the interactive remote control 3410 from the Internet 2225 via the data interface 3560. One or more synchronization signals 2204 between the broadcast network 105 and the Internet-based server computer 2230 map broadcast programming to the channel choices available to the residence 3411. Based on a broadcast schedule, the user's channel selection 3535, and a time associated with this selection 3535, the channel identifier module 3550 identifies the content 3510 presented by the broadcast receiver 2205. In exemplary embodiments, the broadcast schedule can be a table, lookup table, matrix, or a list of time slots, channels, and programming schedule. In another exemplary embodiment, the broadcast schedule also can be a dynamic correlation between channels and advertising and programming content carried on those channels. In other words, the channel identifier module 3550 can use the synchronization signal 2204 as a schedule, effectively defining a current time on a broadcast schedule, without requiring advance or other knowledge of other schedule times.

For example, the user 3421 can input the channel selection 3435 corresponding to “Channel 13” into the interactive remote control 3410 because the user 3421 knows that Channel 13 is currently broadcasting the local news. The channel control module 3545 encodes the channel selection 3535 into the channel control signal 2212 and wirelessly communicates the channel control signal 2212 to the broadcast receiver 2205. In response, the broadcast receiver 2205 tunes to Channel 13 and presents the local news program and the accompanying commercials associated with that program as the content 3510. Channel control module 3545 also communicates the user's “Channel 13” entry to the channel identifier module 3550. Using a schedule or other correlation information, the channel identifier module 3550 correlates the user's Channel 13 channel selection 3535 to the specific local news program that is being broadcast and/or the commercials associated with that program.

In one exemplary embodiment of the present invention, the channel identifier module 3550 uses a lookup table to perform the correlation between the user's 3421 channel selection 3535 and the content 3510 that is presented on the selected channel of the broadcast receiver 2205. The channel identifier module 3550 can downloaded the lookup table from the Internet 2225 via the data station 3450 and the data interface 3560. In alternative exemplary embodiments, the data station 3450, the server computer 2230, or another device linked to the interactive remote control 3410 and coupled to the Internet 2225 can perform, in part or in full, the content identifying correlation.

The channel identifier module 3550 communicates the identification of the content 3510 that is presented on the broadcast receiver 2205 to the data interface 3560 of the interactive remote control 3410. The data interface 3560 communicates the identification of the content 3510 to the data station 3450 via the data signal 3520. The data station 3450 communicates the identification of the content 3510 via the Internet 2225 to the server computer 2230. The server computer 2230 can track the user's viewing patterns, the viewing patterns of the residence 3411, and the viewership of one or more programs or commercials across a number of residences by recording the content 3510 presented to the user 3421. Programs and algorithms running at the server computer 2230 project the acquired viewing statistics of the monitored users 3421 to estimate the viewing patterns of a larger populous. The server computer 2230 also can perform audience estimation and audience characterization, such as demographic profiling, based on the identified programming content 3510.

While the interactive remote control 3410 provides unrestricted access to capabilities for tuning the broadcast receiver 2205, controlled access features can guard the interactive and/or data features of the interactive remote control 3410 from unauthorized use. To control access, the interactive remote control 3410 comprises a biometric sensor 3570 that identifies the user 3421, who may be either an authorized user 3421 or an unauthorized user 3421. Then, an access control module 3565 of the interactive remote control 3410 can grant an appropriate level of access to the user 3421.

In an exemplary embodiment, the biometric sensor 3570 performs a stimulus/response 3575 user recognition function. In that embodiment, the sensor 3570 provides a stimulus or stimuli 3575 to the user 3421 and receives a corresponding response 3575 from the user 3421. The term stimulus, as used herein, refers to an output that causes a response and can include a projection of light or an audible sound. For example, the biometric sensor 3570 can comprise an image recognition system (not shown) that acquires a digital picture of a user's retina or face and identifies the user 3421 as a known and authorized user or as an unknown and suspicious user based on the acquired digital picture. The sensor 3570 can compare the acquired digital picture to a stored digital picture of the user's 3421 retina or face to determine whether the acquired digital picture matches the stored digital picture. If yes, then the sensor 3570 determines that the user 3421 is an authorized user. If the acquired digital picture does not match the stored digital picture, then the sensor 3570 determines that the user 3421 is an unauthorized user. The sensor 3570 communicates the user's status to the access control module 3565. The access control module 3565 grants the appropriate level of access to the user 3665. The access control module 3565 can grant more access to an authorized user and can deny access to an unauthorized user.

In other exemplary embodiments, the biometric sensor 3570 can perform a user recognition function based on other biometric data. For example, the biometric sensor can comprise a device that recognizes a user 3421 based on voiceprint, fingerprint, or deoxyribonucleic acid (“DNA”). In those embodiments, the user 3421 inputs a biometric sample to the sensor 3570, and the sensor 3570 acquires or captures the sample. Then, the sensor 3570 compares the acquired sample with stored samples to identify the user 3421 as an authorized user 3421 or an unauthorized user 3421.

In another exemplary embodiment, the user identification function can be separated from the biometric sensor 3570. In that embodiment, the biometric sensor can capture the biometric sample from the user 3421 and can forward the biometric sample to another component of the system 3500 to identify the user. For example, the sensor 3570 can communicate the biometric sample to the access control module 3565, the data station 3450, the server computer 2230, the data storage center 195, or another component within the system 3500. Then, the component receiving the biometric sample can compare the capture sample to stored samples and can identify an authorized user based on a match between those samples. The component then communicates the user's 3421 authorized or unauthorized status to the access control module 3565.

If the biometric sensor 3570 or other component of the system 3500 determines that the user 3421 is authorized to conduct data communications with the interactive remote control 3410, the access control module 3565 enables such data communication activities. As shown in FIG. 35, the access control module 3565 is symbolically illustrated as a switch that either allows data communication for an authorized user or denies data communication to an unauthorized user. In other exemplary embodiments, the access control module 3565 can provide varying levels of access based on the user's 3421 credentials. For example, authorized users can receive one of multiple levels of access. Additionally, unauthorized users can receive limited access or can be denied access completely. For example, based on a user's identity, the access control module 3565 may authorize data communications that involve low-risk data, such as playing an interactive game but restrict purchasing goods or conducting financial transactions. In other words, the access control module 3565 can provide multiple tiers of access control.

Although depicted in FIG. 35 as located in the interactive remote control 3410, the access control module 3565 can be located, in whole or part, outside the interactive remote control 3410. For example, in one embodiment of the present invention, the biometric sensor 3570 sends a user's identification information to the data station 3450 comprising the access control module 3565, which enables or disables the interactive remote control's 3410 interactive services or interactive data functionalities of the interactive system 3500 according to the user's access rights. Similarly, the server computer 2230, or the data storage center 195 can comprise the access control module 3565 and can control access based on the user's identification or lack thereof.

A barcode scanner 3580 integrated with the interactive remote control 3410 enables the user 3421 to scan advertisements, product packaging, and other printed materials that have barcodes. When a user scans an advertisement, data encoded in the advertisement's barcode transmits from the interactive remote control 3410 to the server computer 2230 via the data station 3450 and the Internet 2225. The server computer 2230 processes acquired barcode data and transmits CR\overline{A}V questions regarding scanned advertisements to the interactive remote control 3410. The interactive remote control's display 2306 presents CR\overline{A}V questions to the user 3421 to immerse the user 3421 in scanned advertisements.

The term “barcode,” as used herein refers to a series of machine-readable marks of varying type, in which digits or characters of an alphabet are represented by a different pattern within the series. One type of barcode comprises a series of vertical bars of varying width, in which each of the digits zero through nine are represented by a different pattern of bar that can be read by a laser scanner.

The user 3421 can scan product packaging with the interactive remote control's barcode scanner 3580 following product consumption, thereby acquiring universal product code (“UPC”) data for home inventory control. The universal remote control 3410 transmits UPCs of such scanned consumer products to the server computer 2230, which tracks residential product consumption. The server computer 2230 provides the user 3421 coupons, offers, and other promotions based on the user's pattern of scanned products. For example, when a user 3421 scans a consumed product, the server computer 2230 can generate a coupon for a competitive product. The server computer 2230 can also maintain a shopping list for the user 3421 based on products that the user scans. A grocer, store, or other product distributor can use the shopping list to replenish the residence's stock of consumer products.

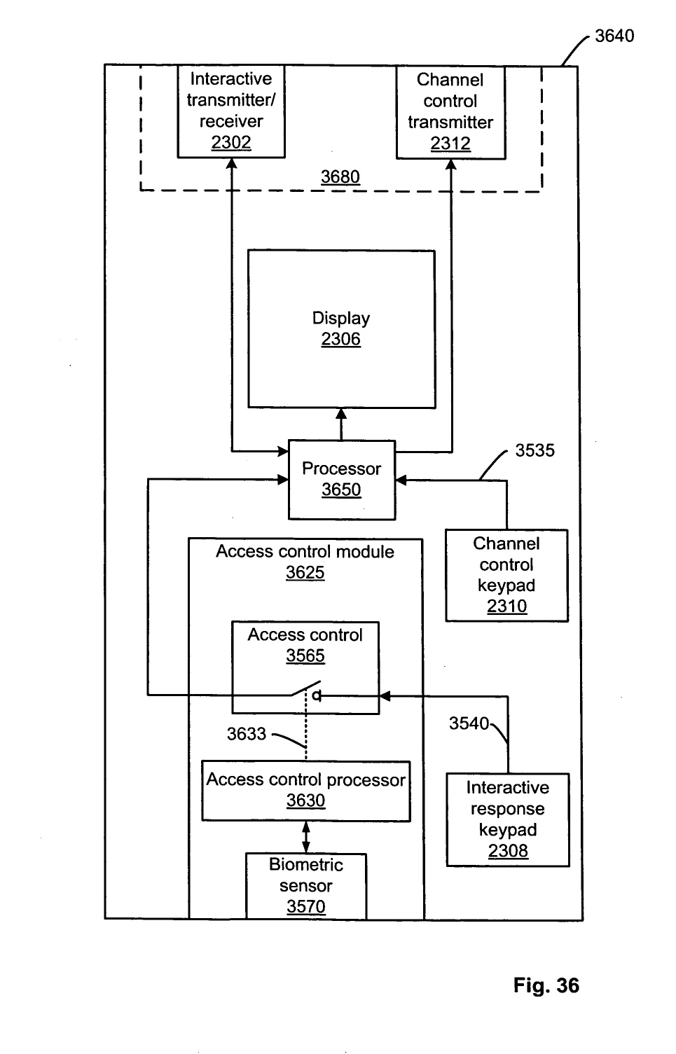

FIG. 36 is a functional block diagram illustrating an interactive remote control 3640 comprising the biometric sensor 3570 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 36 illustrates.

The interactive remote control of FIG. 36 will be described with reference to FIGS. 22 and 34-36. In an exemplary embodiment, the interactive remote control 3640 also comprises a content identification module 3550 (not illustrated in FIG. 36). In one exemplary embodiment of the present invention, the interactive remote control 3640 comprises a barcode scanner (not illustrated in FIG. 36) for scanning household products and printed materials.

The biometric sensor 3570 and an access control processor 3630 are components of an access control module 3625 of the interactive remote control 3640. Based on input from the biometric sensor 3570, the access control processor 3630 communicates an access control signal 3633 to the access control module 3565. The access control module 3565 illustrated in FIG. 36 can comprise an effector, actuator, switch, computer software application, or other suitable access control. The access control processor can grant or deny access based on a determination of whether the user 3421 is an authorized or unauthorized user. If granted authorization by the access control processor 3570 to conduct interactive data activities via the interactive remote control 3640, then the user 3421 can perform interactive functions by entering data inputs 3540 into the interactive response keypad 2308.

The access control 3565 controls the amount and type of interactive functions available to the user 3421 based on the authorization levels granted by the access control processor 3630. In exemplary embodiments, the interactive functions can comprise responding to a CR\overline{A}V question, ordering a product, participating in a survey, viewing adult-oriented content, playing a mature game, conducting a financial transaction, or performing other desired functions, depending on the level of authorization granted to the user 3421 based on his identity. The access control processor 3630 can grant or deny access to one or more of those functions.

If granted access, then the access control 3565 allows the user 3421 to input data to a processor 3650 via the interactive response keypad 2308. In exemplary embodiments, the processor 3650 comprises a microprocessor, microcontroller, hardwired logic, micro-computing device, or other suitable processor. Based on those user inputs, the processor 3650 communicates data signals to the interactive transmitter/receiver 2302 which transmits data-encoded signals 3520 to the data station 3450 for subsequent transmission via the Internet 2225 to the server computer 2230.

The interactive transmitter/receiver 2302 also receives data 3520 from the server computer 2230 via the Internet 2225 and the data station 3450 and transmits corresponding data signals to the processor 3650. In exemplary embodiments, received data can comprise CR\overline{A}V questions, advertisements, game data, user identification files, programming schedules, financial data, survey questions, content, or other interactive data. The processor 3650 supplies display data to the display 2306 based on user input 3540 and information received from the interactive transmitter/receiver 2302.

The interactive remote control 3640 comprises the dedicated channel control keypad 2310 through which a user 3421 can tune the broadcast receiver 2205 to a specific channel. The processor 3650 receives channel control entries 3535 input by the user 3421 via the channel control keypad 2310 and encodes each channel selection 3535 in the signal 2212. Then, the channel control transmitter 2312 communicates the signal 2212 to the broadcast receiver 2205 via wireless transmission to tune the broadcast receiver 2205 to the desired channel. In exemplary embodiments, the interactive transmitter/receiver 2302 and the control transmitter 2312 can be characterized collectively as a functional unit 3680 or as separate elements.

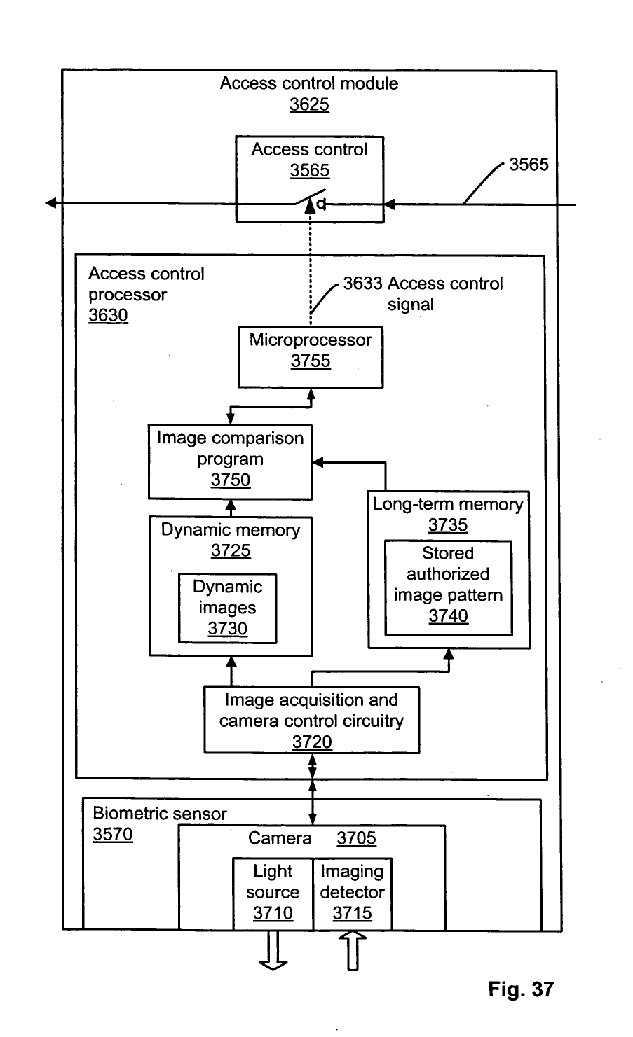

FIG. 37 is a functional block diagram illustrating an access control module 3625 of the interactive remote control 3640 according to an exemplary embodiment of the present invention.

In one exemplary embodiment of the present invention, a method and/or a system for substituting media content, as discussed in further detail with reference to FIGS. 73-76, comprises an element, step, technology, or other item that FIG. 37 illustrates. In one exemplary embodiment of the present invention, the access control module 3625 illustrated in FIG. 37 is a component 3625 of the interactive remote control 3640 depicted in FIG. 36.

The exemplary biometric sensor 3570 in the access control module 3625 comprises a digital camera 3705 with a light source 3710 and an imaging detector 3715. In exemplary embodiments, the light source 3710 can comprise a light bulb, a light emitting diode (“LED”), or other suitable illumination apparatus. In an exemplary embodiment, the imaging detector 3715 can comprise a charge coupled device (“CCD”) coupled to a focusing lens (not shown) that gathers light emanating from a subject and projects an image of the subject onto the CCD.

In operation, the camera 3705 can probe a user 3421 by projecting light onto biological tissue of the user 3421 and collecting light emanating from the user's tissue. The tissue can be connected to the user 3421 at the time of image acquisition or alternatively separated. For example, an image of a user's fingerprint can be taken after the user 3421 transfers the fingerprint from his or her finger to a plate via an ink transfer process. Similarly, a DNA analysis can proceed by swabbing the mouth of a user 3421 and placing the swab in a reading chamber (not shown) of the biometric sensor 3570.

In one exemplary embodiment, the camera 3705 can capture an image of the user's face to identify the user 3421 and determine the user's authorization level. In another exemplary embodiment, the camera 3705 can capture an image of the user's retina or other portion of the user's eye for identification purposes. In yet another exemplary embodiment, the camera 3705 can capture an image of the user's fingerprint, or a portion thereof. In other exemplary embodiments, the camera 3705 can capture any other distinctive features of a user 3421 suitable to identify the user 3421.

The access control module 3625 also comprises the access control processor 3630. The access control processor comprises image acquisition and camera control circuitry 3720 that interfaces with the light source 3710 and the imaging detector 3715, triggers image acquisition, and buffers image data from the camera 3705. The image acquisition and camera control circuitry 3720 feed acquired images to a long-term memory 3735 or a dynamic memory 3725, depending on the operational mode of the interactive remote control 3640.

In a mode of recording an identifying biometric feature of an authorized user 3421, the camera 3705 captures a digital image of the biometric sample of the user 3421 and communicates the authorized digital image pattern 3740 to the long-term memory 3735 for long-term storage. In a mode of attempting to identify an unknown user 3421, the camera 3705 acquires an image of the unknown user and transfers the acquired digital image pattern 3730 to the dynamic memory 3725. In an exemplary embodiment, the long-term memory 3735 retains stored authorized images patterns 3740 when the interactive remote control 3410 is powered down or not in use. Powering down the interactive remote control 3410 or leaving it in an idle state for a prolonged period of time can remove dynamic images 3730 from the dynamic memory 3725.

The access control processor 3630 also comprises an image comparison module 3750, which determines whether the dynamic image 3730 from an unknown user 3421 matches a stored image pattern 3740 of an authorized user 3421. The image comparison module 3750 makes that determination by comparing the dynamic image 3730 with the stored images 3740 to identify a match between the images 3730 and 2740. A match indicates an authorized user, and the lack of a match indicates an unauthorized user.

The access control module 3630 also comprises an onboard microprocessor 3755. The access control processor 3630 outputs an access control signal 3633 to the access control module 3565 based on the results of the image comparison module 3750. The access control module 3565 responds to the access control signal 3633 and either grants or denies access to the user 3421. In other words, the access control signal 3633 communicates a level of authorization granted to a user 3421 by the access control processor 3630.

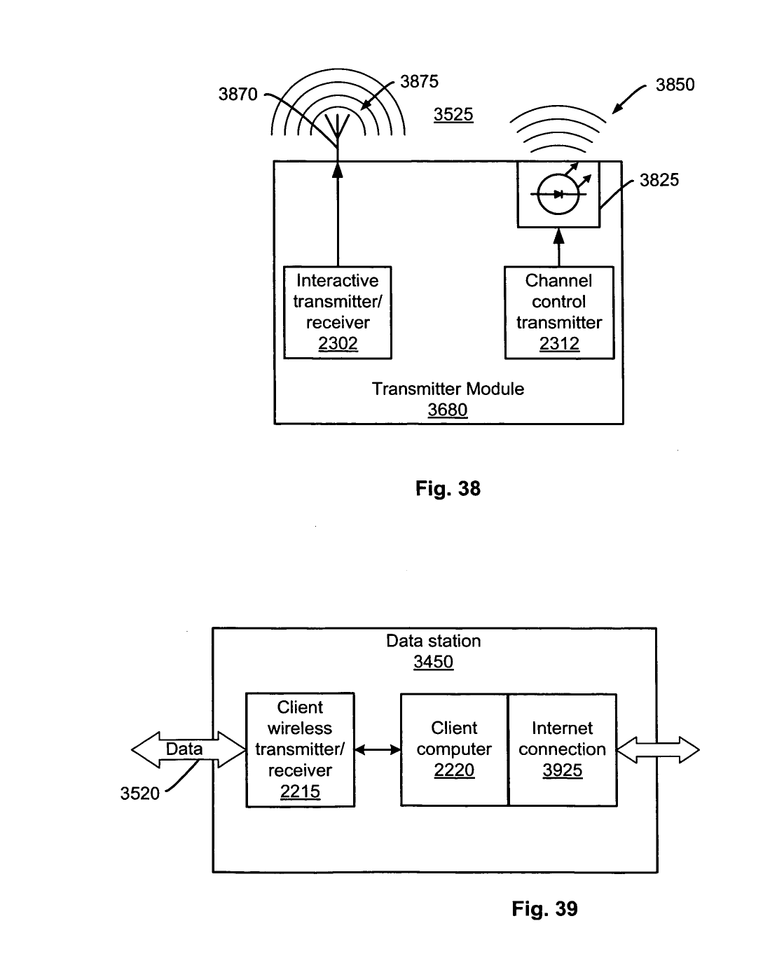

FIG. 38 is a functional block diagram illustrating the transmitter module 3680 of the interactive remote control 3640 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 38 illustrates.

The transmitter module 3680 will be described with reference to FIGS. 34, 35, and 38. The transmitter module 3680 illustrated in FIG. 38 comprises the interactive transmitter/receiver 2302 and the channel control transmitter 2312. However, those components can be spatially separated from one another. For example, those components can be disposed on different circuit boards within the interactive remote control 3410.

The interactive transmitter/receiver 2302 interfaces with an antenna 3870 which sends radio frequency (“RF”) signals 3875 through the air 3525 to the data station 3450. In a receiving capacity, the antenna 3870 receives RF signals 3875 transmitted by the data station 3450. In an exemplary embodiment, the antenna 3870 comprises an omni-directional antenna such that positioning the interactive remote control 3640 in a specific orientation is not required for communication with the data station 3450. In other words, the antenna 3870 sends and receives signals in more than a single direction. Those skilled in the art appreciate that an omni-directional antenna can have certain orientations that are conducive to better reception than other orientations and that an omni-directional antenna can have a degree of directional sensitivity.

The RF signals 3875 can transmit data 3520 between the interactive remote control 3640 and the data station 3450 without a line-of-sight configuration. In other words, the RF signals 3875 can propagate through or around most common residential objects positioned between the interactive remote control 3640 and the data station 3450. For example, for most residences 3411, using the interactive remote control 3640 in a living room while the data station 3450 resides in a remote corner of the residence 3411 does not impede the transmission or reception of the RF signals 3875.

In an exemplary embodiment, the RF signals 3875 carry content identification information that identifies the content 3510 that is presented on the broadcast receiver 2205. In another exemplary embodiment, the RF signals 3875 carry user interaction data such as CR\overline{A}V questions and responses to CR\overline{A}V questions. In yet another exemplary embodiment, the RF signals 3875 carry data that an interactive remote control 3410 having a barcode scanner 3580, as illustrated in FIG. 35 and discussed above, acquires by scanning printed material.

The channel control transmitter 2312 interfaces with an LED 3825, which outputs light 3850 in a directional format. The directional aspect of the emitted light 3850 typically requires pointing the interactive remote control 3640 towards the broadcast receiver 2205 to change a channel. In an exemplary embodiment, the light 3850 from the LED 3825 can comprise infrared light, which is invisible to ordinary human visual perception.

FIG. 39 is a functional block diagram illustrating the data station 3450 of the interactive remote control 3410 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 39 illustrates.

The data station 3450 of FIG. 39 will be described with reference to FIGS. 34, 35, 38, and 39. The data station 3450 couples the data interface 3560 to the Internet 2225, as depicted in FIG. 35. Data 3520 flows between the interactive transmitter/receiver 2302 and the client wireless transmitter/receiver 2215 via the RF signals 3875 illustrated in FIG. 38. In other words, the interactive data 3520 is encoded on the RF signals 3875 propagating between the antenna 3870 and the client wireless transmitter/receiver 2215. The client wireless transmitter/receiver 2215 also can comprise an antenna (not shown) for transmitting and receiving the date 3520.

The data station 3450 also comprises a client computer 2220, which can be a personal computer that residents of the residence 3411 use for various activities, such as household accounting and Internet surfing. Alternatively, the client computer 2220 can be dedicated to performing functions directly associated with interactive television or other interactive media.

The Internet connection 3925 couples the client computer 2220, and thus the data station 3450, to the Internet 2225 thereby enabling interactive data 3520 to flow between the server computer 2230 and the interactive remote control 3640.

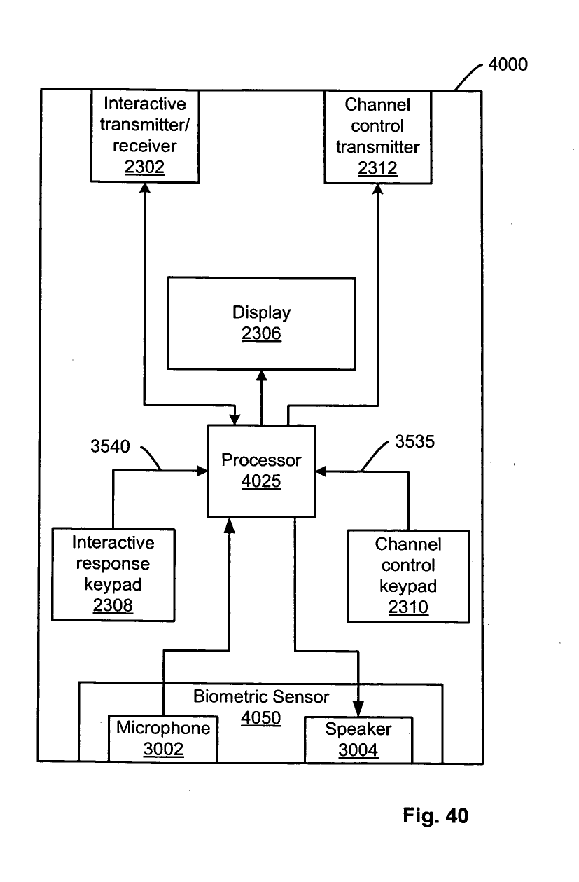

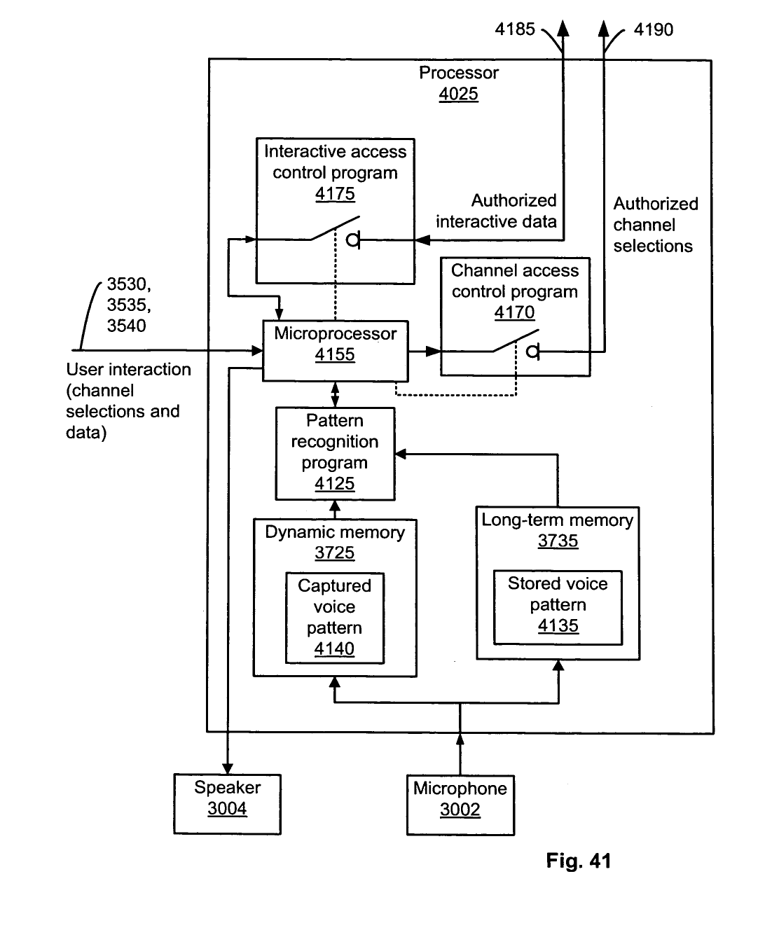

FIG. 40 is a functional block diagram illustrating an interactive remote control 4000 according to another exemplary embodiment of the present invention. In one exemplary embodiment of the present invention, a method and/or a system for substituting media content, as discussed in further detail with reference to FIGS. 73-76, comprises an element, step, technology, or other item that FIG. 40 illustrates.

The interactive remote control 4000 will be described with reference to FIGS. 23, 30 and 40. The interactive remote control 4000 comprises the speaker 3004 and the microphone 3002. The speaker 3004 and the microphone 3002 can function as components of a biometric sensor 4050 of the exemplary interactive remote control 4000. The speaker 3004 can output audio commands to the user 3421. For example, the audio commands can prompt or stimulate the user 3421 to undergo an authorization process and/or an identification procedure.

The microphone 3002 in the biometric sensor 4050 receives voice input from the user 3421. For example, the voice input can comprise the user's 3421 voice print (a voice sample). The interactive remote control 4000 also comprises a processor 4025 that communicates with the speaker 3004, the microphone 3002, the display 2306, the channel control keypad 2310, the interactive response keypad 2308, the channel control transmitter 2312, and the interactive transmitter/receiver 2302. The user 3421 enters channel selections 3535 into the channel control keypad 2310, which in turn provides the channel selection 3535 in electrical format to the processor 4025. Then, the processor 4025 instructs the channel control transmitter 2312 to tune the broadcast receiver 2205 to the selected channel. The interactive response pad 2308 accepts interactive user input 3540 and feeds the data 3540 to the processor 4025. The display 2306 displays interactive information receive via the interactive transmitter/receiver 2302. In exemplary embodiments, the interactive information can comprise CR\overline{A}V questions, gaming figures, survey questions, financial transactions, user prompt, and other interactive information. The interactive transmitter/receiver 2302 communicates the interactive data 3520 to and receives interactive data 3520 from the data station 3450.

Although not illustrated in FIG. 40, in one exemplary embodiment of the present invention, the interactive remote control 4000 can comprise a barcode scanner for reading barcodes or other marks printed on or otherwise fixed to products, product packaging, printed publications, or other writings.

FIG. 41 is a functional block diagram illustrating the processor 4025 of the interactive remote control 4000 according to an exemplary embodiment of the present invention. The processor 4025 will be described with reference to FIGS. 30, 34, 35, 40, and 41.

In one exemplary embodiment of the present invention, a method and/or a system for substituting media content, as discussed in further detail with reference to FIGS. 73-76, comprises an element, step, technology, or other item that FIG. 41 illustrates.

For biometric sensing, the processor 4025 receives audio input from the microphone 3002 and can output prompts, stimuli, or other information to a user 3421 via the speaker 3004. In an exemplary embodiment, the speaker 3004 can output a request for a user 3421 to speak a specific phrase so that the microphone 3002 can receive a sample voice print of the user 3421. During a set-up procedure, the microphone 3002 converts the user's voice pattern, or voice print, into a corresponding pattern of electrical signals. The long-term memory 3735 records the voice pattern 4135 in digital format. When a user 3421 attempts to use a protected feature of the interactive remote control 4000, the processor 4025 can identify the user 3421 to grant or deny access. In that regard, the microphone 3002 captures the user's 3421 voice pattern 4140. Then, the dynamic memory 3725 stores the user's captured voice pattern 4140.

A pattern recognition program 4125 compares the user's captured voice pattern 4140 with the stored voice patterns 4135 of one or more known and authorized users 3421 and, if warranted by the comparison, identifies the user 3421. If the captured voice pattern 4140 matches a stored voice pattern 4135, then the pattern recognition program 4125 identifies the authorized user 3421 based on data corresponding to the matching, stored voice pattern 4135. Then, a channel access control computer application program 4170 grants the appropriate level of access to the user 3421 based on the user's credentials. If the captured voice pattern 4140 does not match a stored voice pattern 4135, then the pattern recognition program 4125 identifies the user 3421 as an unauthorized user. Then, the channel access control program 4170 denies access to the unauthorized user 3421.

A microprocessor 4155 executes the pattern recognition computer 4125, along with an interactive access control computer application program 4175 and a channel access control computer application program 4170. The interactive access control program 4175 and the channel access control program 4170 respond to the user's interactions 3530, 3535, 3540, which can comprise channel selections 3535 and data input 3540, as well as other forms of user interaction.

The interactive access control program 4175 determines the data and interactive features of the interactive remote control 4000 and/or the interactive services that a user 3421 is authorized to access in accordance with a user's access rights. In other words, based on the user's identity as determined by the pattern recognition program 4125 and the authorization level associated with such identity, the interactive access control program 4175 grants the user 3421 a commensurate level of access to interactive services linked to features of the interactive remote control 4000. Authorized interactive data 4185 passes from the processor 4025 to the interactive transmitter/receiver 2302 for wireless transmission to the data station 3450.

The channel access control program 4170 determines the features, such as channel selections, that a user 3421 is authorized to access on a broadcast receiver 2205. The channel access control program 4170 may restrict the content that a user 3421, such as an identified child, is allowed to show on the broadcast receiver 2205. Authorized channel selections 4190 pass from the processor 4025 to the channel control transmitter 2312 for wireless transmission to the broadcast receiver 2205.

In one exemplary embodiment of the present invention, the processor 4025 also comprises a software program (not illustrated in FIG. 41) that controls a barcode scanner 3580, as illustrated in FIG. 35 and discussed above. Such a software program can process UPC data or other data scanned from printed materials.

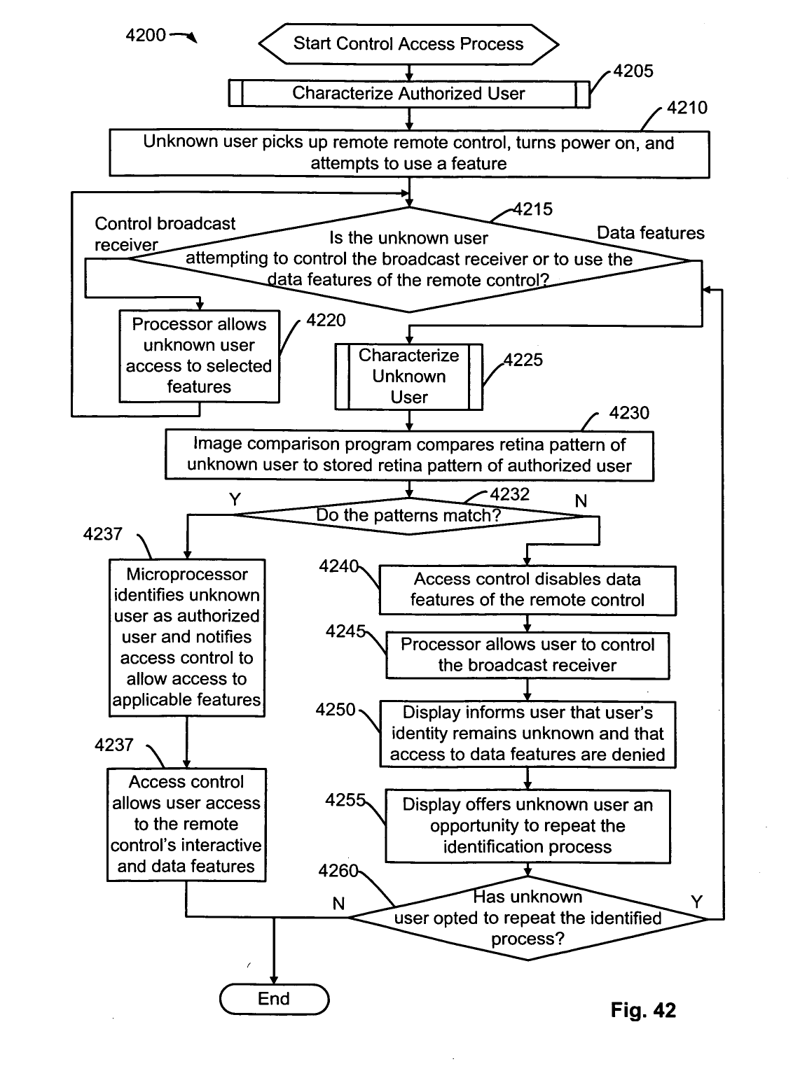

FIG. 42 is a flow chart illustrating a process 4200 for controlling access to features of an interactive remote control 3640 and/or an interactive service associated with a broadcast receiver 2205 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 42 illustrates.

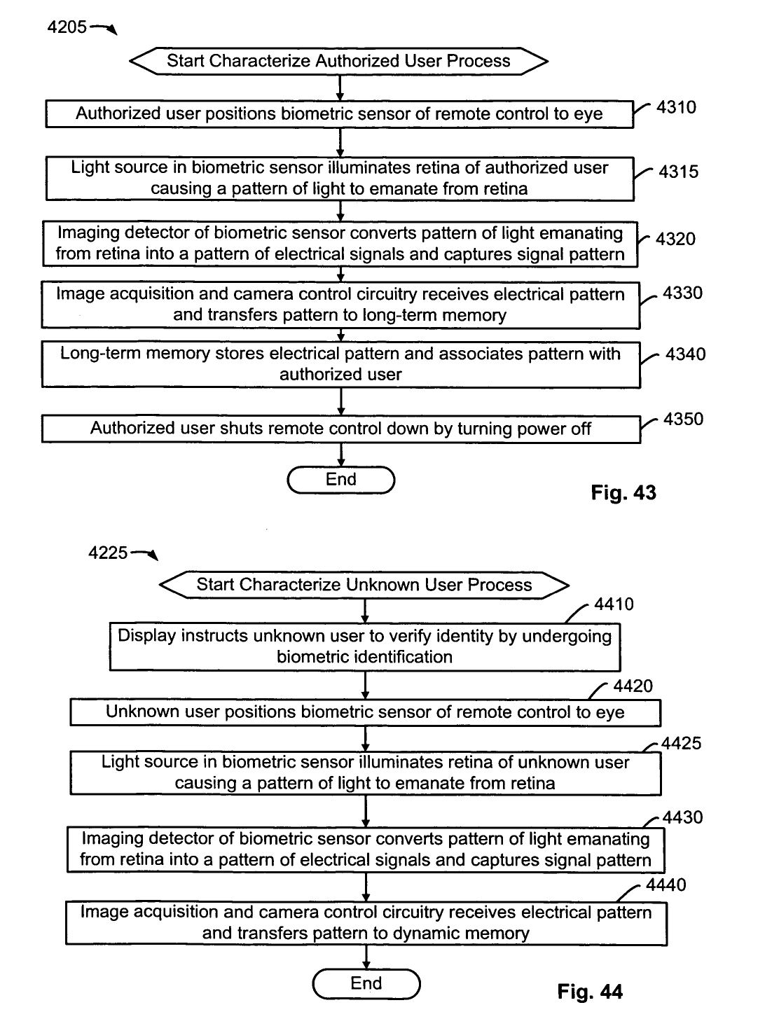

While this process 4200 can be applied to various hardware embodiments associated with the present invention, it and the related processes depicted in FIGS. 43 and 44 will be discussed below in reference to the interactive remote control 3640 and the access control module 3625 of FIGS. 36.

The first step in process 4200 is a process step 4205 for characterizing an authorized user by capturing and storing a biometric print from the authorized user. Step 4205 will be discussed in more detail below with reference to FIG. 43. In step 4205, the interactive remote control 3600 captures and stores a biometric pattern from an authorized user 3421 associated with a level of authorized access.

In step 4210, an unknown user 3421, who may or may not be the user 3421 whose retina pattern was recorded in step 4205, picks up the interactive remote control 3640, turns on the power to the interactive remote control 3640 and/or the broadcast receiver 2205, and attempts to use a feature of the interactive remote control 3640.

In step 4215, the access control processor 3630 determines if the unknown user 3421 is attempting to control the broadcast receiver 2205, for example, to change a channel, or to access an interactive feature of the interactive remote control 3640, such as a data feature or an interactive service available via the Internet 2225.

If the user is attempting to control the broadcast receiver 2205, then the process 4200 branches to step 4220. In step 4220 the processor 3650 allows the unknown user 3421 access for routine interactions with the broadcast receiver 2205. The process 4200 repeats inquiry step 4215 each time the unknown user 3421 attempts to use a feature of the interactive remote control 3640.

If step 4215 determines that the unknown user is attempting to access data features, then the process 4200 branches to step 4225. Step 4225 is a process step for characterizing an unknown user by attempting to identify the unknown user based on a captured biometric sample from the unknown user. Step 4225 will be discussed in more detail below with reference to FIG. 44.

In step 4230, the image comparison program 3750 compares the biometric sample captured in step 4225 to the stored biometric pattern captured in step 4205 to determine whether the biometric sample matches one of the stored biometric patterns. In an exemplary embodiment, the biometric sample can comprise the captured retina pattern 3730 of the unknown user 3421 and the biometric patterns can comprise retina patterns 3740 stored in the long-term memory 3735.

In step 4232, the image comparison program 3750 determines if a match exists between the newly captured biometric sample stored in the dynamic memory 3725 and a biometric sample stored in the long-term memory 3735. If yes, then the process 4200 branches to step 4237. In step 4237, the microprocessor 3650, via a software program 3750, identifies the unknown user 3421 as an authorized user 3421 and notifies the access control module 3565. Then, in step 4239, the access control module 3565 reads the level of authorized access associated with the identified user and grants that level of access to the interactive services available via the interactive remote control 3640. The process 4200 ends following step 4239.

If inquiry step 4232 determines that the unknown user's biometric sample does not match a stored biometric pattern of an authorized user, then the process 4200 branches to step 4240. In step 4240, the access control module 3565 disables the interactive and data features of the interactive remote control 3640, thereby denying the unidentified user 3421 access to those features. In step 4245, the processor 3650 allows the unknown user 3421 to control the broadcast receiver 2205 via the channel control keypad 2310 of the interactive remote control 3640.

In step 4250, the processor 3650 displays a message on the display 2306 to inform the unknown user 3421 that access to interactive data features and associated interactive services are denied because his identity remains unknown since the attempted biometric match was unsuccessful. In step 4255, the processor 3650 displays a message on the display 2306 to offer the unknown user 3421 the option to repeat the user identification process.

In step 4260, the processor 3650 determines whether the unknown user 3421 has elected to repeat the identification process. If yes, then the process 4200 branches to step 4225 to repeat the characterization of an unknown user. If the unknown user 3421 does not opt in step 4260 to repeat the identification process, then the process 4200 ends.

FIG. 43 is a flow chart illustrating the process 4205 for characterizing an authorized user 3421 of an interactive remote control 3640 according to an exemplary embodiment of the present invention, as referred to in step 4205 of FIG. 42. In one exemplary embodiment of the present invention, a method and/or a system for substituting media content, as discussed in further detail with reference to FIGS. 73-76, comprises an element, step, technology, or other item that FIG. 43 illustrates.

The process 4205 will be described with reference to FIGS. 35, 36, 37, and 43. The exemplary process 4205 describes a method for characterizing an authorized user based on a retina image.

In step 4310, an authorized user 3421 positions the biometric sensor 3570 to his eye. In step 4315, a light source 3710 in the biometric sensor 3570 illuminates the authorized user's retina as a stimulus, causing a pattern of light to emanate, reflect, or scatter from the user's retina in step 4320, the imaging detector 3715, which can comprise a CCD, captures the pattern of light from the user's retina and converts the pattern into a corresponding biometric pattern of electrical signals.

In step 4330, the image acquisition and camera control circuitry 3720 receives the biometric pattern from the camera 3705 and transfers the biometric pattern to long-term memory 3735.

In step 4340, the long-term memory 3740 stores the biometric pattern in digital format as the biometric pattern 3740 and associates the pattern 3740 with the identity of the authorized user 3421. In an exemplary embodiment, the identity of the authorized user also can be associated with demographic information or an authorized level of access to interactive services. The process 4205 then proceeds to step 4210 (FIG. 42).

FIG. 44 is a flow chart illustrating a process 4225 for characterizing an unknown user 3421 of an interactive remote control 3640 according to an exemplary embodiment of the present invention, as referred to in step 4225 of FIG. 42. In one exemplary embodiment of the present invention, a method and/or a system for substituting media content, as discussed in further detail with reference to FIGS. 73-76, comprises an element, step, technology, or other item that FIG. 44 illustrates.

The process 4225 will be described with reference to FIGS. 35, 36, 37, and 43. The exemplary process 4225 describes a method for characterizing an unknown user based on a retina image.

In step 4410, the processor 3650 displays a message on the display 2306 to prompt the unknown user 3421 to verify his or her identity by undergoing biometric identification.

In step 4420, the unknown user 3421 positions the biometric sensor 3570 of the interactive remote control 3640 to his eye. In step 4425, the light source 3710 of the biometric sensor 3570 illuminates the retina of the unknown user 3421, thereby causing a pattern of light to emanate from the retina.

In step 4430, the biometric sensor's imaging detector 3715 captures the light pattern from the user's eye and converts it into a biometric sample of corresponding electrical signals. In step 4440, the image acquisition and camera control circuitry 3720 receives the biometric sample from the camera 3705 and transfers the biometric sample to the dynamic memory 3730 for short-term storage. The dynamic memory 3730 stores the biometric sample as a dynamic biometric sample 3730. The process 4225 then proceeds to step 4230 (FIG. 4).

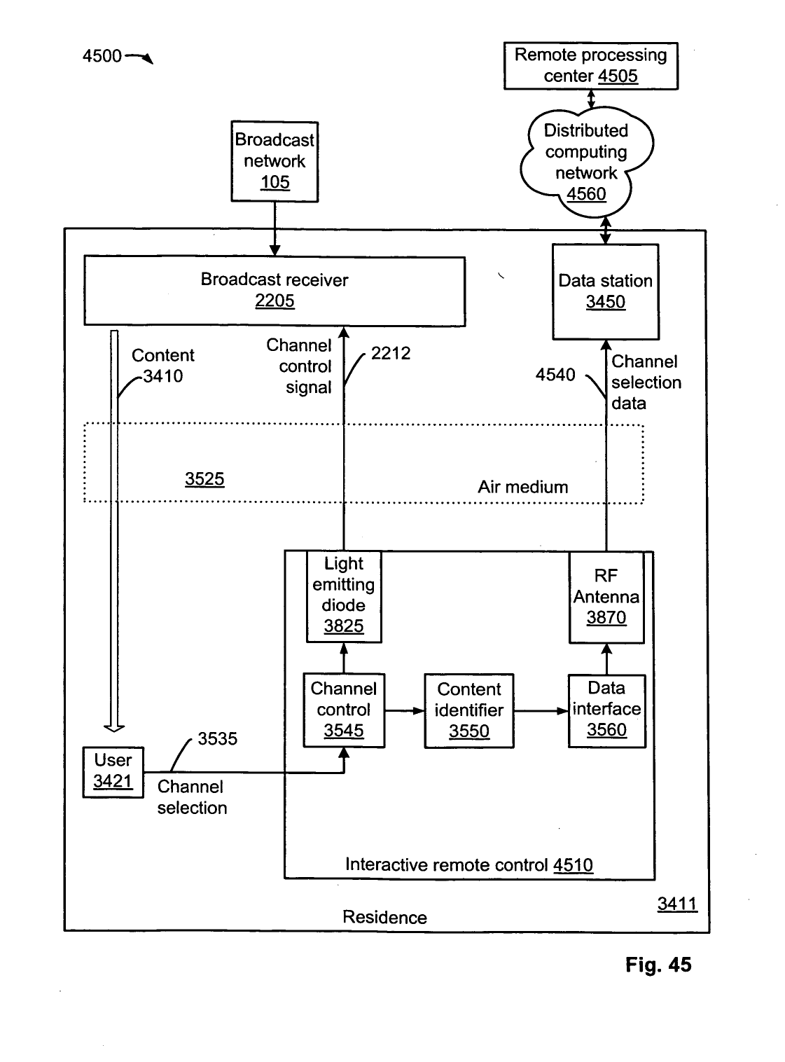

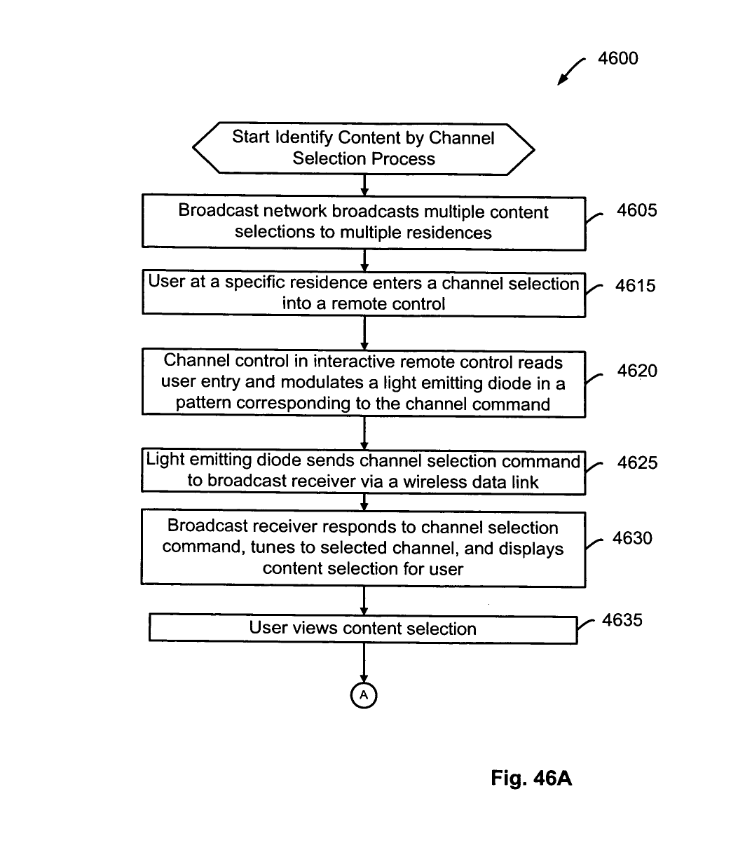

FIG. 45 is a functional block diagram illustrating a system 4500 for identifying presented content based on remote control inputs according to an exemplary embodiment of the present invention. In one exemplary embodiment of the present invention, a method and/or a system for substituting media content, as discussed in further detail with reference to FIGS. 73-76, comprises an element, step, technology, or other item that FIG. 45 illustrates.

The system 4500 comprises an interactive remote control 4510 that tracks presentation of content by monitoring the user's 3421 channel selections 3535 input into the interactive remote control 4510. The system 4500 further comprises a broadcast network 105 that broadcasts content to broadcast receivers 2205 in multiple residences (or locations) 3411, one of which is illustrated in FIG. 45. The residence 3411 comprises connectivity to a broadcast network 105 and to a distributed computing network 4560, such as the Internet 2225. The system 4500 also comprises a remote processing center 4505 coupled to the residence 3411 via the distributed computing network 4560. As an alternative to a distributed computing network 4560, the remote processing center 4505 can be linked to the residence 3411 via a telephony network or other wide area network.

The user 3421 enters a channel selection 3535 or channel tuning input into the interactive remote control 4510 by pressing one or more buttons, pressing a key on a keypad, engaging a switch, or speaking a command for microphone reception, for example. The user 3421 may enter the channel selection 3535 because the user 3421 wishes to surf through available channels without having a specific channel destination in mind. Alternatively, the user 3421 may enter the channel selection 3535 based on the knowledge that a particular program or other content is or will be presented on a particular channel. The user's knowledge of the correspondence between programming content and channel selection can come from a programming guide that the broadcast network 2205 airs on a dedicated channel, from a program schedule in a magazine or newspaper, or from a display (not shown in FIG. 45) on the interactive remote control 4510, for example.

A channel control module 3545 in the interactive remote control 4510 receives the channel selection 3535 from the user 3421 and modulates a LED 3825 in a pattern that carries the channel selection command in a channel control signal 2212 via air 3525 to the broadcast receiver 2205. The broadcast receiver 2205 responds to the channel control signal 2212, tunes to the selected channel, and presents the content 3410 that the broadcast network 105 is broadcasting on the selected channel. The user 3421 views the content 3410, which can comprise entertainment content, educational content, and/or advertising content.

The channel control module 3545 also forwards the channel selection 3535 to a channel identifier module 3550. The channel identifier module 3550 correlates the user's channel selection 3535 to the content 3410 that the broadcast network 105 is broadcasting on the selected channel and that the broadcast receiver 2205 is presenting in response to the user's channel selection input 3535.

The channel identifier module 3550 transfers the identification of the content 3410 presented on the broadcast receiver 2205 to the data interface 3560 of the interactive remote control 4510. The data interface 3560 communicates the identification as data to the RF antenna 3870, which communicates the channel selection data 4540 via the air 3525 to the data station 3450. The data station 3450 transmits the user's viewing pattern over the distributed computing network 4560 to a remote processing center 4505 for analysis and compilation with the viewing patterns of other users at other residences (not shown in FIG. 45).

In one exemplary embodiment, the channel identifier module 3550 tracks and statistically analyzes the user's ordinary pattern of changing channels of the broadcast receiver 2205 and discards any channel selection input 3535 that appears to be invalid based on the statistical analysis. For example, for a user 3421 that historically tunes the broadcast receiver 2205 approximately once per hour, the channel identifier module 3550 might discard data that indicates that this user 3421 has viewed several continuous days of programming without changing the channel. Several days of presenting programming on a single channel can be consistent with the user 3421 leaving a television powered on during an out-of-town vacation or other anomalous circumstance. Under such circumstances, the acquired usage data may be eliminated from further characterization of the user's viewing patterns. In other words, the channel identifier module 3550 can identify anomalous or bad data related to a user's content-viewing patterns or channel selections and can discard such data to avoid wrongly skewing the analysis at the remote processing center 4505.

In an exemplary embodiment, the interactive remote control 4510 communicates the user's raw channel selections 3535 to the data station 3450 in the channel selection data 4540. In other words, the interactive remote control 4510 can function as a repeater, sending optical channel control signals 2212 to the broadcast receiver 2205 and corresponding RF channel selection data signals 4540 to the data station 3450. In that case, the content identifier can forward the channel selection 3535 to the data interface 3560 without correlating the channel selection 3535 to the presented content 3410. Then, the data interface 3560 communicates the channel selection 3535 as the channel selection data 4540 to the data station 3450 via the RF antenna 3870.

Software executing on the data station 3450 can map the user's channel selections 3535 to the programming and advertising content 3410 presented via the broadcast receiver 2205. The remote processing center 4505 can communicate to the data station 3450 a table, map, or synchronization signal for the content 3410 broadcast by the broadcast network 105 to the broadcast receiver 2205 for presentation on the selected channel. Then, the data station 3450 can compare the channel selection 3535 to the received content information to determine the content 3410 presented by the broadcast receiver 2205 in the selected channel during the corresponding time period. After identifying the content 3410 presented on the selected channel, the data station 3450 can communicate that information to the remote processing center 4505 for statistical compilation and analysis.

In another exemplary embodiment, the data station 3450 can send the user's raw channel selections 3535 to the remote processing center 4505, where servers or other computers (not shown in FIG. 45) can process those selections 3535 to characterize the viewing patterns of a user 3421 or a set of users 3421. The remote processing center 4505 can estimate and characterize the audience of a specific content, program, or advertisement broadcast over the broadcast network 105 in a manner similar to that of the data station 3450 discussed above.

In addition to identifying content broadcast to the residence 3411 via electronic transmission, the system 4500 can identify writings broadcast to the residence 3411 on physical media. In one exemplary embodiment of the present invention, the interactive remote control 4510 includes a barcode scanner (not shown in FIG. 45) that can identify printed content by scanning a barcode or other machine-readable mark associated with the printed content. The system 4500 can track a user's pattern of printed material consumption based on data scanned from publications, books, product packing, newspapers, and other printed materials. The system can also estimate an audience of a writing based on scanned data that the interactive remote control 4510 forwards to the remote processing center 4505. Furthermore, the system 4500 can identify product consumption patterns of select users 3421 or a broader class of consumers based on UPC data that the interactive remote control 4510 acquires from the packaging of consumed products.

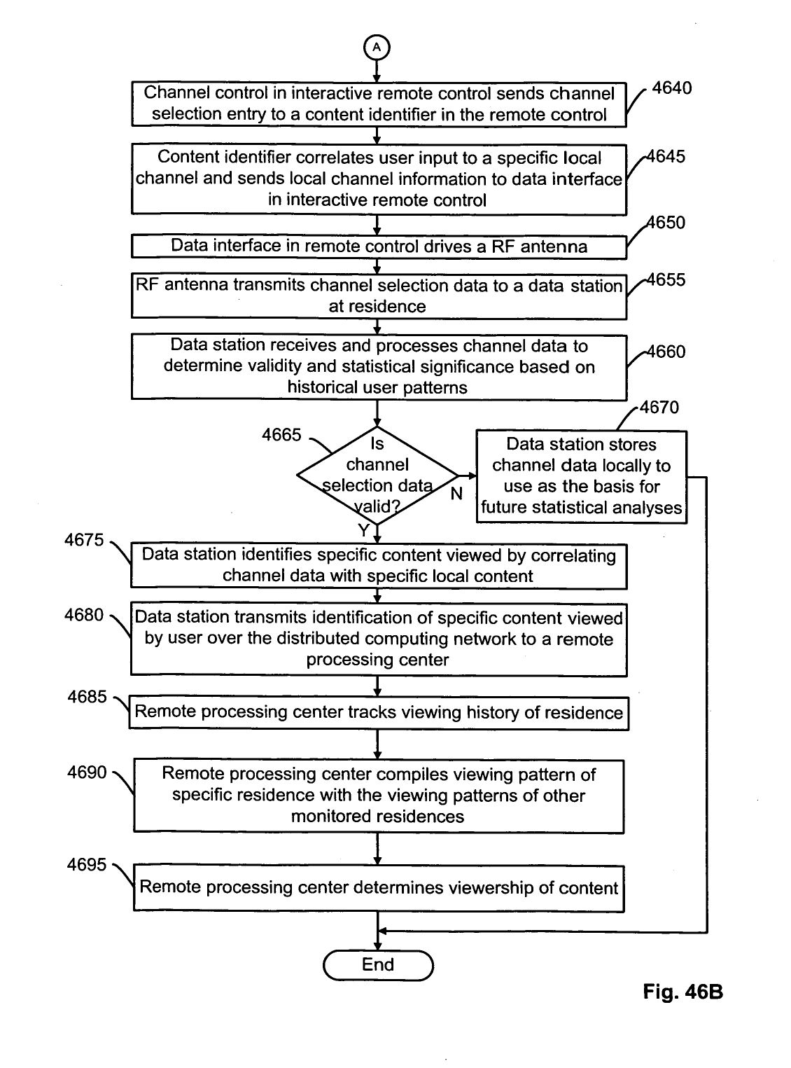

FIGS. 46A and 46B are flow charts illustrating a process 4600 for identifying content 3410 presented by a broadcast receiver 2205 by monitoring user 3421 channel selections 3535 input into the interactive remote control 4510 according to an exemplary embodiment of the present invention.

In one exemplary embodiment of the present invention, a method and/or a system for substituting media content, as discussed in further detail with reference to FIGS. 73-76, comprises an element, step, technology, or other item that FIGS. 46A and 46B illustrate.

The process 4600 will be described below with reference to the system 4500 illustrated in FIG. 45 using an example of broadcasting content to one or more residences 3411 via communication signals. The steps of the exemplary process 4600 can be adapted to identify printed content broadcast to such residences 3411 via physical media using an interactive remote control 3411 comprising a barcode scanner 3580 as illustrated in FIG. 35 and discussed above. That is, an exemplary embodiment of the present invention can identify products and printed materials used at a residence 3411 and perform analysis on residential usage patterns of such items in a manner similar to the analyses illustrated in FIGS. 46A and 46B and discussed below.

Referring back to FIG. 32, the method 3200 for real-time capture of audience information comprises the step 3215 in which the method 3200 determines whether a particular recipient received the broadcast content. In an exemplary embodiment, step 3215 can comprise the process 4600. In that case, step 3210 of the method 3200 is not required.

As shown in FIG. 46A, in step 4605 of the process 4600, the broadcast network 2205 broadcasts multiple content selections, each on a broadcast channel, to multiple residences (or locations) 3411. In step 4615, the user 3421 at a specific one of the residences 3411 enters a channel selection 3535 via a keypad (not shown) or microphone (not shown) into the interactive remote control 4510.

In step 4620, the channel control module 3545 reads the user's channel selection input 3535 and pulses or modulates an LED 3825 in a sequence that the broadcast receiver 2205 interprets as a channel control command signal 2212. In step 4625, the LED 3825 communicates the channel control signal 2212 via the air 3525 to the broadcast receiver 2205.

In step 4630, the broadcast receiver 2205 receives the channel control signal 2212 and, in response, tunes to the selected channel corresponding to the channel control signal 2212 and presents the content 3410 broadcast on that channel. In step 4635, the user 3421 views, listens, or otherwise becomes exposed to the presented content 3410. In step 4640, illustrated in FIG. 46B, the channel control 3545 in the interactive remote control 4510 communicates the channel selection 3535 to the channel identifier module 3550.

Then, the channel identifier module 3550 correlates the user's channel selection entry 3535 with a specific local channel in step 4645. The channel identifier module 3550 provides local channel information to the data interface 3560. For example, the user 3421 might press the “one” key and the “nine” key on a keypad (not shown) of the interactive remote control 4510 to tune the broadcast receiver 2205 to receive the television programming that the broadcast network 105 is broadcasting over its “channel nineteen.” In that example, the channel identifier module 3550 might determine that the cable television network's channel nineteen corresponds to the local CBS channel, which in addition to being carried by the broadcast network 105, is broadcast by the local CBS affiliate's antenna to the local region on a frequency known as “channel three.”

In step 4650, the data interface 3565 encodes the identity of the local channel in an RF signal and drives an RF antenna (not shown in FIG. 45) in the interactive remote control 4510 with the RF signal. In step 4655, the RF antenna communicates the channel selection data 4540 to the data station 3450 at the residence 3411. In step 4660, the data station 3450 receives the selection data 4540 and processes it to determine its validity and/or statistical significance based on the user's historical channel selection patterns.

If in inquiry step 4665 the data station 3450 determines that the channel selection data 3450 is not valid, then the process 4600 branches to step 4670. In step 4670, the data station 3450 stores the invalid data 3450 locally. Stored invalid data can be used as consideration for determining the validity of subsequent data transmission. In other words, the data station 3450 can determine the validity of channel selection data 4540 and eliminate invalid channel selection data from consideration in determining the viewing patterns of the user 3421. The eliminated data can be retained and used as a basis for determining the validity of future data transmissions. Process 4600 ends following step 4670.

If the data station 3450 determines at inquiry step 4665 that the channel selection data 4540 is valid, then the process 4600 branches to step 4675. In step 4675, the data station 3450 identifies the specific content 3410 presented via the broadcast receiver 2205 by correlating the channel selection data 4540 with the corresponding content 3410 presented on the selected channel. In an exemplary embodiment, the data station 3450 performs the correlation based on a programming and advertising schedule downloaded from the remote processing center 4505 via the network 4560.

In step 4680, the data station 3450 communicates the identification of the content 3410 presented by the broadcast receiver 2205 via the distributed computing network 4560 to the remote processing center 4505. In step 4685, the remote processing center 4505 tracks and/or characterizes the viewing habits or historical patterns of the user 3421 and/or the residence 3411. In step 4690, the remote processing center 4505 compiles the viewing patterns of the user 3421 and/or the residence 3411 with the viewing patterns of other users and residences that also are coupled to the broadcast network 105 and the remote processing center 4505.

In step 4695, the remote processing center 4505 determines the viewership of the content 3410 broadcast over the broadcast network 105 and characterizes the audience of the content 3410. The remote processing center 4505 can determine the size and demographics of the audience for the advertising commercials, games, programs, entertainment, and educational materials broadcast over the broadcast network 105.

In an exemplary embodiment, the remote processing center 4505 aggregates the viewing patterns of users on multiple broadcast networks (not shown), each linked to the remote processing center 4505 via the distributed computing network 4560 and/or another wide area network. In that regard, the remote processing center 4505 can determine the number of residences 3411 comprising broadcast receivers 2205 that presented the selected channel and corresponding content 3410. In another exemplary embodiment, the remote processing center 4505 can determine the demographics of specific users 3421 the input the channel selection 3535 corresponding to the presented content 3410. The remote processing center 4505 can make that determination based on stored demographic information associated with known users 3421. The interactive remote control 4510 can communicate user identification information to the center 4505 to identify the known users 3421. For example, a user 3421 can log into the center 4505 to identify subsequent communication from the corresponding interactive remote control 4510 as associated with the logged-in user 3421.

Using an estimate of viewership or usage of the content segments 3410 broadcast over the broadcast network 105, Advertisers, Promoters, content distributors, content producers, product suppliers and other entities involved in providing consumers with content and products can adjust their operations and offerings to serve their profits and business interests and provide consumers with higher value.

Interaction with Writings

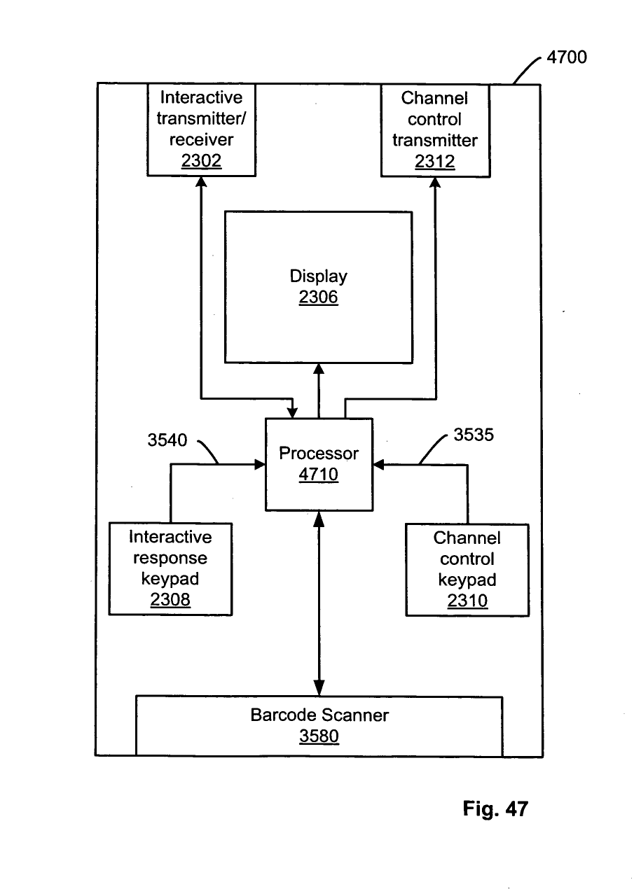

FIGS. 47 through 50B will now be discussed with reference to FIGS. 35 and 39. FIG. 47 is a functional block diagram illustrating an interactive remote control 4700 with a barcode scanner 3580 according to an exemplary embodiment of the present invention.

In one exemplary embodiment of the present invention, a method and/or a system for substituting media content, as discussed in further detail with reference to FIGS. 73-76, comprises an element, step, technology, or other item that FIG. 47 illustrates.

In one exemplary embodiment of the present invention, the system 3500 illustrated in FIG. 35 and discussed above can comprise the interactive remote control 4700 illustrated in FIG. 47. Specifically, interactive remote control 4700 of FIG. 47 substitutes for interactive remote control 3410 of FIG. 35.

The interactive remote control 4700 comprises a channel control transmitter 2312 for controlling an appliance, such as a television, radio, or VCR, that presents content to a user 3421. Such an appliance can present content by converting electrical signals or other communication signals into perceivable sound and/or light. The channel control keypad 2310 accepts command inputs for the appliance from the user 3421.

The barcode scanner 3580 scans printed materials such as magazines, documents, publications, catalogs, flyers, brochures, newspapers, products, product packaging, and other writings to acquire data associated with machine readable marks attached thereto. The barcode scanner 3580 can acquire UPC data as well as other data represented in barcode format. In one exemplary embodiment of the present invention, the interactive remote control 4700 comprises a scanner 3580 that is operative to recognize printed characters such as letters, numbers, and symbols.

The user 3421 can view a television program presented on a broadcast receiver 2205 while intermittently leafing through a magazine, for example. The user 3421 can tune the broadcast receiver 2205 with the interactive remote control 4700 and further use the interactive remote control 4700 to interact with printed content of the magazine. An appearance of a CR\overline{A}V Ad on the magazine can draw the user's attention from the content 3510 presented on the broadcast receiver 2205 to the CR\overline{A}V Ad. Recognizing the advertisement as being interactive based on a CR\overline{A}V logo or other distinguishing feature, the user 3421 can direct the interactive remote control 4700 to the magazine to initiate an immersion level of interaction with the magazine's advertising content.

The CR\overline{A}V Ad can include a machine readable identifier such as a barcode or another pattern of characters or marks that the barcode scanner 3580 reads to acquire data. The barcode scanner 3580 transfers such scanned data to the processor 4710. Software programs executing on the processor 4710 format the scanned data for wireless transmission to the data station 3450 via the interactive transmitter/receiver 2302.

The data station 3450 transmits the scanned data, which identifies the CR\overline{A}V Ad, over the Internet 2225 to the remote server computer 2230. The server computer 2230 processes scanned data and returns messages via the Internet 2225 and the data station 3450 for display on the interactive remote control's display 2306. Such exemplary messages can comprise CR\overline{A}V questions, promotional content, follow-on advertisements, gaming information, product usage suggestions, awards, discounts, survey questions, contest information, prize redemption codes, or detailed product specifications, for example.

The user 3421 can make entries via the interactive response keypad 2308 in respond to messages presented on the interactive remote control's display 2306. For example, the user 3421 can reply to CR\overline{A}V questions, request additional product details, enter a contest, request mailing of an award certificate or coupon, rate product performance, characterize satisfaction with a product, order a product, or redeem prizes using the interactive response keypad 2308. The interactive transmitter/receiver 2302 transmits such user entries to the server computer 2230 via the data station 3450 and the Internet 2225.

Using one handheld device, a user 3241 can not only control channel selections of a broadcast receiver 2205, but also interact with content printed on a physical medium and content 3510 transmitted electronically to a residence 3411 for display on the broadcast receiver. Specifically, the interactive remote control 4700 can interact with content broadcast via signals and content broadcast via physical distribution.

In one exemplary embodiment of the present invention, the interactive remote control 4700 comprises an RFID device (not shown) that can acquire data from items that have an associated RFID tag. The RFID device can be an RFID scanner or reader that supplies radiant energy to an RFID tag, coupled to a product, an advertisement, or to another physical item, and collects or receives energy that passively scatters back or otherwise emanates from the tag in response to the radiant energy. Alternatively, the interactive remote control 4700 can comprise an RFID scanner that receives RF signals actively emanating from a RFID tag via a RF source or generator connected to the tag. Thus, an RFID device associated with the interactive remote control 4700 can scan passive RFID tags that lack an onboard power supply or active RFID tags that have an onboard power supply.

In one exemplary embodiment of the present invention, an RFID scanning device takes the position of the barcode scanner 3580 illustrated in FIG. 47. That is, an RFID scanning device can provide a similar function to, or a similar information result as, the barcode scanner 3580 illustrated in the interactive remote control 4700 of FIG. 47. Such an RFID scanning device can support the functions and processes illustrated in FIGS. 1-50B and discussed herein, for example.

In one exemplary embodiment of the present invention, the interactive remote control 4700 operates in a wireless operating environment. A cellular communication network can covey information between the interactive remote control 4700 and a remote processing site, for example. To support wireless communication over an extended distance, the interactive remote control 4700 can comprise a long-range transceiver linked to a satellite communication system, a communication relay, or a long distance telephony system, for example.

In one exemplary embodiment of the present invention, scanning a barcode with the barcode scanner 3580 modifies or updates one or more functions or features of the interactive remote control 4700. The barcode scanner 3580 can acquire dynamic update information, such as direct dynamic update data, from a barcode or other machine readable mark. The interactive remote control 4700 can have a memory (not shown on FIG. 47) that stores acquired update data. Update data acquired from a barcode can include executable code or instructions.

The interactive remote control 4700 can acquire enhanced functionality or operability via scanning a mark that comprises update data, configuration data, revised software, or a patch program. For example, scanning a mark can upgrade the interactive remote control 4700 to provide compatibility with a new generation of CR\overline{A}V advertisements or a new broadcast receiver 2205. A CR\overline{A}V communication can comprise executable instructions or other data that modify the interactive remote control's operability. In association with scanning a CR\overline{A}V communication, a scanning device associated with an interactive remote control 4700 can read such data for uploading into the interactive remote control 4700.

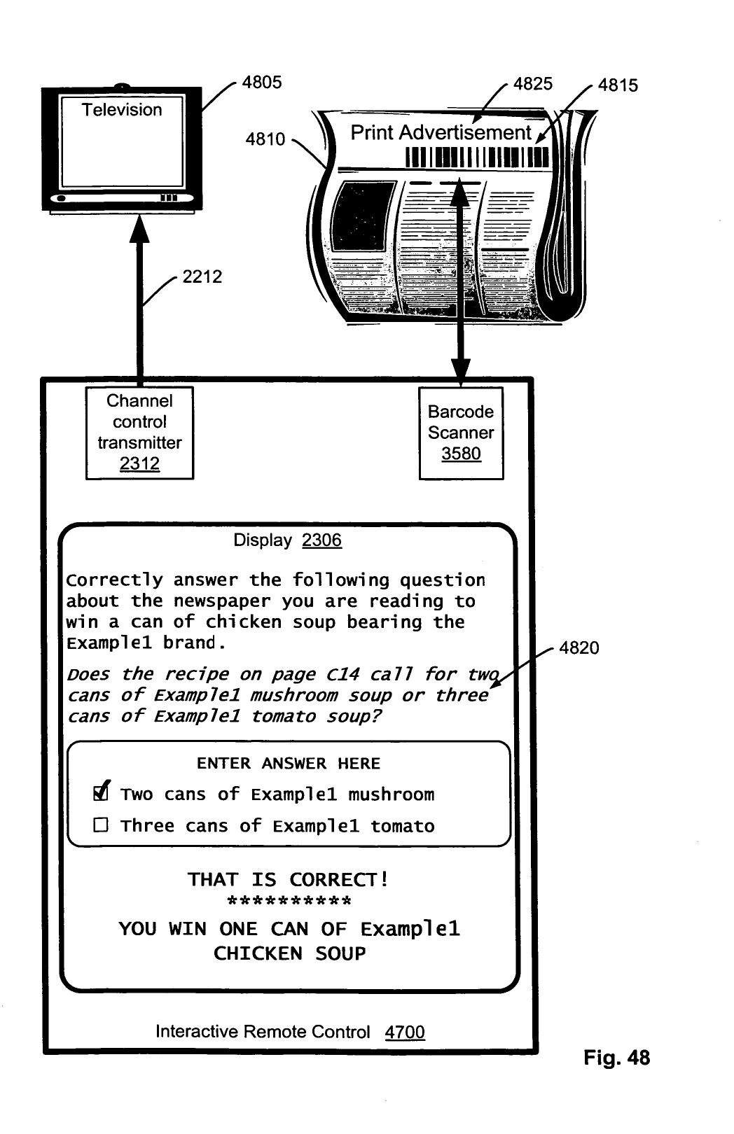

FIG. 48 illustrates an interactive remote control scanning a paper 4815 and displaying a question 4820 regarding printed content of the paper 4810 according to an exemplary embodiment of the present invention. This figure illustrates an exemplary scenario for using the interactive remote control 4700 of FIG. 47 to interact with printed material, in this case a newspaper 4810.

In one exemplary embodiment of the present invention, a method and/or a system for substituting media content, as discussed in further detail with reference to FIGS. 73-76, comprises an element, step, technology, or other item that FIG. 48 illustrates.

The channel control transmitter 2312 sends control signals 2212 to the television 4805 to adjust volume or change channels, for example, according to user input. The television 4805 can be a broadcast receiver 2205.

The newspaper 4810 comprises a barcode 4815 associated with an exemplary print advertisement 4825 that promotes the “Example1” brand of soup. “Example1” is a fictitious and exemplary brand name. When the user 3421 scans the newspaper's barcode 4815 with the interactive remote control's barcode scanner 3580, a CR\overline{A}V communication, transmitted from the server computer 2230, appears on the display 2306. The communication offers the user 3421 a can of Example1 chicken soup for correctly answering a CR\overline{A}V question 4820 regarding the content of the newspaper 4810. The CR\overline{A}V question 4820 directs the user 3421 to page C14, for example the food section, to find the question's correct answer. The question 4820 specifically asks, “Does the recipe on page C14 call for two cans of Example1 chicken soup or three cans of Example1 tomato soup?”

The question stimulates the user 3421 to turn to the referenced page and read the recipe to compose a correct response, thereby immersing the user 3421 in an advertisement or promotion for Example1 brand. If the user 3421 enters the correct response, which is “two cans of Example1 mushroom,” the interactive remote control 4700 displays notification of winning a can of Example1 chicken soup. The server computer 2230 can initiate mail delivery of a coupon redeemable for the can of chicken soup, for example. Alternatively, the server computer 2230 can transmit a message to a grocery store frequented by the user 3421 notifying the store to provide the user 3421 with a free can of Example1 mushroom soup at the user's next shopping trip.

If the user 3421 enters an incorrect response to the CR\overline{A}V question 4820, the interactive remote control 3410 can display another question that continues to immerse the user 3421 in advertisements for products carrying the Example1 brand. For example, a follow up question might ask, “Does the recipe on page C14 require cooking two cans of Example1 mushroom soup for ten minutes or for twenty minutes?” Continued interaction can extend the period of time that the user 3421 is immersed in advertising or promotion for Example1 products.

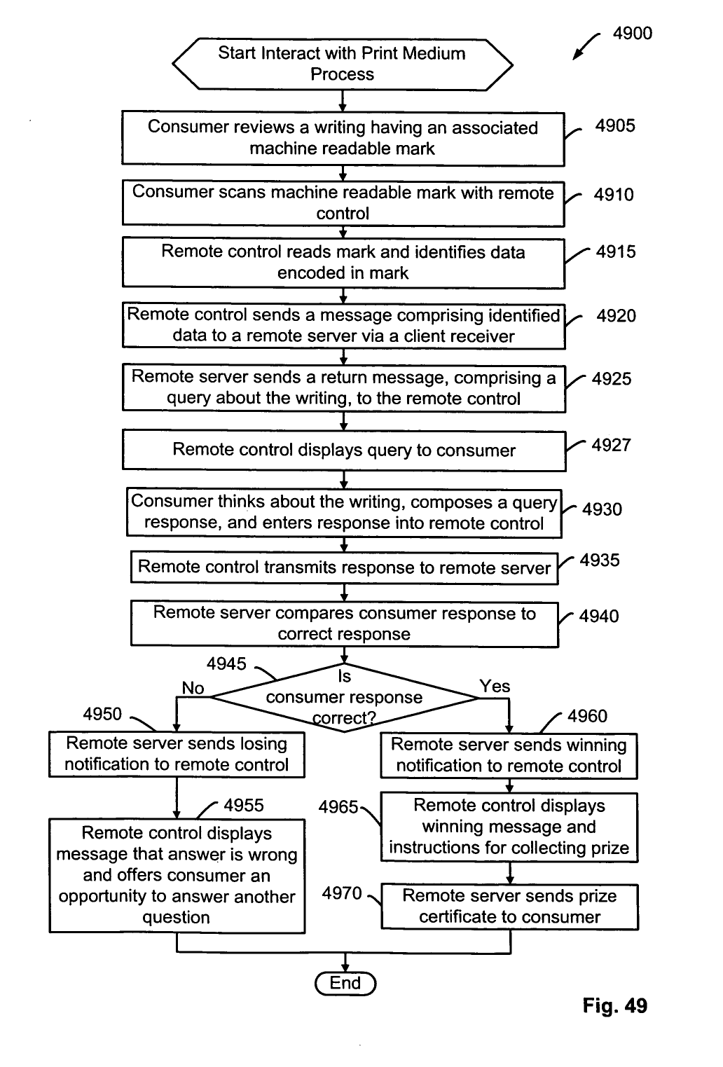

FIG. 49 is a flow chart illustrating a process 4900 for interacting with printed content using an interactive remote control 4700 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 49 illustrates.

In step 4905, a consumer, such as the user 3421 illustrated in FIG. 35, reviews or reads a writing having an associated machine readable mark. The writing can be, for example, a document, publication, book, magazine, article, coupon, postcard, advertisement, mailing, product, product packaging, newspaper 4810, or other physical medium having printing thereon. The writing can also comprise text or graphics printed on a product, product packaging, a physical article, or a tag associated with a product, for example. The associated machine readable mark can be a barcode 4815, or other pattern of marks or characters that a scanner, such as a barcode scanner 3580, can recognize.

In step 4910, the consumer scans the writing, specifically the machine readable mark, with the barcode scanner 3580 of the interactive remote control 4700. A CR\overline{A}V logo or other indicator that the writing is interactive can prompt the consumer to scan the writing.

In step 4915, the interactive remote control 4700 reads the machine readable mark and identifies data encoded within the mark. That is, the interactive remote control's processor 4710 extracts data from a pattern of machine readable marks. For example, the processor can extract a UPC from a barcode 4815 on a product.

In step 4920, the interactive remote control 4700 sends a message comprising the identified data to a remote server computer 2230. This message transmits from the interactive transmitter/receiver 2302 of the interactive remote control 4700 to the data station 3450 via wireless transmission. The data station 3450 can comprise a client receiver 2215, a client transmitter 2215, and a client computer 2220. The data station 3450 sends the message to the server computer 2230 via the Internet. In another exemplary embodiment, the interactive remote control 4700 transmits the message directly to a remote processing center, comprising a server computer 2230, via wireless transmission. Such a remote processing center can comprise a client receiver, a client transmitter, and a client computer.

In step 4925, the remote server computer 2230 sends a return message to the interactive remote control 4700 in response to receiving the data message that the interactive remote control 4700 transmitted in step 4920. The return message comprises a query regarding the writing, for example a CR\overline{A}V question about an advertisement. The remote server computer 2230 can generate the question based on a demographic profile of the user 3421.

As an alternative to a CR\overline{A}V question about an advertisement, the return message can comprise a question that is not directly related to an advertisement. For example, the message can comprise a trivia question or a question about a product physically coupled to a scanned barcode 4815. In one exemplary embodiment, submitting an answer to the question, either a correct answer or an incorrect answer, qualifies the consumer for entry into a lottery or other contest.

The remote server computer 2230 sends the return message via the Internet 2225 to the data station 3450, which in turn forwards the return message to the interactive remote control 4700.

In step 4927, the interactive remote control 4700 receives the return message and displays the query to the integral display 2306. For writings comprising multiple advertisements, the query can comprise a question directed to a selected portion of an advertisement.

In step 4930, the consumer contemplates the query and thinks about the content of the writing. Concentrating on the query and the content to compose an accurate answer immerses the consumer in the subject matter of the writing, for example to promote retention of advertising content. The consumer enters a query response into the interactive remote control 4700 using the interactive response keypad 2308.

In step 4935, the interactive remote control 4700 transmits the consumer's query response to the remote server computer 2230 via the data station 3450 and the Internet 2225. In step 4940, the remote server computer 2230 processes the query response to determine whether the consumer has answered correctly or incorrectly. That is, the submitted response can be deemed either accurate or inaccurate.

If the consumer has answered incorrectly, in step 4945 the process 4900 branches to steps 4950 and 4955. In step 4950, the remote server computer 2230 sends notification to the interactive remote control 4700 that the consumer has provided an incorrect response.

In step 4955, the interactive remote control 4700 displays a message informing the consumer that the submitted answer is incorrect. To continue immersing the consumer in advertising content, the interactive remote control 4700 can offer the consumer opportunities to continue answering questions until the consumer answers correctly and becomes eligible to win a prize, for example. Following step 4955, the process 4900 ends.

If the consumer has submitted a correct, rather than an incorrect, response, step 4945 branches the process 4900 to steps 4960, 4965, and 4970. In step 4960, the remote server computer 2230 sends a winning notification to the interactive remote control 4700. In step 4965, the interactive remote control 4700 notifies the consumer that the submitted answer is correct. This notification can also advise that a reward is forthcoming and provide redemption instructions.

In step 4970, the remote server computer 2230 initiates sending a prize certificate to the consumer as a reward for the correct answer. The prize certificate can be an electronic certificate transmitted to the interactive remote control 4700. The remote server computer 2230 can alternatively initiate mailing a physical prize certificate to the residence 3411 of the consumer. As another example, the remote server computer 2230 can send a notification to a business, such as a store that the consumer routinely visits, for prize redemption. The consumer's prize can be a monetary reward, an advertised product, or a premium, for example. As an alternative to a physical or monetary prize, the consumer's reward for submitting a correct answer can be entry into a drawing for a larger prize, such as an automobile, vacation, or significant cash purse. As yet another example, the consumer can receive a quantity of points that can be accumulated with other points towards receiving a moderate prize, for example a household appliance or a stock of a consumable product. Following step 4970, the process 4900 ends.

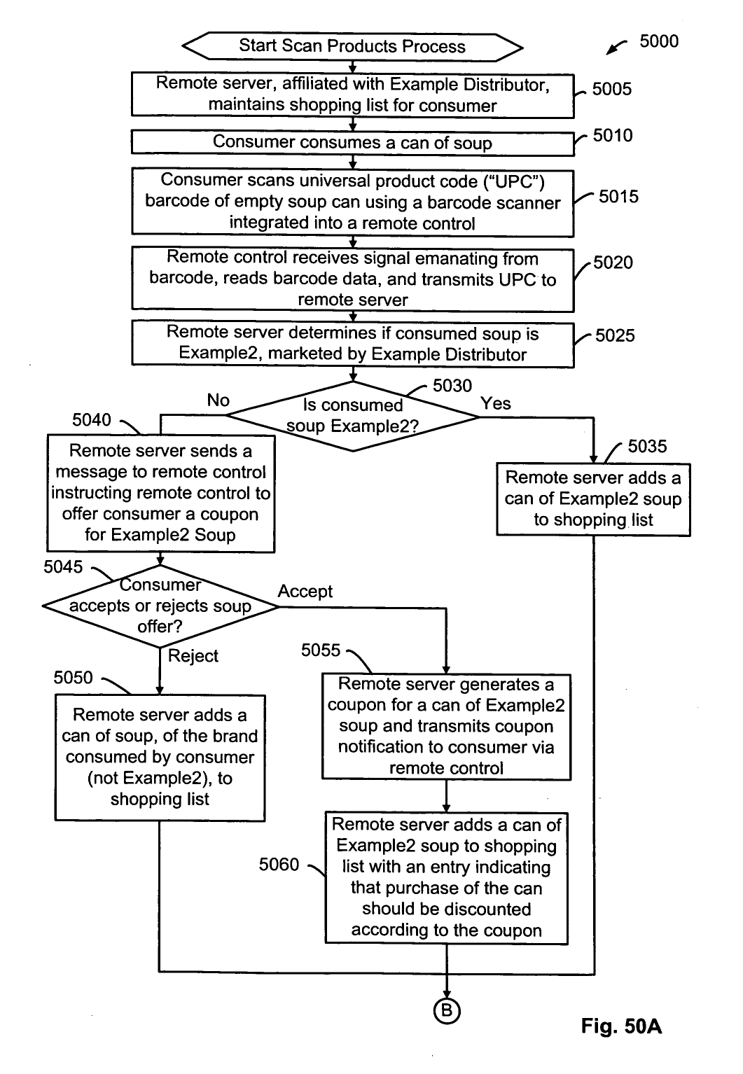

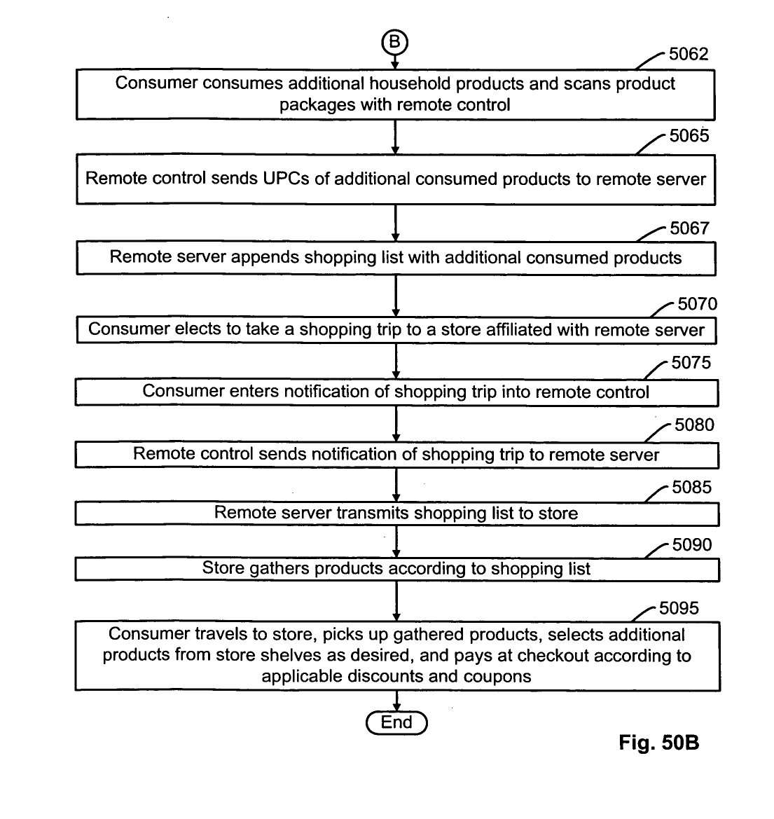

FIGS. 50A and 50B are a flow chart illustrating a process 5000 for scanning products with an interactive remote control 4700 according to an exemplary embodiment of the present invention. In one exemplary embodiment of the present invention, a method and/or a system for substituting media content, as discussed in further detail with reference to FIGS. 73-76, comprises an element, step, technology, or other item that FIGS. 50A and 50B illustrate.

In step 5005, the remote server computer 2230 maintains a shopping list for a specific consumer, for example the user 3421 illustrated in FIG. 35. This remote server computer 2230 typically maintains similar shopping lists for consumers in multiple residences 3411. The remote server computer 2230 can be under contract with one or more business entities that sponsor the shopping list service. In return for receiving payment from a sponsor, the operator of the shopping list service, can attempt to stimulate sales of the sponsor's products. In the specific example of the process 5000, Example Distributor, which is a fictitious name, maintains and operates the remote server computer 2230 to promote products that it distributes.

In step 5010, a consumer, such as a member of a household, consumes a can of soup. In step 5015, the consumer scans the UPC barcode of the empty soup can using the interactive remote control's barcode scanner 3580. Scanning a product or a product package typically involves placing the interactive remote control 4700 adjacent the product and engaging the barcode scanner 3580 to direct a laser beam onto the barcode.

In step 5020, the interactive remote control 4700 scans the UPC barcode, extracts its UPC, and transmits the UPC to the remote server computer 2230. That is, the remote control's scanner receives signals emanating from identifying marks or indicia associated with the product and transmits corresponding data to a processing center. The transmission path to the remote server computer 2230 can comprise a wireless data link between the interactive remote control 4700 and the data station 3450 and an Internet link between the data station 3450 and the remote server computer 2230. The transmission path can comprise a client computer 2220, a client transmitter 2215, and a client receiver 2215.

In another exemplary embodiment of the present invention, the remote server computer 2230 receives notification that the consumer has consumed the can of soup from a radio frequency identification (“RFID”) system (not shown) located at the residence 3411. Such an RFID system can comprise a RFID scanner coupled to a trashcan or similar disposal receptacle at the residence 3411. The RFID scanner can identify products consumed at the residence 3411 based on a pattern of radio frequency signals emanating from disposed product packaging. As an alternative to identifying consumed products, the RFID system can identify unconsumed products present at the residence 3411, for example products in storage. As discussed above, the interactive remote control 4700 can comprise an integrated RFID tag reader for acquiring data from household products.

In step 5025 of the process 5000, the remote server computer 2230 determines if the consumed soup is a product of the server's operator. In this example, the remote server computer 2230 determines if the soup is marketed under the brand name “Example2,” which is a fictitious name, by Example Distributor.

If the consumed soup is Example2 soup of Example Distributor, then step 5030 branches the process 5000 to step 5035. In step 5035, the remote server computer 2230 adds a can of Example2 soup to the consumer's shopping list to replace the consumed can.

The remote server computer 2230 can take additional actions in conjunction with adding the can of Example2 soup to the shopping list in step 5035. For example, the consumer can receive a discount or a coupon for the purchase of a can of Example2 soup, or another product in which Example Distributor has a financial interest. The operator of the remote server computer 2230 can also receive payment from other product companies for product promotion. For example, the server operator might receive a financial benefit for promoting a particular brand of crackers that are complementary to Example2 soup.

The remote server computer 2230 can also process product consumption data acquired from multiple residences 3411 to estimate consumer product usage patterns. That is, a remote server computer 2230 can aggregate product consumption data from consumers at various households and conduct statistical analysis on such data to refine advertising programs.

As another example of process steps that can accompany step 5035, the remote server computer 2230 can engage the consumer in a CR\overline{A}V interaction. The interactive remote control 4700 can present CR\overline{A}V questions to the consumer related to a consumed product or another advertised product. Answering a CR\overline{A}V question or another question, either related or unrelated to the product, can provide the consumer with a tangible benefit. For example, the consumer can receive entry into a sweepstakes or contest for a prize drawing by answering the question, even if the consumer's answer is incorrect. The remote control 4700 can display the question following product scanning without delay that the consumer finds perceptible or annoying. That is, the remote control 4700 can operate in an online manner or in an essentially real time mode.

If the consumed soup is not Example2 soup of Example Distributor, then step 5030 branches the process 5000 to step 5040. In step 5040, the remote server computer 2230 sends a command message to the interactive remote control 4700, instructing the interactive remote control 4700 to offer the consumer a coupon for a free can of Example2 soup. In response, the interactive remote control 4700 displays the offer on its integral display 2306.

Step 5045 branches the process 5000 according to the consumer's response to the free soup offer. If the consumer rejects the offer, in step 5050 the remote server computer 2230 adds to the shopping list a can of soup having whatever brand (not Example2 soup) that the consumer consumed.

Accepting or rejecting a product offer is an exemplary criterion for directing the flow of process 5000. The remote server computer 2230 can apply other criteria such as consumer demographics and answers to questions concerning product preferences. As a result of applying such criteria, the consumer can receive a benefit or the shopping list can include selected product entries, for example.

In connection with step 5050, the remote server computer 2230 can collect competitive market data from the consumer. For example, the interactive remote control 4700 can query the consumer to determine the consumer's reasons for preferring a competitive brand over Example2 soup.

If the consumer accepts rather than rejects the offer for a free can of Example2 soup, step 5045 branches the process 5000 to execute step 5055 rather than step 5050. In step 5055, the remote server computer 2230 generates a coupon for a can of Example2 soup and transmits notification of the coupon award to the consumer via the interactive remote control 4700, which in turn displays the award notification to the consumer.

In step 5060, the remote server computer 2230 adds a can of Example2 soup to the consumer's shopping list to replace the consumed can of soup (having a competitor's brand). The remote server registers the coupon grant on the consumer's shopping list in association with the Example2 soup entry. That is, the shopping list records not only the can of Example2 soup to be acquired, but also an indication that the consumer should receive the soup without making a monetary payment.

As an alternative to step 5060 as discussed above, the coupon can be an electronic coupon that the remote server computer 2230 transmits to the interactive remote control 4700, for storage in local memory. The consumer can transfer the electronic coupon to a preferred store for redemption via wireless transmission from the consumer's residence 3411 to the store. Alternatively, the consumer can physically transport the interactive remote control 4700 to the store. While at the store's premises, the interactive remote control 4700 can load the shopping list from memory to the store's management information system or other computer system. As yet another exemplary alternative, the consumer can print out a paper version of the coupon via a personal computer or a printer associated with the interactive remote control 4700. To accommodate acquiring the soup in sales outlets that lack communication and computer infrastructure, the remote server computer 2230 can initiate sending a physical coupon to the consumer's residence 3411 via postal service.

Following executing any of steps 5035, 5060, and 5050 as discussed above, the process 5000 executes step 5062, illustrated in FIG. 50B. In step 5062, the consumer consumes additional household products and scans the packages of the consumed products with the interactive remote control 4700. Such household products can be groceries, bleach, detergent, water softener, soft drinks, milk, eggs, bread, foodstuffs, household supplies, commodities, etc. The products can have a national brand or a store brand, or can be marketed as a generic or unbranded product.

In step 5065, the remote control sends the UPCs of these scanned products to the remote server computer 2230. In step 5067, the remote server computer 2230 receives UPCs and appends the consumer's shopping list with the scanned products, which correspond to the UPCs.

In step 5070, the consumer elects to take a shopping trip to a store affiliated with or in communication with the remote server computer 2230. In step 5075, the consumer makes an entry into the interactive remote control 4700 indicating that a shopping trip is forthcoming or underway. The consumer may specify, along with this entry, a particular store or chain of stores that the consumer has selected for the shopping excursion.

In step 5080, the interactive remote control 4700 transmits notification of the consumer's shopping trip to the remote server computer 2230. In step 5085, the remote server computer 2230 receives and acknowledges the shopping trip notification. The remote server computer 2230 transmits the consumer's shopping list, along with any discounts or awards that the consumer may have accumulated, to one or more shopping stores. Either a specific store that the consumer frequents or a network of stores affiliated with the shopping list service can receive the list.

In step 5090, the store gathers the consumer's products in a shopping cart or bin according to the shopping list in preparation for or contemporaneous with the consumer's shopping excursion. In step 5095, the consumer travels to the store to pickup the shopping order. The consumer may elect to add impulse or other product purchases to the pre-selected products. When the consumer has completed selecting products for purchase, the store scans the consumer's products at a checkout terminal and computes a total purchase price that takes into account any applicable coupons or discounts. The consumer pays the net purchase price and transports the purchased goods to the residence 3411 for consumption.

In another exemplary embodiment of the present invention, the consumer's shopping list can be filled without the consumer physically traveling to the store. The remote server computer 2230 can transmit the shopping list to a grocery store or another product source or distribution outlet that can deliver products to the consumer's residence 3411. That is, the consumer can order one or more products from the shopping list, or from another list populated by scanning items at the consumer's residence 3411, using the interactive remote control 4700. Following step 5095, the process 5000 ends.

Interacting With On-Demand Video Content

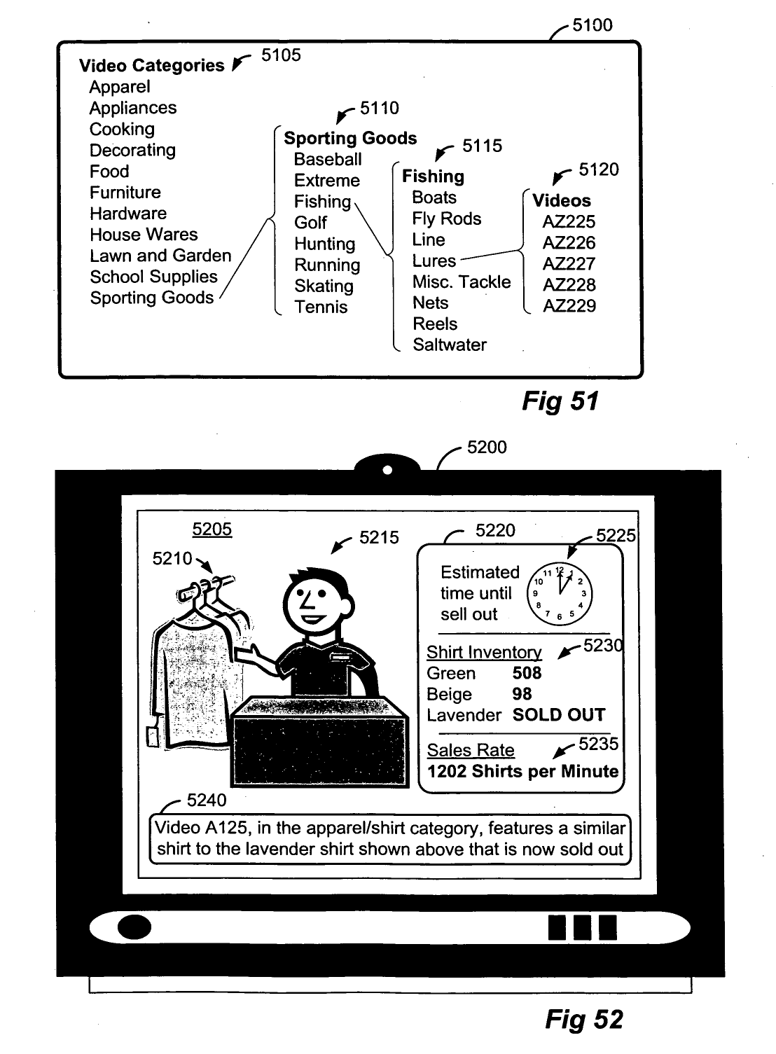

Exemplary embodiments of the present invention can provide a television viewer with an on-demand video that presents a sales offer for a product, item, good, or service and that responds to sales events, such as presenting dynamic sales or inventory data to the viewer. A method and system for providing remotely accessible shopping videos on a television that shows dynamic information in connection with prerecorded shopping content will now be described more fully hereinafter with reference to FIGS. 51-59, which show exemplary embodiments of the invention.

The various systems, modules, technologies, teachings, and methods discussed above and/or illustrated in one or more of FIGS. 1-50 can be applied to interacting with on-demand video content. In other words, an exemplary embodiment of the present invention can comprise or involve interacting with on-demand video content in connection with using the various methods, processes, and systems disclosed in any of FIGS. 1-50 and the accompanying text. Thus, in an exemplary embodiment of the present invention, the CR\overline{A}V methodology for advertising, sales, and promotional, taught at various places throughout this document can be applied to on-demand videos, including on-demand home shopping videos.

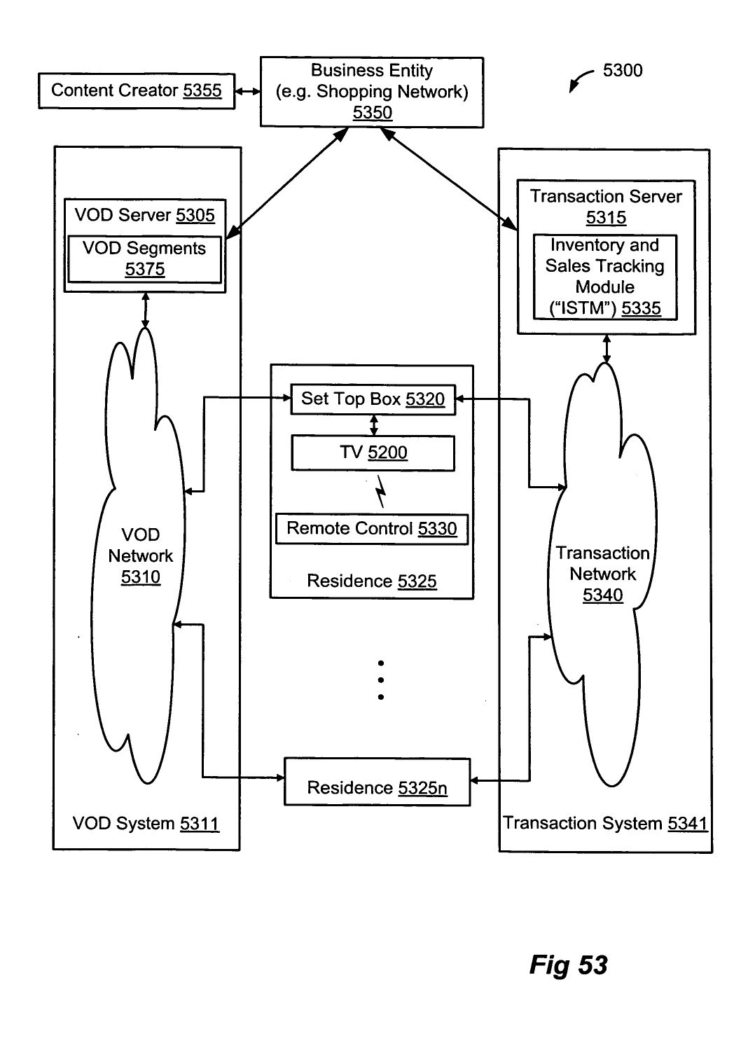

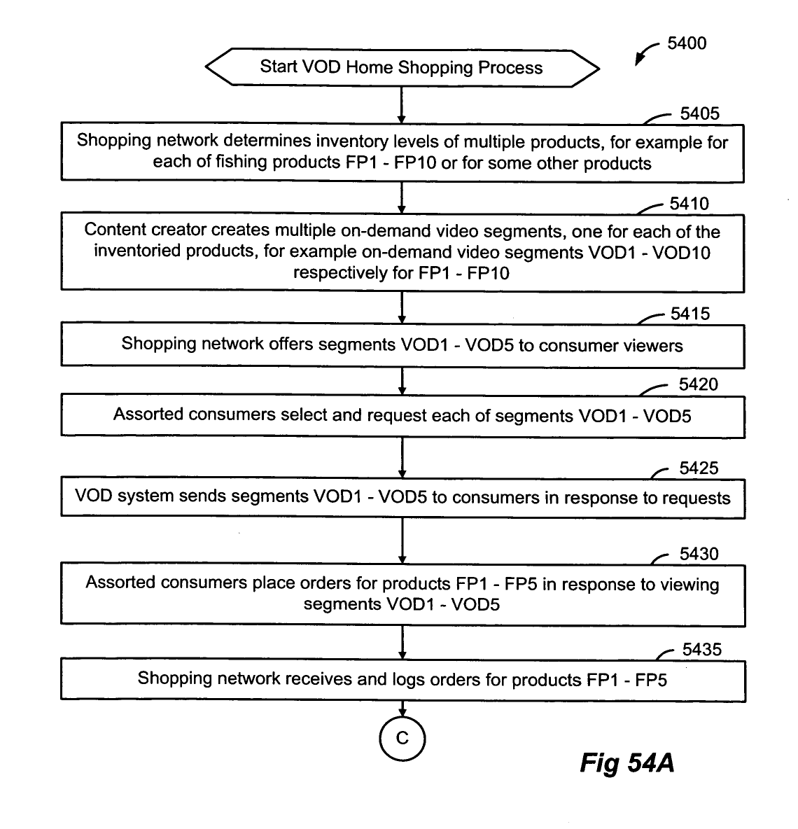

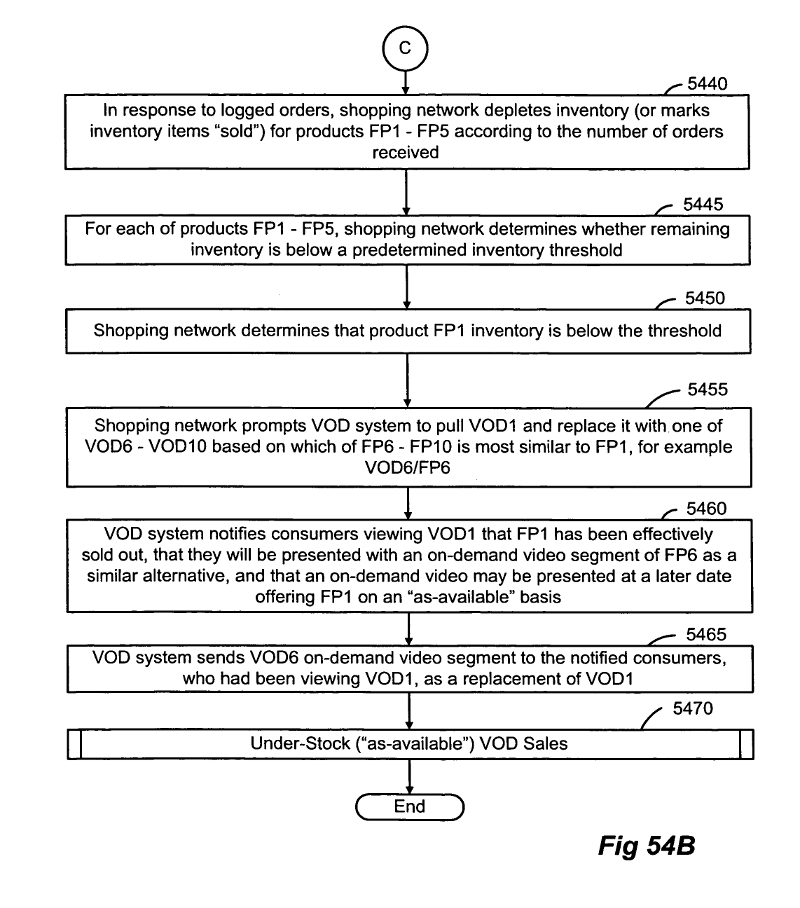

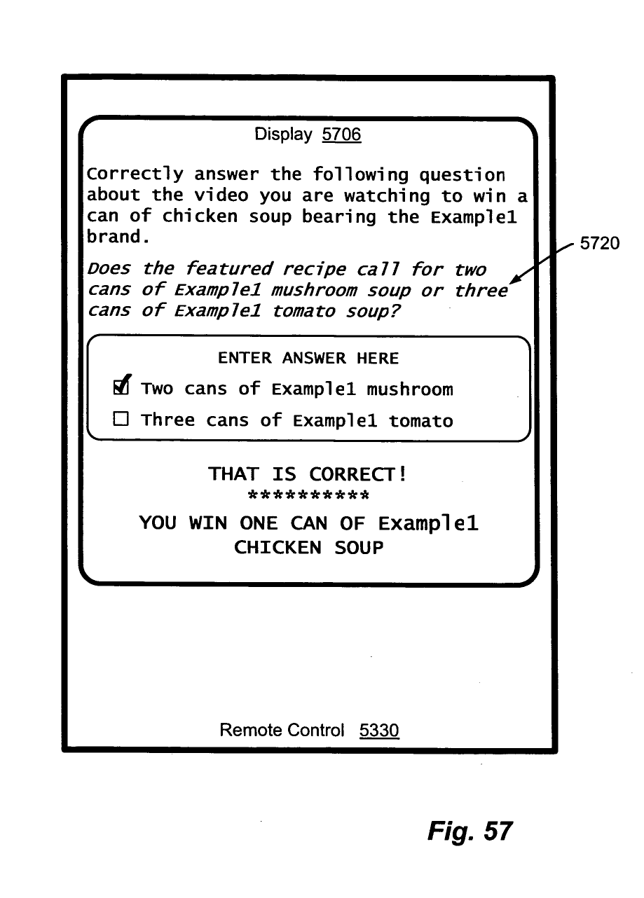

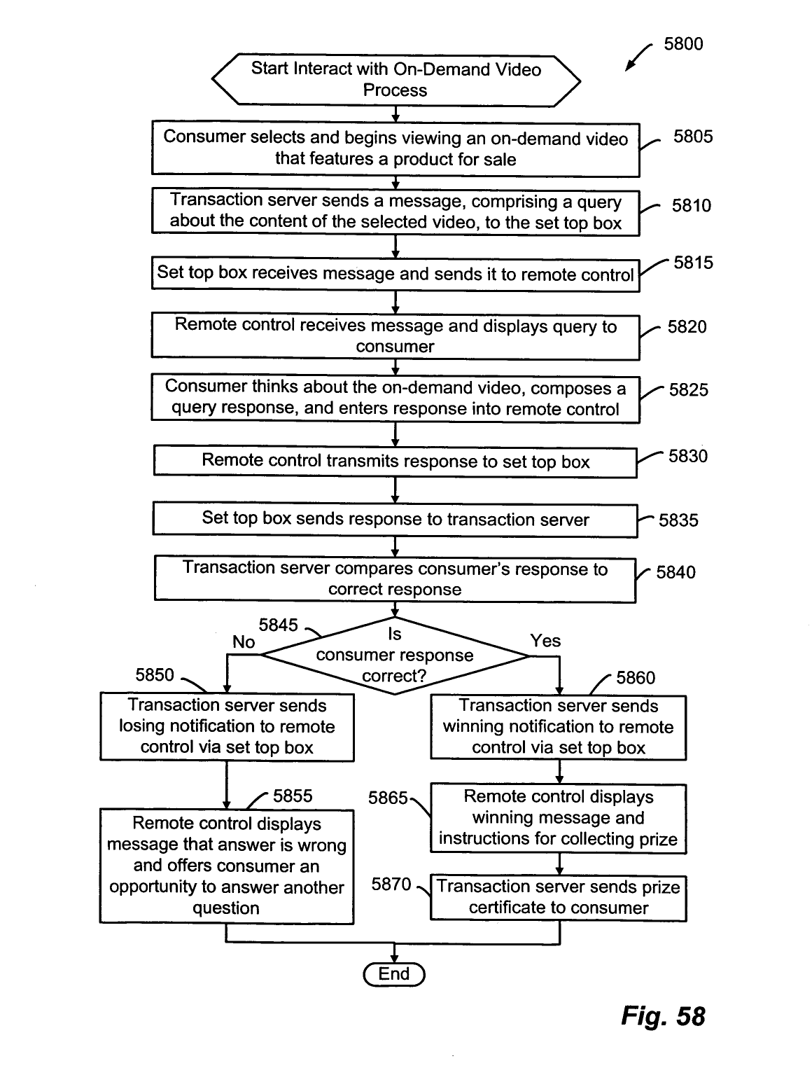

FIG. 51 provides an exemplary tree diagram or schema for organizing home shopping videos according to subject or genre. FIG. 52 provides an exemplary television screen for home shopping in a VOD environment. FIG. 53 provides an illustration of an exemplary network for distributing on-demand shopping videos. FIGS. 54, 55, 56, and 59 present flowcharts of exemplary processes relating to providing on- demand shopping videos. FIGS. 57 and 58 respectively illustrate an exemplary remote control and an exemplary process for interacting with on-demand shopping videos.

The invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” given herein are intended to be non-limiting, and among others supported by exemplary embodiments of the present invention.

Turning now to FIG. 51, this figure illustrates an hierarchical categorization 5100 of on-demand videos offering products for sale in accordance with an exemplary embodiment of the present invention.

In one exemplary embodiment of the present invention, a method and/or a system for substituting media content, as discussed in further detail with reference to FIGS. 73-76, comprises an element, step, technology, or other item that FIG. 51 illustrates.

A consumer can view the categories on a television screen, a computer terminal, or an interactive remote control that is accessible during viewing activities. Thus, FIG. 51 provides an illustration of an exemplary user interface through which the consumer can efficiently select shopping videos. Categorizing the on-demand shopping videos can comprise grouping, classifying, or organizing the videos according to subject matter, viewer taste, shopping departments, genre, or commonality of a feature, usage, or function of a featured product (not an exhaustive list).

In one exemplary embodiment of the present invention, on-demand shopping videos are categorized according to the demographics of the consumers that each video targets. In one exemplary embodiment of the present invention, each category of on-demand shopping video is associated with a demographic profile of the consumers that are likely to find the contents of the category appealing.

A cable multi-system operator (“MSO”) can warehouse a virtual mall of shopping genres on a VOD server. The consumer can immediately access a video of a specific genre by selecting a category offering and then hitting “enter” using a remote control or a pointing device. In this manner, each genre can be likened to a specialty store at a traditional bricks-and-mortal shopping mall. As a result, a shopping experience based on on-demand videos can emulate, replicate, or simulate the familiar shopping experience of walking through a traditional shopping mall. Further, the shopper can enjoy the efficiency and convenience of shopping from home.

The hierarchical categorization 5100 helps consumers efficiently select one or more videos when a purchasing desire for a particular type of product or item arises. The consumers are typically geographically dispersed and linked to one or more central sites that maintain a library, collection, or archive of videos for remote access. If planning a fishing trip, for example, the consumer can select the Sporting Goods Category 5110 to trigger an expansion of the topics or subjects in that category 5110. The category expansion can occur in a popup window, a drag-down menu, a display bar, in a separate screen, or via an expanding outline, to name a few possibilities.

Within the Sporting Goods Category 5110, the consumer can select the Fishing Category 5115 to explore the product types within that category. If interested in fishing plugs, the consumer can select the Lures Category 5120, to show a list of lure videos 5120. While FIG. 51 illustrates those lure videos 5120 by an alphanumeric code, other types of identifiers or descriptors may appear on a user interface. For example, video names or product brand names can distinguish or describe the videos 5120.

Categorizing videos or video content according to subject matter or genre can benefit various types of on-demand videos services and applications beyond shopping videos. For example, a VOD system can present an audience of consumers or other viewers with on-demand movies, entertainment, promotions, advertisements, or educational materials categorized by subject matter or organized in a tree. A VOD network can deliver such content on a “pay-per-view” basis, without charge, in exchange for advertising, or in accordance with other business terms or economic incentives.

The term “video-on-demand network” or “VOD network,” as used herein, refers to a system that is operable to provide moving images from storage to a viewing site in response to a request, demand, message, or prompt initiated at that viewing site. Videos comprising the moving images can be held at or on a storage facility comprising a server, an archive, a mass storage device, a machine-readable medium, or a video library, to name a few examples. Electrical, optical, or electromagnetic signals, or a combination thereof, typically convey or carry the moving images from a storage site to the viewing site.

The term “on-demand video,” as used herein, refers to content comprising moving images that a user at one site can download or otherwise access from another site.

The term “video-on-demand” or “VOD,” as used herein, refers to a descriptor or adjective for remotely accessing video or moving image content from a remote site on an as needed basis, upon entry of a request, in response to sending a message, via a prompt, or at the discretion of a user or a viewer.

Turning now to FIG. 52, this figure illustrates a television monitor 5205 playing an on-demand video that presents prerecorded shopping content 5210, 5215 and dynamic data 5225, 5230, 5235, 5240 related to sales or inventory in accordance with an exemplary embodiment of the present invention.

In one exemplary embodiment of the present invention, a method and/or a system for substituting media content, as discussed in further detail with reference to FIGS. 73-76, comprises an element, step, technology, or other item that FIG. 52 illustrates.

The video shown playing in FIG. 52 can be a selection from a catalog or menu of on-demand videos 5100 organized according to subject matter or product type, as illustrated in FIG. 51 and discussed above. As shown in FIG. 52, the consumer could have selected an on-demand video segment from the Apparel Section of the Video Categories 5105.

In response to the consumer selecting the on-demand video, a remote archive, storage facility, machine-readable medium, or server downloads prerecorded video content 5210, 5215 or otherwise makes content available for viewing on the consumer's television 5200. In addition to the prerecorded content 5210, 5215, the monitor or screen 5205 of the television 5200 shows dynamic information 5225, 5230, 5235, 5240 that changes or is updated while the video is playing. That is, the content that the consumer views comprises prerecorded images 5210, 5215 and live data 5225, 5230, 5235, 5240. Some aspect of the live data 5225, 5230, 5235, 5240 can change between the start of the video and the end of the video in a manner that is unknown a priori or before the start of the video with certainty. Thus, the live data 5225, 5230, 5235, 5240 can change in response to an event connected with showing the video. Furthermore, the live data 5225, 5230, 5235, 5240 can comprise a consumer or viewer response to a video presentation.

The displayed content comprises a moving image of a sales person 5215 delivering a sales presentation or a pitch for green, beige, and lavender shirts 5210. In response to viewing the sales pitch, the consumer can elect to place an order for one or more of the shirts 5210. The consumer may order the item telephonically, through an Internet connection to a website, using a wireless link to a remote host, or via another communication link or medium.

Often, consumers at various sites view the same on-demand shopping video at essentially the same time. For example, while a consumer at one site is viewing the midpoint of the on-demand video, another consumer at a different site might be viewing a concluding segment of that video. With consumers at various sites placing product orders at random times, the inventory of the shirts 5210 can diminish, thereby impacting product availability or the capacity of the video producer or sponsor to fill orders.

The television monitor 5205 presents an area or window 5220 with updatable fields that show dynamic inventory and sales data 5225, 5230, 5235 of interest to the consumer. The inventory section 5230 provides a count of the current shirt inventory that remains available for purchase. As various consumers place orders for shirts and the shirt stock diminishes, the inventory count changes until reaching a sold-out condition. At the time that FIG. 52 illustrates, 508 green shirts and 98 beige shirts remain in stock and available for purchase, while the lavender shirts have all been sold.

The dynamic window 5220 has an area 5235 that shows the consumer the sales rate of shirts, in this example 1202 shirts per minute. Providing sales information to the consumer can positively influence a purchasing decision, for example triggering the consumer to buy an item that is selling quickly.

A time gauge 5225 or clock shows the consumer an estimate of the time that remains until the shirt inventory is fully depleted. The estimate can be derived by dividing the inventory by the sales rate. As a sell out condition approaches, purchasing activity can accelerate in a manner that benefits the shirt vendor.

When the stock of lavender shirts sells out or when lavender shirt inventory drops below a specified threshold, a message 5240 appears on the screen 5205. The message 5240 informs the consumer that another on-demand video features an item that may be a viable replacement for the sold-out shirt. If the consumer elects to obtain that on-demand video or to purchase the recommended replacement, the consumer may be eligible for a discount.

In an alternative embodiment, the message 5240 can alert the consumer that the supply is too low to ensure availability. When inventory is insufficient to meet demand, an item may be placed on backorder or an order can be rejected.

Beyond providing current or up-to-date inventory data 5225, 5230, 5235, 5240 inserted in or overlaid on the viewing screen 5205, sales or inventory event data can support video feedback. In one exemplary embodiment of the present invention, some aspect of the on-demand video presentation changes as a result of a purchasing event that occurs during or in connection with a showing of the on-demand video. The consumer viewing a specific instance of the on-demand video can initiate the purchasing event. Alternatively, another consumer associated with a different television, for example in a different town or neighborhood, can initiate the purchasing event.

Turning now to FIG. 53, this figure illustrates a functional block diagram of a system 5300 for providing on-demand shopping videos that present prerecorded content integrated with dynamic data in accordance with an exemplary embodiment of the present invention. That is, the system 5300 can generate the images, text, and graphics and the underlying data illustrated in FIGS. 51 and 52 and discussed above.

In one exemplary embodiment of the present invention, a method and/or a system for substituting media content, as discussed in further detail with reference to FIGS. 73-76, comprises an element, step, technology, or other item that FIG. 53 illustrates.

The system 5300 comprises a VOD system 5311 and a transaction system 5341. Via the VOD system 5311 and the transaction system 5341, the system 5300 can serve a community, city, state, or region of a country populated with numerous residences 5325, 5325n.

A business entity, such as a shopping network 5350 that uses on-demand videos to market, sell, advertise, or promote goods of commerce, such as products and/or services, links or couples to the VOD system 5311 and the transaction system 5341. The linkages between the shopping network 5350 and the VOD system 5311 and the transaction system 5341 can be direct or may comprise an intermediary, such as another business entity or a cable operator. A content creator 5355 typically produces the on-demand videos for the shopping network 5350 as an internal department or as a contractor, for example.

The VOD system 5311 comprises a VOD network 5310 and a VOD server 5305 that stores prerecorded video content or VOD segments 5375. The VOD network 5310 links a plurality of residences 5325, 5325n to the VOD server 5305.

The transaction system 5341 comprises a transaction server 5315 and a transaction network 5340. An inventory and sales tracking module 5335 associated with or executing at the transaction server 5315 tracks and accounts for purchasing transactions or sales events initiated at the residences 5325, 5325n. The transaction network 5340 links the residences 5325, 5235n to the transaction server 5315.

The residences 5325, 5325n can be geographically dispersed or can be concentrated in a locale, such as a town, neighborhood, or community. In one exemplary embodiment of the present invention, the residences 5325, 5325n are geographically dispersed but share a common demographic characteristic, such as a socioeconomic standard. The present invention is not limited to a specific number of residences 5325, 5325n, but rather can support an arbitrary number. The system 5300 can comprise a single residence, several residences, several hundred residences, or many thousand residences 5325, 5325n. In exemplary embodiments, each of the residences 5325, 5325n can comprise a person's home, a hotel, a restaurant, a bar, a lobby, an airport waiting area, or another suitable location for remotely accessing and viewing a video.

The illustrated functional blocks 5320, 5200, 5330 of the residence 5325 are representative of other residences 5325n of the system 5300. That is, each of the residences 5325, 5325n can have an entertainment system or a television system that comprises a set top box 5320, a television 5200, and a remote control 5330.

The residences 5325, 5325n can be coupled to either or both of the transaction network 5340 and the VOD networks 5310 through a hardwire connection, a wireless connection, or another suitable facility to transfer signals. A hardwire connection can comprise coaxial cable, a fiber optic link, or another suitable connection. A wireless connection can comprise a satellite link, a radio frequency signal path, or another suitable connection.

The set top box 5320 provides the television 5200 with connectivity to the VOD network 5310 and the transaction network 5340. Thus, the set top box 5320 can provide, comprise, or be a video interface supporting that connectivity. The set top box 5320 can be housed separately from the television 5200, as a unit placed near, beside, or on top of the television 5200. Alternatively, the set top box 5320 can be an integral unit, subsystem, or module of the television 5200, for example circuitry, software, and components that are internal to the television 5200. In one exemplary embodiment, the set top box 5320 comprises functionality dispersed among many components and subsystems of the television 5200. Thus, in certain exemplary embodiments, the set top box 5320 is not a single discrete element.

The consumer controls the set top box 5320 and the television 5200 with the remote control 5330 that is typically handheld or portable. The remote control 5330 can comprise an operability for interacting with remotely accessed video content, for placing purchase orders, or for responding to surveys or questions presented on an integral display or on the television 5200.

The consumer can select an on-demand shopping video stored on the VOD server 5305 by making a selection entry into the remote control 5330. In response to receiving the consumer's video selection entry, the set top box 5320 sends a message, prompt, or signal via the VOD network 5310 to the VOD server 5305. The VOD server 5305 then makes prerecorded video content available to the set top box 5320. The set top box 5320 commences downloading and storing or buffering that content for presentation on the television 5200.

The transaction server 5315 maintains dynamic inventory or sales data and makes that data available to the set top box 5320 via the transaction network 5340. When a consumer at one of the residences 5325, 5325n places an order for a shirt 5210, the order transmits over the transaction network 5340 to the transaction server 5315. An inventory and sales tracking module (“ISTM”) 5335 at the transaction server 5315 maintains a log of orders received, remaining inventory, and assorted purchase details. The transaction server 5315 sends current sales and inventory data to the set top box 5320 in response to a prompt, upon occurrence of a predefined event, at the consumer's request, or at regular time intervals, for example.

The set top box 5320 integrates the dynamic sales data from the transaction server 5315 with the prerecorded content from the VOD server 5305. As discussed above, the image on the screen 5205 of FIG. 52 illustrates an exemplary result of integrating static information maintained on the VOD server 5305 with dynamic information maintained on, processed by, or associated with the transaction server 5315.

The VOD server 5305 and the transaction server 5315 can be located at a common facility or site or can alternatively operate from distinct locations offsite from any specific residence 5325. In one exemplary embodiment, a single server system provides the functions of the VOD server 5305 and the transaction server 5315. Thus, the VOD server 5305 and the transaction server 5315 can each be a virtual server of a common computing platform.

In one exemplary embodiment, the system 5300 comprises a dedicated communication link (not shown on FIG. 53) between the transaction server 5315 and the VOD server 5305 that synchronizes the activities of these two server systems 5305, 5315. The communication link can coordinate the transmission of information from each of the systems 5305, 5315 to the set top box 5320.

Either or both of the VOD network 5310 and the transaction network 5340 can comprise a public or a private network, a cable network, the Internet, an intranet, a local area network (“LAN”), a satellite network, a cellular network or another wireless network, the public switched telephone network (“PSTN”), a distributed computing network, an Internet protocol (“IP”) network, a wide area network (“WAN”), a personal video recorder network, a regional network, a metropolitan area network (“MAN”), and/or a packet switched network (not an exhaustive list).

Those experienced in the art will further recognize that numerous communications networks and systems (including presently available systems and future systems) may be substituted or interchanged with the VOD network 5310 and the transaction network 5340 or their respective servers 5305, 5315.

The VOD network 5310 can be segregated from the transaction network 5340 and/or isolated from the transaction network 5340. In a segregated configuration, the signals that carry prerecorded video from the VOD server 5305 to the set top box 5320 avoid traveling along any substantive section of the path traveled by the signals that carry dynamic information from the transaction server 5315 to the set top box 5320. In another exemplary embodiment of the present invention, each of those signals can propagate in a common medium or a common network leg.

In one exemplary embodiment of the present invention, a single network, such as the Internet, comprises both the VOD network 5310 and the transaction network 5340. That is, a single network can provide the set top box 5320 with connectivity to both the VOD server 5305 and the transaction server 5315. In this arrangement, the VOD network 5310 and the transaction network 5340 can each comprise a virtual network.

The system 5300 can comprise any of the technologies disclosed in: 1) U.S. Pat. No. 6,055,560 to Mills et al., entitled “System and Method to Provide Interactivity for a Networked Video Server;” 2) U.S. Pat. No. 6,496,981 to Wistendahl et al., entitled “System for Converting Media Content for Interactive TV Use;” and 3) U.S. Patent Application Publication Number 2004/0098747 to Kay et al., entitled “Electronic Buying Guide Architecture.” Thus, an exemplary embodiment of the present invention can comprise one or more of the hardware elements, software, methods, systems, or network architectures disclosed in those three patent references. Further, the disclosure and teaching of those three patent references can support making and using exemplary embodiments of the present invention. The entire contents of U.S. Pat. No. 6,055,560, U.S. Pat. No. 6,496,981, and U.S. Patent Application Publication Number 2004/0098747 are hereby incorporated by reference.

The system 5300 can further comprise or be supported by one or more of the interactive television products offered by GoldPocket Interactive, Inc. of Los Angeles, California and Concurrent Computer Corporation of Atlanta, Georgia. For example, the system 5300 can comprise the Media-Hawk On-Demand platform and the MediaHawk Interactive Media Solution.

Turning now to FIG. 54, this figure illustrates a flow diagram of a process 5400 for providing on-demand shopping videos to consumers in accordance with an exemplary embodiment of the present invention. The on-demand shopping videos can be or comprise the VOD segments 5375 shown in FIG. 53, for example. When an inventory shortage or outage occurs for a product that a consumer has expressed an interest in purchasing, Process 5400, which is entitled VOD Home Shopping, can provide the consumer with an on-demand shopping video for a substitute product.

In one exemplary embodiment of the present invention, a method and/or a system for substituting media content, as discussed in further detail with reference to FIGS. 73-76, comprises an element, step, technology, or other item that FIG. 54 illustrates.

At Step 5405, the shopping network 5350 determines the inventory level for each of a plurality of items of commerce. While those items could be almost any good or service or widget, for the purpose of illustrating and exemplary embodiment of the present invention, they will be referred to as ten fishing products, designated FP1-FP10. For example, each of FP1-FP10 could be a specific type and brand of saltwater tackle. The ISTM 5335, which can comprise a software program, stores the inventory level at the transaction server 5315. Thus, Step 5405 can comprise initializing the ISTM 5335.

The shopping network 5350 uses videos to market and sell products, including the ten fishing products FP1-FP10. The shopping network 5350 can be an operating division, subsidiary, or joint venture of a business entity that uses the VOD network 5310 to provide a sales channel or a distribution outlet for a broader class of products. Thus, the shopping network 5350 ascertains the stocks of FP1-FP10 that are available for purchase.

At Step 5410, the content creator 5355 produces and records ten videos for marketing and selling the ten fishing products. The ten VOD segments, VOD1- VOD10, respectively correspond to fishing products FP1-FP10. That is, video VODi comprises prerecorded content for marketing and selling FPi, where ‘i’ is an integer from one to ten. The content creator 5355 might be a division of the shopping network 5350 , a partner of the shopping network 5350, or a third party that the shopping network 5350 hires for video production. The shopping network 5350 places a digital or an analog copy of each of the ten videos on the VOD server 5305.

At Step 5415, the shopping network 5350 offers five of the ten video segments, specifically VOD1-VOD5, for remote access and viewing via the VOD network 5310 to a plurality of consumer residences 5325, 5325n. The shopping network 5350 typically presents those video offerings to consumers in categories 5105 arranged according to product type, for example as shown in FIG. 51 and discussed above. The Saltwater Section of the Fishing Category 5115 contains VOD1-VOD5, for example.

At Step 5420, consumers at various residences 5325, 5325n use their remote controls 5330 to select each of VOD1- VOD5 based on an interest in purchasing saltwater fishing tackle. Each viewer request transmits to the VOD server 5305 via the VOD network 5310.

In one exemplary embodiment, the VOD server 5305 allows an essentially unlimited number of copies of each video to be checked out at the same time. Alternatively, the VOD server 5305 can limit the number of residences 5325, 5325n that can view each video during a common timeframe. In either case, a plurality of consumers may be viewing a specific one of VOD1-VOD5 at any given time.

The VOD server 5305 receives the requests for VOD1-VOD5 at Step 5425. In compliance with the requests, the VOD server 5305 transmits or downloads the videos VOD1-VOD5 to the set top boxes 5320 of the requesting parties, each of the residences 5325, 5325n that initiated a video request.

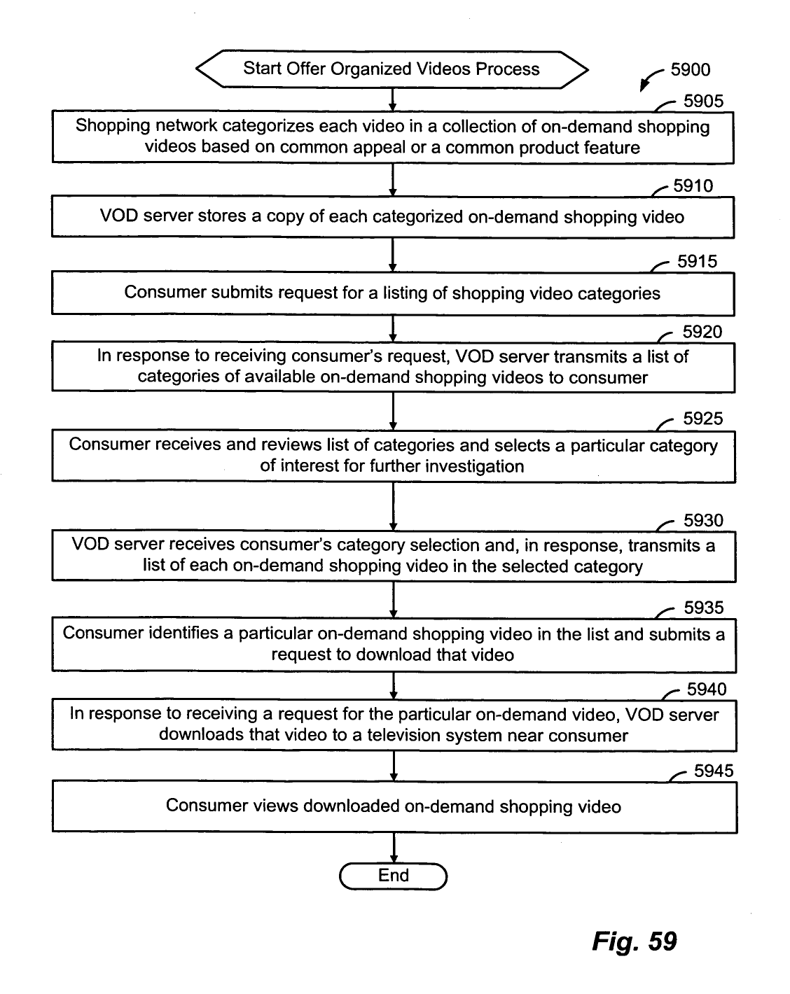

In one exemplary embodiment of the present invention, the process 5900 illustrated in flow diagram form in FIG. 59 and discussed below replaces Steps 5415, 5420, and 5425 of Process 5400. In that embodiment, Process 5900 offers viewers on-demand shopping videos categorized according to featured product, demographic appeal, genre, or some other criteria or criterion.

Referring now to FIG. 54, at Step 5430, consumers at various residences 5325, 5325n or sites on the VOD network 5310 view the downloaded videos VOD1-VOD5 and, in response, order fishing products FP1-FP5. Some of the consumers that view any specific video place an order, while others may elect not to order. Order placement for a specific product often occurs while the video that features that product is playing or shortly after its conclusion.

The shopping network 5350, or an affiliate, receives the incoming orders for FP1-FP5 at Step 5435. A ledger, order receiving system, or log that is coupled to the transaction server 5315 takes and accounts for the orders. Thus, the ISTM 5335 maintains order tracking records for consumer transactions.

At Step 5440, the ISTM 5335 adjusts its sales and inventory records to reflect incoming orders. The ISTM 5335 decrements or diminishes its inventory count to reflect those orders. Thus, the shopping network 5350 accounts for each purchasing event and reduces its inventory of available products accordingly.

At Step 5445, the ISTM 5335 determines whether the current inventory level of each of the saltwater fishing tackle products FP1-FP5 is below a threshold. That is, the shopping network 5350 determines whether its current inventory level is sufficient to support ongoing marketing efforts and sales of those products.

At Step 5450, the shopping network 5350 determines that its product inventory of one of the products, specifically FP1, has been depleted or is insufficient. Thus, continued sales and marketing activities of FP1 may produce orders that the shopping network 5350 lacks sufficient supply to fill.

At Step 5455, the transaction server 5315 sends a message to the VOD server 5305 to terminate availability of VOD1, which features FP1, for downloading on the VOD network 5310. In place of VOD1, the VOD server 5305 substitutes another on-demand video or video segment that features a similar product to FP1. Specifically, the VOD server 5305 uses a lookup table to select the product from FP6-FP10 that is most similar to FP5 or provides a common functionality for example. For example, the VOD server 5305 can elect to offer VOD6, featuring FP6, as a substitute for VOD1/FP1.

The transaction server 5315 can send the inventory depletion message to the VOD server 5305 via a dedicated communication link, over a telephone line, or over the Internet, for example. Alternatively, that message can transmit from the transaction server 5315 to the set top box 5320 via the transaction network 5340 and from the receiving set top box 5320 to the VOD server 5305 via the VOD network 5310.

At Step 5460, the VOD server 5305 terminates the availability of VOD1 for remote access and offers VOD6 as a substitute to consumers interested in purchasing saltwater fishing tackle. The VOD server 5305 also sends a message, alert, or notification to the set top boxes 5320 that are currently playing VOD1 that a sold out condition exists or is approaching.

In response to receiving that message, those set top boxes 5320 present an audible or visual message 5240 on the screens 5205 of their associated televisions 5200 regarding the supply-shortage or supply-outage condition. The message 5240 may recite that the product FP1 is sold out and that VOD6 features a similar product, FP6, that may be a viable substitute. The message 5240 can also inform the consumer that order cancellation or other events may provide a small residual inventory that the shopping network 5350 may offer at a future date on a limited or as-available basis. In one exemplary embodiment, the message 5240 is graphical or textual in format and offers a discount for the substitute product or for any order that is subject to backordering.

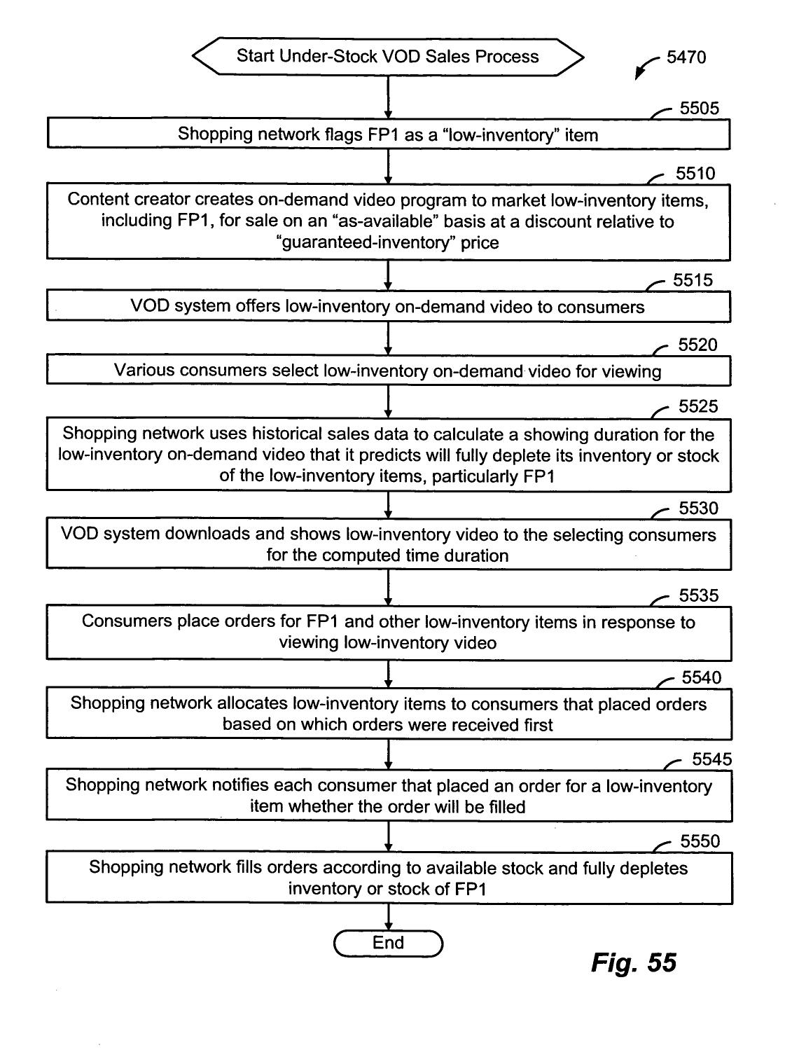

At Step 5465, the VOD server 5305 sends the substitute video, VOD6, to the appropriate set top boxes 5320. At Step 5470, the shopping network 5350 proceeds to handle or dispose of any stock of FP1 that remains in inventory. FIG. 55 illustrates an exemplary embodiment of Step 5470, which is entitled Under-Stock VOD Sales. Following Step 5470, Process 5400 ends.

In one exemplary embodiment of the present invention, the VOD server 5305 stores multiple on-demand segments or VOD segments 5375, each offering at least one distinct product (which could be a service) for sale. An on-demand video program may comprise a series or an ordered arrangement of two or more of the segments. Thus, an on-demand shopping video program can comprise multiple content segments about products in a common category, such as a fishing product category.

When a trigger event occurs, such as a low-inventory condition, the VOD server 5305 can pull the relevant segment (or segments) from the program and replace that segment with another segment. Alternatively, the VOD server 5305 can simply delete a selected segment, thereby shortening the program.

The VOD server 5305 can make such a change to a program that has already been downloaded and is actively playing at a residence 5325. Alternatively, the VOD server 5305 can implement the program change to a stored version of the program, held on the server 5305, so the revised program is available for downloading. Segments can be truncated, shortened, or automatically edited for time or content to support insertion of one segment into the time slot of another segment that was pulled or terminated due to an occurrence of an inventory event or a product supply condition. In this manner, on-demand video programs can be changed, updated, edited, or created in response to dynamic conditions, using content drawn from shorter on-demand programs or segments of prerecorded content. The changes can be implemented automatically, via computer processing, without direct human intervention, via man-machine collaboration, or manually, for example.

Turning now to FIG. 55, this figure illustrates a flow diagram of a process 5470 in which a system 5300 that provides on-demand shopping videos responds to a low-inventory condition in accordance with an exemplary embodiment of the present invention.

In one exemplary embodiment of the present invention, a method and/or a system for substituting media content, as discussed in further detail with reference to FIGS. 73-76, comprises an element, step, technology, or other item that FIG. 55 illustrates.

In an exemplary embodiment of the present invention, the Process 5470 can be a step, specifically Step 5470, in Process 5400, which FIG. 54 illustrates as discussed above. The on-demand shopping videos can be or comprise the VOD segments 5375 illustrated in FIG. 53, for example

At Step 5505, the transaction server 5315 of the shopping network 5350 flags or notes FP1 as a low-inventory item, thereby characterizing the supply of that product as potentially insufficient to meet new orders.

At Step 5510, the content creator 5355 produces an on-demand video program for marketing items with limited inventory. The on-demand video program can be or comprise an segment of prerecorded sales content. The video program features FP1, for which sales events occurring in association with Process 5400 produced a low-inventory condition, as well as other low-inventory items. The low-inventory video program offers those products on an as-available basis at a price discount relative to merchandise that standard videos feature. That is, consumers can receive a discount for placing an order for featured items that may or may not be in stock.

At Step 5515, the VOD server 5305 offers the low-inventory video to consumers via the VOD network 5310. At Step 5520, consumers at various residences 5325, 5325n on the VOD network 5310 select the low-inventory video for downloading and viewing.

At Step 5525, the transaction server 5315 uses prior sales data to predict a showing or playing duration for the low-inventory video that should fully deplete the remaining stock of the low-inventory items, particularly FP1. The transaction server 5315 can compute a showing time or a duration for placing the low-inventory video on the categorized viewing window 5100. Using sales records that the ISTM 5335 maintains, the computation can scale the full-inventory sales rate of FP1 according to the historical sales rate that a previous low-inventory video achieved for a similar product.

By way of illustration, suppose another low-inventory video sold ten units of a similar fishing product per hour and that the standard video for that product sold twenty units per hour. Under those conditions, the computation could predict that a low-inventory video featuring FP1 would sell units of FP1 at one-half (50%) of its full-inventory sales rate. If fifty units of FP1 remain in inventory and VOD1 sold fifty units of FP1 per hour, then a two-hour showing time of the low-inventory video that features FP1 should sell fifty units of FP1, thereby exhausting the remaining inventory.

At Step 5530, the shopping network 5350 shows the low-inventory video for the computed time duration (e.g. two hours). The shopping network 5350 can add a margin to the time estimate in order to increase the probability that the stock of FP1 will be fully consumed.

Consumers view the low-inventory video and place orders for FP1 at Step 5535. At Step 5540, the shopping network 5350 accepts orders in the sequence of receipt or on a first-come-first-served basis. The transaction server 5315 notifies each consumer that placed an order whether that order will be filled, backordered, or rejected on the basis of insufficient supply.

The shopping network 5350 fills the orders for which it has sufficient stock, thereby fully depleting its inventory at Step 5550. Process 5470 ends following Step 5550.

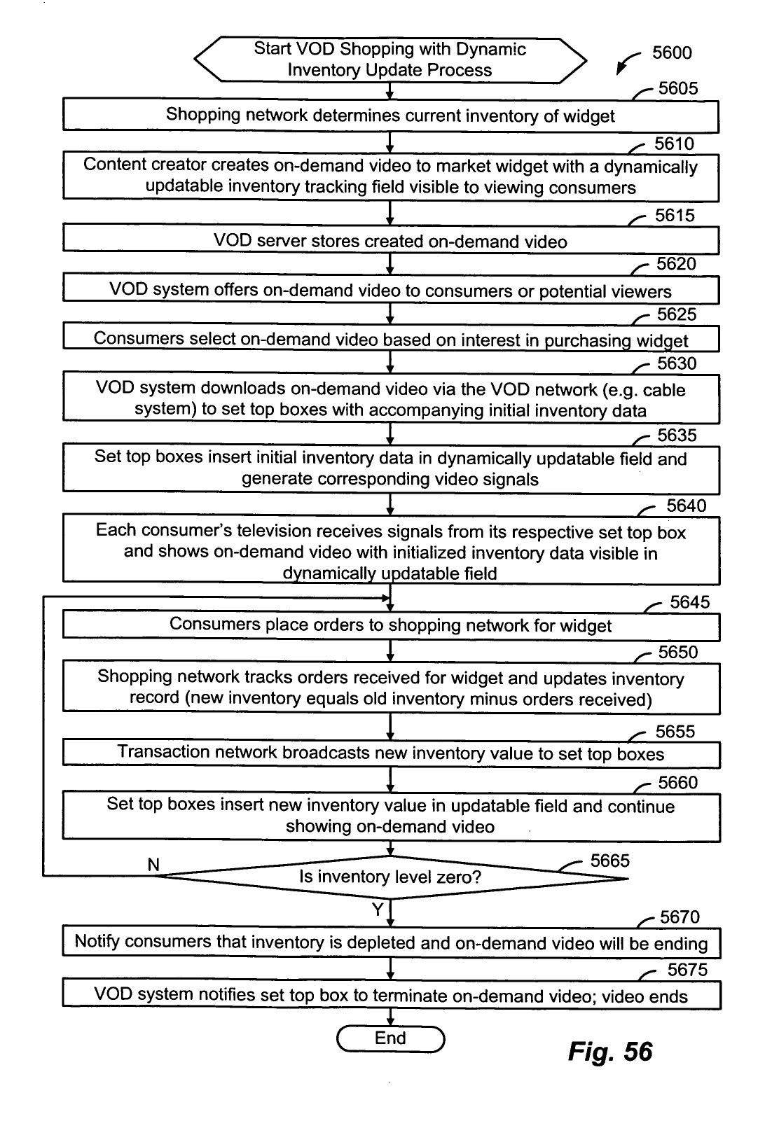

Turning now to FIG. 56, this figure illustrates a process 5600 for providing on-demand shopping videos that present prerecorded content integrated with dynamic inventory data in accordance with an exemplary embodiment of the present invention.

In one exemplary embodiment of the present invention, a method and/or a system for substituting media content, as discussed in further detail with reference to FIGS. 73-76, comprises an element, step, technology, or other item that FIG. 56 illustrates.

The Process 5600, which is entitled VOD Shopping with Dynamic Inventory Update, can provide graphics, text, or images on a television monitor or screen 5205 to present live information and prerecorded content as exemplified in FIG. 52. The on-demand shopping videos can be or comprise the VOD segments 5375 illustrated in FIG. 53, for example.

At Step 5605, the transaction server 5315 operated by a shopping network 5350 determines a current or initial inventory of a widget. At Step 5610, a content creator 5355, typically compensated by the shopping network 5350, creates an on-demand video program to market the widget. The video program comprises prerecorded content and a field or window 5220 for presentation of dynamic information that changes in response to purchasing events.

At Step 5615, the VOD server 5305 stores the video program for remote accessibility. At Step 5620, a cable system or the VOD network 5310 offers the video program to consumers. At Step 5625, consumer viewers select the video program for viewing, thereby expressing a potential interest in purchasing or acquiring the widget.

At Step 5630, the VOD server 5305 downloads the video program via the VOD network 5310 to the set top boxes 5320 of the consumers who requested that program. At Step 5635, the set top boxes 5320 insert the initial inventory data in the window 5220, thereby initializing the program with real data or a measured value. Thus, the set top boxes 5320 receive signals carrying prerecorded content that comprises a sales presentation.

At Step 5640, each the set top boxes 5320 send video signals to their associated televisions 5200. Those signals carry image data representative of both the prerecorded content and the initial inventory data. Thus, the television monitors 5205 present images 5210, 5215 based on or comprising prerecorded content and other images 5220, 5225, 5230, 5235, 5240 based on or comprising inventory data.

At Step 5645, consumers place orders for the widget in response to viewing the downloaded video. Thus, purchase events occur. At Step 5650, the ISTM 5335 tracks the incoming orders and updates its inventory records to reflect those orders. For example, the ISTM 5335 could compute a new inventory count as an old inventory count minus the number of orders received.

At Step 5655, the transaction server 5315 broadcasts the new inventory count on the transaction network 5340. At Step 5660, the set top boxes 5320 receive signals carrying inventory data that is live, dynamic, or changes in response to sales events. The set top boxes 5320 that are actively showing the widget video receive the broadcast inventory count and insert that data into the applicable fields 5230 of the video. That is, the set top boxes 5320 process incoming signals that carry live data and incoming signals that carry prerecorded video content and integrate the live data with the prerecorded video content to provide a unified video presentation.

The video continues showing the prerecorded content with live updates to the fields or images 5220, 5225, 5230, 5235, 5340 that are responsive to live data. In other words, some aspect of the video presentation changes in response to a purchasing event that may occur either at the residence 5325 of that video presentation or another consumer site on the VOD network 5310.

At Step 5665 the ISTM 5335 determines whether widget inventory has depleted or alternatively has dropped below a threshold. If salable inventory remains, Process 5600 iterates Steps 5645-5665 until inventory is insufficient for sales and marketing to continue unabated.

Step 5670 follows Step 5665 when widget inventory has been depleted. At Step 5670, the transaction server 5315 sends notification to the set top boxes 5320 that the current supply of widgets has sold out and that the widget video will be ending. The set top boxes 5320 output video signals that cause the television monitors 5205 to display that notification to the consumers.

At Step 5675, the set top boxes 5320 terminate the presentation of the video program. Process 5600 ends following Step 5675.

In many situations, the shopping network 5350 can financially benefit by increasing the consumer's attentiveness to the downloaded video and to the promotions or sales offers that the video presents. In one exemplary embodiment of the present invention, in connection with a video presentation, a consumer or a viewer is queried or questioned about some aspect of the video presentation or about a product that the video features. The question, which may concern either live sales and inventory information or prerecorded content, can cause the consumer to pay close attention to the video or to become immersed in a video presentation.

In one exemplary embodiment, the question transmits to the viewer via the transaction network 5340, and the transaction network and the VOD network 5310 may be isolated or segregated from one another. In one exemplary embodiment, the question and the on-demand content arrive at the residence 5325 via propagation on a common medium or a common network, such as the VOD network 5310.

In one exemplary embodiment of the present invention, awareness to or effectiveness of a VOD shopping video results from using one or more of the methods or systems for increasing viewership or immersion disclosed or taught in U.S. patent application Ser. No. 10/976,149, which was filed Oct. 28, 2004, published as U.S. patent application Publication Number 2005/0060232 on Mar. 17, 2005 to Maggio, and entitled “Method and System for Interacting with a Writing,” the entire contents of which are hereby incorporated by reference. A substantial portion of U.S. patent application Ser. No. 10/976,149 has been repeated herein. Thus, in one exemplary embodiment of the present invention, awareness to or effectiveness of an on-demand video that makes a sales offer results from using one or more of the methods or systems for increasing viewership or immersion discussed above with reference to FIGS. 1-50. A CR\overline{A}V advertisement, communication, or question can accompany a downloaded video, and a consumer can receive a reward for properly responding to a question, for example. That is, in an exemplary embodiment of the present invention, the CR\overline{A}V methodology for advertising, sales, and promotional, which is taught in U.S. patent application Ser. No. 10/976,149 and/or in various portions of the present application, can be applied to on-demand shopping videos.

Thus, to increase viewership, attention, and immersion, a CR\overline{A}V question about one or more on-demand sales presentations or video segments can follow delivery of those presentations or segments. One or more correctly responding consumers will receive or win something of value, which may include the very items being offered for sale.

The awarding of a CR\overline{A}V prize can be delayed until a predetermined number of consumers have accessed or watched a video segment. Alternative arrangements for staging an award include, without limitation, at a scheduled date, in connection with a marketing campaign, upon an occurrence of an event, or based on a calculation. The calculation could be one prize awarded for every thousand viewers, whereby each viewer perceives a one-in-one-thousand (1:1000) chance of winning.

This “simulated drawing” methodology can entice a consumer with the possibility of instant gratification and with the potential to know right away if her or she has won. Over time, the shopping network 5350 can refine the loss-to-win or prizing-to-exposure ratio, arriving at a calculus that best serves the network's financial objectives.

Referring now to FIG. 57, this figure illustrates a handheld remote control device 5330 that presents a consumer with questions 5720 about a shopping video in accordance with an exemplary embodiment of the present invention. This figure illustrates an exemplary scenario for using the remote control 5330 of FIG. 53 to interact with remotely accessed video content and/or dynamic data associated with a shopping video.

In one exemplary embodiment of the present invention, a method and/or a system for substituting media content, as discussed in further detail with reference to FIGS. 73-76, comprises an element, step, technology, or other item that FIG. 57 illustrates.

The remote control 5330 sends control signals to the television 5200 and to the set top box 5320 to adjust volume and to select remotely accessible videos according to user input. A consumer viewer can also use the remote control 5330 to order a product featured in a video. Additionally, the consumer make an entry on the remote control 5330 in response to a question 5720 about a VOD video. The consumer can receive a prize or a reward for entering a correct answer to the question 5720, for example.

In accordance with the illustrated scenario, a home shopping video or an on-demand video that features the “Example1” brand of soup is playing, is about to play, or has recently concluded. “Example1” is a fictitious and exemplary brand name. When the consumer selects the soup video from the Food Section of the Video Categories 5105 that FIG. 51 illustrates, the VOD server 5305 downloads the video. As discussed above, the transaction server 5315 sends dynamic information for showing on the television 5200 in connection with presentation of the video.

The transaction server 5315 further sends over the transaction network 5340 a message comprising a CR\overline{A}V communication or question 5720 about the soup video to the remote control 5330. The set top box 5320 receives the transmitted message and forwards it to the remote control 5330. When the remote control 5330 receives the message, the communication appears on the display 5706.

The communication offers the consumer a can of Example1 chicken soup for correctly answering a CR\overline{A}V question 5720 regarding the content of the on-demand shopping video. That content includes a recipe that has a soup ingredient. The CR\overline{A}V question 5720 specifically asks, “Does the featured recipe call for two cans of Example1 chicken soup or three cans of Example1 tomato soup?”

The question 5720 stimulates or induces the consumer to pay close attention to the video presentation to compose a correct response, thereby immersing the consumer in a sales pitch, promotion, or offer for Example1 brand. If the consumer enters the correct response, which is “two cans of Example1 mushroom,” the remote control 5330 displays notification of winning a can of Example1 chicken soup.

The transaction server 5315 can initiate mail delivery of a coupon redeemable for the can of chicken soup or direct mail delivery of that product, for example. Alternatively, the transaction server 5315 can transmit a message to a grocery store frequented by the consumer, notifying the store to provide a free can of Example1 chicken soup at the consumer's next shopping trip. As yet another example, the transaction server 5315 can communicate a code that the consumer can use to redeem the reward in connection with viewing another on-demand shopping video.

In one exemplary embodiment, the transaction server 5315 electronically credits an account in response to receipt of a response that is correct or that meets some other criterion. Such an account can be a bank account of the consumer, such as a checking or savings account. Alternatively, the account can be a reward account, dedicated to maintaining a record of entitled rewards that have yet to be redeemed or collected.

If the consumer enters an incorrect response to the CR\overline{A}V question 5720, the remote control 5330 can display another question that continues to immerse the consumer in advertisements, promotions, or sales offers for products carrying the Example1 brand. For example, a follow up question could ask, “Does the recipe require cooking two cans of Example1 mushroom soup for ten minutes or for twenty minutes?” Continued interaction can extend the period of time that the consumer is immersed in sales offers for Example1 products.

While FIG. 57 illustrates a textual presentation of the CR\overline{A}V question 5720 on the remote control 5330, exemplary embodiment of the present invention can support a variety of other presentation formats. The CR\overline{A}V question 5720 may be spoken, printed, displayed, heard, or communicated by any other possible means, or any combination of possible means.

As an alternative to the remote control 5330, the consumer can view the question 5720 and/or enter a response on a land-line phone, a cellular telephone, a personal digital assistant (“PDA”), an interactive TV, an Internet computer, an interface to a hospitality industry private network (i.e., a sports bar and pub device), a print medium, or any other suitable device. In one exemplary embodiment, the consumer can prepare a printed response by composing a handwritten or typewritten response on a paper that is mailed to the transaction server 5315 or to a representative of the shopping network 5350. The CR\overline{A}V question 5720 can also appear on the television monitor 5205 or on a nearby home computer system, for example.

The content of the question 5720 can change based on sales events, inventory changes, or dynamic information that the ISTM tracks. For example, a query can ask the consumer to enter a current sales rate or inventory level that is showing on the television 5200 at the time of query presentation.

The query can precede, follow, or be aligned with a selected portion or part of the on-demand video content. In this manner, the viewing consumer can readily correlate or associate the query with the content section to which it pertains. Further, the shopping network 5350 or some advertiser or promoter can use the query to emphasize and heighten attentiveness to selected portions of the on-demand content, such as a particular aspect of a featured product.

In one exemplary embodiment, the on-demand video comprises a plurality of commercials or advertisements, and the query is about a selected one of the commercials or advertisements. The query may further be about a selected portion of a selected one of the commercials or advertisements, such as a specific advertised product.

In one exemplary embodiment, the video presentation includes an on-screen counter that increments as the video plays, thereby providing an indication of the position of the video that the consumer is viewing. That is, an identifier appears on the television monitor 5205 to identify the segment of the video that is playing at any particular time. The CR\overline{A}V communication 5720 can reference a specific identifier value, thereby incentivizing the consumer to focus on a selected portion of the video. Furthermore, the consumer may be enticed to replay a section of the video that correlates to the specific identifier value.

CR\overline{A}V questions 5720 can evolve in complexity or subject in a manner that coincides with the video's duration or that is aligned to the presentation flow of the on-demand video. The on-screen counter, or a graphic that changes from one state to another state as the video plays, can correspond to the evolution of the questions 5720.

In one exemplary embodiment, questions change or evolve based on the amount of content viewed. Questions can become more difficult or easier to answer in response to extending the viewing time, for example.

In one exemplary embodiment, the consumer can watch the video with knowledge about the sections of the video that will present questions 5720. For example, an opening segment of the video can present a list or index of the counter values at which questions will appear. Informing the consumer about the locations or timing of the questions 5720 in the video helps avoid any tendency of the consumer to wait until the end of the video to place an order.

In one exemplary embodiment, the counter is tied to a clock or provides an indication of time. That is, the counter can reflect the actual date and time that a consumer is watching the video. In this situation, the counter provides live time information that can supplement prerecorded content. The counter can be used for correlating a timestamp to the CR\overline{A}V question 5720, an answer to the CR\overline{A}V question 5720, or a purchase event.

In one exemplary embodiment, the counter is a unique identifier or a code that the system 5300 broadcasts across the transaction network 5340 at designated time intervals or in response to a unscheduled occurrence of a selected event. The value of that identifier can change over time based on time passage or event occurrences.

An opening section of a CR\overline{A}V interaction can require the consumer to input the current unique identifier as well as a personal identification number that differentiates that consumer from other consumers. 'In this exemplary situation, the question 5720 can be tailored to the broadcast identifier and/or the identity of the consumer that is the recipient of the question 5720. Consumers with different purchasing histories, demographics, or patterns of viewing specific genres of videos may receive unique, tailored, or custom questions 5720.

The CR\overline{A}V question 5720 can be presented to the consumer in connection with order placement. For example, question presentation can occur when the viewer logs in to an ordering system or makes an expressed attempt to place the order. Alternatively, an answer to the question 5720 can be solicited before or after the consumer verifies or confirms the order or executes a payment transaction.

In addition to qualifying the consumer for a chance to receive a prize, the submission of an answer to the question 5720, can earn the consumer a discount or value applicable to the order. For example, the consumer can receive free shipping for the order, a coupon for another product featured on another video, and entry into a drawing for a car. In one exemplary embodiment, the consumer receives a partial award, and the consumer must perform an additional step, such as answering another question 5720 within designated timeframe, to receive the entire reward.

For example, an on-demand video may offer an on-sale price of $699 for a fishing motor that has a manufacturer's suggested retail price of $999. The video may present a message informing viewing consumers that a correct response to the question 5720 will entitle the consumer to free shipping. Text shown on the television monitor 5205 might state “Free shipping if you get the CR\overline{A}V question shown on your remote control correct.”

In one exemplary embodiment, consumers can answer CR\overline{A}V questions 5720 to receive refunds on or payment towards previously placed orders. Thus, a consumer can place an order for a product that an on-demand video features with the knowledge that he or she has an opportunity to receive that product for free or at a discount by answering some CR\overline{A}V question 5720 at a future date. Such a retroactive reward, helps address the tendency of some consumers to delay ordering a product of interest until favorable purchasing terms can be obtained by submitting a correct response. In words, consumers are incentivized to purchase early rather than to delay.

In one exemplary embodiment, some aspect of the CR\overline{A}V question 5720 or the CR\overline{A}V interaction changes based on dynamic inventory or sales data or other live information. For example, the shopping network 5350 can elect to present CR\overline{A}V questions 5720 when inventory moves above or below a threshold in connection with a purchasing event initiated from an arbitrary location on the transaction network 5340 or the VOD network 5310. Alternatively, prize values or the terms associated with receiving a reward can change based on live data, purchasing volume, or some other selected condition.

In a phone-ordering environment, ordering consumers can receive priority for answering the question 5720 over consumers that are answering with no expressed intention of making a purchase. In this manner, when call volume is high, ordering consumers can experience less delay in receiving telephonic service than non-ordering customers may experience. That is, a call-processing system that processes answers to CR\overline{A}V questions 5720 from consumers placing orders and from other consumers that are not placing orders can differentiate between those two classes of consumers and move the consumers placing orders to the front of a call-processing queue.

Prioritizing the handling of responses to CR\overline{A}V communications 5720 is not limited to a telephonic communication environment. Rather, VOD systems 5300 that communicate with consumers via the Internet or another communication infrastructure can determine or assign an order for handling responses to CR\overline{A}V communications 5720 that financially benefits the shopping network 5350.

A CR\overline{A}V communication 5720, or a series of CR\overline{A}V communications 5720, may also be the basis for an on-demand video or a home shopping video. That is, an on-demand video can feature advertisements and questions 5720 without providing a direct sales channel for products or services that are the subjects of those advertisements or questions 5720.

Turning now to FIG. 58, this figure illustrates a flow diagram of a process 5800, entitled Interact with On-Demand Video, in which a consumer interacts with on-demand video content in accordance with an exemplary embodiment of the present invention. The on-demand video content can comprise prerecorded material, including a sales pitch for a product, and material or data that changes in response to purchasing activities initiated by one or more viewing individuals.

In one exemplary embodiment of the present invention, a method and/or a system for substituting media content, as discussed in further detail with reference to FIGS. 73-76, comprises an element, step, technology, or other item that FIG. 58 illustrates.

At Step 5805, a consumer or another viewer, selects a video clip, program, or segment for access from a remote site that comprises the VOD server 5305, a video archive, a machine-readable medium, or a facility for storing a library of videos. A CR\overline{A}V logo or another indicator or identifier can alert the viewer that the video is interactive. The selected video transmits via electronic, electromagnetic, or optical signal transmission to a television system that comprises a set top box 5320 and a television 5200. The television 5200 plays and the consumer reviews, watches, or views the video.

At Step 5810, the transaction server 5315 transmits a message that comprises a query 5720 about the selected video to the set top box 5320. The VOD server 5305 and the transaction server 5315 can communicate with one another via the PSTN, a dedicated communication link, the Internet, or another communication path. The VOD server 5305 can use that communication path to transmit a prompt to the transaction server 5315 that initiates transmission of the query message.

The transaction server 5315 or another remote computer can generate the query 5720 based on a demographic profile of the consumer. The set top box 5320 can generate the demographic profile in connection with monitoring the consumer's viewing habits and video selections.

As an alternative to the query 5720 directly concerning the video, a query can concern another subject. For example, a query can comprise a trivia question or a question about another product that the shopping network 5350 is interested in promoting.

At Step 5815, the set top box 5320 receives the query message from the transaction server 5315 and sends it to the remote control 5330 for receipt at Step 5820. In response to receiving the query message, the remote control 5330 displays the query 5720 to the consumer.

At Step 5825, the consumer studies, thinks about, absorbs, or becomes immersed in the video. The consumer composes or prepares a response to the query 5720 and enters the response on the remote control 5330. As the consumer contemplates the query 5720 and thinks about the video content, the consumer becomes immersed in that content.

At Step 5830, the remote control 5330 transmits the consumer's entry to the set top box 5320, which forwards it to the transaction server 5315 at Step 5835. In receipt of the consumer's response, the transaction server 5315 compares it to the correct entry at Step 5840.

At Step 5845, the Process 5800 branches according to whether the consumer's response is correct or proper or complies with another criterion. If the consumer has submitted an incorrect response, Step 5850 follows Step 5845, and the transaction server 5315 sends a losing notification to the remote control 5330 via the set top box 5320.

At Step 5855, the remote control 5330 displays a message that the response is wrong and offers the consumer an opportunity to answer another question. To continue immersing the consumer in advertising content, the remote control 5330 can offer the consumer repeated opportunities for answering queries until the consumer answers correctly and becomes eligible to win a prize, for example. In one exemplary embodiment, submitting an answer to the query 5720, either a correct answer or an incorrect answer, qualifies the consumer for entry into a lottery or another contest.

If the consumer has submitted the correct response, then Step 5860 rather than Step 5850 follows Step 5845. At Step 5860, the transaction server 5315 sends a winning notification to the remote control 5330 by way of the set top box 5320. At Step 5865, the remote control 5330 displays an announcement that the consumer has submitted a winning response and provides the consumer with information about collecting the prize. The information can comprise details about redeeming a reward certificate, for example.

At Step 5870, the transaction server 5315 sends the reward certificate to the consumer. In one exemplary embodiment, the certificate arrives electronically, such as via an e-mail attachment.

The transaction server 5315 can alternatively initiate mailing a physical prize certificate to the residence 5325 of the consumer. As another example, the transaction server 5315 can send a notification to a business, such as a store that the consumer routinely visits, for prize redemption. The consumer's prize can be a monetary reward, an advertised product, or a premium, for example. As an alternative to a physical or monetary prize, the consumer's reward for submitting a correct answer can be entry into a drawing for a larger prize, such as an automobile, vacation, or significant cash purse. As yet another example, the consumer can receive a quantity of points that can be accumulated with other points towards receiving a moderate prize, for example a household appliance or a stock of a consumable product.

Following the execution of either Step 5870 or Step 5855, according to whether the consumer submitted a correct response, Process 5800 ends.

Turning now to FIG. 59, this figure illustrates a flow diagram of a process 5900 for offering a consumer a categorized list of on-demand shopping videos in accordance with an exemplary embodiment of the present invention. As discussed above with reference to FIG. 54, Process 5900, which is entitled Offer Organized Videos, can replace Steps 5415, 5420, and 5425 of Process 5400.

In one exemplary embodiment of the present invention, a method and/or a system for substituting media content, as discussed in further detail with reference to FIGS. 73-76, comprises an element, step, technology, or other item that FIG. 59 illustrates.

At Step 5905, the shopping network 5350 categorizes each on-demand shopping video in a collection, group, library, or set of on-demand videos. Creating the categorization 5105 can comprise organizing the on-demand videos or associating each of the on-demand videos with a category identifier. Each category can contain on-demand videos that appeal to a common demographic of consumer or viewer or that make sales offers for products or services that have a common feature, function, usage, operability, or price range, for example.

At Step 5910, the VOD server 5305 stores a copy of each categorized on-demand shopping video. The stored videos can be or comprise the VOD segments 5375 illustrated in FIG. 53, for example.

At Step 5915, the consumer submits a request or a prompt to download a listing of the categories of on-demand shopping videos that are available for downloading. The consumer could make the request via an entry into the remote control 5330, for example. The request transmits to the VOD server 5305 via the VOD network 5310 or via the transaction network 5340 and the shopping network 5350.

At Step 5920, the VOD server 5375 receives the request and transmits the requested list of video categories to the consumer via the VOD network 5310. Alternatively, the transaction server 5315 can receive and process the request.

At Step 5925, the consumer receives and reviews the category list. The television 5200 or an integrated display on the remote control 5330 may display the category list, for example. The consumer selects a particular category within the list based on a purchase interest or a browsing interest, for example. Browsing electronic categories can emulate “window shopping” in a bricks-and-mortar shopping mall without entering any particular specialty store or department. The consumer could identify a specific category by making an entry into the remote control 5330, for example.

At Step 5930, the VOD server 5305 receives the consumer's category selection. In response, the VOD server 5305 transmits a list of each of the on-demand shopping videos within the selected category. The list may contain a brief description of each video in the category and/or a description of the featured products.

At Step 5935, the consumer receives the requested list of on-demand videos within the specified category. After reviewing the list, the consumer selects one or more specific on-demand shopping videos for downloading and submits a download request to the VOD server 5305.

At Step 5940, the VOD server 5305 downloads the selected on-demand video to the set top box 5320. At Step 5945, the television 5200 plays, presents, or shows the downloaded video content while the consumer views that content. Viewing the video content can comprise viewing dynamic or live content and prerecorded content on a common television monitor at essentially the same time. Process 5900 ends following Step 5940.

In one exemplary embodiment of the present invention, one user request prompts the VOD server 5305 to provide the consumer with an on-demand video guide or index. The guide can show the consumer all of the on-demand video categories and a list of the videos within each category. For example, Steps 5915, 5920, 5925, and 5930 could be integrated into a single step. The consumer can select one or more videos from the guide for targeted downloading. In one exemplary embodiment, a user request prompts the VOD server 5305 to download the category window 5100 and its associated operability, as shown in FIG. 51 and discussed above.

In one exemplary embodiment of the present invention, Process 5900 emulates or simulates certain aspects of the traditional bricks-and-mortar shopping experience without the inconvenience of leaving the residence 5325 and physically traveling to a traditional shopping mall.

Sample CR\overline{A}V Printed Responses

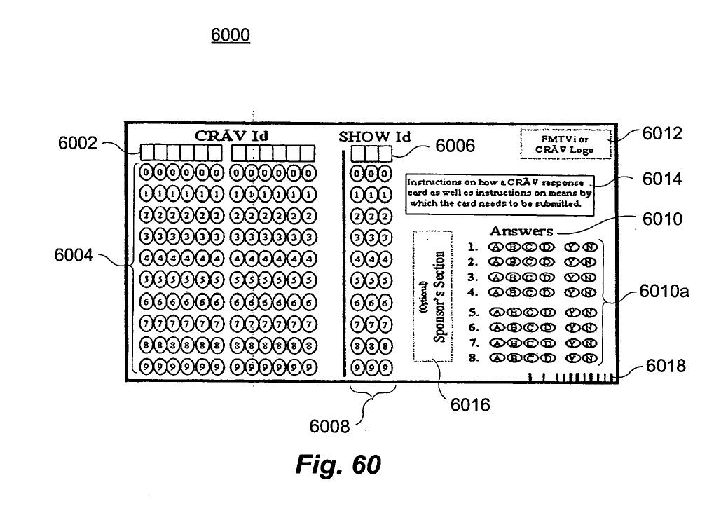

FIGS. 60-63 illustrate representative printed responses according to exemplary embodiments of the present invention. FIG. 60 illustrates a representative OMR printed response 6000 according to an exemplary embodiment of the present invention. As shown in FIG. 60, the printed response 6000 comprises CR\overline{A}V identification number blocks 6002 and corresponding OMR bubbles 6004. Accordingly, a registered recipient can enter his CR\overline{A}V identification number in the blocks 6002 and can darken the corresponding bubbles in the bubbles 6004.

In one exemplary embodiment of the present invention, a method and/or a system for substituting media content, as discussed in further detail with reference to FIGS. 73-76, comprises an element, step, technology, or other item that FIG. 60 illustrates.

The printed response 6000 also comprises show identification number blocks 6006 and corresponding OMR bubbles 6008. The recipient can enter the show identification number in the blocks 6006 for the particular show in which the recipient reviewed the CR\overline{A}V advertisement and can darken the corresponding bubbles 6008. The printed response 6000 can be used for multiple CR\overline{A}V-enabled shows by allowing the recipient to enter in blocks 6006 the particular show identification number for which the recipient is responding to the query. Accordingly, the printed response 6000 can provide greater flexibility and longevity for distribution channels, such as physical distribution points.

An answer section 6010 comprises OMR bubbles 6010a for each Query. In the exemplary embodiment of FIG. 60, the answer section 6010 includes OMR bubbles 6010a for eight Queries. To answer a Query about a Vignette, the recipient darkens one of the OMR bubbles 6010a corresponding to the answer choice for a particular Query. As illustrated in FIG. 60, the OMR bubbles 6010a can comprise four multiple choice answers A-D, as well as a yes/no answer choice for each Query. The yes/no answer choices can allow a recipient to answer an optional advertiser fulfillment question for each Query.

The printed response 6000 also can comprise an alert 6012 to indicate that the recipient can receive substantial awards by answering a question about a corresponding broadcast advertisement. In an exemplary embodiment, the alert 6012 can comprise the FMTVi or CR\overline{A}V logo. In an alternative exemplary embodiment, the alert 6012 can provide additional information to inform the consumer to watch a particular televised CR\overline{A}V ad or ad pod comprising the Vignette and/or Query. An advertisement pod comprises multiple advertisements, at least one of which comprises a CR\overline{A}V advertisement. The multiple advertisements of an advertisement pod can be presented together in a group, individually at different times, or as a combination of individual and group advertisements.

An instruction section 6014 informs the recipient how to complete and submit the printed response 6000 to qualify for the substantial rewards. For example, submission instructions can include a postal address or facsimile phone number. In an alternative embodiment, the instructions can be provided separately from the printed response. For example, the instructions can be provided in the corresponding advertisement, a separate advertisement, a website, or other location. In a sponsor's section 6016, advertising space can be sold to a sponsor to produce revenues that offset printing and distribution costs of the printed response 6000. A return address (not shown) can be provided on the back of the printed response 6000. The return address can inform the recipient of the address for submitting the printed response 6000. A bar code 6018 provides a registration mark for the OCR and OMR scanning equipment.

In operation, a recipient completes and submits the printed response 6000. An OMR reader detects the blackened bubbles in sections 6004, 6008, and 6010a to verify immersion by determining whether the recipient correctly answered the Query.

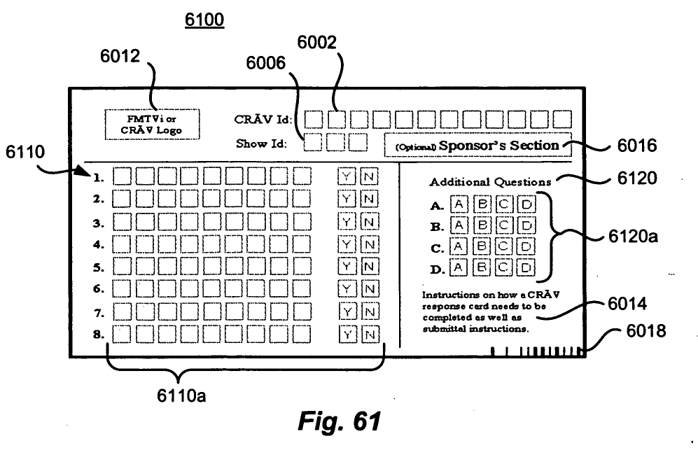

FIG. 61 illustrates a representative OCR printed response 6100 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 61 illustrates.

As shown in FIG. 61, the printed response 6100 comprises the CR\overline{A}V identification number blocks 6002 and the show identification number blocks 6006. However, because an OCR reader can detect the written characters in the blocks 6002 and 6006, corresponding OMR bubbles are not provided.

An answer section 6110 provides answer blocks 6110a in which a recipient can enter the response to the Query. With the OCR printed response 6100, a recipient's answers are not confined to multiple choice. Accordingly, a recipient can enter any characters in the answer blocks 6110a. Additionally, as shown, a recipient can answer an optional yes/no advertiser fulfillment question for each Query in the corresponding Y/N blocks.

In the exemplary embodiment illustrated in FIG. 61, an additional questions section 6120 allows a recipient to respond to additional questions asked by an advertiser. As shown, the additional questions section 6120 comprises answer blocks 6120a in which the recipient can enter a response to each of several additional questions. As illustrated, the additional question answer blocks 6120a can present a multiple-choice answer selection in an undetectable color to indicate the expected character for the recipient to enter.

In operation, a recipient completes and submits the printed response 6100, and an OCR reader detects the characters in blocks 6002, 6006, 6110a, and 6120a to verify immersion by determining whether the recipient correctly answered the Query.

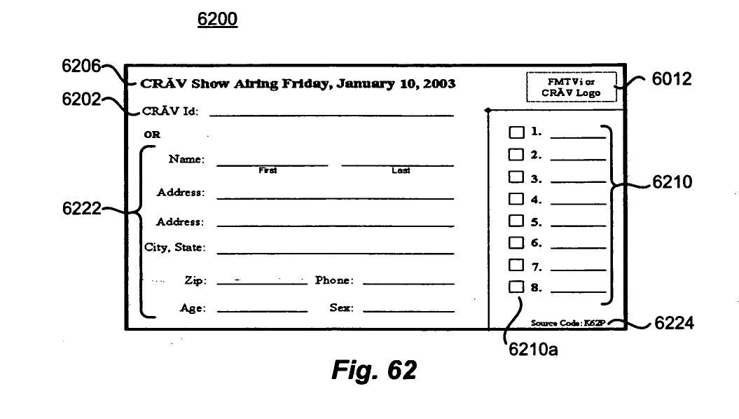

FIG. 62 illustrates a representative manual data entry printed response 6200 according to an exemplary embodiment of the present invention. The manual data entry printed response 6200 does not require any special paper stock and can be printed easily on newsprint, magazine, or other stock.

In one exemplary embodiment of the present invention, a method and/or a system for substituting media content, as discussed in further detail with reference to FIGS. 73-76, comprises an element, step, technology, or other item that FIG. 62 illustrates.

As illustrated in FIG. 62, the printed response 6200 comprises a CR\overline{A}V identification section 6202, a registration section 6222, and an answer section 6210. Each section 6202, 6222, and 6210 allows a recipient to write in all data in the blanks provided. The registration section 6222 allows a recipient to register at the time the recipient submits the answers to the query. Alternatively, the recipient can enter a pre-registered CR\overline{A}V identification number in the section 6202. In the answer section 6210, a recipient writes answers in the blanks corresponding to the respective Query. Additionally, the recipient can check a fulfillment box 6210a provided next to each Query number to indicate that the recipient has provided an answer for that query.

The printed response 6200 also comprises a predetermined show identification section 6206 to indicate the particular show for which the printed response 6200 applies. Accordingly, the printed response 6200 can be used for only the particular show identified in section 6206, thereby providing a one time, one-game use printed response.

A source code 6224 provides information regarding the location where the recipient obtained the printed response 6200.

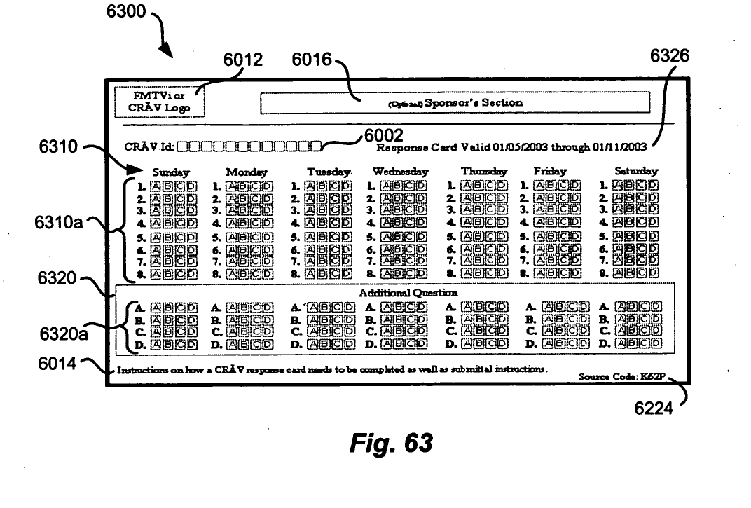

FIG. 63 illustrates a representative multiple-entry printed response 6300 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 63 illustrates.

As illustrated in FIG. 63, the printed response 6300 comprises a weekly printed response having daily answer sections 6310 for an entire week of scheduled CR\overline{A}V advertisements. Each daily answer section 6310 comprises answer blocks 6310a in which a recipient can enter a response to multiple Queries for advertisements broadcast during the respective day. The exemplary printed response 6300 comprises OCR answer blocks 6310a. In an alternative embodiment, the printed response 6300 can comprise OMR answer blocks. The printed response 6300 also comprises an additional questions section 6320 comprising additional daily question blocks 6320a for each respective day of the week.

A validity field 6326 indicates the effective date of the printed response 6300. The printed response 6300 can allow multiple days of CR\overline{A}V ads to be verified on a single printed response. The weekly printed response 6300 illustrated in FIG. 63 can be distributed once a week, or smaller printed responses could be distributed daily. In an exemplary embodiment, weekly and daily printed responses can be delivered to the recipients via national or local newspapers, or other print media.

The exemplary printed responses illustrated in FIGS. 60-63 are not limited to the specific features discussed above. Other features can be added to the printed responses within the scope of the present invention. Additionally, combining features from different printed responses discussed above is within the scope of the present invention.

Delivery of Printed Response to the Data Center

All versions of the printed response, regardless of the type of process used to process the data, can be transmitted or mailed to recipients utilizing a private or public delivery network, such as the United States Postal Service. Versions of the printed response that will be processed manually also can be transmitted by facsimile to the recipients.

The recipients can return the printed responses by mail, facsimile transmission, or other electronic methods to the data storage center 195. The data storage center 195 receives mailed printed responses and processes them manually or through OCR/OMR to capture the data on each printed response. The data storage center 195 can print printed responses received by facsimile transmission and can process the printed responses in a similar manner. Additionally, if the data storage center 195 captures the faxed printed response via facsimile server, then data input personnel can view the faxed printed response on a screen to process the data, thereby alleviating the need to print the faxed printed response.

In exemplary embodiments, recipients can utilize other methods to return the printed responses to the data storage center 195. For example, the recipients can hand deliver the printed responses (personally or via courier), as well as deliver the printed responses by overnight or priority delivery. The allowed methods of delivery depend on the Promoter, who can establish the particular methods acceptable for each response based on volume processing needs.

Combined CR\overline{A}V Ad and Printed Response

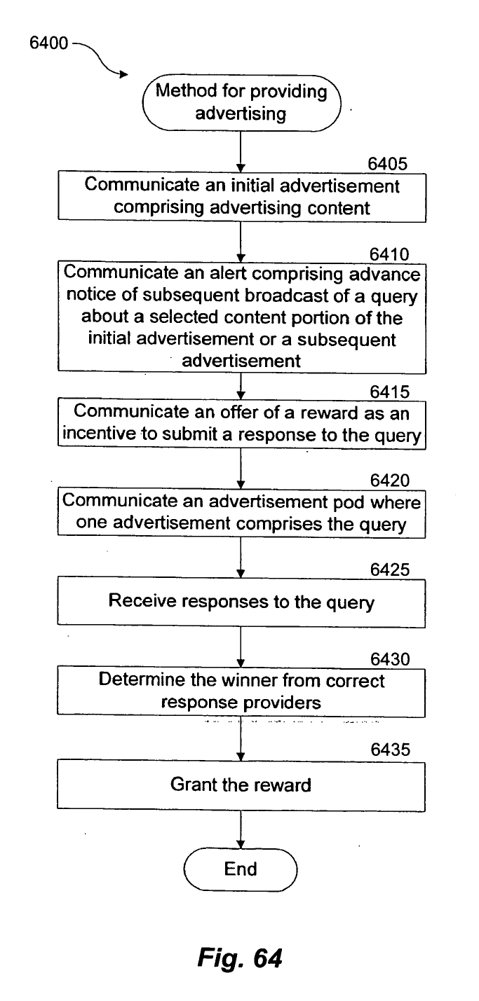

In an exemplary embodiment, a CR\overline{A}V printed response can combine elements of a CR\overline{A}V ad itself. When those elements are combined with the written interactive portion of the reply, the printed response can serve as a self-contained CR\overline{A}V promotion. Such a combination will be described with reference to FIG. 64.

FIG. 64 is a flow chart depicting a method 6400 for providing advertising that combines CR\overline{A}V ad elements with the interactive portion of a reply according to an exemplary embodiment of the present invention.

In one exemplary embodiment of the present invention, a method and/or a system for substituting media content, as discussed in further detail with reference to FIGS. 73-76, comprises an element, step, technology, or other item that FIG. 64 illustrates.

In step 6405, the Promoter communicates an initial advertisement to multiple recipients via a mass media, non-interactive broadcast network. The initial advertisement comprises advertising content for a promotion and is communicated prior to subsequent advertisements related to the initial advertisement. In step 6410, the Promoter communicates an Alert that provides advance notice of subsequent broadcast of a Query about a selected content portion of the initial advertisement. The Alert can provide notice that the Query will be presented during one of multiple advertisements broadcast at a subsequent time. In an exemplary embodiment, the Alert can be communicated in the initial advertisement. In an alternative exemplary embodiment, the Alert can be communicated separately from the initial advertisement.

In step 6415, the Promoter communicates an offer of a reward as an incentive for the recipients to submit a response to the query. Accordingly, the offer can provide an incentive for the recipients to become exposed to the subsequent broadcast of the Query to be able to submit a response.

In step 6420, the Promoter communicates an advertisement pod to multiple recipients via a mass media, non-interactive broadcast network. The advertisement pod comprises multiple advertisements, at least one of which comprises a CR\overline{A}V advertisement. One of the multiple advertisements can comprise the Query, as indicated in the Alert. The recipients then respond to the Query, and the data storage center 195 receives the responses in step 6425. In step 6430, the data storage center 195 processes the responses and determines one or more winners of the reward, based on correct responses to the Query. Finally, in step 6435, the Promoter grants the reward to each winner.

In an exemplary embodiment, the initial advertisement can be communicated on or with a printed response. Accordingly, the recipients can respond to the Query by indicating their response on the printed response and forwarding the printed response to the data storage center 195 for processing.

For example, HammerTime Hardware store publishes a printed advertisement in a national newspaper, such as USA Today. In the advertisement, HammerTime prints the CR\overline{A}V logo (qualifying as an Alert), and utilizes the advertisement's content portion of the promotion to educate the recipients about several new benefits of HammerTime's newly renovated stores. Among the benefits described is the “3 or Free” promotion, under which a consumer waiting more than 3 minutes in a checkout line at HammerTime receives one item free.

The Alert also can inform the recipient that a Query about a selected content portion of HammerTime's newspaper advertisement will be broadcast subsequently on the CRS TV network during a televised CR\overline{A}V advertisement pod airing Monday evening during the 8:00 PM program hour. The advertisement also can comprise an offer of a reward by indicating that HammerTime will award fifty 24k gold hammers to recipients that respond correctly to the Query. That offer can serve as a clue that the CR\overline{A}V ad within the advertisement pod will be an advertisement by HammerTime Hardware.

The newspaper advertisement further can comprise a printed response section to be completed by the recipient. The printed response can comprise an area for insertion of a CR\overline{A}V ID number, or a section to register, an answer area to darken bubbles for A, B, C, D responses to the Query, and a yes/no question asking if the consumer wants to receive a $10 coupon redeemable at the nearest HammerTime Hardware store.

Such a CR\overline{A}V advertisement, combined with a printed response, might appear as a typical printed advertisement, with an Alert logo on the page or printed response, and comprising a printed response similar to one of the exemplary printed responses illustrated in FIGS. 60-63. In this example, the Immersion Verification Query will be distributed via network television, and the advertisement or printed response comprises the Alert and Vignette elements of a CR\overline{A}V advertisement.

The CRS network broadcasts a plurality of ads, including a HammerTime ad, on CRS during the 8:00 PM Monday evening hour. The CRS network also broadcasts the Immersion Verification Query, “How many minutes will you wait before one item you are buying is free?” The Query can be correctly answered by immersion in either the newspaper or TV HammerTime advertisement. The recipient views the plurality of ads and the Query and selects one of the answer choices a) 1, b) 2, c) 3, and d) 5 minutes on the printed response. The recipient can darken the “c” bubble, enter their CR\overline{A}V ID number, and mail the clipped printed response to the instructed address to qualify for substantial rewards. The recipient may choose to receive a free $10 coupon as well.

Additional Considerations for Printed Responses

Printed responses have several benefits when compared to live, immediate responses delivered via the Internet or telephone. The greatest benefit of printed responses is the ease of distribution (via most publishing methodologies, or via direct mail), and the simple nature of interaction that is available to virtually everyone who can read. However, the deferred time between submission of a response by a recipient and receipt by the Promoter allows for the consumer to potentially research the CR\overline{A}V advertisement before submitting a response, which potentially can lessen the quality of Immersion. For example, a recipient could tape a program containing CR\overline{A}V ads and could simply rewind to the portion of the CR\overline{A}V advertisement that presents the Immersion Verification Query. Then, the recipient could seek out only that element of the advertisement that comprises the Query and could avoid the remainder of the advertisement. Alternatively, the recipient could pay less attention to some portions while focusing only on the topic subject to the query (in our example, the number of wait minutes.) The consumer might not need to memorize an advertisement to be better able to successfully verify Immersion. On the other hand, the deferred player may be afforded the time to tape and replay the advertisements multiple times, which provides for repeat exposure of the advertisements to the consumer.

If a Promoter believes that memorization is a key element for obtaining Immersion, and that delayed verification (say, by printed response, or via Internet after a predetermined time frame has elapsed) is not desirable, then the Promoter can provide differing levels of awards based on the type of Interaction. For instance, in the above example, the Promoter can announce that forty of the fifty gold hammers will be awarded to recipients that respond within sixty seconds of the broadcast advertisement pod. The balance of ten hammers will be awarded to recipients that successfully respond within forty-eight hours (or other time frame) of the advertisement pod broadcast. That prizing structure rewards live interaction and memorization more while allowing slower methods of response.

Additionally, the deferred response prizing structure can apply to a deferred response from any response device. For example, a recipient that responds within sixty seconds, or any predetermined time frame, can qualify for a specified reward or reward pool. The recipient can respond within the time frame by any response device. For example, the recipient can respond within the time frame by telephone, Internet, faxed printed response, or other response device. The recipient can qualify for a different level of reward or reward pool by responding after the initial time frame and before the closing of the response period. Again, the recipient can respond by any response device to qualify for the different reward level. For example, the recipient can respond within the time frame by telephone, Internet, faxed printed response, mailed printed response, or other response device.

The Promoter also can determine whether to distribute long-term printed responses (such as the weekly printed response 6300 of FIG. 63), daily printed responses, or single use printed responses (as in the HammerTime example above). An entire week of scheduled CR\overline{A}V ads could be verified on a single printed response distributed once a week (for example, in a national newspaper). Alternatively, daily or single-use printed responses could be distributed daily in a local newspaper and can allow interaction with consumers that missed the weekly printed response distribution. Additionally, the weekly printed response also could be distributed every day in a daily publication, which might increase advertisement size and corresponding advertisement cost to the Promoter. Weekly printed responses potentially can provide savings to recipients in postage when compared to daily or single use printed responses, especially when drop-off locations are not convenient or when printed responses do not have prepaid postage.

Promoters also can consider the cost of collecting data submitted on printed responses, particularly data submitted on printed responses printed in publications having paper stock that is not suitable for OCR and OMR machines (such as newsprint). Printed responses may be submitted via postal delivery and may be folded and inserted into an envelope, potentially requiring the fulfillment and verification process to include opening of envelopes and manual data entry (both of which add to promotional costs). Promoters may avoid some of those costs with weekly printed responses to reduce envelope opening to once a week.

Additional data collected during a CR\overline{A}V advertisement (such as polling information) is obtained more cost-effectively when the additional queries are presented during the response process, as opposed to during the more expensive broadcast for which the Promoter must purchase additional air time. To provide interaction to these additional queries on a printed response, the Promoter can include the queries on the printed response.

A weekly printed response may provide areas for response interaction for nine advertisements per day, for seven days, totaling sixty-three response areas. To make a CR\overline{A}V pod of four advertisements more effective, the Promoter wants recipients to pay attention to all four advertisements even if only one advertisement in the pod comprises an actual CR\overline{A}V advertisement. Such a level of attention can provide all advertisers with high levels of Immersion. Accordingly, the Promoter can structure the printed response to prevent the printed response from providing a clue to the particular CR\overline{A}V advertisement within the pod. For instance, in the HammerTime example discussed above, the Promoter attempts to avoid indicating that the second question of the third pod on Monday will be sponsored by HammerTime Hardware. Therefore, in some cases, the Promoter may not provide non-Immersion Verification queries, or related query interaction areas, on a printed response, to avoid providing clues that potentially impact other advertisements in a pod negatively.

In such an instance, where only Immersion Verification responses and ID information are provided on a mailed-in or delivered printed response, the Promoter can ask the recipient to place his CR\overline{A}V ID number on the face of the envelope. Then, the Promoter may elect to draw envelopes at random to award prizes, thereby avoiding opening and data entry costs for all non-winning printed response submissions. That process works best when the Promoter sees little or no value in the non-Immersion Verification responses (such as polling responses). Alternatively, the Promoter can have the CR\overline{A}V ID numbers manually entered from the envelope fronts, if the Promoter deems that information to be valuable. The Promoter also can ask the recipient to place on the envelope's outside the number of CR\overline{A}V advertisements to which the consumer is responding (e.g., 27 of 63 advertisements were viewed in a week). The Promoter may value that data, which can be entered without incurring the costs of opening all envelopes and entering all data.

The CR\overline{A}V system and process can be utilized across any mass media Broadcast Network 105. For example, the mass media Broadcast Network 105 can comprise TV, cable, satellite, radio, outdoor media (billboards, signs, buses), print media (newspapers, magazines), direct mail, the Internet, or other broadcast network, as well as private networks. Private networks can comprise networks having connected Personal Recording Devices such as a TiVo®. Additionally, a convergence of multiple mass media Broadcast Networks 105, when utilized together, can broaden the reach and effectiveness of CR\overline{A}V ads. “Concentrated segments” of CR\overline{A}V ads can saturate consecutive segments of time. For example, concentrated CR\overline{A}V segments can be broadcast as a game show, or through a dedicated network of continuous CR\overline{A}V ads. That concentrated process can allow a Promoter, Advertiser(s), or network(s) to increase the portion of mass media time (or in the example of print media, space) that can be allocated to revenue-generating CR\overline{A}V ads, while lowering the portion of time once dedicated to costly content. The consumers will support the concentrated ads, provided the substantial rewards associated with CR\overline{A}V ads remain a central component of the game show or dedicated network.

Types of Mass Media CR\overline{A}V Ads

Radio

Radio programs are distributed over the airwaves, and/or over the Internet. As with the television industry, ad revenues garnered by radio stations are utilized to offset the costs of content (music, news, sports, etc.) and its production, as well as overhead costs such as staff and marketing. As with television, ads and ad pods are embedded between content segments. Consumers tend to avoid radio ads by switching channels, listening to alternate forms of entertainment (such as CDs, DVDs, television, etc.), or by turning off the radio.

Within radio program segments, single CR\overline{A}V ads or CR\overline{A}V ad pods can be broadcast. Some or all ads within the program may be CR\overline{A}V ads. CR\overline{A}V ads can contain “Alert” tones or specific Alert wording to entice immersion. The Alert can be provided at the beginning of a program or program segment, or at the beginning or end of an ad or ad pod. After the ads (audio “Vignettes”) are broadcast, listeners can be provided with log-in instructions. The instructions can suggest immersion verification via telephone or cellular phone. Additionally, the instructions can suggest immersion verification through any of the Response Devices 111. Accordingly, consumers can register and/or provide query responses to immersion verification or other queries through the Response Devices 111. The Queries can be broadcast on air, before or after the CR\overline{A}V ad. Alternatively, the Queries can be provided during the Query-response interaction process utilizing Devices 111 over networks provided by Service Providers 112.

Promoters may desire to provide multiple queries to make cheating more difficult.

For example, cheating can include one consumer learning the content and providing the query and answer to subsequent players. Promoters may also desire to limit the amount of time allowed for interaction. In addition to Immersion Verification queries, other queries can be included. For example, the other queries can comprise sponsor-designed questions, polling questions, demographic questions, etc., similarly to television use of CR\overline{A}V ads.

Aspects of the television industry's use of CR\overline{A}V ads discussed above mirror the radio industry. Those aspects comprise the advance promotion and registration of CR\overline{A}V players, the assignment of CR\overline{A}V ID numbers, research, and the substantial prizing and prize fulfillment aspects. Those practiced in the art will recognize the similarities between the radio broadcast and television broadcast industries, as well as the similarities in the methods, analysis, and sales techniques utilized by Promoters to determine the sales price and costs of CR\overline{A}V ads.

Print Media: Books/Magazines/Newspapers

Books, magazines, and newspapers are distributed to subscribers through vending or printed work sales outlets. Additionally, on-line versions of those printed materials may be distributed via the Internet. Over-air broadcast mass media (such as television and radio) have costs affiliated with time. In other words, radio and television costs of content are measured in units of time, and ad units are sold as units of time. On the other hand, print mass media content costs are affiliated with space, such as ad size on printed pages. The more printed pages, the higher the cost of a printed work.

Ad revenues garnered by print media are utilized to offset the costs of paper, printing costs, distribution, development of written and photographic content and its production, and staff and marketing overhead. Ads of different sizes can be embedded between content segments or sections of the print media. Consumers tend to avoid print ads by ignoring the ad, reading around the ad, turning the page, or discontinuing reading the written work.

Within and between printed content segments, CR\overline{A}V ads of different sizes can be printed or distributed. The ads can comprise an Alert mark or logo to entice immersion. Additionally, specific printed instructions can be provided within the ad to entice immersion. Internet distribution of magazines (e-magazines or e-zines) or newspapers also can comprise audio or visual Alerts. An Alert logo can be provided on a printed ad to invite immersion in the content of that individual ad. Alternatively, an Alert logo can be provided on multiple ads to invite immersion in the content for a section of ads or for one of the ads in the section. The multiple ads can comprise the printed version of an ad pod.

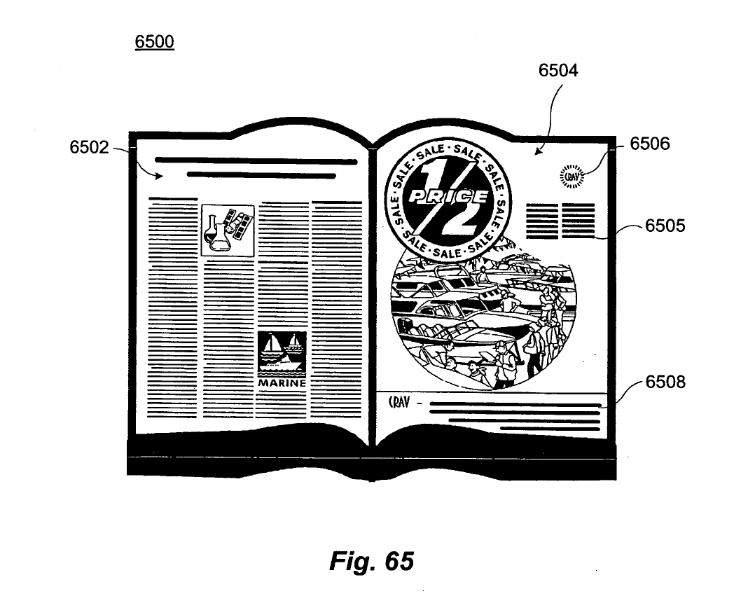

FIG. 65 illustrates a print media advertisement 6500 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 65 illustrates.

As shown in FIG. 65, the print media ad 6500 comprises content 6502 and a CR\overline{A}V ad 6504. The CR\overline{A}V ad 6504 comprises advertising content 6505, which can comprise a Vignette. The CR\overline{A}V ad 6504 also comprises an Alert logo 6506, which alerts the consumer to a possible reward for becoming immersed in the CR\overline{A}V ad content 6505. A CR\overline{A}V instruction/verification section 6508 can provide one or more of a Query about a selected portion of the advertising content 6505, instructions for responding to the Query, prize information, an alert to subsequent broadcast or distribution of a Query, or other information.

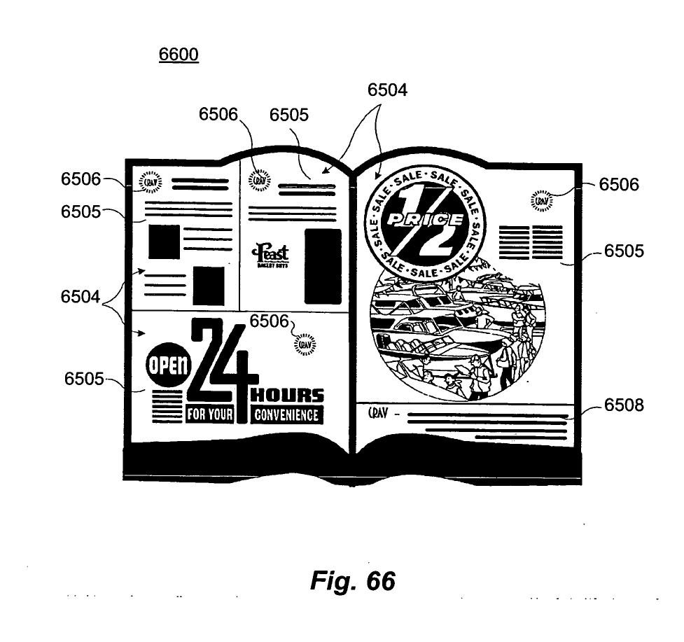

FIG. 66 illustrates a print media advertisement pod 6600 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 66 illustrates.

As shown in FIG. 66, the print media ad pod 6600 comprises multiple CR\overline{A}V ads 6504. Each CR\overline{A}V ad 6504 comprises advertising content 6505, which can comprise a Vignette. Additionally, each CR\overline{A}V ad 6504 comprises the Alert logo 6506, which alerts the consumer to a possible reward for becoming immersed in the CR\overline{A}V ad content 6505. The CR\overline{A}V instruction/verification section 6508 can provide one or more Queries about a selected content portion of one or more of the multiple ads 6504. Additionally, the CR\overline{A}V instruction/verification section 6508 can provide one or more of instructions for responding to the Query, prize information, an alert to subsequent broadcast of a Query, or other information.

After the consumers review the print media ads, they can register and/or provide a query response through the various Response Devices 111. In exemplary embodiments, the Immersion Verification Query can be printed on the ad, hidden elsewhere within the printed publication, or provided only during the Query interaction/response process through the Response Devices 111. Providing the Query during the interaction/response process can enhance immersion by requiring memorization of the ad to assist in expeditious answering of the Query.

As discussed above, Promoters may desire to provide multiple queries to make cheating more difficult. Promoters can attempt to allow a consumer to interact with an ad only once, further increasing the likelihood of serious desire to play properly and increasing the likelihood and effectiveness of immersion. To prevent subsequent reviewing of the ad, Promoters can limit the amount of time allowed for interaction, or can allow interaction and immersion verification within a limited, announced timeframe. Accordingly, the consumers can rely on memory to correctly and timely answer the Query. In addition to immersion verification queries, other queries can be included. For example, other queries can comprise sponsor-designed questions, polling questions, demographic questions, etc.

Most aspects of the television industry's use of CR\overline{A}V ads discussed above mirror the mass-media print industry. For example, similarities include advance promotion and registration of CR\overline{A}V players, the assignment of CR\overline{A}V ID numbers, research, and the substantial prizing and prize fulfillment aspects. Those practiced in the art will recognize the similarities between the radio and television broadcast industries, when compared to the print industry, as well as the methods, analysis, and sales techniques utilized by Promoters to determine the sales price and costs for CR\overline{A}V ads.

Outdoor Media

Outdoor media can comprise billboards, fixed signs on or inside buildings, and mobile signs on taxis, buses, plane banners, or blimps. Outdoor mass media advertising can rely on capturing the attention of passing consumers for short time periods. To create outdoor media, Promoters utilize printed materials such as billboard “wraps” or printed card inserts for taxis, paint applied directly to boards or buildings, and electronic billboards. Electronic billboards can display advertising messages and entertainment content, such as news headlines, sports headlines, etc. However, most outdoor media comprise advertising messages and do not comprise substantial amounts of traditional content.

Ad revenues generated by outdoor media Promoters are utilized to offset the costs of development of written and photographic content and its production, paper, printing costs, paint, distribution, installation, material costs, overhead, rental fees, or other fees charged by billboard property owners, taxi cab, or advertising facility owners. Consumers tend to avoid outdoor media ads by ignoring them, or by looking away.

A CR\overline{A}V version of an outdoor mass media ad can comprise a recognized visual “Alert” mark or logo on an outdoor media ad to entice immersion. Alternatively, the outdoor media ad can comprise an audible tone to entice immersion. The audible tone can be provided over radio waves or can emanate from the outdoor media item itself. The outdoor media CR\overline{A}V ad also can provide log-in instructions, allowing interaction through the various Response Devices 111 for consumers to register and/or to provide Query responses. The Immersion Verification Query can be printed on the outdoor media ad. Alternatively, the Immersion Verification Query can be provided during the Query interaction/response process through the Response Devices 111.

As discussed above, Promoters may desire to provide multiple queries to make cheating more difficult. Promoters can attempt to allow a consumer to interact with an ad only once, further increasing the likelihood of serious desire to properly play and increasing the likelihood and effectiveness of immersion. To prevent subsequent reviewing of the ad, Promoters can limit the amount of time allowed for interaction, or can allow interaction and immersion verification within a limited announced timeframe. Accordingly, the consumer can rely on memory to correctly and timely answer the Query. In addition to immersion verification queries, other queries can be included. For example, other queries can comprise sponsor-designed questions, polling questions, demographic questions, etc.

Aspects of the television industry's use of CR\overline{A}V ads discussed above mirror the outdoor media industry. For example, those aspects comprise the advance promotion and registration of CR\overline{A}V players (a billboard Promoter could advise passerby's of “WATCH THIS SPACE FOR FUTURE CR\overline{A}V ADS”), the assignment of CR\overline{A}V ID numbers for registered players, research aspects of registration and query responses, and the substantial prizing and prize fulfillment aspects. Those practiced in the art will recognize the similarities between the radio and television broadcast industries, when compared to the outdoor media, as well as the methods, analysis, and sales techniques utilized by Promoters to determine the sales price and costs for CR\overline{A}V outdoor ads.

Direct Mail

Direct mail relies on capturing the attention of consumers while opening their mail. Many Direct Mail Promoters utilize printed materials (envelopes, printed advertising fliers, brochures, coupons, etc.) and incur substantial costs in distributing their advertising. Most direct mail media, like outdoor media, do not comprise substantial amounts of traditional content and are typically dominated by advertising messages. However, in some respects, direct mail Promoters face many of the cost structures of the print media industries because costs are determined by space rather than broadcast time.

Direct mail Promoters can mail one advertising insert, or multiple ad inserts, to a mass mailing list, taking advantage of economies of scale such as bulk mail rates. In the event of multiple mailed pieces within one envelope (the direct mail version of an ad “pod”), costs of distribution are shared by multiple advertisers, lowering the costs per insert. Ad revenues garnered by direct mail media Promoters are utilized to offset the costs of paper, printing costs, distribution and postage, handling, overhead, and development of written and photographic content and its production. Consumers tend to avoid direct mail media ads by discarding them while sorting incoming mail, often before even opening the envelopes.

A CR\overline{A}V version of a direct mail ad can comprise a recognized visual Alert mark or logo on the envelope or on the insert itself. An Alert logo can be added to a single printed insert to invite immersion in that individual CR\overline{A}V ad. Alternatively, an Alert can apply and invite immersion for all inserts in the event of multiple inserts (a direct mail ad pod.) The CR\overline{A}V envelope or CR\overline{A}V ad can provide printed log-in instructions, allowing interaction facilitated through the various Response Devices 111. Accordingly, consumers can register and/or provide Query responses through the Response Devices 111. The Immersion Verification Query also can be printed on the envelope or insert. Alternatively, the Query can be provided during the Query response/interaction process.

As discussed above, Promoters may desire to provide multiple queries to make cheating more difficult. Promoters can attempt to allow a consumer to interact with an ad only once, further increasing the likelihood of serious desire to play properly and increasing the likelihood and effectiveness of immersion. To prevent subsequent reviewing of the ad, Promoters can limit the amount of time allowed for interaction, or can allow interaction and immersion verification within a limited announced timeframe. Accordingly, the consumer can rely on memory to correctly and timely answer the Query. In addition to immersion verification queries, other queries can be included. For example, other queries can comprise sponsor-designed questions, polling questions, demographic questions, etc.

Aspects of the television industry's use of CR\overline{A}V ads discussed above mirror the direct mail media industry. Those aspects comprise the advance promotion and registration of CR\overline{A}V players (initial mailings can advise recipients of future mailings bearing the CR\overline{A}V logo or pre-registration), the assignment of CR\overline{A}V ID numbers for registered players, research aspects of registration and query responses, and the substantial prizing and prize fulfillment aspects. Those practiced in the art will recognize the similarities between the radio and television broadcast industries, when compared to the direct mail media industry, as well as the methods, analysis, and sales techniques utilized by Promoters to determine the sales price and costs for direct mail CR\overline{A}V ads.

Internet

Mass distribution of CR\overline{A}V ads over the Internet can take multiple forms, each of which can share aspects of other mass media types. In addition, the Internet can save Promoters certain costs affiliated with less modem forms of mass media. For example, Internet Promoters can create “broadcast e-mail ads.” In such ads, a Promoter can mass broadcast e-mails to a list of e-mail addresses, simulating a direct mail campaign without bearing the costs of materials and postage.

Internet Promoters also can “stream” video versions of televised or radio content and embedded ads, or merely the ads themselves, to consumers. In “requested streamed Internet ads,” the Promoters can stream the content to consumers upon request. Alternatively, in “simulcast broadcast ads,” the Promoters can stream simulcast versions of televised or radio content and embedded ads, which are mass broadcast over a web site. In the example of streaming audio or video feeds, Promoters bear bandwidth costs, which must be considered when calculating the cost to the Advertiser for sending streaming ads, or streaming CR\overline{A}V ads, to consumers.

Some distributors of printed materials offer “Internet mirrored display ads.” For example, newspaper distributors can offer on-line versions of their printed works on a website. Internet consumers of the printed work can review content and ads in the newspaper on the website. Those Internet mirrored display ads are similar to the printed media ads discussed above.

Internet Promoters also use “mass media banner ads” as a means of Internet advertising. A Promoter can create a CR\overline{A}V mass media banner ad by consistently posting the ad on a mass media website in a non-targeted fashion without linking the advertiser directly to the consumer. The CR\overline{A}V banner ad can comprise an Alert and can provide substantial rewards to some of the consumers who register and verify immersion in the ad's content. Those CR\overline{A}V ads are different from the types of targeted Internet ads displayed only to consumers that meet specified criteria.

Consumers tend to avoid Internet ads by closing browser windows containing ads, or avoiding web sites that comprise ads altogether. However, Internet CR\overline{A}V ads can overcome the consumers'tendencies by drawing the consumers'attention to the ads. Each of the Internet ads discussed above can comprise a CR\overline{A}V ad by implementing the Alert and Immersion Verification processes for the ad itself. Multiple CR\overline{A}V ads within a requested stream, simulcast broadcast, mirrored display, or mass media banner broadcast can comprise a “pod” of ads, whereby an Immersion Verification Query can be posed about one or more of the ads in the pod. The CR\overline{A}V ads can comprise Alert logos or tones, or specific Alert wording to entice immersion.

After the ads are broadcast by stream, display, or banner with video and/or audio vignettes, consumers can be provided with log-in instructions, typically suggesting log-in for immersion verification via the Internet, but also available through the other Response Devices 111. Accordingly, consumers can register and/or provide query responses to immersion verification queries using the Response Devices 111. Queries also can be broadcast following the vignette or before or after the CR\overline{A}V ad. Alternatively, the Queries can be provided during the Query response/interaction process utilizing the Response Devices 111 over networks provided by Service Providers 112.

As discussed above, Promoters may desire to provide multiple queries to make cheating more difficult. Promoters can attempt to allow a consumer to interact with an ad only once, further increasing the likelihood of serious desire to play properly and increasing the likelihood and effectiveness of immersion. To prevent subsequent reviewing of the ad, Promoters can limit the amount of time allowed for interaction, or can allow interaction and immersion verification within a limited, announced timeframe. Accordingly, the consumer can rely on memory to correctly and timely answer the Query. In addition to immersion verification queries, other queries can be included. For example, other queries can comprise sponsor-designed questions, polling questions, demographic questions, etc.

Aspects of the television industry's use of CR\overline{A}V ads discussed above mirror CR\overline{A}V ads over the Internet. Those aspects comprise the advance promotion and registration of CR\overline{A}V players, the assignment of CR\overline{A}V ID numbers, research, and the substantial prizing and prize fulfillment aspects. Those practiced in the art will recognize the similarities between the Internet and television broadcast industries, as well as the methods, analysis, and sales techniques utilized by Promoters to determine the sales price and costs for CR\overline{A}V ads.

Private Networks

Private networks can exist across all mass media industries. For example, private networks comprise a mailing list (distribution of materials over the U.S. Postal Service delivery network), magazine subscription list, e-mail address distribution list, taped music distributed to subscribers (like Muzak), a connected network of broadcast content linked to interactive devices within bars and restaurants (such as NTN), consumers connected through a cable system to Video on Demand servers, and owners on a Personal Video Recorder network.

For mass media broadcasting of CR\overline{A}V ads over a private network, the private network requires the ability to cost effectively distribute (i.e., broadcast) ads across the entire network. That broadcasting differs from targeted media, which include distributing interactive ads to a segment of consumers connected to the private network based on targeted profiles, such as demographics.

In general, ads distributed over a private network are subject to the same consumer avoidance techniques indicative of the industry (i.e., print ads can be avoided by turning the page). Similarly, the implementation of CR\overline{A}V ads across a private network will enhance immersion, just as it would across the public network version of the same CR\overline{A}V ads.

Convergence

To enhance the effectiveness of CR\overline{A}V ads, the CR\overline{A}V ads can be broadcast across a convergence of multiple media forms (“cross-media” broadcasting). For example, a Promoter can distribute CR\overline{A}V ads comprising the same message about a new automobile across the radio, television, Internet, and print mediums. The ads can be presented simultaneously or at different times on the multiple media forms. While the ads can have different appearances based upon restrictions of each media, the immersion verification query can be the same across all media.

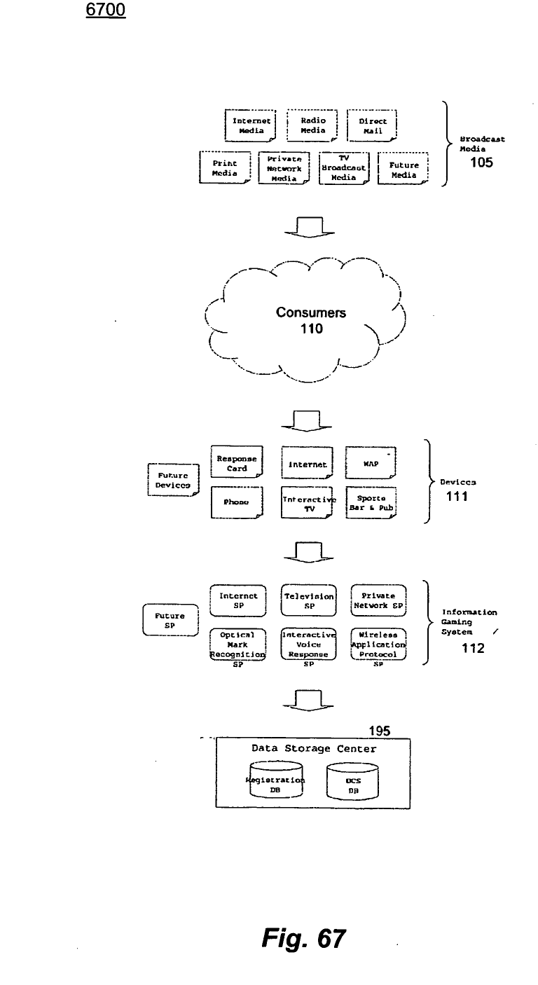

FIG. 67 illustrates a CR\overline{A}V ad broadcast over a convergence 6700 of mass media formats according to an exemplary embodiment of the present invention. In one exemplary embodiment of the present invention, a method and/or a system for substituting media content, as discussed in further detail with reference to FIGS. 73-76, comprises an element, step, technology, or other item that FIG. 67 illustrates.

As shown in FIG. 67, a Promoter can broadcast to consumers 110 a CR\overline{A}V ad or ad pod over two or more of the Broadcast Networks 105. The CR\overline{A}V ad or ad pod can be broadcast simultaneously or independently over the multiple Broadcast Networks 105. The consumers 110 can react to the CR\overline{A}V ad or ad pod by responding to an immersion verification query about a selected content portion of a CR\overline{A}V ad or pod. The consumers 110 can respond to the query through one or more of the Response Devices 111. The query can be provided over one or more of the multiple Broadcast Networks 105. Alternatively, the query can be provided over the Response Devices 111. The Response Devices 111 communicate the consumers'query responses to the Data Storage Center 195 through the respective Service Provides 112. A reward can be granted to a consumer that responds correctly to the query.

In an exemplary embodiment, a Promoter or advertiser can bundle CR\overline{A}V ads across all media, and the interaction process also can be triggered by each media individually or through instructions provided in one of the media (for example, television). In an exemplary embodiment, one media can provide “clues” to assist CR\overline{A}V players in correctly answering CR\overline{A}V ads in another media. For example, a local newspaper might publish an ad with a CR\overline{A}V logo. The ad can explain that a televised CR\overline{A}V ad sponsored by the same advertiser will be broadcast within a CR\overline{A}V ad pod during a certain timeframe that evening, over a specified television network. In an exemplary embodiment, immersion verification can be available only after the televised CR\overline{A}V ad airs. The Query can be broadcast on air, provided in the original ad, or provided during the response/interaction process. Accordingly, the CR\overline{A}V logo on the print ad can provide the future televised CR\overline{A}V ad viewer with a clue as to which ad in the indicated CR\overline{A}V pod is the ad for which the immersion Query applies. This convergence methodology can be implemented over the radio, or in unison with radio, print, television, well-timed direct mail, private networks, or other broadcast media. Additionally, such a “detached” CR\overline{A}V ad can be distributed in various parts over various mass media formats.

Another exemplary form of convergence is the utilization of the bandwidth provided over a high definition signal. This bandwidth can be divided into multiple signals, which can include data, Internet, radio, and televised content. Multiple-channel use of this bandwidth can provide delivery of normal or high definition televised or radio CR\overline{A}V ads, while also providing Internet content that might include Immersion Verification Queries. Similarly, the Internet signal might include CR\overline{A}V ads (stream, display, or banner with video and/or audio vignettes). As indicated above, those Internet CR\overline{A}V ads can utilize the same Immersion Verification Queries as other cross-media CR\overline{A}V ads in the marketplace. Additionally, the multiple media formats can provide clues to viewers of televised CR\overline{A}V ads as to which ad or ads in a scheduled televised pod will be subject to immersion verification.

Another exemplary form of convergence comprises “back channel” technology, which provides a data feed from television set top boxes or private video recorders (“PVRs”). The set top boxes and PVRs receive broadcast content signal over a satellite or cable network and display the signal on a monitor. The monitor can comprise a TV. Consumers can access the back channel of the set top boxes or PVRs to send data from the set top boxes or PVRs to a third party. This back channel signal can be delivered by a second signal source. The second signal source can comprise broadband or dial-up Internet access, telephone, cable, or satellite. The back channel signal also can provide two-way communication. Accordingly, immersion verification, registration, and response/interaction can be performed utilizing the back channel capabilities of the set top boxes or PVRs.

For set top boxes and PVRs, CR\overline{A}V ads (or elements of CR\overline{A}V ads) can be delivered to the consumer via a convergence of mass media formats. For example, the Alert and Vignette can be delivered via television broadcast, while the immersion verification query and interaction elements can be delivered via Internet.

In an exemplary embodiment, while watching a CR\overline{A}V ad, the consumer can press a button on the set top box, PVR, or the remote control, which opens a second CR\overline{A}V ad. The second CR\overline{A}V ad can comprise a display ad or even full motion video and can provide some or all of the elements of the on-air CR\overline{A}V ad. That exemplary embodiment can expose the consumer to a second branded CR\overline{A}V advertisement.

Those skilled in the art will recognize that the present invention applies to any mass media broadcast network and that new types of delivery technologies can serve as new mass media platforms for the delivery of content and ads, including CR\overline{A}V ads. Those future media will form part of the CR\overline{A}V ad delivery and interaction system and will be able to participate in the cross-media convergence methodologies discussed above.

Concentrated CR\overline{A}V Ads

CR\overline{A}V ads can be concentrated to create an entire program comprising continuous or contiguous CR\overline{A}V ads. The concentrated ads can generate sponsorship revenues for the Promoters for each CR\overline{A}V ad “content” segment, thereby converting content from a cost generating item to a revenue generating item. Concentration allows broadcasting a series of back-to-back CR\overline{A}V ads or pods without interruption by traditional content, which also can include a period of time for query responses between ads. In an exemplary embodiment, concentrated CR\overline{A}V can comprise a new game show format that allows a Promoter or Broadcaster to utilize a greater percentage of the program hour (or publication) to generate revenue, providing Promoters with the ability to realize a paradigm shift in the advertising-supported, mass media industry.

Over time, CR\overline{A}V players can become authorized and indoctrinated players of CR\overline{A}V games and game shows across all mass media models, including television, radio, print, direct mail, Internet, private networks, and outdoor media. Accordingly various extended (or even 24-hour) broadcast networks of CR\overline{A}V ads can be established to broadcast consecutive CR\overline{A}V ads or CR\overline{A}V pods.

Consumers can immediately find and interact with CR\overline{A}V ads on these extended broadcast networks. In a mature and evolved market, where CR\overline{A}V consumers are considered a valuable and voluminous portion of the general public, traditional broadcast networks or publications supported by advertising can sell blocks of advertising time or space to the Promoters or owners of an extended CR\overline{A}V network. That block of advertising can temporarily boost the number of consumers viewing a simulcast CR\overline{A}V ad or pod on both the traditional and extended CR\overline{A}V broadcast networks. The selling network can provide the Promoter with discounted pricing for the amount of space or time being purchased, in exchange for which the Seller can avoid sales costs and can generate net incremental revenues. The Promoter can increase the fees charged to advertisers (or even to the traditional broadcast network) for airing CR\overline{A}V ads during the simulcast or multi-print platform segment. Indeed, multiple broadcast networks (across multiple industries) can sell synchronized advertising or ad pod time to the extended CR\overline{A}V network to simulcast identical CR\overline{A}V ads to a connected synchronous network of television, radio, and Internet consumers. The synchronized advertising can enhance the audience size and the substantial rewards available to successfully immersed and validated consumers.

CR\overline{A}V Game Show or Publication

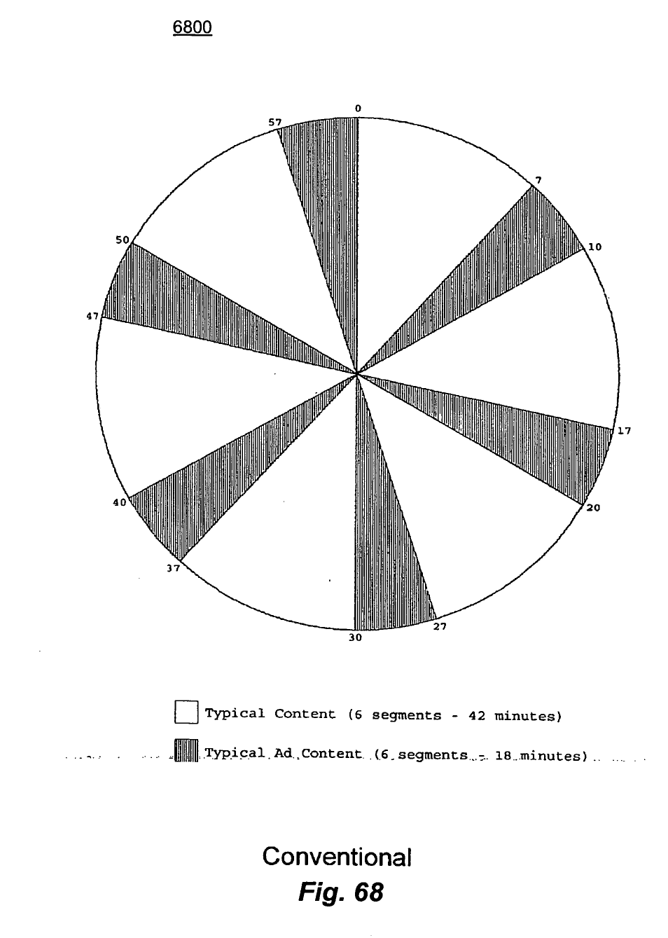

FIG. 68 illustrates the ratio 6800 of ad minutes to content minutes in a conventional programming hour-long broadcast. As shown in FIG. 68, the conventional programming hour comprises six content segments lasting seven minutes each for a total of forty-two content minutes. The conventional programming hour also comprises six ad segments lasting three minutes each for a total of eighteen ad minutes. Accordingly, the ad to content ratio 6800 of the conventional programming hour is eighteen to forty-two.

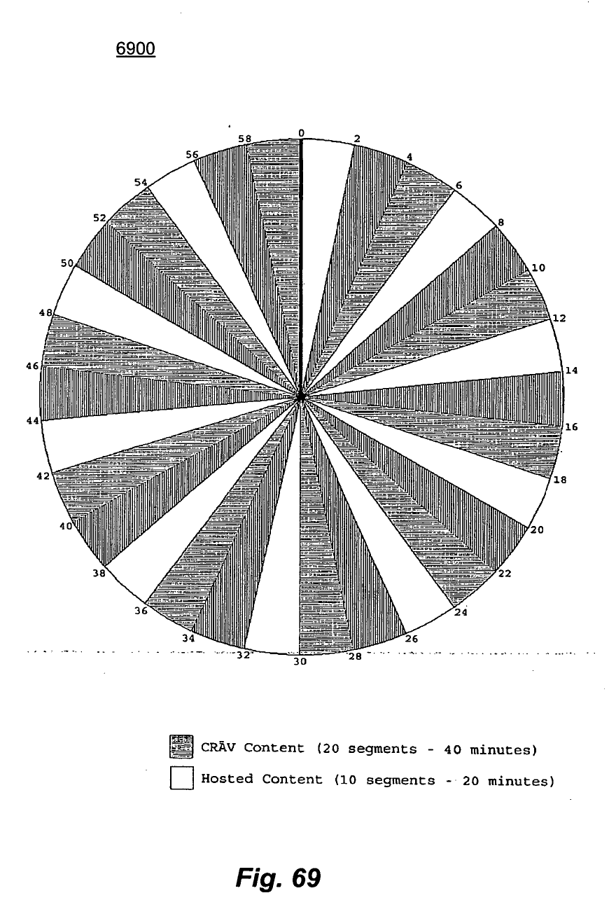

FIG. 69 illustrates the ratio 6900 of ad minutes to hosted program minutes in a CR\overline{A}V game show hour-long broadcast according to an exemplary embodiment of the present invention. In one exemplary embodiment of the present invention, a method and/or a system for substituting media content, as discussed in further detail with reference to FIGS. 73-76, comprises an element, step, technology, or other item that FIG. 69 illustrates.

As shown in FIG. 69, the CR\overline{A}V game show hour comprises twenty ad segments lasting two minutes each for a total of forty ad minutes. The CR\overline{A}V game show hour also comprises ten hosted content segments lasting two minutes each for a total of twenty hosted content minutes. Accordingly, the ad to hosted content ratio 6900 of the CR\overline{A}V game show hour is forty to twenty.

When compared to a CR\overline{A}V ad or ad pod, a feature of a CR\overline{A}V game show is that individual CR\overline{A}V ads or pods take on the characteristics of content. Traditional content can be reduced or eliminated over an extended period of time. For example, a televised CR\overline{A}V game show can last thirty or sixty minutes and can provide hosted segments between four minute, self-contained CR\overline{A}V ads or pods. As shown in FIG. 69, an hour-long CR\overline{A}V game show can comprise forty minutes of CR\overline{A}V ads, which generate revenues, while containing only twenty minutes of hosted content. Accordingly, the CR\overline{A}V game show can virtually reverse the conventional ratio of content cost to advertising revenue illustrated in FIG. 68.

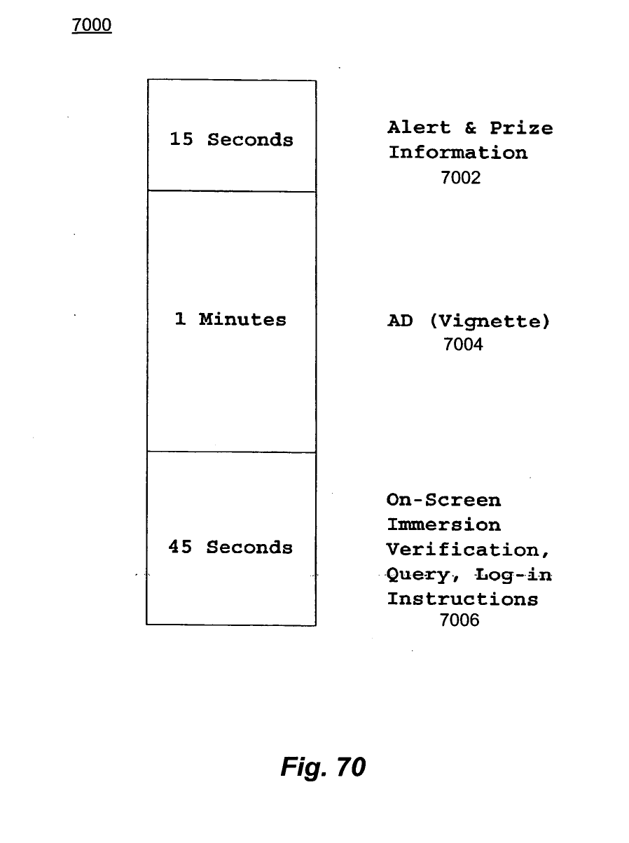

FIG. 70 illustrates a representative CR\overline{A}V game show two minute segment 7000 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 70 illustrates.

As shown in FIG. 70, the segment 7000 comprises fifteen seconds of Alert and prize information 7002, a one minute Vignette 7004, and forty-five seconds of on-screen Immersion Verification Query posting and log-in instructions 7006. The forty-five second portion 7006 also can comprise on-screen awards and a Query answer period.

This continuous game show format and system also can be transitioned from traditional shows with embedded CR\overline{A}V ads to a CR\overline{A}V game show with little or no traditional content by way of a hybrid version of a CR\overline{A}V game show. In such a hybrid version, the “content” can reference the embedded CR\overline{A}V ads or pods, beginning the process by which consumers will become accustomed to, and ultimately accepting and desirous of, higher concentration of CR\overline{A}V ads during certain time frames.

In an exemplary embodiment, a hybrid version of a CR\overline{A}V game show can comprise “reality” programming where the consumers starring or winning on the program itself were selected from consumers who successfully verified immersion to CR\overline{A}V ads that aired in prior weeks. In such a program, program content can become closely associated with the CR\overline{A}V ad pods broadcast between content segments.

CR\overline{A}V game shows (or hybrid versions) also can be presented over the radio, Internet, private networks, or any other form of mass media. For example, a publication containing CR\overline{A}V ads and little other content can comprise a CR\overline{A}V game. Consumers can immerse themselves in the CR\overline{A}V ad content and interact over the Internet or phone by answering one or more immersion verification questions of some ads in the publication. The questions can be generated at random from a pre-designed list of questions created by the Promoter or Advertiser. The questions can include time limitations so that the consumer must commit the CR\overline{A}V ads to memory due to the insufficient time allowed for the consumer to re-review the ad and subsequently to provide the answer.

Another exemplary form of a hybrid game show (which verges on a form of a hybrid network) can be “manufactured” with the use of Personal Video Recorders (“PVRs”) tied to a broadcast network such as television or the Internet. Since PVRs can record programs based on air times or tags embedded within the signal that notifies the recorder to record a segment, CR\overline{A}V ads or pods also can be scheduled or tagged for recording over the course of a timeframe (hours or days). The PVRs can record all programs that meet a certain criteria, such as name of show, starring actor, type of programs, etc. Accordingly, a CR\overline{A}V ad tag can be added as a search criteria, and PVR's can strip the traditional program content away from the ads. Then, the consumer can watch back-to-back CR\overline{A}V ads or pods. If immersion verification can be watched on a delayed, or “time shifted” basis, then the consumer can review a virtual game show of CR\overline{A}V ads manufactured from the individual CR\overline{A}V ads or pods broadcast over the designated recording period.

The manufactured CR\overline{A}V game show also can be created over the Internet. In that case, a multi-media computer can search for CR\overline{A}V ads, store them in a section of a hard drive, and thereafter allow the consumer to view, read, or listen to CR\overline{A}V ads saved and stored within the computer.

Concentrated CR\overline{A}V Network

A more saturated form of CR\overline{A}V advertising can be broadcast over a continuous network feed, comprising a series of back-to-back CR\overline{A}V ads or pods. This feed can be delivered by traditional or newer forms of Broadcast Networks 105 and can be received for commercial purposes. For example, the continuous feed can be broadcast to a television network that can retransmit some or all of the signal to consumers. Alternatively, the continuous feed can be broadcast directly to consumers via a 24-hour CR\overline{A}V television network channel.

The direct-to-consumer network can allow a Promoter to sell CR\overline{A}V ads or pods to advertisers interested in placing CR\overline{A}V ads on a network dedicated entirely to CR\overline{A}V ads. Consumers can turn to the CR\overline{A}V broadcast at any time to view, hear, or read CR\overline{A}V ads. Such availability can provide consumers with a rewarding alternative to the non-CR\overline{A}V ads being embedded within other programs.

Ultimately, during non-CR\overline{A}V commercial breaks (“conventional commercial breaks”) on conventional television, radio, Internet, or private network broadcasts, a consumer can elect to temporarily (or permanently) change channels to the continuous CR\overline{A}V broadcast. Accordingly, a consumer can avoid being exposed to conventional advertising (non-CR\overline{A}V advertising) by turning to the CR\overline{A}V ads on the continuous CR\overline{A}V broadcast.

In an exemplary embodiment, the conventional broadcasts can substitute the continuous CR\overline{A}V signal during the conventional commercial breaks. Currently, conventional networks must sell their ad time directly to advertisers, or to media companies, who place the ads with their Clients. Utilizing the concentrated CR\overline{A}V process, the conventional network can sell a three minute block of time to the Promoter of the CR\overline{A}V network. That three minute block of time can be scheduled for distribution during a commercial break between conventional content segments of the conventional broadcast. Then, the Promoter can add the viewing audience from the traditional network, when calculating the audience size for the particular CR\overline{A}V pod airing during that three minute time period. Additionally, the Promoter can implement that process across multiple networks and media (such as radio and television). In that manner, the Promoter can package a “road block” of CR\overline{A}V ads appearing simultaneously on multiple media and multiple channels within those media, as well as on the concentrated CR\overline{A}V network.

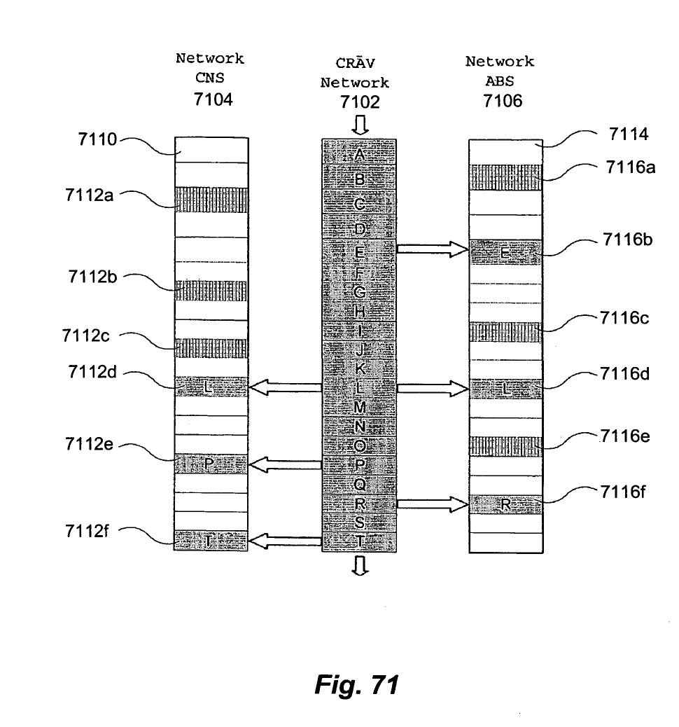

FIG. 71 illustrates the substitution of conventional advertising segments with CR\overline{A}V ad segments broadcast on a continuous CR\overline{A}V network 7102 according to an exemplary embodiment of the present invention. In one exemplary embodiment of the present invention, a method and/or a system for substituting media content, as discussed in further detail with reference to FIGS. 73-76, comprises an element, step, technology, or other item that FIG. 71 illustrates.

As shown in FIG. 71, the continuous CR\overline{A}V network 7102 can broadcast three-minute CR\overline{A}V ads or ad pods A-T in a continuous manner during the illustrated hour-long segment. Simultaneously, CNS network 7104 can broadcast two conventional thirty-minute programs, comprising content segments 7110 with three-minute ad segments 7112a-f. Additionally, ABS network 7106, on another channel, can broadcast a conventional one-hour program comprising content segments 7114 and three-minute ad segments 7116a-f.

As shown in FIG. 71, the networks 7104, 7106 can link with the continuous CR\overline{A}V network 7102 during selected ad segments 7112d-f and 7116b, d, and f, respectively. During those linked segments, the conventional ad segment on networks 7104, 7106 are replaced with (substituted by) the CR\overline{A}V ad pods E, L, P, and T being broadcast on the continuous CR\overline{A}V network 7102 during the corresponding time slot.

FIG. 71 illustrates that during the first thirty minutes, CNS network 7104 does not link with the CR\overline{A}V network. However, during the second thirty minutes, all of the ads within the CNS network 7104 broadcast program are synchronized to the CR\overline{A}V network 7102 pods L, P, and T. Accordingly, the CR\overline{A}V network pods L, P, and T are substituted for the corresponding CNS network 7104 ad segments. Meanwhile, on ABS network 7106, the second ad pod on the program is synchronized with pod E from the CR\overline{A}V network 7102, as are pods L and R, but the remaining three pods in the program are not CR\overline{A}V ads. Accordingly, the CR\overline{A}V network pods E, L, and R are substituted for the corresponding ABS network 7104 ad segments.

In the example illustrated in FIG. 71, CR\overline{A}V network pod L is shown on three networks. Accordingly, the audience for CR\overline{A}V pod L is larger than other pods on any of the three networks individually.

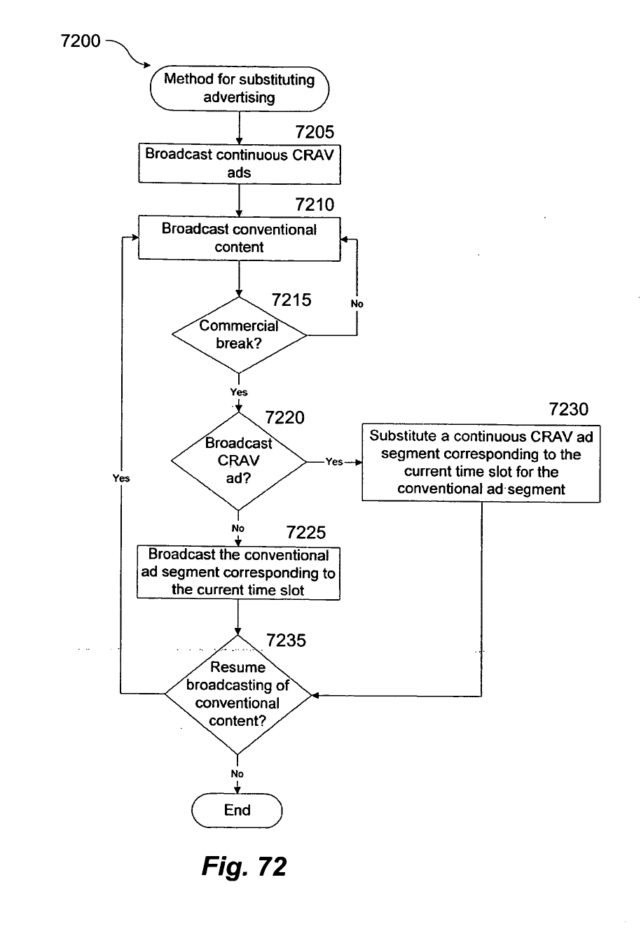

FIG. 72 is a flowchart depicting a method 7200 for substituting a CR\overline{A}V advertisement for a conventional advertisement according to an exemplary embodiment of the present invention. In one exemplary embodiment of the present invention, a method and/or a system for substituting media content, as discussed in further detail with reference to FIGS. 73-76, comprises an element, step, technology, or other item that FIG. 72 illustrates.

Referring to FIG. 72, the CR\overline{A}V network 7102 broadcasts continuous CR\overline{A}V ads or ad pods in step 7205. In step 7210, the CNS network 7104 simultaneously broadcasts conventional content. In step 7215, the CNS network 7104 determines whether it is time for a commercial break in the conventional content. If not, then the CNS network 7104 continues broadcasting the conventional content (step 7210). If it is time for a commercial break, then the method 7200 branches to step 7220.

In step 7220, the CNS network 7104 determines whether to broadcast a CR\overline{A}V ad segment during the commercial break. If not, then the method 7200 branches to step 7225. In step 7225, the CNS network 7104 broadcasts a conventional ad segment corresponding to the current time slot. The method then proceeds to step 7235 in which the CNS network 7104 determines whether to resume broadcasting the conventional content. If yes, then the method branches back to step 7210 to broadcast the conventional content. If not, then the method ends.

If the method 7200 determines in step 7220 to broadcast a CR\overline{A}V ad segment during the commercial break, then the method branches to step 7230. In step 7230, the CNS network 7104 substitutes the continuous CR\overline{A}V ad segment being broadcast during the corresponding time slot of the commercial break for the conventional ad segment. To substitute the CR\overline{A}V ad segment for the conventional ad segment, the CNS network 7104 can receive the continuous broadcast CR\overline{A}V ads and can rebroadcast those ads over the CNS network 7104. The method then proceeds to step 7235 discussed above.

The CR\overline{A}V ad segment substituted for the conventional ad segment can comprise any of the CR\overline{A}V features, such as the alert, vignette, query, answer, response instructions, etc. In an exemplary embodiment, a three-minute CR\overline{A}V ad segment on the CR\overline{A}V network can comprise three thirty-second vignettes, one sixty-second vignette, and thirty seconds of on-screen immersion verification information, which can comprise prize information, log-in instructions, and live awarding and correct answer broadcast. However, the ad pod can comprise any combination of vignettes and immersion verification, as well as an alert and other CR\overline{A}V elements.

When promoting CR\overline{A}V pods on the CR\overline{A}V network, the Promoter achieves audience size “spikes” based on the number and audience sizes of the traditional networks that also broadcast the CR\overline{A}V network ads or pods over the traditional network. During these spike periods, the Promoter can increase the cost of the CR\overline{A}V ads and the size of the substantial rewards being awarded for the effected CR\overline{A}V ad or pod.

The traditional network can elect, during entire program segments, days, or even permanently, to provide, produce, and broadcast only traditional content, and can sell some or all of its commercial inventory time to the CR\overline{A}V network Promoter. That process can eliminate or reduce the traditional network's sales operating costs and activities related to selling advertising time to advertisers. In that case, the CR\overline{A}V network Promoter can add to its own audience size and share the audience size and share of the traditional network during all CR\overline{A}V ad pods that are “piggybacked” by the traditional networks.

In addition to increasing the number of CR\overline{A}V ads being broadcast and the number and size of substantial rewards being awarded, consumer acceptance of CR\overline{A}V ads can allow traditional broadcasters to partition ad segments differently. For example, ad pods can be located at the end of a program, or during a single, extended ad period, as opposed to interrupting content numerous times over the course of a program. Consumers tend to find content interruptions intrusive and disruptive and desire greater spans of uninterrupted content delivery. For example, consumers pay additional fees for premium channels that show uninterrupted content without advertising support. Accordingly, CR\overline{A}V ads tied to a CR\overline{A}V network can change the landscape of traditional mass media delivery, where sections of programs (television, magazines, web sites, etc.) can be distinctly set aside as CR\overline{A}V ad sections, and traditional content can be easier to locate and enjoy in uninterrupted segments.

By recognizing the value of a consumer's time and feedback and by offering CR\overline{A}V ads instead of traditional, non-rewarding ads, the mass media providers can phase out the practice of interrupting content with advertising as a means of forcing consumers to be exposed to ads. The providers can replace the entire ad process with a more civil, friendly approach to delivering consumer-desired ads. This new approach can be built on the principals of mutual respect between networks, advertisers, and consumers, where consumers acknowledge that advertisement provides them with lower cost (or free) programming, and consumers agree to watch, interact, and even embrace CR\overline{A}V ads during extended CR\overline{A}V ad segments in exchange for which networks deliver longer segments of uninterrupted content. Further, ad replacement can occur without or without the consent of the mass media providers.

Automated Substitution of Media Content

In one exemplary embodiment of the present invention, a business disassociated with or competitive to the mass media provider can present consumers with commercial content without necessarily having consent from the mass media provider. Presentation of the commercial content can provide the business with economic benefit or financial value while reducing or eliminating the mass media provider's benefit or value.

In one exemplary embodiment of the present invention, a business entity can replace original commercial content in which the business has little or no economic interest with alternative commercial content in which the business has more economic interest. A media program, such as a broadcast television show or radio program, can have associated original commercial content. That is, a media program can comprise entertainment content, such a scene of a situation comedy, and original commercial content, such as an advertisement. The original commercial content can appear during a commercial break or a program intermission of the entertainment content. Distribution of the original commercial content is intended to economically benefit the mass media provider or the media program's producers or sponsors or some other affiliated party.

A machine or a human can monitor the media program to detect the commercial break or an occurrence of some other commercial event associated with presentation of the original commercial content. In response to detecting the commercial break, presentation of the original commercial content can be manually or automatically interrupted, suspended, or stopped. The alternative commercial content can be presented during the commercial break as a replacement or substitution for the original commercial content, thereby benefiting the business entity. The agent monitoring the media program and/or implementing the substitution can be a party other than the consumer who is the intended recipient of the original commercial content. Thus, a business entity can distribute its commercials or advertisement in a manner that preempts the presentation of another business entity's commercials.

A method and system for substituting media content in accordance with a representative embodiment of the present invention will now be described with reference to FIGS. 73 to 76. The various methods, processes, steps, devices, systems, components, elements and apparatuses illustrated in FIGS. 73-76 can comprise one or more of the various technologies shown in FIGS. 1-72 and discussed above. That is, exemplary embodiments of the present invention can comprise one or more of the methods, processes, steps, devices, systems, components, elements and apparatuses illustrated in FIGS. 1-72 and discussed above combined with one or more of the methods, processes, steps, devices, systems, components, elements and apparatuses illustrated in FIGS. 73-76 and discussed below. Further, it is intended that one of ordinary skill in the art should be able to implement such combinations based on the disclosure and teachings of this writing and the appended figures in combination with that ordinary skill.

Thus, the above disclosed embodiments can be readily adapted to provide methods or systems for media substitution in accordance with exemplary embodiments of the present invention. Moreover, in accordance with exemplary embodiments of the present invention, the below disclosed embodiments can be readily adapted to provide methods or systems for implementing the objectives, results, technologies, processes, or devices discussed above with reference to FIGS. 1-72. Such adaptations are supported by the disclosure and teachings presented herein along with ordinary skills and knowledge that practitioners of the art typically possess.

Turning now to FIGS. 73-76, FIG. 73 illustrates a functional block diagram depicting an exemplary system 7300 for providing media content that comprises substitute, alternative, or replacement commercial content 7380 according to an embodiment of the present invention.

The system 7300 comprises a cable system 7335 for providing, distributing, or broadcasting media content to a plurality of residences 7360, 7360n. One or more sponsoring business entities 7305 typically influence or control, directly or indirectly, certain operations of the cable system 7335. Influenced operations can include the selection of programming for distribution over the cable network 7330. The broadcast media content comprises entertainment content 7320, and accompanying commercial content 7315. That accompanying commercial content 7315 can be referred to as original or initial commercial content 7315 in the sense that the sponsoring business entity 7305 and/or the cable system 7335 typically intents for a linkage to exist between the commercial content 7315 and the entertainment content 7320.

The entertainment content 7320 can comprise a game show, a soap opera, news, sports, educational materials, a situation comedy, live broadcasts, home shopping programming, on-demand video, on-demand shopping videos, movies, weather reports, etc. Presentation of the entertainment content 7320 typically lures or entices the consumers to view or watch the media content as a whole, including the original commercial content 7315.

The sponsoring business entity 7305 can be, for example, a Sponsor, Promoter, or mass media provider that associates the original commercial content 7315 with the entertainment content 7320 in an effort to achieve some financial or economic objective. The sponsoring business entity 7305 usually intends for the consumers to view the original commercial content 7315 in connection with viewing the entertainment content 7320. A soft drink manufacturer might compensate the sponsoring business entity 7305 (or the cable system 7335) for presentation of a soft drink advertisement to a set of consumers, for example.

The original commercial content 7315 can be interlaced in, intermingled with, or embedded in the entertainment content 7320. For example, the broadcast media content can comprise one or more sections or periods of original commercial content 7315 sandwiched, bracketed, or disposed between two sections or periods of entertainment content 7320. A commercial break or programming intermission might have associated original commercial content 7315 in the form of an advertisement, a promotion, or a commercial.

The broadcast server 7310 or some other storage facility or archive holds the original commercial content 7315 and the entertainment content 7320. Under management direction, the cable system 7335 accesses the broadcast server 7310 to assemble the original commercial content 7315 and the entertainment content 7320 into a specific broadcast media program. Alternatively, the cable system 7335 can compose a media program in real time from live entertainment content and/or live commercial content.

The cable system 7335 enlists the broadcast transmitter 7325 to transmit or broadcast the media program, including its original commercial content 7315 and its entertainment content 7320 over the cable network 7330. In exemplary embodiments, the media program can transmit over a cable television network, a VoIP network, a packet-switched network, the Internet, an intranet, a cellular network, a distributed computing network, a telephony network, the PSTN, a personal video network, a regional network, a MAN, a LAN, a VOD network, a satellite network, a wireless network, a closed circuit network, a private network, or a wide area network, to name a few examples. Signals carrying the media program can propagate through an air medium, an electrically conductive wire, a waveguide, an optical medium, or via satellite, for example.

Those experienced in the art will further recognize that numerous communications networks and systems (including presently available systems and future systems) may be substituted or interchanged with the cable network 7330 and/or its associated server 7310.

The sponsoring business entity 7305 typically intends for the consumers of the residences 7360, 7360n to be the recipients of its broadcasts. Each residence 7360 has a set top box 7345 for receiving the signals that carry the media program and an associated television (“TV”) 7350. Each consumer can use a remote control 7355 to control the set top box 7345 and/or the television 7350, for example setting a station channel or implementing a volume adjustment.

The residences 7360, 7360n can be geographically dispersed or can be concentrated in a locale, such as a town, neighborhood, or community. In one exemplary embodiment of the present invention, the residences 7360, 7360n are geographically dispersed but share a common demographic characteristic, such as a socioeconomic standard. The present invention is not limited to a specific number of residences 7360, 7360n, but rather can support an arbitrary number. The system 7300 can comprise a single residence, several residences, several hundred residences, or many thousand residences 7360, 7360n.

In exemplary embodiments, each of the residences 7360, 7360n can comprise a person's home, a hotel, a restaurant, a bar, a lobby, an airport waiting area, or another suitable location for remotely accessing and viewing a video. That is, in one exemplary embodiment of the present invention, the system 7300 can comprise, in substitution for a personal home, various facilities where a person might encounter a media receiver or a media display device, such as the television 7350.

The illustrated functional blocks 7340, 7345, 7350, 7355 of the residence 7360 are representative of other residences 7360n of the system 7300. Thus, each of the residences 7360, 7360n can have an entertainment system or a television system that comprises a set top box 7345, a television 7350, and a remote control 7355 along with a signal integrator 7340, discussed below.

In addition to the cable system 7335, each residence 7360, 7360n is coupled to an alternative content network (“ACN”) 7390 that is a component of a content substitution system 7395. The content substitution system 7395 provides each residence 7360, 7360n with substitute or alternative commercial content 7380 accessed from the commercial server 7375.

The substitution business entity 7365 typically benefits by showing the consumer the alternative commercial content 7380 rather than the original commercial content 7315. The benefits can be tangible or intangible and can comprise economic benefit, financial benefit, competitive benefit, or strategic benefit, for example.

As discussed above, the original commercial content 7315 might comprise an advertisement for a specific brand of soft drink. In this example situation, the alternative commercial content 7380 could comprise an advertisement for a competitive brand of soft drink. The manufacturer or distributor of the competitive soft drink product might compensate the substitution business entity 7365 for showing the consumer the alternative commercial content 7380 rather than the original commercial content 7315. Thus, the competitive soft drink manufacturer would benefit not only from the showing of its own advertisement but also from elimination of its competitor's advertisement.

In one exemplary embodiment of the present invention, the alternative commercial content 7380 comprises one or more CR\overline{A}V ads, a pod of ads, a stream of advertisements or commercial presentations, or some other form of CR\overline{A}V content discussed above.

The content substitution system 7395 comprises a monitor 7370 coupled to the cable network 7330 that monitors or observes media programming broadcast or distributed by the cable system 7335. The monitor 7370 can comprise a sensor, a detector, or an observer that determines occurrences of commercial events or advertising events, such as the airing of a commercial on the cable network 7330. The monitor 7370 can comprise a human, a machine, or a system that comprises a human and a machine.

In one exemplary embodiment of the present invention, the monitor 7370 comprises a person who views programming on a television that receives programming via a set top box connected to the cable network 7330. In this embodiment, the person views programming as it is broadcast over the cable network 7330 to the residences 7360, 7360n. The monitoring observer can be an agent of the substitution business entity 7365 or the content substitution system 7395.

In one exemplary embodiment, when the monitor 7370 determines that a commercial event has occurred, such as a broadcast of a segment of original commercial content 7315, the monitor 7370 sends a signal, message, alert, or notification to the commercial server 7375. If the monitor 7370 determines that the detected commercial event could benefit the substitution business entity 7365, the monitor 7370 can elect to withhold sending the signal. The cable system 7335 might, for example, broadcast an advertisement for a specific product that the substitute business entity 7365 wants to promote.

The commercial server 7375 accesses the alternative commercial content 7380 from storage, such as a machine-readable medium or a tape, and sends that content 7380 to the commercial transceiver 7385. In one exemplary embodiment, the commercial server 7375 provides the alternative commercial content 7380 in response to a trigger signal from the monitor, on an on-demand or as-needed basis. The commercial server 7375 can select a particular advertisement from a library or catalog of advertisements based on real time conditions, demographic information, feedback, statistical data, etc. Alternatively, the commercial server 7375 can provide a continuous stream of advertising content.

The commercial transceiver 7385 transmits or broadcasts the alternative commercial content 7380 over the alternative content network 7390, typically in the form of electrical, optical, or electromagnetic signals. The commercial transceiver 7385 also transmits control signals over the alternative content network 7390 for reception by the remote control 7355. In other words, the content substitution system 7395 engages the commercial transceiver 7385 to send the alternative commercial content 7380 and the accompanying control signals to one or more residences 7360, 7360n via the alternative content network 7390.

In exemplary embodiments, the alternative content network 7390 can comprise a cable television network, a VoIP network, a packet-switched network, the Internet, an intranet, a cellular network, a distributed computing network, a telephony network, the PSTN, a personal video network, a regional network, a MAN, a LAN, a VOD network, a satellite network, a wireless network, a closed circuit network, a private network, or a wide area network, to name a few examples. Signals carrying the alternative commercial content 7380 can propagate through an air medium, an electrically conductive wire, a waveguide, an optical medium, or via satellite, for example.

Those experienced in the art will further recognize that numerous communications networks and systems (including presently available systems and future systems) may be substituted or interchanged with the alternative content network 7390 and/or its associated server 7375.

The alternative content network 7390 can be segregated from the cable network 7330 and/or isolated from the cable network 7330. In a segregated configuration, the signals that carry original commercial content 7315 and entertainment content 7320 to the residence 7360 can avoid traveling along any substantive section of the path traveled by the signals that carry alternative commercial content 7380 to the residence 7360. In another exemplary embodiment of the present invention, each of those signals can propagate in a common medium or a common network leg.

In one exemplary embodiment of the present invention, a single network, such as the Internet, comprises both the cable network 7330 and the alternative content network 7390. Thus, a single network can provide the residence 7360 with connectivity to both the broadcast server 7310 and the commercial server 7375. In this arrangement, the alternative content network 7390 and the cable network 7330 can each comprise a virtual network.

The residences 7360, 7360n can be coupled to either or both of the cable network 7330 and the alternative content network 7390 through a hardwire connection, a wireless connection, or another suitable facility to transfer signals. A hardwire connection can comprise coaxial cable, a fiber optic link, or another suitable connection. A wireless connection can comprise a satellite link, a radio frequency signal path, or another suitable connection.

The set top box 7345 provides the television 7350 with connectivity to the cable network 7330 and the alternative content network 7390 via the signal integrator 7340. The set top box 7345 can provide, comprise, or be a video interface supporting that connectivity. The set top box 7345 can be housed separately from the television 7350, as a unit placed near, beside, or on top of the television 7350. Alternatively, the set top box 7345 can be an integral unit, subsystem, or module of the television 7350, for example circuitry, software, and components that are internal to the television 7350. In one exemplary embodiment, the set top box 7345 comprises functionality dispersed among many components and subsystems of the television 7350. Thus, in certain exemplary embodiments, the set top box 7345 is not a single discrete element.

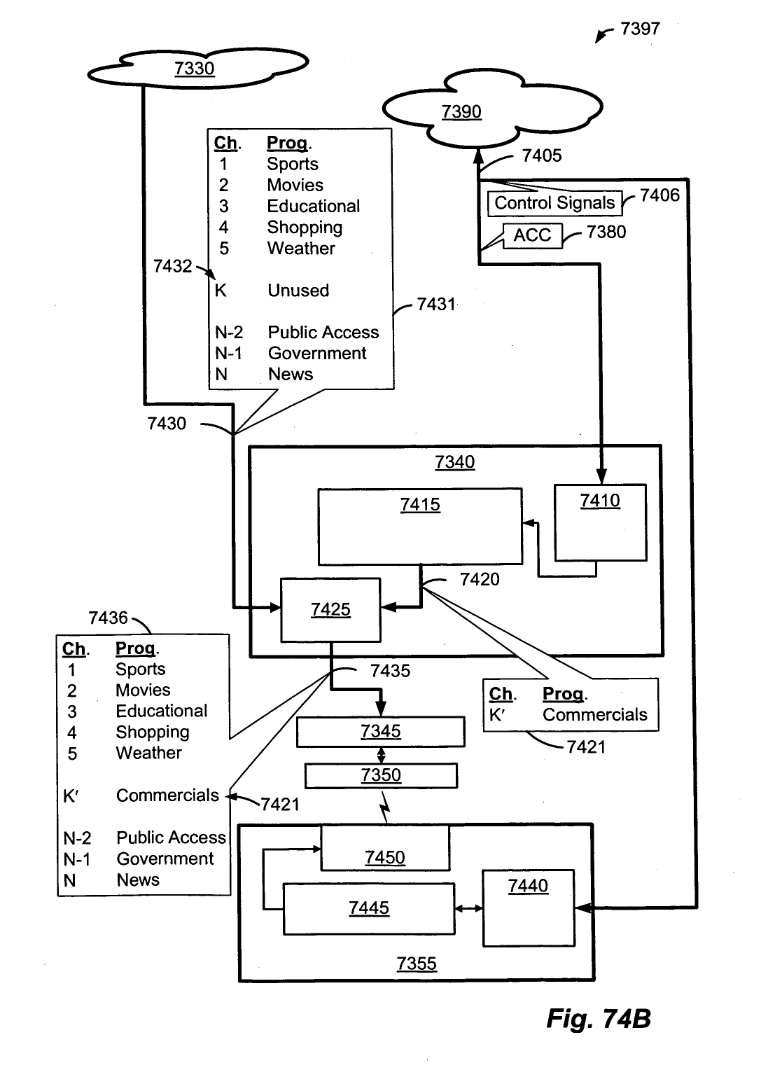

The signal integrator 7340 integrates or combines the signals that carry or convey the alternative commercial content 7380 with the signals that carry or convey the broadcast media content, which comprises entertainment content 7320 and original commercial content 7315. As will be discussed in further detail below with reference to FIG. 74, the signal integrator 7340 places incoming alternative commercial content 7380 onto a channel of the cable system 7335. That channel can be a spare channel or a frequency band that otherwise remains unused, underutilized, or vacant. Alternatively, the signal integrator can remove the cable system's signals from a selected channel and can dedicate that channel to carrying alternative commercial content 7380.

The signal integrator 7380 can be an integral component of the set top box 7345. Alternatively, the signal integrator 7340 can be a separate module or box that is plugged into or otherwise connected to the set top box 7345. The signal integrator 7380 might be supplied by a manufacturer other than the manufacturer of the set top box 7345.

In one exemplary embodiment of the present invention, the supplier of the set top box 7345 does not necessarily condone or approve usage of the signal integrator 7340. In one exemplary embodiment, the management of the cable system 7335 and the sponsoring business entity 7305 may not condone or approve the usage of the signal integrator 7340. Usage of the signal integrator 7340 might not conform to industry standards.

The signal integrator 7340 can support linking the alternative commercial content 7380 with the entertainment content 7320 in a manner that may erode or adversely impact profit of the cable system 7335, the sponsoring business entity 7305, or some affiliated sponsor, advertiser, or marketer. That is, the signal integrator 7340 can perform a function that provides detriment or loss to the cable system 7335 and/or the sponsoring business entity 7305.

The consumer controls the set top box 7345 and the television 7350 with the remote control 7355, which is typically handheld or portable. In a manual mode, the consumer can elect to set the set top box 7345 to receive the alternative commercial content 7380 for display on the television 7350.

In its automatic mode, the remote control 7355 receives control signals issued by the commercial transceiver 7385. Upon receipt of appropriate control signals, the remote control 7355 automatically controls the television 7350 and/or the set top box 7345 to cause the television 7350 to show the alternative commercial content 7380 instead of the original commercial content 7315.

As discussed briefly above and in more detail below, when the monitor 7370 identifies the beginning of a commercial break in the entertainment content 7320, the commercial transceiver 7385 issues a control signal. In response to receiving the control signal, the remote control 7345 tunes the television 7350 (frequently via interaction with set top box 7345) to the channel that carries the alternative commercial content 7380. When the monitor 7370 identifies the conclusion of the commercial break, the commercial transceiver 7385 issues another control signal that prompts the remote control 7355 to return the television 7350 / set top box 7345 to the channel carrying the entertainment content 7320.

Thus, the consumer views the alternative commercial content 7380 rather than the original commercial content 7315, thereby benefiting the substitution business entity 7365 rather than the sponsoring business entity 7305. In other words, to the benefit of the substitution business entity 7365 and the detriment of the sponsoring business entity 7305, the alternative commercial content 7380 preempts the original commercial content 7315.

The remote control 7355 can comprise the remote control 2210, the remote control 3000, the remote control 3410, the remote control 3640, the remote control 4000, the remote control 4510, the remote control 4700, or the remote control 5330, which are discussed above and illustrated in respective figures. Further, in an exemplary embodiment, the remote control 7345 can provide one or more of the features, components, or functions of any of the remote controls 2210, 3000, 3410, 3640, 4000, 4510, 4700, and 5330, as discussed above.

For example, the remote control 7345 can comprise an operability for interacting with media content, for downloading on-demand content, for placing purchase orders, or for responding to surveys or CR\overline{A}V questions/queries presented on an integral display or on the television 7350.

Turning now to FIG. 74, this figure illustrates in further detail representative elements of the system 7300 that the reference number “7397” designates. That is, the system 7300 depicted in FIG. 73 and discussed above comprises the system 7397. Thus, FIG. 74 provides a detailed view of the functional aspects of certain system elements present in the system 7300. Whereas FIG. 74A illustrates the functional blocks and the associated interconnections, FIG. 74B further illustrates representative information or data that signals flowing on those interconnections can carry.

More specifically, FIG. 74 illustrates a functional block diagram of an exemplary system 7397 for replacing original commercial content 7315 with alternative commercial content 7380 according to an embodiment of the present invention. The system 7397 interrupts or halts the presentation of the original commercial content 7315 to the consumer and instead presents the alternative commercial content 7380 to the consumer.

As discussed above, the cable network 7330 broadcasts or otherwise provides various entertainment programming 7431 on an arbitrary number of channels. The channels typically comprise predetermined frequency bands. A conductor 7430, which can be a coaxial cable or some other signal channel, connects the signal integrator 7340 to the cable network 7330. Specifically, the conductor 7430 links the combiner 7425 to the cable network 7330. Thus, the conductor 7430 can carry a lineup of channels 7431 to the signal integrator's combiner 7425. The channel lineup 7431 might comprise a sports channel, a movie channel, an educational channel, a shopping channel, a weather channel, an unused channel 7432, a public access channel, a government channel, and news channel, among others, for example.

The signal path 7405, which can be characterized as a signal channel, provides connectivity to the alternative content network 7390. The signal path 7405 typically comprises a wireless or air medium but can alternatively comprise a wire or conductor. The control signals 7406 and alternative commercial content 7380 propagate on the signal path 7405 for respective reception by the remote control 7355 and the signal integrator 7340.

The signal integrator 7340 comprises a wireless receiver 7410 that receives the alternative commercial content 7380 from the signal path 7405. That is, wireless signals transmitting on the signal path 7405 have been encoded with the alternative commercial content 7380. The wireless receiver 7410 receives those wireless signals, processes the signals, and provides them in electrical format to the encoder 7415.

The encoder 7415 processes the incoming signals that carry the alternative commercial content 7380. More specifically, the encoder 7415 generates a signal having the frequency characteristics of the unused Channel K 7432 but carrying the alternative commercial content 7380. In other words, the encoder modulates a signal with the alternative commercial content 7380 and adapts that modulated signal 7421 to Channel K'(“Channel K-prime”) 7421. The adaptation provides the modulated signal with compatibility to Channel K 7432, which remains unused by the cable system 7335. Thus, Channel K 7432 and Channel K' 7421 have a common frequency band but carry distinct information in that frequency band.

The conductor 7420 transmits the Channel-K'alternative commercial content signal 7421 to the combiner 7425. Meanwhile, the conductor 7430 transmits the cable system's contents 7315, 7320 on Channels 1-N 7431 (with Channel K 7432 unused) to the combiner 7425.

The combiner 7425 blocks the incoming transmission of Channel K 7432 on the signal path 7430 and allows passage of Channel K' 7421 on the signal path 7420. Thus, the output line 7735 of the combiner 7425 carries a set of channels 7436 that comprises the original set of channels 7431 (except unused Channel K 7432) and the alternative commercial content 7380 on Channel K'7421. In other words, the combiner 7425 inserts the alternate commercial content 7380 into the band of the frequency spectrum occupied by Channel K 7432. The combiner 7432 can comprise a band reject or blocking filter for excluding transmission of Channel K 7432 and another filter for allowing transmission of Channel K' 7421.

From the perspective of the set top box 7345 and/or the television 7350, the alternate commercial content 7380 resides on one of the channels 7431 carried by the cable network 7330. Thus, in one exemplary embodiment, the insertion of the alternate commercial content 7380 onto the unused channel 7432 can be transparent to the set top box 7345 and the television 7350. Further, the cable system 7335 can lack visibility into the presence of the alternate commercial content 7380 on Channel K/K' 7432, 7421.

As discussed above, the consumer can use the remote control 7355 for routine interaction with the television 7350 and the set top box 7345, for example implementing channel changes and volume adjustments. The consumer can elect to tune the television 7350 to Channel K' 7421 to view alternative commercial content 7380 as provided by the content substitution system 7395. In other words, in one exemplary embodiment, the content substitution system 7395 provides an ongoing or continuous stream of alternative commercial content 7380 on Channel K' 7421. Channel K' 7421 can carry CR\overline{A}V commercials, CR\overline{A}V advertisements, CR\overline{A}V queries, or another form of CR\overline{A}V content, for example.

The remote control 7355 comprises a wireless transceiver 7440 that can communicate with the commercial server 7375 via exchanging wireless signals over the alternative content network 7390. The remote control's channel selection module 7445 determines the current channel that the consumer has selected and is presumably viewing. In its sending mode, the wireless transceiver 7440 transmits an identification of that current channel selection to the commercial server 7375.

In one exemplary embodiment of the present invention, the remote control 7355 provides content and/or channel identification in accordance with the remote control 3410, the content identifier 3550, and the associated system 3500 discussed above with reference to FIG. 35. The system 7300 identifying content and/or a channel can comprise one or more steps in the Process 4600, which is illustrated in FIG. 46A and 46B and discussed above.

Referring to FIG. 74, as discussed above, the monitor 7370 determines whether a commercial event has occurred, or perhaps is ongoing, on the channel to which the consumer has the television 7350 or its associated set top box 7345 tuned. That is, the monitor 7370 observes the broadcast media programming of the last channel setting that the consumer has entered into the remote control 7355. In this manner, the monitor 7370 identifies commercial breaks in the entertainment content 7320.

In response to the monitor 7370 detecting a commercial event on the channel that the consumer is viewing, the commercial transceiver 7385 outputs the control signal 7406, as discussed above, for receipt by the remote control's wireless transceiver 7440. In response to receiving a control signal 7406 indicating the beginning of a commercial intermission, the remote control's channel selection module 7445 automatically changes the channel of reception to Channel K' 7421. The remote control 7355 comprises an infrared emitter 7450 that outputs light, encoded with control information, for receipt by the television 7350 and/or the set top box 7345. That infrared light carries the channel- change command.

When the monitor 7370 determines that the intermission has concluded or is nearing conclusion, the commercial transceiver 7385 issues another control signal 7406 to inform or notify the remote control 7355 of that event. In response to receipt of the conclusion notification, the channel selection module 7445 changes the channel from Channel K' 7421 back to the channel that the consumer was viewing prior to the commercial intermission. Thus, the consumer can continue viewing, without substantive interruption, the entertainment content 7320 that the cable system 7335 is broadcasting.

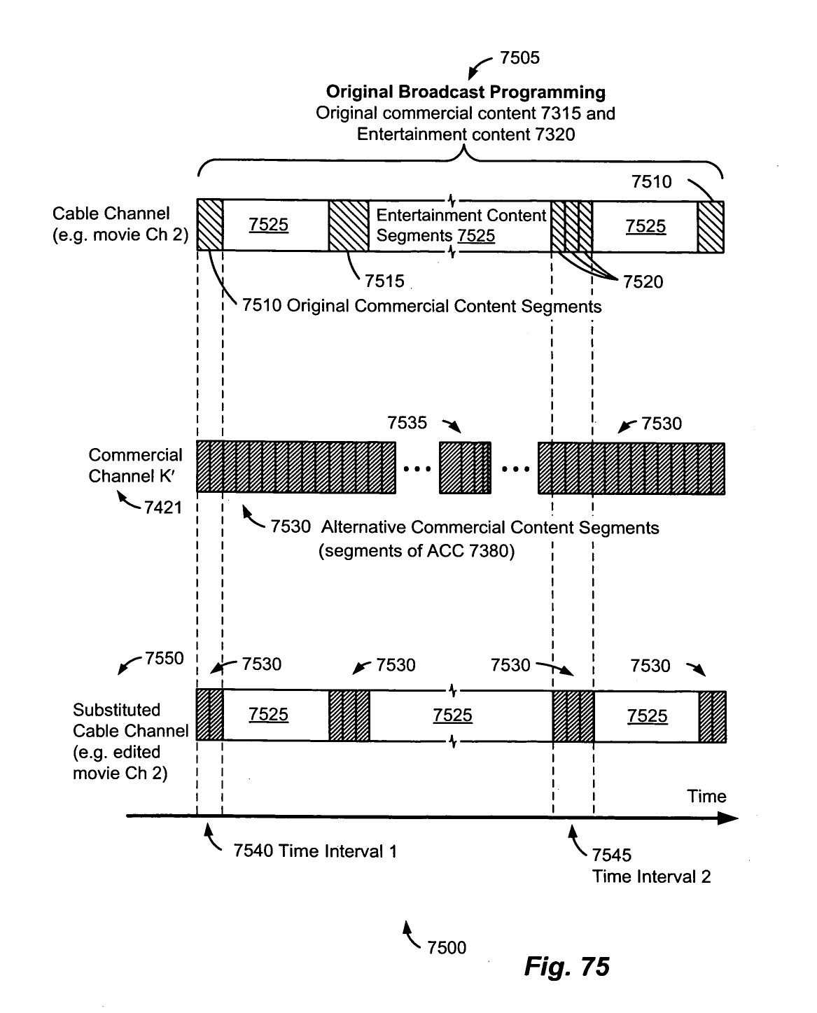

Turning now to FIG. 75, this figure illustrates an exemplary timing diagram 7500 for replacing original commercial content 7315 with alternative commercial content 7380 according to an embodiment of the present invention. The timing diagram 7500 provides a representative illustration of certain operations of the system 7300 and the system 7397, discussed above.

One of the channels 7431 provided by the cable network 7330 carries the original broadcast programming 7505 depicted in the upper portion of the timing diagram 7500. The original broadcast programming 7505 comprises entertainment content 7320 that FIG. 75 depicts as entertainment content segments 7525. The original broadcast programming 7505 further comprises original commercial content 7315 in the form of original commercial content segments 7510, 7515, 7520 of various lengths. The original broadcast programming 7505 might comprise movies on Channel 2 and accompanying commercial advertisements, for example.

Three segments 7520 of original commercial content 7315 occur in time interval two (2) 7545, while a single segment 7510 occurs in time interval one (1) 7540. The segment 7510 might occupy twice the amount of time as the segment 7520. The segments 7520, 7510, and 7515 might respectively last thirty seconds, sixty seconds, and ninety seconds, for example.

The commercial channel K' 7421 provides a stream of commercial segments 7530, 7535. That is, in the embodiment that FIG. 75 depicts, the commercial transceiver 7385 outputs a steady or essentially continuous series of segments 7530, 7535 of alternative commercial content 7380. In addition to providing segments 7530 of essentially fixed length, Channel K' 7421 carries segments 7535 of varying length.

The timing diagram of the substituted cable channel 7550 illustrates the content that a viewing consumer would see on the television 7350 after selecting the cable channel that provides the original broadcast programming 7505. As discussed above, that selected channel might be the movie channel, Channel 2, for example.

Whereas the original broadcast programming 7505 provided original commercial content segments 7510 in time interval one 7540, the television 7350 presents the consumer with two of the alternative content segments 7530 during that time 7540. That is, the content substitution system 7395 controls the content shown during commercial intermissions. More specifically, that system 7395 displaces the original commercial content segments 7510 and instead presents two alternative commercial content segments 7530. In other words, the alternative commercial content segments 7530 preempt the original commercial content segment 7510.

Whereas two alternative commercial content segments 7530 show during time interval one 7540, time interval two 7545 provides sufficient length for presentation of three of the alternative commercial content segments 7530.

In one exemplary embodiment of the present invention, the encoder 7415 can store alternative commercial content segments 7535 of various lengths. The encoder 7415 can select from the stored segments 7535 one or more segments 7535 to fill a particular timeslot. In other words, the system 7397 can select one or more stored segments 7535 that, in combination, run for a length of time that matches the length of a commercial intermission. In this situation, the signal integrator 7340 can delay or buffer the original broadcast programming 7505 to provide the monitor 7370 adequate time to detect the beginning and ending of commercial intermissions.

As one alternative to changing the television's channel of reception, a computer- based machine can autonomously edit the media program 7505 to insert the alternative commercial content 7380 in place of the original commercial content 7315. Such a computer-based machine can operate on the signals that carry the media program 7505 or that are encoded with the media program 7505. The computer-based machine can also edit the media program 7505 by processing components of the media program 7505 stored on a storage device or held temporarily in a buffer.

As another example of implementing the showing of the alternative commercial content 7380, a storage medium at the residence 7360 could hold alternative commercial content 7380. That is, the system 7397 can access content from an onsite location for presentation in the timeslots 7540, 7545 of the original commercial content segments 7510, 7520.

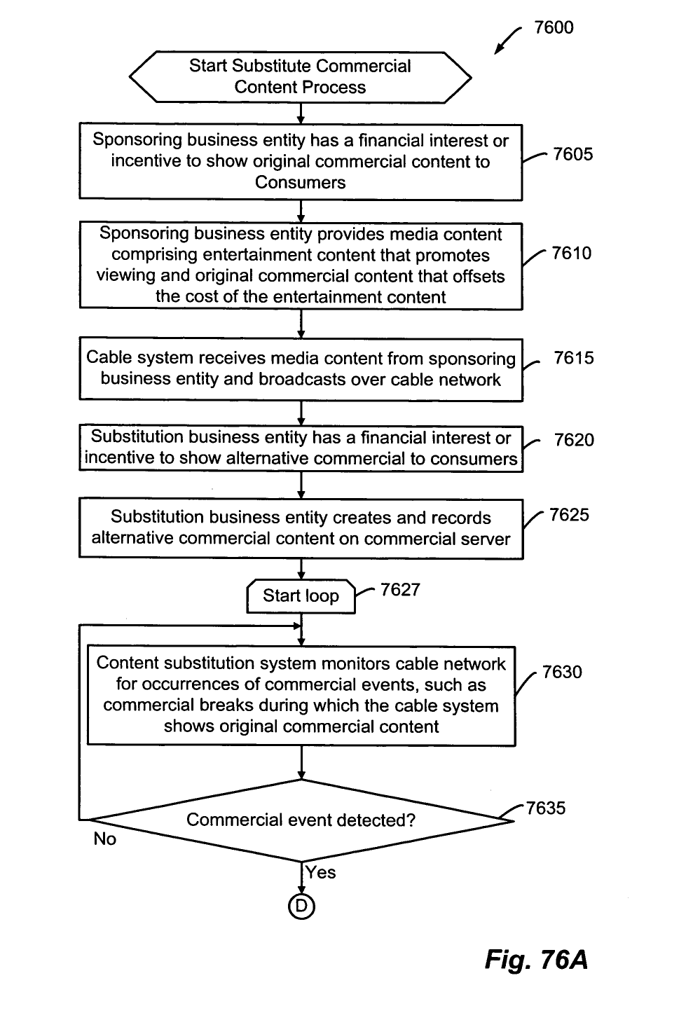

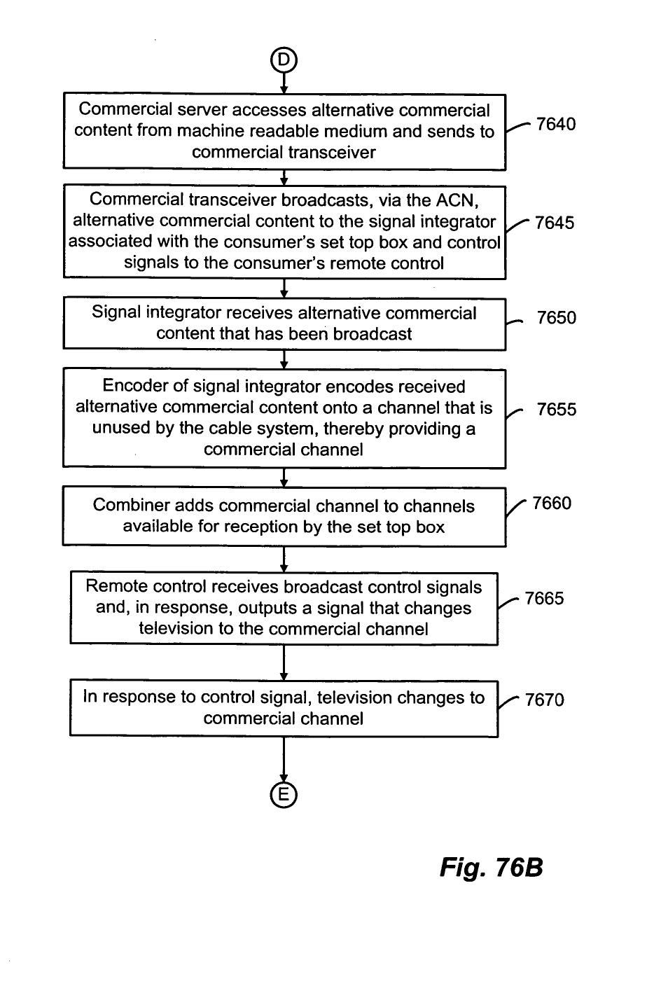

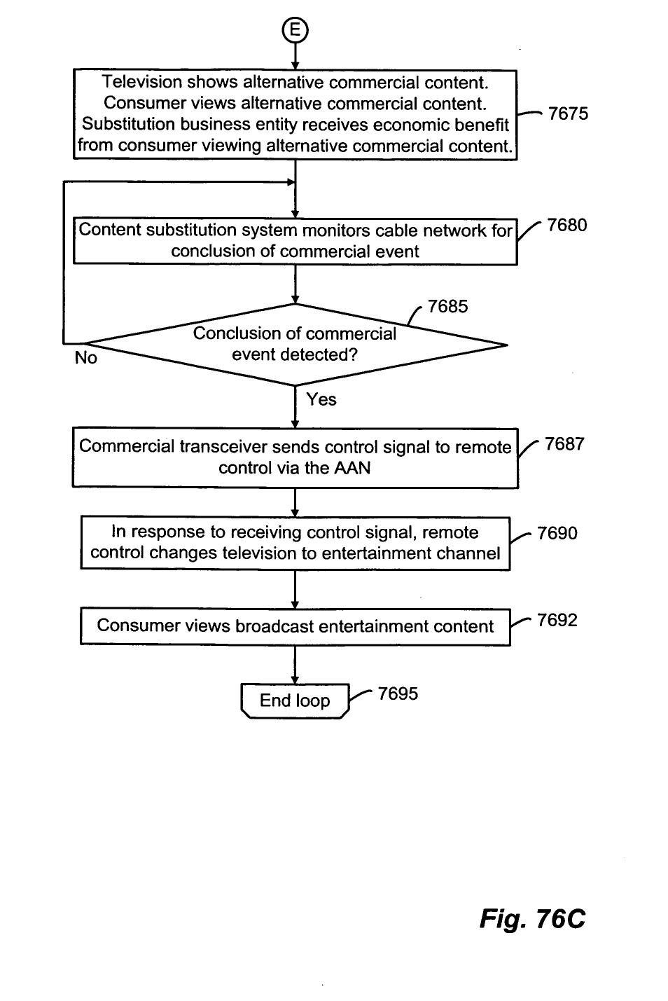

Turning now to FIG. 76, this figure illustrates a flowchart of an exemplary process 7600 for replacing original commercial content 7315 with alternative commercial content 7380 according to an embodiment of the present invention. The system 7300, illustrated in FIG. 73 and discussed above, can perform the Process 7600, which is entitled Substitute Commercial Content.

At Step 7605, the sponsoring business entity 7305 has a financial interest or incentive in showing the original commercial content 7315 to the consumers. The sponsoring business entity 7305 might be under contract with a manufacturer to market a particular product using broadcast media or some other method for distributing advertisements, for example.

At Step 7610, the sponsoring business entity 7305 assembles or provides media content comprising entertainment content 7320 and commercial content 7315 that can be characterized as original commercial content 7315. The media content could be the original broadcast programming 7505 illustrated in FIG. 75 and discussed above, for example.

The entertainment content 7320 promotes viewership of the original commercial content 7315. Whereas the sponsoring business entity 7305 might receive no direct compensation for providing the entertainment content 7320 (and might even pay for the right to distribute entertainment), product manufacturers typically pay the sponsoring business entity 7305 for distributing advertisements. Moreover, the sponsoring business entity 7305 can comprise a product manufacturer or distributor whose goods are the subject of the original commercial content 7315.

At Step 7615, the sponsoring business entity 7305 enlists or employs the cable system 7335 to broadcast the entertainment content 7320 and the accompanying original commercial content 7315. In one exemplary embodiment, the sponsoring business entity 7305 produces the original broadcast programming 7505 and sends that programming 7505 to the cable system 7335. The cable system 7335 broadcasts the entertainment content 7320 and the original commercial content 7315 over the cable network 7330 with the intention of its presentation on the residential televisions 7350 of the residences 7360, 7360n.

At Step 7620, the substitution business entity 7365 has a financial interest or incentive to present the alternative commercial content 7380 to the consumers. The substitution business entity 7365 might have a contract with a particular product supplier that seeks to promote its products to the consumers, for example. Thus, the substitution business entity 7365 can receive financial compensation from a third party for presenting substitution advertisements at the residences 7360, 7360n.

At Step 7625, the substitution business entity 7365 produces or acquires alternative commercial content 7380 and places that content 7380 on the commercial server 7375 of the content substitution system 7395.

Start loop Step 7627 serves as a loop return point, as discussed in further detail below with reference to end loop Step 7695.

At Step 7630, the monitor 7370 of the content substitution system 7395 monitors or observes the programming content 7505 that the cable system 7335 is broadcasting or distributing on the cable network 7330. The monitor 7370 typically observes multiple channels 7431 but can alternatively monitor a single channel. The single monitored channel may be linked to a particular demographic group or of interest to a client of the substitution business entity 7365, for example. Specifically, the monitor 7370 seeks to identify occurrences of commercial events, such as promotional events, sales presentations, advertisements, programming intermissions, commercial breaks, etc.

Decision Step 7635 iterates Step 7630 until the monitor 7370 detects a commercial event. When the monitor 7370 detects a commercial event, execution of Step 7640 follows Step 7635.

At Step 7640, the commercial server 7375 accesses the alternative commercial content 7380 from a machine readable medium, such as a hard drive, a magnetic tape, or a bulk video storage device. The commercial server 7375 sends the accessed alternative commercial content 7380 to the commercial transceiver 7385 for transmission on the alternative content network 7390 at Step 7645.

As an alternative to transmitting the alternative commercial content 7380 in response to the detection at Step 7635 of a commercial event, as illustrated in the flowchart of FIG. 76, the commercial transceiver 7385 can transmit a stream or series of alternative commercial content segments 7530, 7535. As discussed above, FIG. 75 illustrates a representative temporal arrangement of such a stream of alternative commercial content segments 7530, 7535. In such an exemplary embodiment, Step 7640 and the transmission of the alternative commercial content 7380 can follow Step 7630 and precede Step 7635.

Returning to the exemplary embodiment of Process 7600 that the flowchart of FIG. 76 illustrates, at Step 7645, the commercial transceiver 7385 sends the alternative commercial content 7380 to the signal integrator 7340. The commercial transceiver 7385 also sends a notification of the start of the commercial event to the remote control 7355 via the alternative content network 7390.

At Step 7650, the signal integrator 7340 receives the alternative commercial content 7380. At Step 7655, the encoder 7415 places the alternative commercial content 7380 on a channel 7421, 7432 that remains unused by the cable system 7335. Alternatively, the encoder 7415 can place the alternative commercial content 7380 on a channel that the consumer designates as unneeded or as carrying content that does not interest the consumer.

At Step 7660, the combiner 7425 combines the newly created commercial-content channel 7421, with the other channels 7431 broadcast on the cable network 7330. As discussed above, the combiner 7425 can integrate those channels using filtering schemes known in the art in combination with the guidance of the present disclosure and teaching.

At Step 7665, the remote control 7355 receives the control signals 7406, which indicate a beginning of a commercial event, from the alternative content network 7390. The remote control 7355 outputs an infrared signal that, at Step 7670, automatically changes the television 7350 to the channel 7421 designated at Step 7655. As discussed above that designated channel 7421 has been adapted to carry the alternative commercial content 7380.

In one exemplary embodiment, if the consumer has recently tuned the television 7350 to a channel that is not carrying the detected commercial event, then the remote control 7355 withholds outputting, at Step 7665, an infrared signal that changes the television 7350 to the channel 7421 designated at Step 7655. Thus, the remote control 7355 can make a determination regarding whether the channel should be changed based on the consumer's last channel selection and the control signals 7406 issued by the commercial transceiver 7385. In other words, the remote control 7355 can override certain commands based on current conditions.

Alternatively, as discussed above, the remote control 7355 can notify the content substitution system 7395 about the current state of the television 7350. In other words, logic or rules that determine whether the remote control 7355 should autonomously change the television channel can reside at the remote control 7355, at the commercial server 7375, or at the monitor 7370. Further, such logic can be distributed among multiple components of the system 7300.

In one exemplary embodiment of the present invention, Process 2800, or a derivative thereof, automatically controls the television 7350 or the set top box 7345 for reception and presentation of alternative commercial content 7380 or some other substitution media content. FIG. 28 illustrates a representative flowchart for Process 2800, as discussed above. Thus, an exemplary embodiment of a method for preempting presentation of one commercial with presentation of another commercial can comprise one or more of the steps of Process 2800. Moreover, substituting content on a media network can comprise any of the disclosure or teachings discussed above with reference to the flowchart of FIG. 28 or the related systems.

In one exemplary embodiment of the present invention, the substitution of advertising content proceeds in accordance with the disclosure and/or teachings of FIGS. 71 and 72 and the accompanying discussion. Thus, an exemplary process for substituting advertising content that benefits a selected party can comprise one or more of the steps of Process 7200 as discussed above with reference to FIG. 72.

Referring now to FIG. 76C, at Step 7675, the television 7350 shows the alternative commercial content 7380 to the consumer. The substitution business entity 7365 gains some advantage or benefit, typically but not necessarily economic, from presentation of the alternative commercial content 7380 to the consumer in place of the original commercial content. Moreover, the consumer can interact with the commercial content via a CR\overline{A}V interaction or ordering a product, for example.

At Step 7680, the monitor 7370 continues observing activities or communications on the cable network 7330 in anticipation of the commercial event concluding. The monitor 7370 can process signals propagating on the cable network 7330 to detect the conclusion, for example.

Decision Step 7685 repeats Step 7680 until the commercial event concludes, indicating that the cable network 7330 is or soon will be transmitting entertainment content 7320 of interest to the consumer. When the cable network 7330 returns to providing entertainment content and/or concludes the commercial event, then Process 7600 executes Step 7687.

At Step 7687, the commercial transceiver 7385 sends an updated control signal 7406 to notify the remote control 7355 that the television 7355 should be returned to the last channel selected by the consumer.

At Step 7690, in accordance with the notification, the remote control 7355 tunes the television 7350 to the previously selected channel. The consumer returns to viewing the entertainment content 7320 on that channel at Step 7692.

End loop Step 7695 returns the flow of Process 7600 to the start loop Step 7627, thereby iterating the process steps that follow Step 7627. In this manner, Process 7600 can continue identifying commercials that do not benefit the substitution business entity 7365 and can preempt presentation of those commercials with presentation of other commercials that do benefit the substitution business entity 7365. Thus, Process 7600 can provide commercial content that benefits a selected party or business entity.

Although specific embodiments of the present invention have been described above in detail, the description is merely for purposes of illustration. Various modifications of, and equivalent steps corresponding to, the disclosed aspects of the exemplary embodiments, in addition to those described above, also can be made by those skilled in the art without departing from the spirit and scope of the present invention defined in the following claims, the scope of which is to be accorded the broadest interpretation so as to encompass such modifications and equivalent structures.

What is claimed is:

1. A method for preempting advertisement presentation, comprising the steps of:
on behalf of a first business entity, determining whether a media channel carries an advertisement of a second business entity for presentation on a media receiver; and
if the media channel is determined to carry the advertisement, preempting presentation of the advertisement on behalf of the first business entity.

2. The method according to claim 1, wherein the step of preempting presentation of the advertisement comprises presenting on the media receiver a second advertisement that benefits the first business entity.

3. The method according to claim 2, further comprising the step of presenting a user of the media receiver with a question about the second advertisement.

4. The method according to claim 1, wherein the step of preempting presentation of the advertisement comprises tuning the media receiver from the media channel to a second media channel.

5. The method according to claim 1, wherein the media receiver is located at a premises, and
wherein the step of determining whether the media channel carries the advertisement comprises monitoring signals of the media channel from a location offsite of the premises.

6. The method according to claim 1, wherein the step of preempting presentation of the advertisement further comprises preempting presentation of the advertisement to the detriment of the second business entity, and wherein the method further comprises the step of receiving payment from the first business entity for preempting presentation of the advertisement.

7. The method according to claim 1, wherein the advertisement is about a first product, and
wherein the step of preempting presentation of the advertisement comprises presenting another advertisement for a second product that is competitive with the first product.

8. A method for controlling advertisement presentation to economically benefit a business entity, comprising the steps of:
providing a plurality of advertisements in which the business entity has at least a level of economic interest;
monitoring a media program to detect another advertisement in which the business entity has less economic interest than the level;
interrupting presentation of the another advertisement in response to detecting the another advertisement; and
presenting one of the plurality of advertisements during the interruption.

9. The method according to claim 8, further comprising the step of continuing presentation of the media program following presentation of the one of the plurality of advertisements during the interruption.

10. The method according to claim 8, wherein the business entity has essentially no economic interest in the another advertisement, and
wherein the step of presenting one of the plurality of advertisements comprises
on behalf of the business entity, presenting the one of the plurality of advertisements during the interruption.

11. The method according to claim 8, wherein the step of detecting the another advertisement comprises automatically detecting the another advertisement, and
wherein the step of presenting one of the plurality of advertisements comprises automatically presenting the one of the plurality of advertisements during the interruption.

12. The method according to claim 8, wherein the step of interrupting the presentation comprises tuning a television to a selected channel in advance of presentation of the another advertisement.

13. The method according to claim 8, wherein the step of providing the plurality of advertisements comprises storing on a machine-readable medium the plurality of advertisements in which the business entity has at least the level of economic interest.

14. The method according to claim 13, wherein the step of presenting one of the plurality of advertisements comprises accessing a selected one of the plurality of advertisements from the machine-readable medium and presenting the accessed one of the plurality of advertisements during the interruption.

15. The method according to claim 8, further comprising the step of selecting one of the plurality of advertisements based on duration, and
wherein the step of presenting one of the plurality of advertisements comprises presenting the selected one of the plurality of advertisements during the interruption.

16. The method according to claim 8, further comprising the step of selecting one of the plurality of advertisements based on content, and
wherein the step of presenting one of the plurality of advertisements comprises presenting the selected one of the plurality of advertisements during the interruption.

17. The method according to claim 8, wherein the step of monitoring the media program comprises a representative of the business entity monitoring the media program.

18. The method according to claim 8, wherein the step of presenting the one of the plurality of advertisements comprises presenting content on a video monitor, and
wherein the step of monitoring the media program comprises automatically monitoring the media program from a site that is remote from the video monitor.

19. The method according to claim 8, wherein the media program comprises one of a broadcast television program and a radio program.

20. The method according to claim 8, wherein monitoring the media program comprises monitoring signals propagating on a packet-switched network.

21. The method according to claim 8, wherein the presenting step comprises presenting the one of the plurality of advertisement to a consumer during the interruption, and wherein detecting the another advertisement comprises an agent other than the consumer detecting the another advertisement.

22. The method according to claim 8, further comprising the step of offering a viewer a reward for correctly answering a query about the one of the plurality of advertisements.

23. The method according to claim 8, further comprising the step of associating a content query with each of the plurality of advertisements.

24. A computer-implemented method for preempting commercial content, comprising the steps of:
monitoring a media program for a presence of first commercial content; and
in response to detecting the presence of the first commercial content, preempting presentation of the first commercial content on a video monitor with presentation of second commercial content on the video monitor.

25. The method according to claim 24, wherein the step of monitoring the media program comprises monitoring a presentation of the media program on a second video monitor for the presence of the first commercial content.

26. The method according to claim 24, wherein the step of preempting presentation of the first commercial content comprises:
in response to detecting the presence of the first commercial content, transmitting a message over a packet-switched network; and
in response to receipt of the message, preempting presentation of the first commercial content on the video monitor with presentation of the second commercial content on the video monitor.

27. The method according to claim 24, wherein a first business entity has an economic interest in presentation of the first commercial content on the video monitor,
wherein preempting presentation of the first commercial content on the video monitor comprises benefiting a second business entity that competes with the first business entity, and
wherein presentation of the second commercial content on the video monitor comprises benefiting the second business entity.

28. The method according to claim 24, wherein the preempting step comprises, in response to detecting the presence of the first commercial content, an agent other than a viewer of the video monitor preempting presentation of the first commercial content on the video monitor with presentation of the second commercial content on the video monitor.

29. A computer-implemented method for replacing advertising content with alternative advertising content, comprising the steps of:
detecting an occurrence of an advertising event in response to monitoring a first channel that carries the advertising content to a content receiver;
in response to detecting the occurrence of the advertising event, automatically setting the content receiver to a second channel for reception of the alternative advertising content during the advertising event; and
automatically setting the content receiver to the first channel following the occurrence of the advertising event.

30. The method according to claim 29, wherein monitoring the first channel comprises using a monitoring device to monitor signals transmitted on a network.

31. The method according to claim 29, wherein detecting the occurrence of the advertising event comprises automatically detecting a commercial break of an entertainment program.

32. The method according to claim 29, further comprising the step of offering a viewer of the alternative advertising content a reward for submitting a correct answer to a question about the alternative advertising content.

33. The method according to claim 29, further comprising the step of providing an essentially continuous feed of advertisements on the second channel.

34. The method according to claim 33, wherein the method further comprises the step of associating with each advertisement in the feed of advertisements a respective question about a featured product.

35. The method according to claim 33, wherein a selected advertisement in the 30 feed of advertisements comprises the alternative advertising content.

36. The method according to claim 29, wherein carrying the advertising content to the content receiver comprises transmitting signals on a first network, segregated from a second network, and
wherein the method further comprises the step of transmitting the alternative advertising content on the second network for reception by the content receiver.

37. The method according to claim 36, wherein one of transmitting the signals on the first network and transmitting the alternative advertising content on the second network comprises transmitting information via Internet protocol.

38. The method according to claim 36, wherein one of the first network and the second network comprises a packet-switched network.

39. The method according to claim 29, further comprising the step of accessing the alternative advertising content from a machine-readable medium for presentation on the second channel.

40. The method according to claim 39, further comprising the step of transmitting the accessed alternative advertising content from a remote server to the content receiver for reception during the advertising event.

41. The method according to claim 29, wherein the content receiver comprises one of a television and a radio.

42. The method according to claim 29, wherein the step of automatically setting the content receiver to the first channel comprises automatically setting the content receiver to the first channel in connection with conclusion of the advertising event.

43. A computer-based method for controlling a media receiver, comprising the steps of:
monitoring a first media channel for a presence of first commercial content;
determining whether a user has set the media receiver to the first media channel; and
if the user is determined to have set the media receiver to the first channel and the presence of the first commercial content is detected, automatically tuning the media receiver to a second media channel for reception of second commercial content.

44. The computer-based method according to claim 43, further comprising the step of providing a stream of commercial content sections on the second media channel,
wherein one of the commercial content sections comprises the second commercial content, and
wherein the step of monitoring the first media channel comprises monitoring the first media channel by an agent other than the user.

45. A method for replacing commercial content associated with a broadcast, comprising the steps of:
monitoring the broadcast, comprising first commercial content transmitted over a first network and intended for presentation during a commercial break by a broadcast receiver on a first channel;
changing the broadcast receiver from the first channel to a second channel in response to detecting the commercial break; and
providing, via a second network, second commercial content on the second channel for reception by the broadcast receiver and presentation during the commercial break.

46. The method according to claim 45, wherein the broadcast receiver comprises a television system,
wherein the first commercial content comprises a first advertisement and the second commercial content comprises a second advertisement,
wherein the step of detecting the commercial break comprises detecting the commercial break using a machine, and
wherein the method further comprises the step of changing the television system from the second channel to the first channel following reception by the television system of the second advertisement.

47. The method according to claim 45, wherein the first commercial content features a first product of a first business entity,
wherein the second commercial content features a second product of a second business entity, and
wherein the method further comprises the step of receiving compensation from the second business entity for providing the second commercial content during the commercial break.

48. The method according to claim 45, wherein the step of providing the second commercial content further comprises accessing the second commercial content from a machine-readable medium.

49. The method according to claim 45, wherein the step of providing the second commercial content further comprises accessing the second commercial content from a remote server in response to detecting the commercial break.

50. The method according to claim 45, wherein the first network is segregated from the second network.

51. The method according to claim 45, further comprising the step of offering a user of the broadcast receiver a reward for answering a question about the provided second commercial content.
